(19) United States
(12) Patent Application Publication
(10) Pub. No.: US 2025/0252508 A1
(43) Pub. Date: Aug. 7, 2025

(54) SYSTEM FOR ASSESSING SILENT BIAS

(71) Applicant: Chenope, Inc., Half Moon Bay, CA (US)

(72) Inventors: Elizabeth CHARNOCK, Half Moon Bay, CA (US); Steven ROBERTS, Half Moon Bay, CA (US); Philip WANG, Washington, DC (US)

(21) Appl. No.: 19/049,949

(22) Filed: Feb. 10, 2025

Related U.S. Application Data
(60) Provisional application No. 63/551,000, filed on Feb. 7, 2024.

(51) Int. Cl. G06Q 50/00

(52) U.S. Cl. CPC G06Q 50/01

(57) ABSTRACT

Systems and methods described herein involve detecting silent bias across media platforms, comprising executing several empirical models on media across different media outlets to detect silent bias such as strategic omission. Other bias may also be detected across the media platforms in accordance with the example implementations. Example implementations described herein can be executed in a hardware/software hybrid system, or a pure hardware system to facilitate the desired implementation.

### CROSS-REFERENCE

This application claims priority to U.S. Provisional Patent Application No. 63/551,000, with a filing date of Feb. 7, 2024, the disclosures of which are incorporated herein by reference in its entirety.

### FIELD OF THE INVENTION

The present invention relates to detecting and measuring the ways in which different types of media coordinate in order to influence the public perception of individuals, entities or issues. The invention disclosed in this application does this using pragmatic intent markers rather than traditional sentiment analysis techniques, as these are ill-suited to detecting many types of more subtle or context-bound bias. Most importantly, it performs its measurements in an objective and unbiased way. The invention is suitable for any type of media, from individual user accounts operating on a given social media platform to large, traditional media outlets.

### BACKGROUND

Much has been written in recent years about the combination of “new” media becoming the means by which much of the public understands the world around them, and the polarization of society. Such increasing polarization creates strong incentives for media of all kinds and sizes to either or both align themselves with the biases of particular segments of the population and/or to try to shift the viewpoints of adjacent or “independent” segments of the public, whose views may be open to manipulation over time—but not to immediate, outright proselytization.

As a result, “objective” analysis of news and events becomes increasingly more difficult to come by. During bitterly-contested election seasons such as the 2024 U. S. presidential election, questions of media bias or “gaslighting”—including the social media platforms themselves—rise to the forefront public debate and consciousness. Just how much actual, measurable bias is there? How much of a threat to society does it pose? Yet as of this writing, scalable, objective means of assessing the degree of such bias remain elusive-despite the increasing desire of political parties, governments, advertisers, investors and just members of the general public to understand it.

Whether it is so-called “new” media or traditional media, very few media outlets would try to claim that they have never succumbed to bias in their reporting or analyses. This is to be expected. However, an apt analogy is that of resumés. Experienced hiring managers understand that perhaps 20% of most candidates' resumés are exaggeration or worse. Nonetheless, resumés remain a useful and highly-used filtering tool for candidates. This is because they are assumed to be “true enough” the majority of the time. If, however, it ever became generally understood that 80% rather than 20% was exaggeration or worse, the resumés would lose all validity as a useful hiring tool. Arguably we are reaching that point in the U. S. with respect to most media as of this writing. This means that a critical need exists for systems that can monitor public information sources for objectivity.

It is important to understand the injection of bias and the resultant attempted exertion of influence as the desired outcome of a collection of a great many individual editorial or creative decisions. This includes what news topics are amply covered and which are ignored—and not simply as to whether positive or negative sentiment comments are being made about a particular named entity. Direct, evidently polarity-bearing statements such as ad hominem insults are unlikely to change many opinions in a highly-polarized society. Rather, if hearts and minds are to be altered at any meaningful scale, it must generally be done by creating an information environment that leads (at least some) people to arrive at their own conclusion that a given thing is good—or bad—based on their understanding of the facts. Thus, while the creation or amplification of a particular sentiment is the desired outcome, it is increasingly likely to be done with little or no explicitly sentiment-bearing statements.

### Technical Obstacles

The problem of bias measurement is thus an extraordinarily difficult one. This is ultimately for two main reasons. First, because for the measurement to have real world commercial value, a solid case must be makable for its own objectivity and accuracy-both of which require a good number of orthogonal, difficult-to-argue-with markers. Secondly, because inserting bias is often successfully achieved by consistently omitting key information so that much of the public is left simply unaware of it. It is much easier to establish patterns based on the presence of information rather than its absence. Furthermore, much as is the case in the legal realm with respect to fraud, one aspect of the measurement should be the apparent intent to exert influence. Measuring intent is also a difficult problem.

A key technical implementation difficulty is that full natural language processing, especially on large corpora of current events, simply does not work very reliably for many use cases—and will not work reliably in the future in this particular use case, either. The reasons for this include:
1. Large corpora of current events may contain important novelties that can't be pretrained into an LLM, ML, or other model that must, by necessity, rely on prior knowledge. To take a very simplistic example, the actual arrival of a spaceship on Earth would initially flummox such models who would all “know” that aliens from outer space only exist in science fiction. (While such an example might at first blush be easy to dismiss as an edge case, the reality is that such high impact edge cases can have significant national security implications.)
2. Disagreements as to what's true about a given situation are often rampant. Any automated analysis that is capable of properly handling negations will find plenty of contradictory information about a great many topics of interest in the news in a free society. Algorithmic mechanisms to trust opinions of those with, for example, a greater number of followers, references, better social network, more “likes” or other user engagement actions, or credentials, would not only insert subjectivity—and a deeply undesirable dependency on black box algorithms used by various social media platforms—but would also have to grapple with the difficulties of assessing the boundaries of each “expert's” knowledge and adjusting appropriately.
3. Past a certain point, any automated interpretation is foiled by the inherent ambiguity and subjectivity of text, which requires a large amount of shared subtle context between the reader and the author in order to be understood properly. This is especially true at a global scale, at which many different languages, dialects, and subcultures, with their own distinctive histories, must be taken into account.
4. The increasing presence of active hybrid warfare wreaks additional chaos because actual real-world events may in fact be artificially made to occur, and are then rightly reported on. Thus, the event itself in such cases is a form of disinformation. Unfortunately, such cases are not always questioned or recognized initially, which means that an event can almost “unhappen” at a future point. A true understanding of hybrid war is not likely trainable.

### Less Blatant is More Effective

While specific instances of blatant lack of media objectivity in the case of well-known, large media outlets may provoke the occasional public backlash, the likely ultimate result will be the emergence of more subtle methods of trying to accomplish the same thing. Trends in state-actor or para-statal organization (such as terrorist groups) disinformation point in this direction. The use of subtler, longer, more multi-channel, and more narratively complex content is becoming more common simply because it is more effective for generating influence that is more sustained and ingrained. The fact that various forms of Generative AI greatly facilitate this only accelerates the existing trend.

Such subtler and more indirect methods, in fact, possess a number of key advantages for those wishing to quietly exert influence. While specific pieces of “fake news” or “deep fakes” can be debunked fairly quickly and easily with great fanfare, harder-to-pinpoint bits and pieces of content cannot be. Similarly, it is easier to inoculate the public against the more obvious fakes, since they are by definition both a) discrete, concrete, usually easily traceable pieces of information, and b) highly improbable- or at least would be highly newsworthy because of its improbability, if in fact true.

By “harder-to-pinpoint” content, we mean the repeated use of content—very often distributed among different voices (e.g., user accounts, reporters)—which relates to a particular named entity and which have amorphous aspects. This includes but certainly isn't limited to the following types of statements:
1. Interpretations. Example: “President Zelensky is on the brink of exhaustion. It doesn't seem as if he will be able to continue in office.”
2. Statements involving quantity that avoid quantification, or that use universal quantification. Example: “Macron's party has been falling in most of the polls.” and “All of Ukraine's cities are lying in rubble.”
3. Use of questions. Example: “How long can Ukraine hold out?”
4. Use of predictions. Example: “If Trump is elected, he will immediately cut off all aid to Ukraine.”
5. “Experts agree” statements. Example: “Most experts agree that a ceasefire will be difficult to achieve.”

These classes of examples share two key traits in common:
None assert actual, objective, verifiable facts—or indeed provide much in the way of specifics at all. So, not only can they not be fact-checked; the individual instances are difficult to recall exactly because of their lack of distinctiveness. However, if they appear repeatedly, emanating from an apparently large number of sources, they collectively create a shared impression of reality.
None of them actually employs negative sentiment about any named entity. In other words, none of them explicitly makes any intrinsic positive or negative assertions about any named entity-only assertions about the named entity in a particular context. For example, the statement “Joe didn't sleep well last night,” whether or not true, lacks the pragmatic intent of making a negative statement about what kind of person Joe might be.

No computer system can be a consistently accurate arbitrator of ground truth, just as no person can. The biases of the human trainers and designers inevitably find their way into the system. Sometimes the rare outlier opinion is unexpectedly proven correct. Even some well-accepted ground truths sometimes change or even reverse over the course of time. Increasingly complex issues dominate our world. This often makes accurate determinations of ground truth dependent on the ready availability of numerous pieces of supporting context. In many cases, owing to this complexity, reasonable people can disagree even if presented with ample context. Therefore, both humans and computers will struggle and ultimately fail to determine ground truth on a variety of important topics. Unlike a human however, a computer system can identify a range of artifacts in the characteristics of content over time that very strongly suggest an intent to manipulate. That is the aim of the system disclosed in this application.

The measurement of many of these artifacts is already possible to a high degree of accuracy with existing methods—named entity recognition (NER), for example, is generally acknowledged to exceed 90% accuracy. While this does not hold true of all of the artifactual measurements described in this application, reliance on the number of largely independent high-accuracy artifacts can help over time raise the accuracy of the relatively less accurate measurements as well. Further, it can be hoped that over time, the state of the art of the different types of analyses referenced in this document will continue to improve, at least incrementally. Most importantly, perhaps, to the extent that no automated measurement is totally without flaw or unanticipated edge case, when these measurements are off, it will be along vectors that are totally orthogonal to any type of political bias. This is because the system does not rely upon traditional sentiment analysis techniques, nor any type of assessment, of any provenance, of what is or is not ground truth.

### SUMMARY OF THE INVENTION

Systems and methods described herein involve detecting silent bias across media platforms, comprising executing several empirical models on media across different media outlets to detect strategic omission.

### BRIEF DESCRIPTION OF THE DRAWINGS

FIG. 1 is an illustration of several example different markers in a news article that together could be used in multi-dimensional analysis by embodiments of the system to determine Silent Bias.

FIG. 2 is a block diagram of individual markers assessed by one embodiment of the system to determine Silent Bias.

FIG. 3 is a block diagram of High Cloud/hardware system architecture.

FIG. 4 is a block diagram that illustrates a system architecture.

FIG. 5 is a block diagram of the universes of potential editorial choices available to embodiments of the invention.

FIG. 6 is a block diagram of content types supported by most embodiments of the system.

FIG. 7 is a block diagram of one embodiment of a hierarchy of media outlets, sub-outlets, their components, and their formats.

FIG. 8 is a block diagram of an embodiment of story and its attributes, which may be assessed by the system.

FIG. 9 is a block diagram of a process by which new content from a data collection is determined to be a story and fed into the hierarchical clustering algorithm of an embodiment of the system.

FIG. 10 is a block diagram of context definitions used as alternative in stories handled by an embodiment of the invention that are not centered around any particular real-world event.

FIG. 11 is a block diagram that illustrates target entities and the hierarchy between them and their co-occurring entities as used by embodiments of the system.

FIG. 12 is an illustration of an example of a group entity.

FIG. 13 is a block diagram that illustrates how an embodiment of the system processes a story to extract references to target entities and other entities.

FIG. 14 is a block diagram that illustrates embodiments of individual and collective entities.

FIG. 15 is a block diagram of mention types supported by most embodiments of the system.

FIG. 16 is an illustration of an example of mentions and the significance of the order of their appearance relative to each other in a story section, as detected by an embodiment of the system.

FIG. 17 is an illustration of an example of an editorial choice profile as examined by an embodiment of the system.

FIG. 18 is an illustration of a high-level example of decisions implemented by an embodiment of the system over the course of a multimedia story concerning specific named entities.

FIG. 19 is a block diagram of time window types supported by an embodiment of the system.

FIG. 20 is a high level bias detection process diagram.

FIG. 21 is a block diagram of example segmentations needed across different media formats to normalize the content ingested by embodiments of the system as part of the indexing process.

FIG. 22 is a block diagram of the determination process of high-level content-based markers in an embodiment of the system.

FIG. 23 is a block diagram of one embodiment of the different levels of comparison sets of stories analyzed by the system.

FIG. 24 is a block diagram that shows markers that cross media types analyzed by an embodiment of the system.

FIG. 25 is a block diagram showing an example of featuring events attended by entities, whose images and videos are assessed by an embodiment of the system for aesthetic goodness and their consequent editorial selection for their polarity-bearing characteristics.

FIG. 26 is a block diagram showing a processing pipeline for detecting image markers in one embodiment of the system.

FIG. 27 is a block diagram showing image instance attributes.

FIG. 28 is a block diagram showing different kinds of contexts handled by an embodiment of the system.

FIG. 29 is an illustration of photographs from stories about a specific event which include inappropriate images alongside appropriate ones, which an embodiment of the system may flag as potentially injecting bias.

FIG. 30 is an illustration of a hierarchy of contexts provided by embodiments of the system to establish appropriateness of selected media objects used in a story.

FIG. 31 is an illustration of examples of topic tags and “read next” tags, which embodiments of the system will consider as evidence of a new long news cycle as new ones emerge.

FIG. 32 is a block diagram illustrating an example of a news forest supported by embodiments of the system.

FIG. 33 is an illustration of how the choice of images and videos featuring specific target entities may indicate the implied polarity intended to be associated with a story.

FIG. 34 is a block diagram showing how an embodiment of the system assigns context to profiles and analyses.

FIG. 35 is a block diagram showing how an embodiment of the system may score facial features found on images and videos.

FIG. 36 is a block diagram showing how most embodiments of the system will flag bias.

FIG. 37 is an illustration showing several photographs of a particular target entity to demonstrate as if one or more media outlets consistently depict him as angry.

FIG. 38 is a block diagram showing an example distribution of entity state probabilities within a given universe of images featuring the entity, included in an embodiment of the system.

FIG. 39 is a block diagram of how an embodiment of the system may determine when an image of a target entity is too out-of-date from an age perspective of the target relative to the story context.

FIG. 40 is a block diagram of how an embodiment of the system may process centrality markers.

FIG. 41 is an illustration featuring examples of centrality markers in images.

FIG. 42 is an example of an image whose visual centrality is challenged by a large backdrop.

FIG. 43 is a block diagram of text-related marker processing in one embodiment of the system.

FIG. 44 is an illustration of airtime where third-party commentary dwarfs comments made by a target entity, as would be detected by an embodiment of the system.

FIG. 45 is a block diagram of how a token-counting embodiment assesses the airtime proportion of third-party interpretation of an entity relative to the entity's own airtime.

FIG. 46 is a block diagram showing a process by which an embodiment of the system may measure airtime.

FIG. 47 is a block diagram illustrating the handling of incorrect quote attribution cases.

FIG. 48 is an illustration of headline sentences, where a target entity is shown as a subject in one and an object in another.

FIG. 49 is an illustration of stories featuring lists of target entities.

FIG. 50 is a block diagram of statement types supported by an embodiment of the system.

FIG. 51 is an illustration of how, conceptually, comments from a specific event could deviate from its transcript.

FIG. 52 is a block diagram showing how an embodiment of the system might handle cases of incorrect quote attributions.

FIG. 53 is an illustration of the use of contrastive hedge.

FIG. 54 is an illustration showing sections of a news website.

FIG. 55 is a block diagram showing an example of placement of mentions within a story and how an embodiment of the system may score the placements for the entities mentioned.

FIG. 56 is an illustration of a simple set of placement values within a story that might be used by an embodiment of the system.

FIG. 57 is a block diagram illustrating overall placement score including story placement.

FIG. 58 is a block diagram illustrating an example of placement of components within a story as considered by an embodiment of the system.

FIG. 59 is a block diagram illustrating an example of placement of mentions within a structured multimedia component embedded in a story, as considered by an embodiment of the system.

FIG. 60 is an illustration showing example placements of news stories within their immediate container objects.

FIG. 61 is a block diagram illustrating the types of containing structures in an embodiment of the system.

FIG. 62 is an illustration showing an example of story positions and bounding boxes.

FIG. 63 is a block diagram illustrating the determination of cluster polarities for specific target entities by an embodiment of the system.

FIG. 64 is an illustration showing an example set of overlapping stories and disposition of the slots with and without values filled in from the story by an embodiment of the system.

FIG. 65 is a block diagram showing an embodiment of the system's process of detecting missing quantifications and attempts to fill the missing slots.

FIG. 66 is a block diagram showing the process of determining high-level content-based markers in an embodiment of the system.

FIG. 67 is an illustration of quotes from a news cycle and their classifications as quotes, assertions, and unprovable or subjective statements.

FIG. 68 is an illustration of an example quote showing a highly-specific assertion.

FIG. 69 is an illustration of an example of biased editing markers measuring in an embodiment of the system some logical possibilities in how different media outlets could select a quote excerpt they each reference.

FIG. 70 is a block diagram showing the type of excerpts.

FIG. 71 is an illustration of an example of quote excerpt cherry-picking, as identified by an embodiment of the system.

FIG. 72 is an illustration of two examples of biased editing of quotes across many media outlets, as identified by an embodiment of the system.

FIG. 73 is an illustration on how an assertion is created from fragments taken from quotes.

FIG. 74 is an illustration of three examples of text containing comment elements which combine to create an assertion, in an embodiment of the system.

FIG. 75 is an illustration of an example sequence of statements from a transcript of an interview, following clustering by an embodiment of the system.

FIG. 76 illustrates the structure of a Bayesian network as a factor graph

FIG. 77 shows a possible fragment of a Bayesian network used for bias detection

FIG. 78 illustrates the structure of interval temporal graph edges.

FIG. 79 illustrates how the time intervals on temporal edges and their end points should be consistent.

FIG. 80 is a block diagram showing the basic components of the omissions identification system.

FIG. 81 illustrates the layout of retrieval requests (queries to the omission identification system).

FIG. 82 illustrates the omissions identification processing pipeline.

FIG. 83 illustrates one embodiment of a data crystal.

FIG. 84 is a block diagram that illustrates the two most often mentioned cluster-independent assertions and the two most often omitted assertions.

FIG. 85 is a block diagram illustrating assertions by frequency of mention in a data crystal.

FIG. 86 illustrates the visual boundaries rendered to separate contiguous instances of assertions where the cardinality is different.

FIG. 87 is an illustration that shows actors on a social media channel shaping opinions on a specific or linguistic entities.

FIG. 88 is an illustration of the first of four sequential frames showing the sudden large outbreak of assertions and omissions that lead to the collapse and shattering of a data crystal in an embodiment of the UI.

FIG. 89 is an illustration of the second of four sequential frames showing the sudden large outbreak of assertions and omissions that lead to the collapse and shattering of a data crystal in an embodiment of the UI.

FIG. 90 is an illustration of the third of four sequential frames showing the sudden large outbreak of assertions and omissions that lead to the collapse and shattering of a data crystal in an embodiment of the UI.

FIG. 91 is an illustration of the fourth of four sequential frames showing the sudden large outbreak of assertions and omissions that lead to the collapse and shattering of a data crystal in an embodiment of the UI.

FIG. 92 is an illustration of the first of four sequential frames showing an example visual comparison between two data crystals in an embodiment of the UI.

FIG. 93 is an illustration of the second of four sequential frames showing an example visual comparison between two data crystals in an embodiment of the UI.

FIG. 94 is an illustration of the third of four sequential frames showing an example visual comparison between two data crystals in an embodiment of the UI.

FIG. 95 is an illustration of the fourth of four sequential frames showing an example visual comparison between two data crystals in an embodiment of the UI.

FIG. 96 is an illustration of details of an embodiment of a radio tower from the radio tower visualization.

FIG. 97 is an illustration of an embodiment of the radio tower visualization UI.

FIG. 98 is an illustration of the movements of the emitted particles from an embodiment of a radio tower from the radio tower visualization.

FIG. 99 is an illustration of example data ornaments from an embodiment of the radio tower visualization.

FIG. 100 is an illustration of the animation of data ornament “firework bursts” and “sputterings-out” from an embodiment of the radio tower visualization.

### DETAILED DESCRIPTION

### Introduction

We will use the term “silent bias” or just “bias” to refer to a set of consistent editorial decisions[210] made by traditional media outlets, social media platforms, branded social media accounts, or any other type of content creator, which have the impact of favoring—or disfavoring—a particular person[370] or group[380] in any given window of time[670]. In particular, bias[260] refers to the decisions[210] made over time relative to what those decisions[210] could have reasonably been. This is accomplished by systematically comparing the universes[940] of choices[210] in particular story[100] contexts[730]. To take a very simple example, a media outlet[160] cannot reasonably choose to make a 60-year-old appear as a 20-year-old in the current day. But they can choose to select images[130] of a person[370] that make them appear to be somewhat older, or somewhat younger. Likewise, an outlet[160] can choose to quote[560] an entity[370] from an interview[395] verbatim, can in theory simply make up a quote[560], or do anything in between (such as editing or paraphrasing the actual quote[560]).

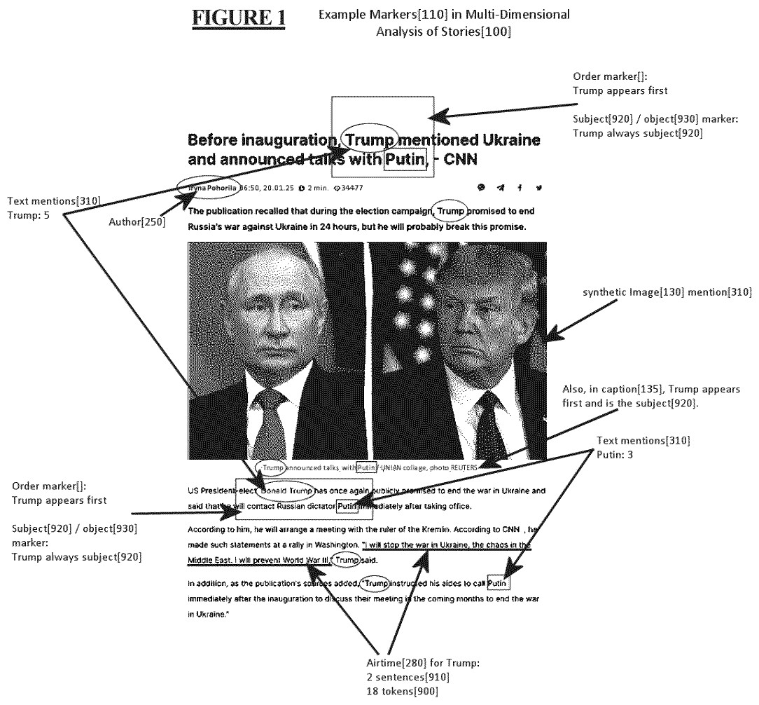

The presence and degree of silent bias[260] between pairs of media outlets[160] and target entities[150] are determined by the system[180] disclosed in this application by assessing numerous individual markers[110] across corpora of news-related content[320]. As shown in FIG. 1, these markers[110] are designed to work together to provide a multi-dimensional analysis of stories[100]; even the small portion of the pictured story[100] is responsive to 5 different markers[110]: text[120] mention[310] detection, image[130] mention[310] detection, mention[310] order[1367] detection, subject[930] versus object[920], and “airtime” [280], or the amount of direct quoting.

Most embodiments will build a probabilistic model[680] on the basis of these marker[110] scores[270]. In most embodiments, bias[260] can also be assessed with respect to coverage of a news cycle[235]. In most embodiments, this model[680] will provide probabilistic assessments of both a media outlet[160] showing consistent bias[260] towards particular entities[350], with respect to particular news cycles[235], and also of a set of media outlets[160] implicitly colluding[650] with one another with respect to particular entities[350].

Most embodiments will use probabilistic models[680] such as dynamic Bayesian inference networks for this purpose. The choice of probability-based models[680] is motivated by the fact that distinguishing collusion[650] from likeminded-ness beyond a shadow of a doubt simply based on the resulting stories[100] may not be possible. Likewise, even for the demonstration of bias[260]. However, it surely possible to assess a high probability that, for example, collusion[650] and/or overall bias[260] occurred in a given outlet[160]. In addition to probabilities, many embodiments will provide anchored scale labels and associated icons in the user interface[820] and reports[1090] such as “strong evidence,” “some evidence,” “little evidence,” and “no evidence.”

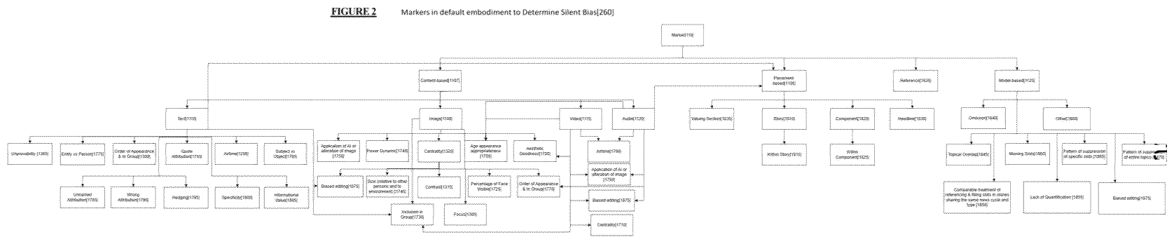

Many of the individual markers[110] disclosed can use any of a range of well-established methods with little to no impact on overall system[180] accuracy, in combination with novel methods including those focused on omissions[690]. A list of these markers[110] included in a default embodiment is depicted in FIG. 2. This is because the system[180] relies on having a large number of such markers[110], many orthogonal to one another, each providing an additional boost to system[180] accuracy. In part because there are a great many different methods from which to choose (and which hopefully improve over time)—and quite a few markers[110] in most embodiments, preferred embodiments will perform constant tests across the set of data[1435] to identify markers[110] that are consistently providing outlier scores[270]. Such markers[110] of dubious implementation quality in most embodiments will be assigned a lower weight and eventually discarded unless/until replaced with an improved implementation. In almost all embodiments, it will generate error notifications.

Many embodiments will actually prefer to use simple, straightforward, and easy-to-understand metrics over more complex and/or black box ones that arguably have somewhat better accuracy so as to give users[800] greater confidence in the general correctness of the measures. To take a simple example, while incrementally more accurate methods may exist to determine how much time it takes an average reader to read a given story[100] than simply counting the number of words[900] in it, the simple method possesses the advantage of being very difficult to argue with and immediately understandable.

Most embodiments will nonetheless make use of machine learning, LLM's and other data-driven approaches[1180] for implementing certain markers[110]. However, most embodiments will place complete restrictions on the use of these approaches[1180] so as to avoid the potential for bias[260], especially but not only of a political nature, being injected. Such possibilities include, but are not limited to: human/trainer subjectivity and bias in the annotation process, and LLM behavior modifications for political correctness. Specifically, the restrictions in most embodiments will include, but not necessarily be limited to: sentiment detection, any kind of truth or falsehood labeling, and any kind of importance ranking. Some embodiments may go still further in this regard, also precluding news cycle[235] detection and classification; mature, straightforward clustering-based and other statistical approaches to hierarchical topic detection and new news story detection predate ML or LLM approaches[1180]. (Many embodiments will choose to leave users[800]—via the user interface[820] or API—to create and define the semantic boundaries of user topics[1370]. In this way, what may be regarded as subjectivity is injected by the specific user[800] according to their needs.)

For example, although many embodiments may depend at least in part on training classifiers to implement the detection of unprovable or subjective statements[515] as a class, or to determine in which specific contexts the use of a group entity's[380] name is more appropriate than that of its leader[385], most will opt both to use a very topically broad corpus, and to replace named entity[350] references[310] with either variable name or randomized names. Many embodiments may choose even to avoid including content[320] in training sets on issues known to be polarizing to the given society, even if at a small potential cost of accuracy. This will be seen as a necessary precaution by many embodiments, owing to known skewing according to political biases in detecting things including but not limited to whether a user is a bot or human, whether assertions[500] or stories[100] are “disinformation,” or similar.

Most embodiments will not depend on or in many cases even use traditional sentiment analysis techniques to detect bias[260] towards an entity[350]. The motivation for this is not only the lack of accuracy with such methods on many types of content[320]. It is that as information and influence operations become more sophisticated, they will often become deliberately more subtle as well. The use of clear insults and other obviously negative polarity[630] modifiers applied to a particular entity[350] in fact may make it harder to successfully exert influence on an audience. Thus, trying to measure negative polarity [630] and using it as a marker[110] for bias [260] could be counterproductive. Note also that there is little commercial or other value in identifying media outlets[160] who are overtly biased towards specific entities[350] as the bias is extremely obvious.

The key technological improvements offered by this invention include the following:
The ability to perform bias[260] analysis in a completely objective, highly accurate, empirically-driven and common sense way across different media formats[200] via artifactual analysis, rather than depending on training models[1180] or creating symbolic systems[550] into which human bias and prejudices will inevitably creep. (While these approaches may be used in many embodiments in order to perform specific tasks, very few embodiments will use them for the actual bias[260] detection.) This ability will become increasingly more critical as information or influence operations, both involving generative Al capabilities and otherwise, become ever more sophisticated in nature. Recent studies on LLM chatbots such as those documented here¹ demonstrate that not only does clear political bias slip in but even that similar political bias also, among the LLM chatbots released by different companies. ¹ https://www.realclearpolitics.com/articles/2025/02/04/whos_afraid_ofjonathan_turley_chatgpt_for_one_15230 0.html
The ability to likewise detect omissions[690] of different scopes. These include:
   Excerpting[570] quotes [560] so as to omit important content[320], where “importance” is assessed according to the spectrum whose endpoints are the evident eagerness with which some outlets[160] repeat the omitted excerpt[575] at every opportunity—and the equal insistence with which others[160] consistently avoid ever disclosing it.
   Omitting—or stressing—specific assertions[500] in stories[100] relevant to specific news cycles[235].
   Omitting—or stressing—specific detailed pieces of data such as quantifications[1270] of important quantities.
The ability to likewise detect and quantify highly probable instances of collusion[650] across presumably independent media outlets[160].
Compact and intuitive complex visualization[830] of omissions[690].

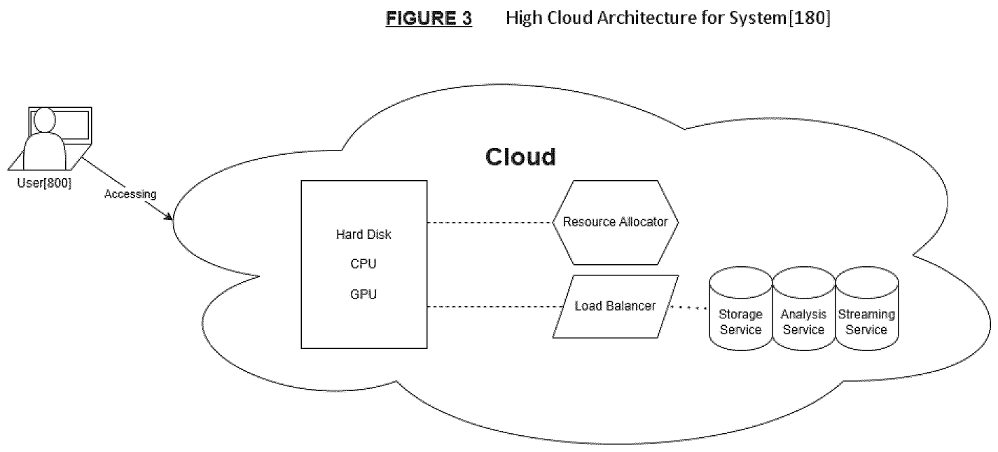

As shown in FIG. 3, the system[180] disclosed in this document will most often be run on a fairly typical server cloud computing configuration for systems which analyze large multimedia data sets. Specifically, the system[180] will need a way to stream data[1435] to it, large amounts of storage, and considerable GPU time for image[130] and video[140] processing, as well as other computationally intensive tasks.

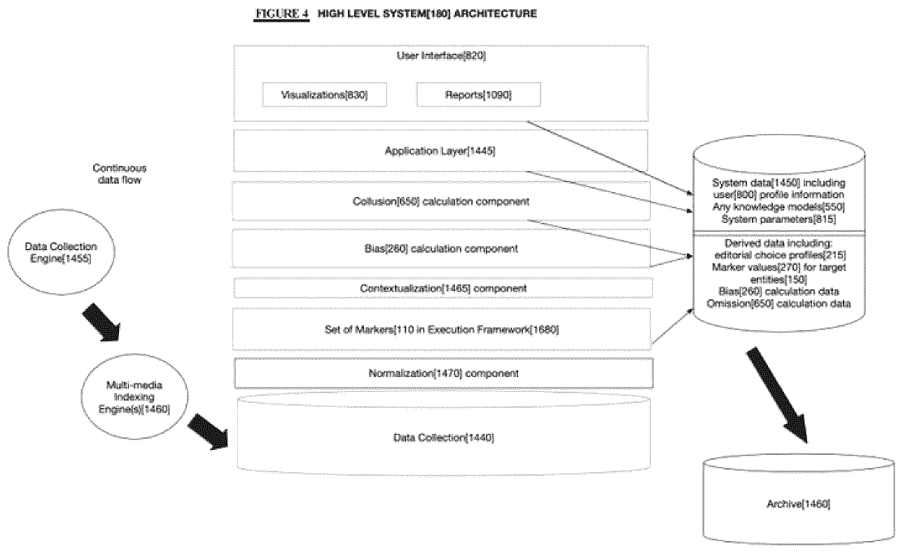

As shown in FIG. 4, a default embodiment includes the following components:
A data collection engine[1455], which, in many cases, may lie outside the system[180] boundary.
One or more indexing engines[1460], as needed for the different media formats[200] to be analyzed.
A data store[1440] for the collected, indexed, and analyzed data [1435].
A normalization component[1470] which normalizes marker values[270] across the different kinds of media formats[200].
An execution framework[1680] for the set of markers[110] to be used.
Each of the individual marker[110] components.
Bias[260] calculation component[260], which handles both the bias marker[1415] and bias calculation[1420] steps. This includes contextualization component[1465] in some embodiments.
Collusion[650] calculation component[260] which handles collusion detection[1425].
A standard application layer[1445].
A user interface layer[820] that contains visualizations[830] and reports[1090].
A system data[1450] store that contains all data required by the system[180]. This includes but is not limited to: user[800] preferences, configuration parameters[815], the editorial choice profiles[215] and all other derived data.
A system archive[1460].

Many of these components are standard, and many suitable options are available.

### Silent Bias[260]

Silent bias[260] in most embodiments is determined relative to specific target entities[150]. Most embodiments permit hierarchical groups[380] of such entities[150], for example, an individual politician belonging to a political party, which in turn may belong to some international group.

Each of these can separately be a target entity[150]. In most embodiments, target entities[150] must be specified either by a system user[800] through an application[820], or programmatically via an API. This allows the system[180] to stay focused on processing data that is relevant to the needs of the user[800].

In most embodiments, this process requires providing—or at least verifying—some base information about the target entity[150] so as to reduce the likelihood of mistaken identities. For example, in the case of individuals in most embodiments, good quality, at least relatively recent images[130] should be provided; in the case of container entities[380], a list of known members[465], a leader[385] if appropriate, and references to the container[380] such as different names and logos that it uses. However, most embodiments will expand the set of target entities[150] provided so as to be able to perform the apples-to-apples comparisons that calculating the bias markers[110] will require—for example, comparing the coverage of presidents of arguably comparable countries. In most embodiments, the entities[350] added for comparison purposes (as opposed to having been specifically targeted) will only appear by default in visualizations[830] and reports[1090] as secondary objects[1095] that are used for purposes of comparison, unless the user[800] chooses to promote them to first class status.

In most embodiments, individual markers[110] may relate to text[120], images[130], video[140], audio [290], or any subset of these. Some markers[110] have a clear polarity[630] attached to them, while others[110] are designed to catch changes in the content[320] being analyzed, the polarity[630] of which may vary by real-world context or are unknown. Each marker[110] measures a specific type of editorial choice[210]. Editorial choices[210] are choices which exist within a definable universe [940] of potential choices[210] that are circumscribed by the system[180].

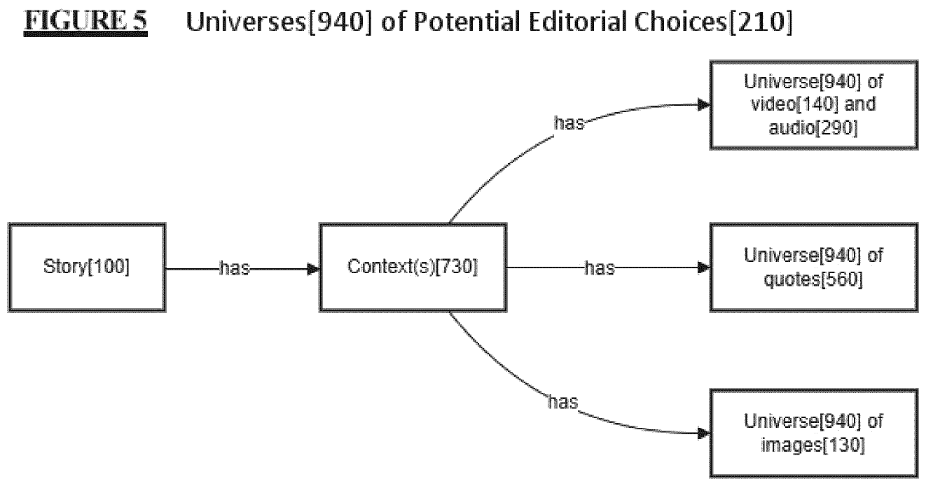

As shown in FIG. 5, the cardinality of the universes[940] can vary considerably according to the context[730] of the story[100]. However, in almost all cases, at least N many decisions[210] were logically possible, hence there is choice[210] involved. Continuing with the example above, for some individual target entities[370] a vast number of recent photographs[130] may exist while for others perhaps only one or two images[130] exist, leaving little choice[210].

Most embodiments will support the concept of appropriate universes[940] for multiple types of objects. These may include, but are not limited to: quotes[560], images[130], video[140], and audio[290] clips.

To take another example, out of comments[120] from a specific interview[395] with or speech[395] by a public figure[370], a finite number of editorial choices[210] are possible. At the two extremes, all of the comments[120] made during the interview[395] may be ignored altogether—or they could be quoted in full. (Most embodiments will treat the editorial choice[210] of misquoting or simply inventing comments[120] in such a scenario as a single choice[210] logically; otherwise the number of possible choices[210] would be infinite.)

A number of logically possible excerpts[570] exist in the scenario in which a transcript[480] of the remarks[395] exists. Most embodiments will identify these empirically, based on which excerpts[570] are actually found in the set of properly scoped media outlets[220]. For example, sector-based media outlets[160] will naturally provide longer—and perhaps different—excerpts[570] in their respective areas of specialty—than more broadly-scoped[170] media outlets[160]. This empirical strategy has the advantage of avoiding having to assess the most newsworthy portions of the comments[395], which can lead to the injection of bias[260]. However, certain embodiments may instead prefer to use or factor in informational value[780] (as defined in U.S. Pat. No. 9,569,729B1) or the semantic novelty of the text[120] so as to establish which excerpts[570] contain the greatest amount of unexpected or interesting information. However, this does have the cost of deep parsing, which is why many embodiments will not choose to do it.

To take a hypothetical example, consider a high-security diplomatic summit at which only one highly constrained group photo[130] of attendees[370] could be taken. Scoped media outlets[220] in this scenario have a limited universe of likely editorial choices[210]. They can:
Not use the picture[130].
Only use a subarea of the picture[130], cutting out some number of persons [370] in the original photograph[130], so the number of potential variations is limited.
Use the full picture (e. g., all persons[370] present are captured in the photograph[130]).
Create some sort of montage of images[133] or other synthetic image[133] of individual attendees[350].

Of course, in theory, all kinds of other things could be done to the photograph[130], such as adding devil horns to the heads of some of the pictured persons. Such edge-case instances notwithstanding, most embodiments will choose to define the universe of editorial choices[210] according to the set of standard choices allowed by system configuration definitions [815].

However, most embodiments will empirically add such specific novel alterations to the set of possible editorial choices[210] for that particular image[130] if it is observed and sufficiently in the case of the specific image[130]; some embodiments may additionally generalize it to other images[130] of any individual target entity[150] endowed with the horns, or similar. (This assumes that the alterations being performed are similar enough to one another that they are computationally recognizable as being the same or similar with existing computer vision techniques.) Still other embodiments will extend it to any target entity group[380] to which the person(s)[370] belong.

It should be noted that some markers[110] are context-free in nature—and so can be analyzed on a per-story[100] basis. For example, the relative size and centrality[660] of different individuals [370] in an image[130] can be assessed on a per-image[130] basis. Once calculated per story[100] and per media outlet[160], the scores[270] will be compared to other media outlets[160] having the same scope[170]. Model-based markers[1125], by contrast, require gathering and analyzing different kinds of broader context. For example, omissions[690] made by a given media outlet[160] can only be detected via the analysis of comparable content[320] from other similarly-scoped media outlets[220] during the same time period[670] that did not omit the thing in question.

### Important System[180] Objects

We will note here for concision that all instances of system[180] objects will have the full set of standard attributes needed for purposes such as audit trails and error logs. These attributes include, but are not limited to UID's and creation dates.

### Media Outlets[160]

A media outlet[160] is defined to be literally any regular producer of content[710] intended for consumption by an audience. While most embodiments may choose to place lower limits by content[320] production or audience on what may be considered a valid outlet[160], even something as small as an individual user account on X is by default a valid outlet[160], just as large legacy media is. No source of content production[710] for the public with any following operates in a vacuum, whether it is a reporter with a boss and an editorial committee, or an informal network of accounts on a social media platform that often reference one another. (In other words, traditional and “new” media may have their differences, but also inescapably many similarities.)

However most embodiments will establish lower limits on content production for a content producer[710] to be treated by the system[180] as a valid media outlet[160]. While different embodiments may choose their own strategies in this regard, most of them will require:
Periodicity or near-periodicity of posts/publication [990]—in other words, the production of content[320] must be regular. (By near-periodicity, we mean that, as discussed in U.S. Pat. No. 8,887,286 B2, some anomalies are expected, including but not limited to reasons such as holidays, force majeure, and individual people simply being ill or on vacation, in the case of smaller content producers.)
A minimal required periodicity. In a default embodiment, this is monthly.
A minimum average amount of content[320] per publication [990]/post. Different embodiments can choose their own measurement. Valid options include but are not limited to: token[900] count, sentence[910] count, and a combination of these. For video[140] or audio[290], most embodiments will use a simple measure such as length[750]. For image[130]—heavy content formats[440], a number of images[130] can be specified.
The content[320] must be scopable[170]. By this we mean that the content[320] must be automatically identifiable as having at least one scope[170] such as geographical or sector, and must be broadly categorizable as having news-related content[320]. Any NLP technique or combination of techniques can be used for this purpose.

Certain embodiments will allow threads[1628] on social media platforms[1625] under certain conditions to be treated by the system[180] as if it were a transcript[480] from a panel interview[395]. These conditions may include, but are not limited to: that the participating entities[350] are considered known; that some or all of the participants[350] each have produced a specified minimum amount of content[320] within a given time window[670] in relation either to a relevant content container[420] such as a social media[1625] channel[627] and/or specific type of linguistic entity[1690] such particular traded commodities; that the number of participants in the thread is less than a system[180]—specified threshold; that the duration of the thread[1628] in calendar length[750] and/or total content[320] is bounded; and that the amount of topic drift is bounded.

Some embodiments will additionally choose to support the construct of “comparable” [1525] media outlets[160]. This is because many users[800] may wish to limit the media outlets[160] among which they wish comparisons to be made, even if the data collection[1440] includes content[320] from other valid content producers[710] who share the same scope[170]. For similar reasons, some users[800] may wish at times to only have comparisons performed among outlets[160] of the same media format[200].

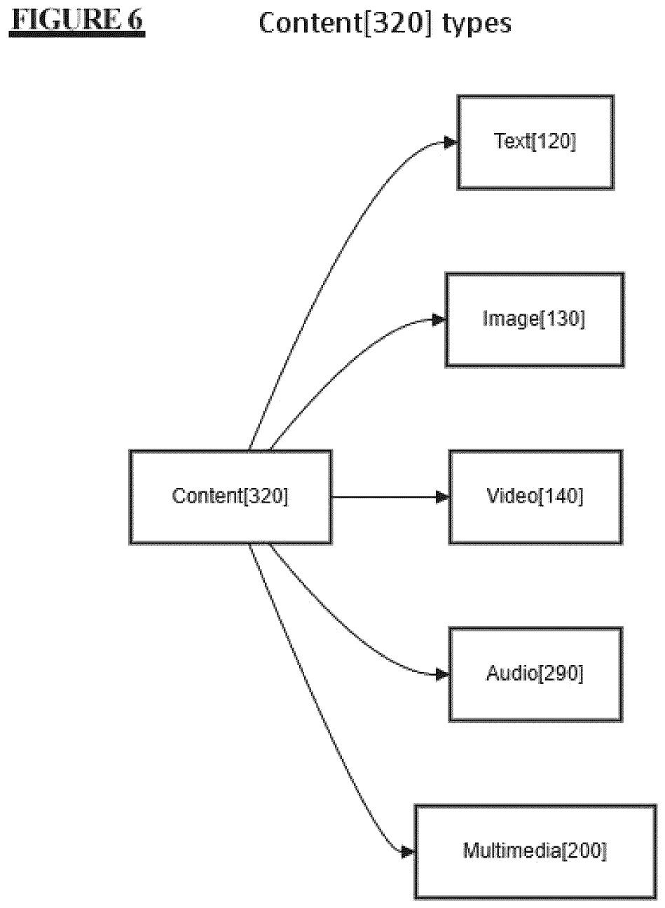

Almost all embodiments will allow users[800] to alter these default values. Most embodiments will support the content[320] types shown in FIG. 6.

In a default embodiment, media outlets[160] will have attributes which include but are not limited to: UID, human readable name, optional description, sub-outlets[165] (if any), authors[250], one or more scopes[170], one or more media outlet formats[440], (including optionally a custom one), an owner (if known) that may be a conglomerate [430], and of course all of its associated content[320].

### Media Outlet[160] Scopes[170]

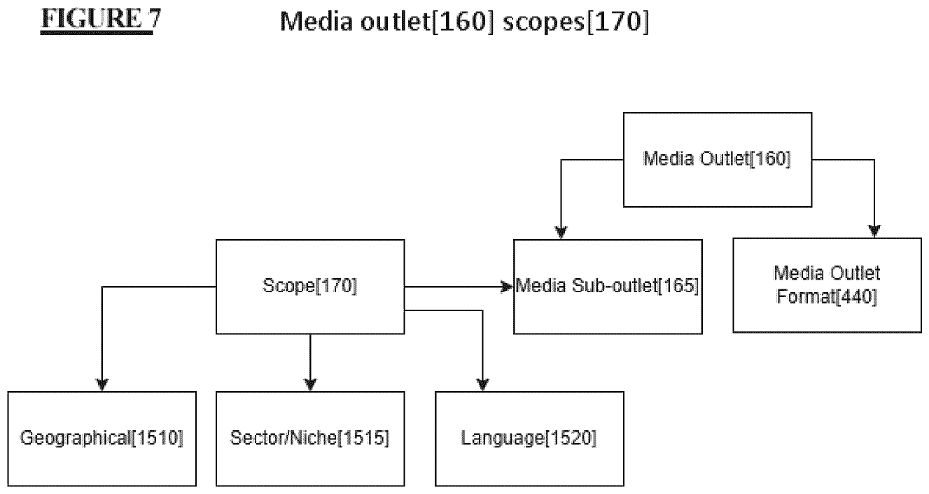

As shown in FIG. 7, media outlets[160] may have one or more sub-outlets[165], or distinct, at least somewhat independent and perhaps separately branded components, and multiple media outlet formats[440]—that is, they deliver content[320] in editions[990] that have different media formats[200] from one another, for example a TV show versus a website. Sub-outlets[165] may also have special formatting or structure characteristics that may impact the system's[180] analysis, for example a news column with a Q & A format.

Media outlets[160] in almost all embodiments may have multiple scopes[170]. A default embodiment provides defaults for a geographic scope[1510], a sector scope[1515], and a language scope[1520]. Most embodiments can optionally determine these scopes[170] automatically using existing methods including but not limited to language identification for language[1520], detection of domain-specific jargon for sector[1515], and LLM's or topic detection[1650] for geographic scope[1510]. Such scoping[170] is necessary so as to be able to perform apples-to-apples behavioral comparisons among outlets[160], and to avoid confounding intentional and entirely appropriate audience focus with bias[260].

Most embodiments will support hierarchical scopes[170] to allow greater precision in comparisons among media outlet[160] behavior. For example, a complex field like medicine has many sub-specialties; Europe is composed of numerous countries. These are distinct portions or properties of a larger media outlet[160] that may have their own scope[170] values that differ from that of their parent entity. One example of this would be a Spanish language version of an otherwise English language media outlet[160].

It is only to be expected, for example, that Polish media outlets[160] will heavily feature the Polish president, as well as other heads of government in nearby countries in their reporting, whereas in the US coverage of a given event like the NATO summit, the Polish president might very well not be pictured at all. Likewise, for example, a sports publication may be expected to focus on sports, with non-sports figures rarely ever pictured, no matter what is currently going on in the world. Thus, many embodiments will use the scopes[170] for two purposes:
To literally compare the handling of specific news cycles[235] among the set of media outlets[160] with the same scope[170], for example the set of Polish publications. Many embodiments will also opt to apply a regional strategy so as to have a greater number of media outlets[160], with the reasoning that there is some bleed from one country to its neighbors. Thus, a regional scope[1510] may be defined by an embodiment that covers Central and Eastern European countries.
To abstractly compare the behavior of media outlets[100] with respect to a generic “home team” bias so as to establish norms for outlets[160] of that geographic scope[1510]. To take a simple example, how many more mentions[310] will any Olympian or professional athlete generally receive from sports-focused media outlet[100] in his or her own country than elsewhere? Such “home team” bias is understandable, and so will be ignored by almost all embodiments from a bias[260] perspective.

Almost all embodiments allow users[800] to redefine default scope[170] definitions provided by the system[180] in order to best suit their needs or to create new types of scopes[170] beyond the default. No one set of scope[170] definitions is “correct.” All that is important is to ensure that apples-to-apples comparisons of media outlets[160] are generally being made. We will refer to the set of outlets[160] that share one or more scopes[170] in common as being scoped media outlets[220]. Some embodiments may require that all scopes[170] are shared to place media outlets[160] in the same scoped set[220].

If the vast majority of scoped media outlets[160] are all covering the substantially same thing in substantially the same way within a given time window[670], it becomes uninteresting from a bias[260] analysis standpoint. By definition in such cases, there can be very little bias[260] present. The same logic applies to anything that is not being covered by literally or virtually any media outlet[160]. As far is the system[180] is concerned, the thing in question simply does not exist because it does not (yet) exist in any data collection[1440] that is accessible to it. It is only in the cases in which the scoped outlets[220] are providing inconsistent information that is not explainable by lower-level scoping[170] differences that there is potentially bias[260], at least in most embodiments.

### Stories[100]

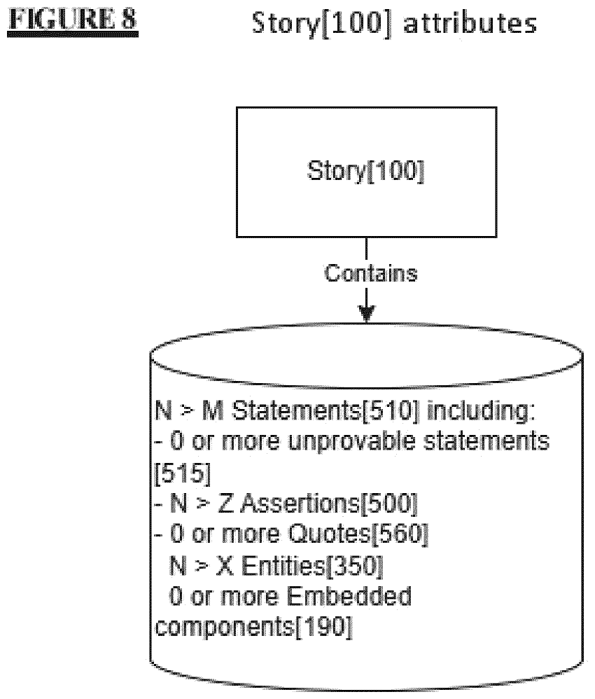

A story[100] is defined to be a container object with certain properties whose content[320] can be meaningfully analyzed for bias[260] by the system[180]. A story[100] can be multimedia, or single media. It must have a headline[970] or title[970], an estimated or actual creation date[1265], and meet the system configuration[815] requirements for sufficient content[320]. In most embodiments, this will be determined by parameters [815] which specify different aspects of the minimum amount of content[320] required for different media format[200]. These parameters[815] are to ensure that sufficient content[320] is present to warrant analysis. As shown in FIG. 8, further story[100] attributes in a default embodiment include but are not limited to:
0 or more authors[250].
0 or more subheadlines[975].
1 or more sections[410].
0 or more embedded components[190].
N>M entities[350] referenced.
N>Q statements[510] including.
0 or more unprovable statements[515].
0 or more assertions[500].
0 or more quotes[560].
N>Z references to named entities[350].

In some media formats[200], determination of the boundaries of a story[100] is trivial. For example, with traditional media, programmatic access may exist; failing that, it is not difficult to train an ML or similar model to recognize structural, visual, temporal, topical or other boundaries or discontinuities that divide one story[100] from another[100] (or from other types of content[320], such as advertisements).

In the case of social media, most embodiments will consider a periodic post[990] to be either the equivalent of an edition[990] in traditional media, or a story[100], depending on whether the content[320] can be broken into multiple stories[100] by analyzing the content[320] by default in the same way as is done for traditional media. Readers depend on visual, structural and other cues to quickly see that one story[100] has ended and another has begun regardless of the media type[200]. Thus well-structured content[320] should be decomposable.

However, in any particular cases of special interest in which a content producer[710] who meets the system[180] criteria for being treated as a media outlet[160] produces content[320] that the system[180] is unable to break into individual stories[100], almost all embodiments will allow the system administrator[810] to provide a template for processing the particular content[320].

Such a template would provide instructions as to which symbols or other markers signaled the end of a story[100] for example. More generally, most embodiments will provide default templates for interpreting different standard media formats[200]. Many embodiments will also provide tools to build templates for individual outlets[160] that are deemed especially important to the user[800] so as to ensure that the system[180] treats the outlet's[160] content[320] in the desired way, including its breakdown into sub-outlets[165] if present.

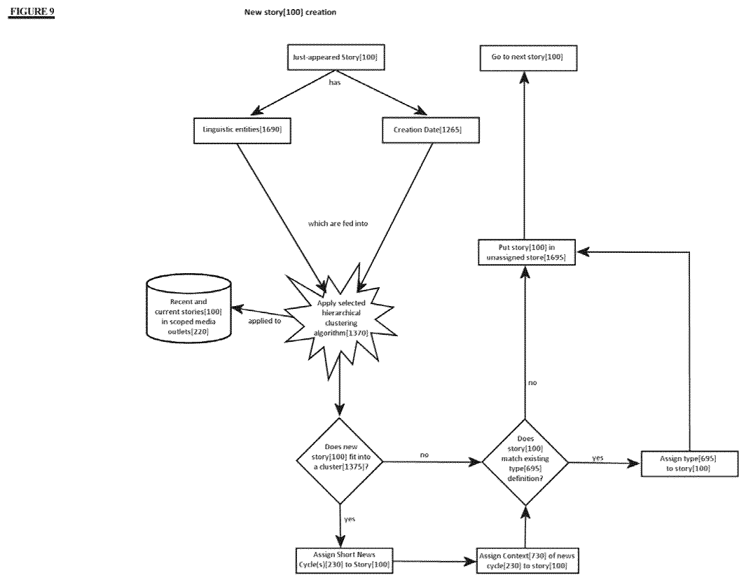

FIG. 9 shows when new content[320] first appears in the data collection[1440] from a media outlet[160] within the currently examined scope[170], and is found to meet the simple requirements for being considered a story[100]. In the pictured embodiment, all linguistic entities[1690] (thus including locations[1535] and dates[1540]) mentioned[310] within the story[100] and the creation date[1265] (most often but not always the current date) are fed into a hierarchical clustering or logically equivalent algorithm[1372]—a broad range of which can be selected. Most embodiments will use hierarchical clustering[1372] because stories[100] are frequently inherently hierarchical in nature. Most embodiments will place only minimal requirements on the definition of what content[320] counts as story[100], owing to differences in different media formats[200] and different social media platforms[1625] whose characteristics can change substantially over time.

While some embodiments may prefer to cluster[1340] on the full text[120] content[320], for example, doing so can add undesirable noise from the perspective of determining what actual real-world event[340] the story[100] is about. The more constrained approach is consistent with classical topic detection methods[1650] for identifying the emergence of new rea-world events[340] based on the combination of entities[350] and linguistic entities[1690] such as locations[1535] and dates[1540]. Most embodiments will prefer to use this class of approach. (However as noted, certain specific types of stories[100] do not necessarily center around real-world events[340], and so must be treated a bit differently.)

If the newly-appeared story[100] is found to match with an existing short news cycle[230], it will be assigned to that cycle[230], as well as the context[730] of that cycle[230], and any of their existing parent long cycles[240]. The system[180] will also try to match the story[100] to a known type[695], for example “earthquakes” in most embodiments. This is in part to catch the case in which the very first new stories[100] about a real-world event[340] occur. By definition, it cannot yet be part of a news cycle[235]. However, if the story[100] corresponds to a known type[695], special treatment can be provided by the system[180] with respect to notifications[1000] and otherwise if desired (as would be the case for certain key types[695] such as serious national security ones).

In this simple embodiment, if neither news cycle[230] nor type[695] has been matched successfully for the new story[100], the system[180] will place the story[100] in the unassigned store[1695]. Different embodiments may choose to handle the unassigned store[1695] in different ways, some preferring a push approach and others a pull. Regardless of the exact approach used, virtually all embodiments will revisit the unassigned store[1695] in attempts to assign a news cycle[230] to unassigned stories[100].

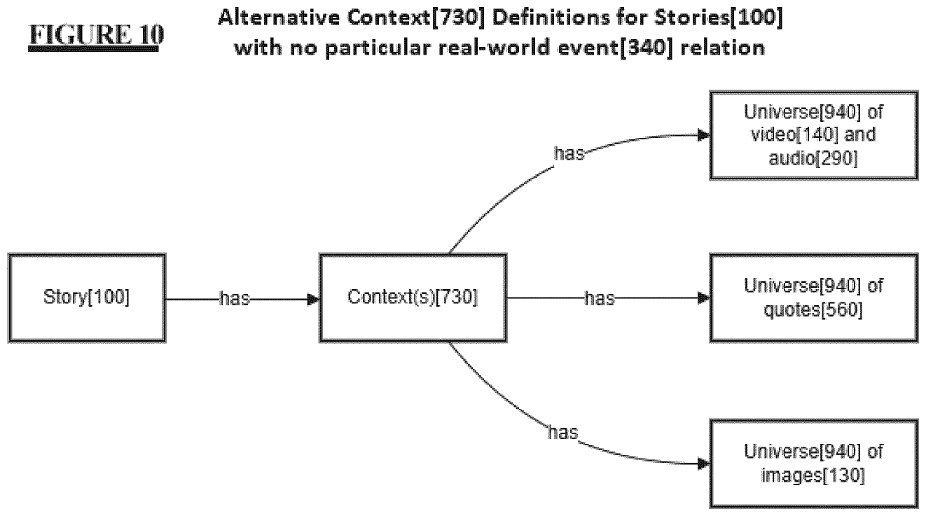

Four logical cases exist for such stories[100] in most embodiments:
The story[100] is simply “early” or breaking news, and will be assigned a cycle[230] once a system configuration[815] threshold number of different outlets[160] have published stories[100] on the same real-world event[340]. (Most embodiments will provide a system configuration[815] parameter for how long to leave a story[100] in the unassigned store[1695] before aging it out.) Once assigned a news cycle[230], the story[100] will be removed from the unassigned store[1695].
Even if the story[100] ideally should be assigned to an existing news cycle[230], for whatever reasons, it is enough of an outlier that it will fail to be (at least with automated methods).
The story[100] is essentially a one-off; the real-world event[340] or whatever else it is talking about is too objectively unimportant to gain further coverage, and so is not worth analyzing.
The story[100] does not apparently relate to any particular real-world event[340], per se. Profiles[615] and analysis[610] pieces fall into this bucket, and in most embodiments will have their own context[730] definitions that are used as an alternative to those stories[100] which are real-world-event[340]—centered. Please refer to FIG. 10.

### Target Entities[150] and Containers

Target entities[150] may be individual persons or group entities[380] that are themselves named entities[350] such as corporations or governments. However in most embodiments, target entities[150] also are logically contained in other types of objects[383] which may sometimes overlap with one another. While target entities[150] are entities[350] specifically targeted or requested by the user[800] via the user interface[820] or programmatically, in stories[100] they will often be grouped together with other named entities[350] not so targeted. We will refer to these co-occurring entities[350] as secondary objects[1095] for reporting[1090] purposes and visualizations[830].

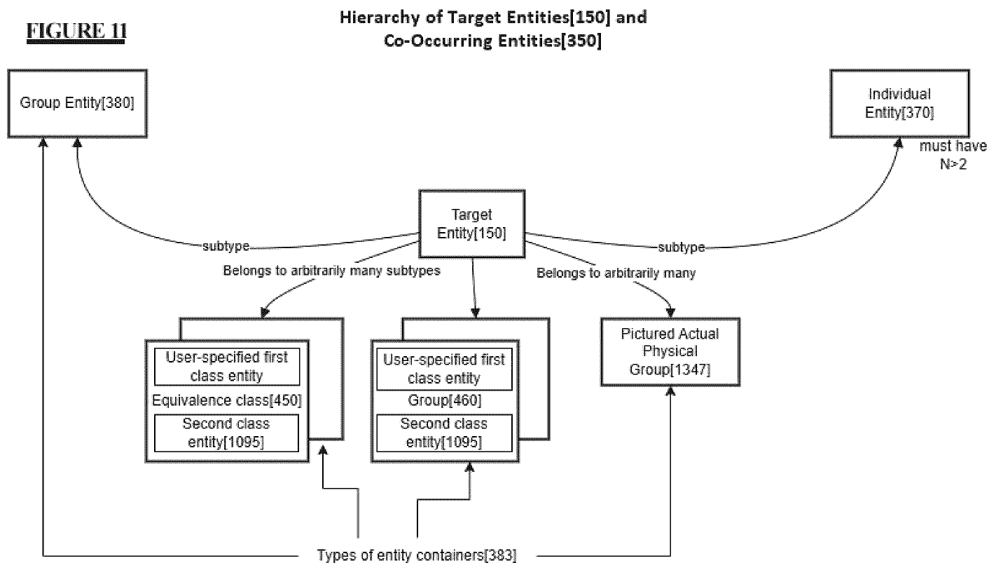

In a default embodiment, as indicated in FIG. 11, these include, but are not limited to: Equivalence class[450]: A set of similar entities[350] to the specific target entity[150] as determined by the user[800] via the user interface[820], programmatically using data from a third-party system, or via the system's[180] own determination. These classes[450] are used mostly for benchmarking purposes—for example, so as to compare the treatment of one big company CEO to another. Because the main use of these classes[450] is comparative, it is not necessary for members of the same class[450] to ever co-occur in the same story[100]. A target entity[150] may simultaneously belong to an arbitrary number of equivalence classes[450]—these are essentially just logical categories.

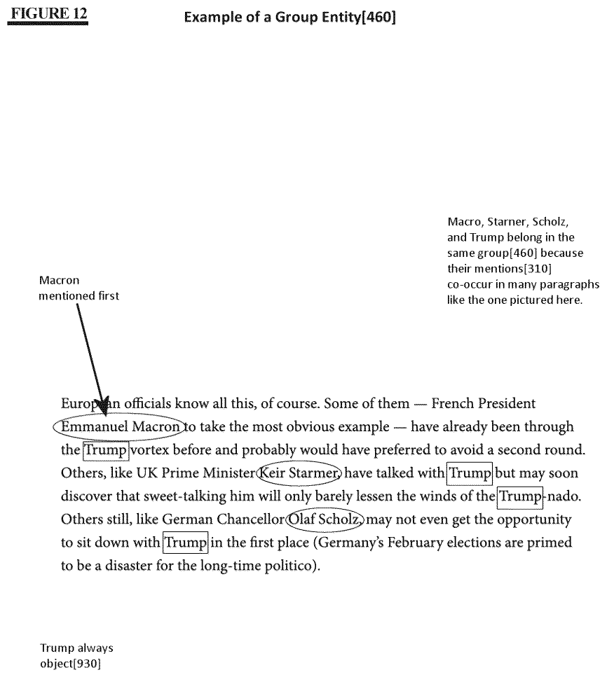

Group[460]: A group of entities[460] is formed when mentions[310] of the entities[350] in question co-occur significantly in stories[100] across media types[200] and media outlets[160]. FIG. 12 shows a typical example of this. Some embodiments may require tighter definitions of co-occurrence, for example, for text[120], co-occurrence in the same sentence[910], paragraph[950] or section[410]. Likewise in the case of video[140] or images[130], a threshold number of distinct co-occurrences may be set; in video[140], this may be weighted by the length[750] of the co-occurrence instance. Many embodiments will choose their own match rules[1215] to identify mentions[310] of the same logical group[460] since the number of entities[350] appearing in a group[460] in any given story[100] will vary quite a bit in most cases due to simple space reasons, specific context[730] and editorial decisions[210].

Thus almost all embodiments will determine groups[460] in a flexible way; space limitations alone mean that there will be significant variation of presentations of a logical real-world with several members or more. Note that for group[460] determination purposes, many embodiments may choose to ignore stories[100] with an insufficient amount of content[320] by their determinations. Some embodiments may make different choices based on the type of media format[200] or content delivery format[440]. Such a choice is likelier with certain media outlet formats [440] such as digitized print[1635].

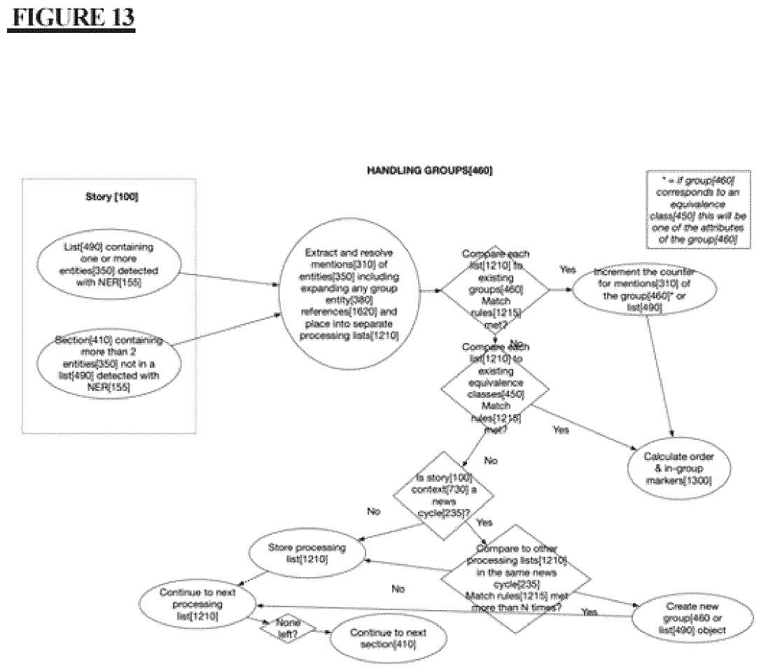

As shown in FIG. 13, a simple embodiment will extract references[1620] to target entities[380] and other entities[350] as different sections[410] of story[100] content[320] are processed. The extracted mentions [310], regardless of format[200], will be placed in a temporary processing list[1210], which will then be matched up to existing groups[460] and equivalence classes[450] with the set of matching rules[1215] in place.

These matching rules[1215] can be as simple as requiring M of N entities[350] associated with the group[460] to be mentioned[510] for different values of N, or requiring X of Y entities[350] who have a probabilityp>P of appearing[310] when the group is mentioned[310].

If the entities[350] in the temporary processing list[1210] correspond to any existing groups[460] or equivalence classes[450], the mention[310] counter for the given group[460] will be incremented by +1; likewise for an equivalence class[450] that does not currently correspond to a group[460] (but will have a new group[460] object created for it if it surpasses the system[180]—specified number of mentions[310] for this purpose). If the entities[350] in the temporary processing list[1210] do not correspond to any existing groups[460] or equivalence classes[450], this simple embodiment will try to apply its matching rules[1215] to identify any other stories[100] within a system[180]—specified window[677] in which matches can be found. If a system[180]—specified value of N or more of these are found and either the short[230] or long news cycle[240] matches at least once, a new group[460] will be created and its mention[310] count will be incremented according to the number of matches found. Other embodiments may prefer more complex approaches. Nonetheless, unlike equivalence classes[450], groups[460] very often are associated with news cycles[235] in an N:M way.

Some embodiments may choose to implement match rules[1215] using additional or other methods. These may include but are not limited to using social network, sector, geographical, topical connections, or any of these to make the assessment that an empirically co-occurring group of entity[350] references[1620] constitutes a valid group[460]. Most matching rules[1215] will automatically expand group entities[380], equivalence classes[450] or any other logical grouping of entities[350] implemented in the given embodiment.

Some embodiments will support media-type-specific groups[460], such as “co-pictured-with.” Groups[460] in some cases may be news cycle [235]—specific. A high-status, or highly-placed group[463] is considered desirable for an entity[350] to be included in—that is, to be consistently mentioned along with it—if the group[460] happens to either include or correspond to a named entity[350]—and/or along with the other members of the group[460]. In some embodiments, the status[463] of a group[460] is determined according to the aggregate value[307] of the placements[300] it receives relative to other groups[460] within a system[180]—specified sliding window[677] of time.

However, other embodiments may safely make any number of other valid choices in this regard. These include, but are not limited to: frequency of mentions[310]; placements[300] of individual entities[350] belonging to the group[460]; measuring the difference (if any) between the placement values[307] of the group[463] and the average, mean, or median of the placement values[307] of the member[455] entities[350]—all of the preceding within the same system[180]—specified sliding window[677] of time, user[800]—defined, ontologically determined, or any combination of these.

Unlike an equivalence class[450], whose specific membership or membership criteria may be defined external to the data[1435], groups[460] are formed entirely empirically in most embodiments. A target entity[150] may simultaneously belong to an arbitrary number of groups[460]. In most embodiments, group[460] definitions will age out according to a system[180]—specified sliding window[675]. Similarly, most embodiments will periodically re-evaluate whether an ongoing group[460] is high-status[463] or not. Many embodiments will handle the re-evaluation period with a configuration variable[815]. In this way, any groups[463] who have apparently lost their importance for whatever reason can be demoted to normal groups[460]. Many embodiments will also automatically elevate a group[460] to high status[463] in the event that it abruptly gains in placement[300] or frequency of mentions[310] (or whatever other metric is being used by the given embodiment). The rules for this will be config[815]—driven in most embodiments. This is to avoid obsolete content[320] impacting the analysis.

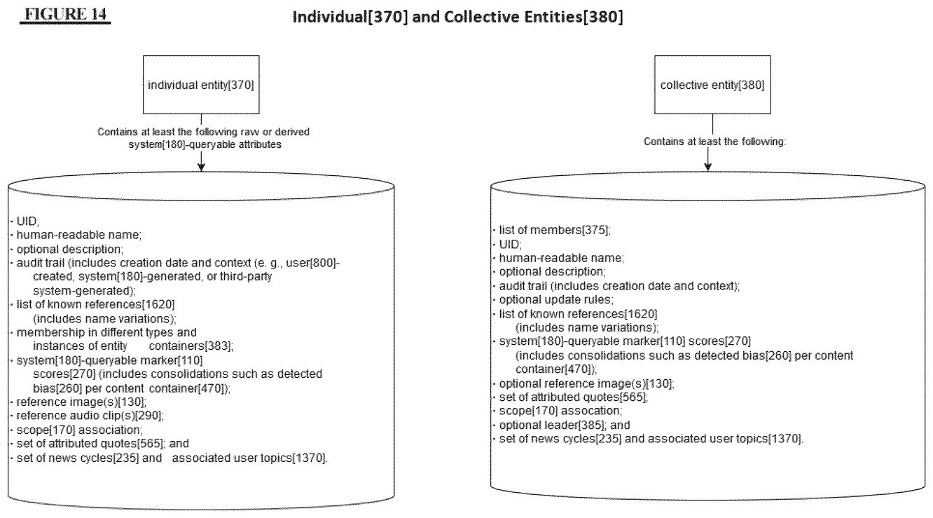

As pictured in FIG. 14, a default embodiment, individual entities[370] will have at least the following raw or derived system[180]—queryable attributes: UID; human readable name; optional description; audit trail including creation date and context (e. g., user[800]—created, system[180]—generated or third-party system-generated); list of known references[1620] including name variations; membership in different types and instances of entity containers[383]; system[180]—queryable marker[110] scores[270], including consolidations such as detected bias[260] per content container[470]; reference image(s)[130]; reference audio clip(s)[290]; scope[170] association; set of attributed quotes[565]; and set of news cycles[235] and associated user topics[1370]. Non-target entities[350] being analyzed for comparison purposes may have a smaller set of attributes in some embodiments.

Likewise, collective entities[380] will have at least the following: a list of members[375]; UID; human readable name; optional description; audit trail including creation date and context; optional update rules; list of known references[1620] including name variations; system[180]—queryable marker[110] scores[270], including consolidations such as detected bias[260] per content container[470]; optional reference image(s)[130]; set of attributed quotes[565]; scope[170] association; optional leader[385]; and set of news cycles[235] and associated user topics[1370]. It should be noted that in many embodiments, group entities[380] can have both associations with other system[180] objects such as quotes[565] and marker[110] values[270] that are associated only with the group entity[380] as opposed to any of its members[375] or its leader[385] (at least explicitly). For example, an assertion[500] such as “A Facebook spokesperson said [QUOTE]” would in most embodiments be treated as a quote[565] attributed to the collective entity[380] of Facebook.
Lists[490]: Certain entities[350] tend to co-occur specifically in lists[490]. This is a special case of a group[460], because lists[490] inherently have an order to them which can be analyzed.
Group in Image[130] or Video[140] [1347]: Some embodiments will implement a marker[1100] to assess the interpersonal dynamics of a group[1347] of people[350] which contains at least one identified target entity[370]. These embodiments will often use existing algorithms to assess the relative status of individuals [370] within a pictured physical group based on visual cues including but not limited to body language, directions of gaze, and relative physical position.

### Mentions[310]

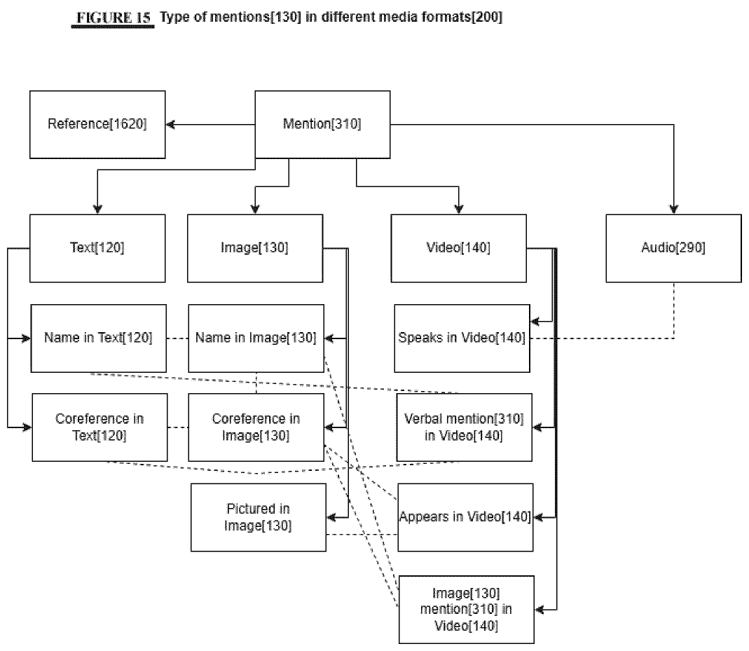

As shown in FIG. 15, a mention[310] in most embodiments can be literally any type of reference[1620] to an entity[350] in any supported media format[200]. Most embodiments also support mentions[310] for assertions[500] and for quotes[560]. Such mentions[310] are equated to detected appearances of assertions[500] and quotes[560]. In a default embodiment, mentions[310] may include, but are not limited to:
Entity[350] name appearing in text[120].
Any other type of recognizable text[120] reference[1620] to the entity[350], for example by title or role.
An image[130] or video[140] containing the entity[350]. Note that this will also apply for group entities[380] in some embodiments. These embodiments will use any model of their choosing for associating images[130] with a group entity[380]. Examples include, but are not limited to: a photo[130] of an organization's headquarters, an image[130] of a landmark like the Eiffel Tower to indicate a city, and an image[130] of the entity's[380] leader[385].
OCR′able text[120] references[1620] to the entity[350] in images[130] or video[140]. Examples of this include but are not limited to: campaign signs, and protest signs.
In audio[290] any detectable reference[1620] to the entity[350] from speech-to-text translation, as well as voice fingerprinting to identify entities[370] actually speaking (if available in the embodiment).

References[1620] or co-references in computational linguistics include all instances of references to an entity[350] that lack explicit naming, encompassing pronouns, or generally-named entities like “the new president.” Errors in detecting such references[1620] are most likely to be recall-related with existing NLU approaches as of this writing. However, in real-world use, these errors are unlikely to impact system[180] accuracy significantly. This is because the kind of bias [260] the system[180] is seeking to detect may in many instances be subtle, but is broadly present in the media outlets[160] who display significant bias[260]. Thus recall-related errors will cause little harm. Because, as of this writing, co-reference detection with existing methods lacks the accuracy of NER[155], for example, some embodiments will have a configuration setting[815] that determines whether or not co-reference resolution will be attempted. Note that for this reason, we will use the term reference[1620] to clearly indicate all mentions[310] possible to detect in the given embodiment.

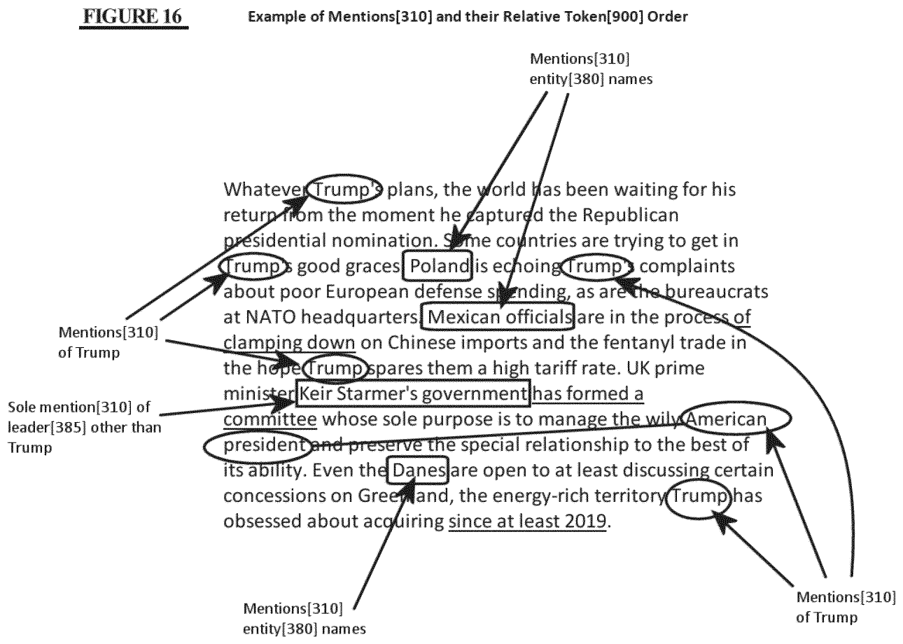

In most embodiments, mentions[310] have both relative token[900] order to one another within a section[410] of a story[100] (when scanning in reading order for the relevant language[1520]), and also placement values[305] based on the value[305] of the section[410] in which they appear. As shown in FIG. 16, “Trump” [370] is mentioned first, and most often. Furthermore, he is the only leader named by his own name, rather than that of the country or organization (see entity vs person marker[1775]).

### Editorial Choice Profile[215]

An editorial choice profile[215] records each editorial choice[210] made by a media outlet[160] with respect to a target entity[150]. For any target entity[150] who receives considerable media[160] coverage, the editorial choice profile[215] presents a highly detailed record of decisions[210] that enable good probabilistic assessment as to whether observable degrees of similarity among media outlets[160] in the collection of these choices[210] could have occurred naturally. The profile[215] can be examined in most embodiments with respect to a particular news cycle[235], a user[800], a programmatically defined window of time[670], or time since the first mention[310] ever of the entity[150] in the system[180] data collection[1440] for the media outlet[160].

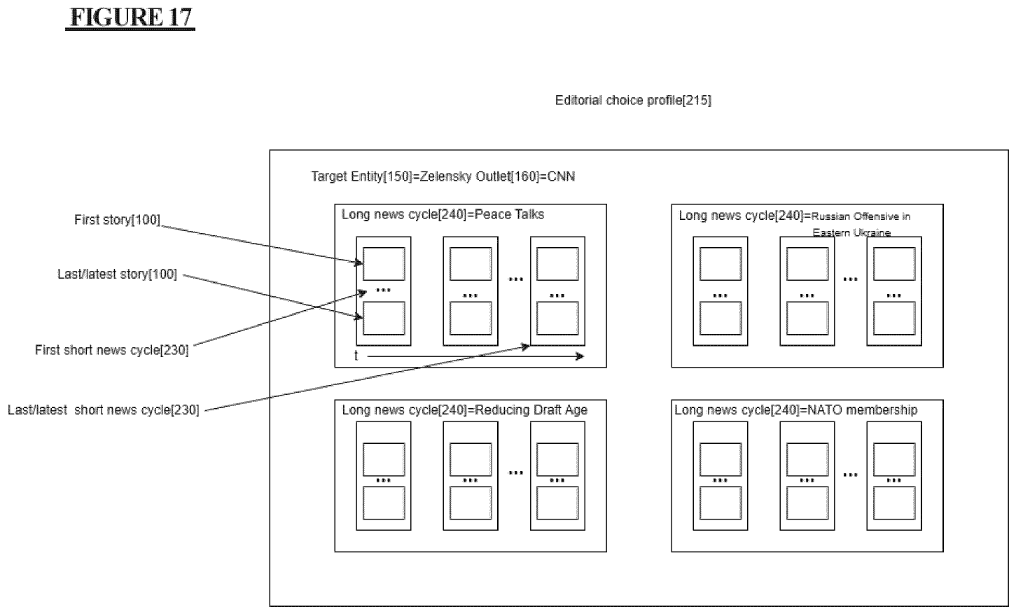

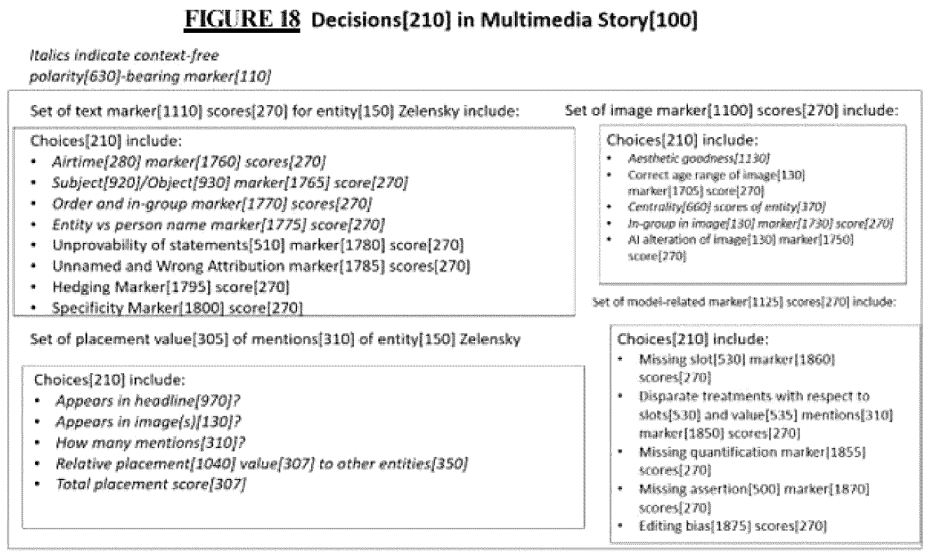

A high-level example of an editorial choice profile[215] is pictured in FIG. 17. For a case such as entity[370] Zelensky and outlet[160] CNN, there will be multiple long news cycles[240] and a large number of short cycles[230]. Each short cycle[230], from the first one identified to the very latest one will have one or more stories[100], which in turn are composed of different sections[410] and components[190], each of which will be analyzed by format[200] type for all relevant markers[110] as shown in FIG. 18, implemented by the particular embodiment.

### Time Windows

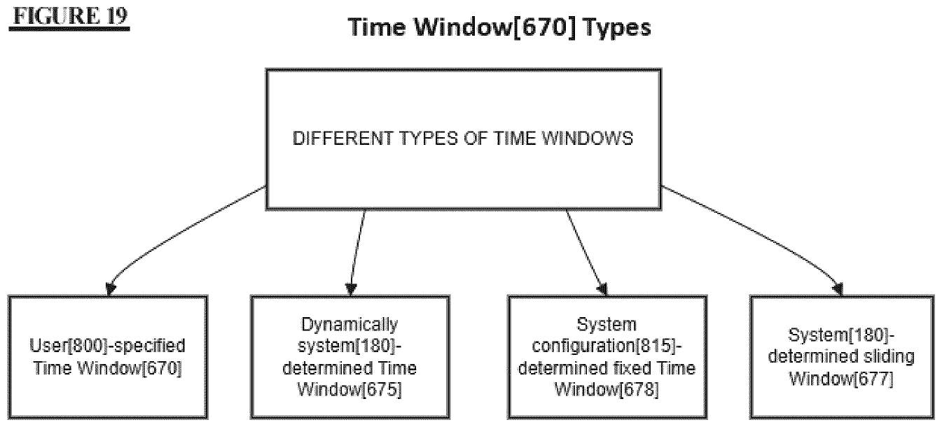

Time windows[670] for analysis generally, individual and sets of markers[110], and specific visualizations [830] in pretty much all embodiments can be specified by the system end-user[800] via the user interface[820] or programmatically; often a specific time period is of special interest for one reason or another. As shown in FIG. 19, a default embodiment will support the following logical types of time windows: user[800]—defined windows[670]; dynamically-determined windows[675]; fixed windows[678] as determined by the system configuration[815] including lookback periods[960] in most embodiments; and sliding windows[677].

It will often be the case that different markers[110] have different logical needs in different situations in this regard. Thus, almost all embodiments will also determine time windows[670] for calculations involving the markers[110] or at least set bounds on them. For example, time windows[670] must be long enough to yield a sufficient amount of content[320] about the specific target entity[150] within a given set of scoped media outlets [220] for analysis to be performed. Different markers[110] will require differing amounts of content[320] and so will have their own time window[670] requirements. An easy-to-understand example is the system's[180] need to empirically estimate the length of a new news cycle[230] around a specific real-world event[340]. Likewise, most embodiments will automatically reinitiate system[180]—defined time windows[675] when any significant discontinuities in multiple markers[110] for the same target entity[150] is detected.

### High Level Bias[260] Detection Process

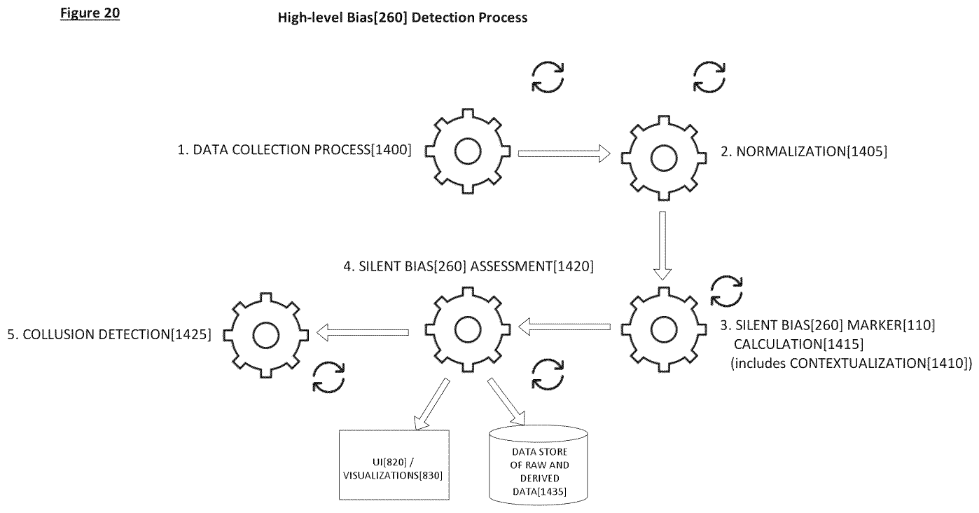

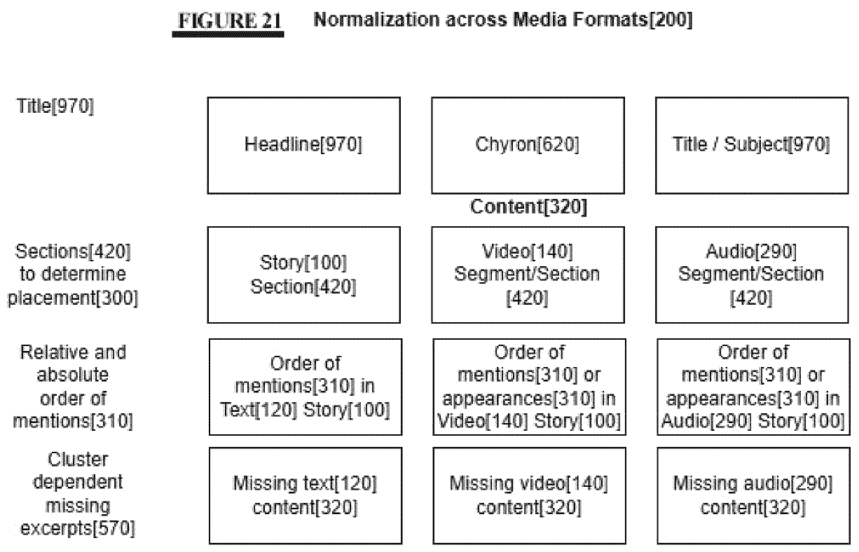

As indicated in FIG. 20, most embodiments will measure bias[260] against one or more target entities[150] in a media outlet[160] by a five-step continuous process. However different embodiments may merge this into a smaller number of steps, or in some cases even change their order.
1. Intake & Processing[1400]: In the first step, corpora of news-related content[320] are ingested. Each piece of content[320] will be indexed. In most embodiments, this step[1400] includes but is not limited to: any speech-to-text recognition needed for audio[290] content, and analysis of image[130] and video[140] content[320] to identify and tag instances of target entities[150] that are persons [370], OCR, and methods such as Welsh, Kaz et al for robustly parsing news website structure. The data will frequently be multimedia in format[200]. While a preferred embodiment will opt to have its own collection engine so as to maintain quality control, it is not essential for the system[180] to perform its own data collection, so long as a high-quality and comprehensive data collection is performed, including all embedded multimedia objects as well as all metadata, including time and date stamps. This is in essence a very standard process used for complex data analysis.
2. Normalization Step[1405]: In this step, which in some embodiments will simply be part of the indexing process[1400], the content[320] of different media formats[200] and media outlet formats[440] is normalized[1405]. By normalized, we mean that any segmentations needed in order to perform measurements across different media formats[200] and delivery types[440] are added to the indexes of content[320] in the data store[1440]. With even standard multimedia indexing, things like the relative order of mentions[310] of target entities[150] within a story[100] should already be available whether a literal mention in text[120] or an actual appearance of a person[370] in inline video[140], image[130], or audio content[290]. The notion of relative order of appearance is a valid marker[110] as it has the same implications regardless of media format[200] or delivery type[440]. Likewise, TV chyrons[620] may be normalized to headlines[970] by the indexer. Some examples of these are shown in FIG. 21.
   Depending on the capabilities of the indexing engine(s)[1460] being used, this step[1405] may default into a quality assurance check to ensure that no sections[330] of content[320] are above a system[1801]—specified size, whether that is token[900] count, length of time[750] or other format[200] or delivery format[440]—specific type. Any content[320] whose size is above such a threshold will be tagged by most embodiments as being in an error state relating to failure to segment and will not be processed further in most embodiments.
3. Bias[260] Marker[110] Calculation[1415]: In the third step, all relevant markers[110] present in the content[320] for each media outlet[160] with respect to a target entity[150] with the user[800]—requested time window[670] are scored. In the case of group entities[380], in most embodiments, this means assessing each member[370] and the container group[380] separately. This stage includes building a behavioral model[680] of the corpora resulting from each set of scoped media outlets[220]. This is because some key markers[110] can only be calculated on a relative basis. For example, it is impossible to determine that a specific piece of content[320] has been omitted by some media outlets[160] unless other media outlets[160] with the same scope[170] contained it. This step is very important because without knowing both what other choices[210] were logically available, and what other media outlets[160] actually chose from among them, it is impossible to accurately assess whether any type of bias[260] or collusion[650] is present.
4. Contextualization/Aggregation Step[1410] By contextualized, we mean the process of placing the editorial decisions[210] made in individual stories[100] to the entire particular media outlet[160] in the context of the editorial decisions[210] made in the stories[100] in other media outlets[160], as broadly as possible and across as many scopes[170] as feasible for the relevant news cycles[235] within the same time period[670]. (Restricting comparisons to media outlets[160] of the same scope[170] will often be necessary as a practical matter since, for example, what is big news in Denmark may not register in American media[160] at all, thus precluding the possibility of apples-to-apples comparisons. Truly international news cycles[235] may, however, be analyzed across the set of all media outlets[160] available[1020] to the system[180].)
   In most embodiments, this process also includes contextualizing the treatment of like entities[350]. In most embodiments, this will be done by using equivalence classes[450] and groups[460]. (In most embodiments, the equivalence class[450] members may be defined manually by an end user[800] selecting named entities[350] from LLM or similar generated lists of entities[350], an end user[800] verifying or altering the generated list, or done altogether automatically via LLM's or other approaches.) Most embodiments will choose to provide default classes[450] for obvious categories such as world leaders; almost all embodiments will allow users[800] to make changes to these defaults, including adding new categories[450]. Some embodiments will implement automated updating rules so as to capture roles that change after an election, for example.
   However, certain embodiments will also employ and automatically label (with any summarization technique[1593] of their choosing) different metrics of “similarity” so as to reflect the real-world reality that different valid categorizations of the same persons[370] exist. This both allows the end user[800] to better understand which version of similarity is being indicated in a visualization[830], and for the system[180] to try to infer defacto categorizations based on any distinctive clusters[1375] in the data[1435] and coincidence with obvious group labels in the same paragraph[950] as the list. For example, the President of France belongs logically to a few different groups including: presidents of NATO countries, EU countries, francophone countries, and G7 countries. One reason for the system[180] to generate these categories [450] continuously is that there are many different equivalence classes[450] of interest, and their members change frequently.
5. Bias[260] Determination[1420]: Once all of the content[320] for the specified sets of scoped media outlets[220] has had its markers[110] calculated, the next step is to assess bias[260] at the level of the individual media outlet[160]. Because a determination of bias [260] requires a pattern of bias[260] that is detectable over time, bias[260] must be associated at the media outlet[160]—or at the conglomerate [430] level if it exists—rather than story[100] level. However, most embodiments will make a bias[260] assessment at the sub-outlet[165] and author[250] level if the amount of relevant content[320] is sufficient in order to do so. A preferred embodiment will use dynamic Bayesian inference networks for this purpose. As this is a statistical approach, in most embodiments, a bias [260] determination will not be made in any instance in which there is an insufficient amount of content[320] for the sub-outlet[165], author[250], or top-level media outlet[160] for an adequately statistical measure.
6. Implied Collusion[650] Detection[1425]: While editors at many media outlets[160] may tend to generally exhibit certain biases[260], this by itself does not suggest collusion[650] —as opposed to correlation of behavior. In most embodiments, the bar for implied collusion[650] is both higher and different. Implied collusion[650] in most embodiments requires a sustained, highly-similar pattern of individual editorial choices[210] among different media outlets[160] with respect to specific target entities[150]. This is because there is a large difference between taking a particular high-level editorial viewpoint and making numerous, almost identical and quite specific editorial decisions[210] to slant or distort.
   In other words, even if N media outlets[160] all openly prefer the same political candidate, the extent and the specific means with which they try to implement that editorial viewpoint should vary if the only commonality is their preference for the same candidate.
   Most embodiments will not consider media outlets[160] that are part of the same conglomerate[430] to be colluding by definition, as opposed to content sharing and/or being under effectively single editorial control. Likewise, media outlets[160] that use content[320] from a third party service such as AP or a syndicating service will be considered to be content[320] sharing rather than colluding. Most embodiments will in fact not consider any detected instances of clear plagiarism as evidence of collusion[650]. More generally, the test is not having shared content[320]—a situation that can arise in a number of different ways—but rather the pattern of editorial choices[210] in their own, at least somewhat distinct, content[320].
   In this step, an editorial decision profile[215] of each of the scoped media outlets[220] that had a sufficient amount of content[320] in relation to each target entity[150] within the given time window[670] will be constructed. In most embodiments, this profile[215] will consist of each editorial decision[210] captured by a marker[110] for any target entity[150]. These profiles[215] will then be clustered to identify self-similar groupings. In many embodiments, the clustering[1340] will be performed both for individual target entities[150], as well as for the full set of target entitiesl[150]. The motivation for the latter is that it may be interesting to assess the extent to which different media outlets[160] are generally willing to exercise their biases[260]. Some embodiments will use multi-dimensional scaling (MDS) for this purpose; other embodiments will stick with dynamic Bayesian inference networks. However, different embodiments may choose other approaches.

Almost all embodiments will provide end-user[800] visualizations [830] of the bias[260] detected. These are discussed in a subsequent section.

All derived data will be stored for future use, although most embodiments will opt to perform some version of archiving of older data.

### Different Classes of Markers[110]

As shown in FIG. 2, most embodiments will have the following types of markers[110]:
Content[320]—related (analyzing the “what” that is present at the level of individual stories[100]):
   Image[130] Analysis.
   Video[140] Analysis.
   Text[120] Analysis.
   Audio[290] Analysis.
Placement[300]—related (assessing the desirability of the “where”).
Model-based[1125] (assessing relative behavior of different comparable media outlets[160]).

### Content-Related Markers[1107]

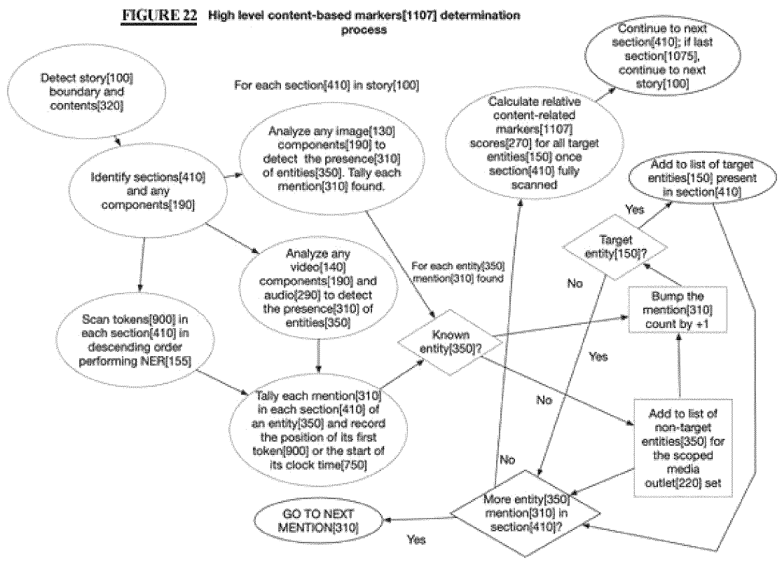

Content-related markers[1107] analyze the content[320] of a story[100] and any embedded components[190]. As depicted in a simple embodiment in FIG. 22, after a new story[100] has been identified and broken up into sections[410], content[320] of each media format[200] present in the story[100], including in embedded components[190] will be scanned by format[200]—appropriate methods in order to identify mentions[310] of, or references[1620] to target and other entities[350] of interest. In a default embodiment, these methods include but are not limited to: NER[155] for text[120], facial identification for video[140] and images[130] and voice fingerprinting for audio[290].

Appearances[310] of entities[350] in text[120] and video[130] content[320] will be tallied by story[100] section[410]. The starting position of each entity[350] mention[310] in token[900] position or time offset[750] respectively will be logged, as this information will be used in most embodiments for assigning placement values[305] to individual mentions[310]. For images[130], in this simple embodiment, an entity[350] will be either mentioned in a given image[130] or not; some embodiments may prefer a more nuanced approach (as documented elsewhere). In some embodiments, if an entity[350] is found once or more in the image[130]—more than one mention[310] is possible in the case of synthetic images[133] such as montages—each mention[310] will be tallied. Some embodiments will choose to also scan images[130] or video[140] for any OCR′able text[120] mentions[310] of, or references[1620] to the entity[350].

Most embodiments will also analyze sub-outlet[165] content[320] when that container[470] is present; this will in many cases be tantamount to the author[250]. Most embodiments will not include in a set of author[250] content stories[100] or components[190] that have multiple authors[250] because of the ambiguity. However, some of these embodiments will make an exception in the case of pairs of authors[250] who have a story[100]—generating frequency that is consistent with a typical single author[250] with the set of scoped media outlets[220].

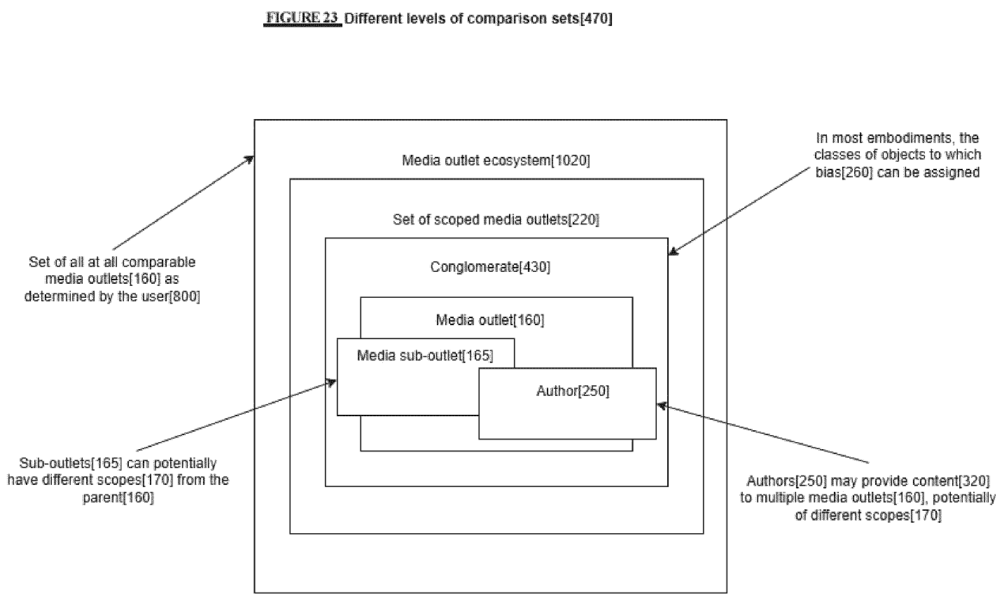

As depicted in FIG. 23, in a default embodiment, stories[100] sharing the same author[250] are aggregated for the bias marker analysis step[1415] for analysis, as are, separately, all stories[100] associated with a given media outlet[160] or sub-outlet[165]; in the case in which multiple media outlets[160] are owned by the same conglomerate [430], aggregation will also be performed by most embodiments.

This is motivated by the fact that, for example, bias[260] can be injected anywhere from the level of the individual author[250] to the head of a large conglomerate [430] in larger organizations[160]—or anywhere in between. While in the case of small media outlets[160], such as on social media, such distinctions may not exist, it is still important to be able to compare media outlets[160] within the same scope[170] in order to assess whether the bias[260] is reflective of a broader societal one; consider that Vladimir Putin understandably gets very little airtime[280] in most Western media outlets[160] but receives a huge amount in Russian media[160].

It should be emphasized that individual stories[100] are not considered biased[260] in most embodiments as there is simply not enough evidence of a pattern of bias[260] within just one story[100]. Any one story[100] after all will only be so long; it is often the case that multiple related or somewhat topically overlapping stories[720] may exist concurrently, overlap in time, or appear within a very short time interval of one another, in the same media outlet[160]. In such cases, editors understandably wish to avoid excessive redundancy. Further, within the often brief time period in which a given story[100] may have to be composed, a lack of new information about a given target entity[150] may limit the editorial choices[210] that exist.

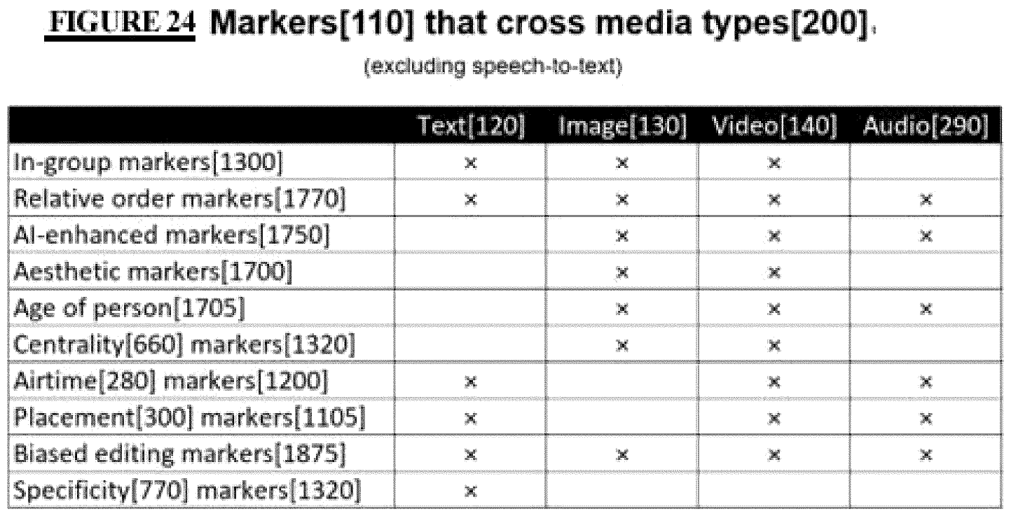

In most embodiments, separate markers[110] exist for text[120], image[130], video[140], and audio[290] objects. However there are also multimedia markers[110] that are conceptually the same but implementationally quite different across multiple media formats[200]. For example, which target entities[150] appear with other entities[350] is a metric that logically applies across all media types [200]. This is shown in FIG. 24 for one embodiment which includes the markers[110] as shown. It should be noted that few markers[110] can be fully implemented across all media types[200]. For example, visual aesthetic quality determinations[1130] necessarily require an image[130] or video[140], as does the notion of visual centrality[660]. At least the age range of an entity[370] can be estimated with reasonable accuracy algorithmically when an image[130], video[140] or audio[270] clip of reasonable quality (and in the case of at least audio[270] length) is provided. No direct analog exists in text[120] content[320].

However, there are important exceptions. For example, the notion of relative order can be implemented in a straightforward way across all media formats[200]; in text[120] content[320] by token[900] order, in an image[130] by reading order of the presented entities[370], and in video[140] or audio[290], by temporal order. All formats[200] are subject to editing in ways that can indicate bias[260]; damaging snippets[575] of text[120] from a quote[560] or interview[395] can be omitted, damaging video[140] or audio[290] snippets likewise edited out. An image[130] can also be clipped, for example, to remove undesired elements.

### Image[130]—Related Markers[1100]

This class [1100] of marker[110] relates to how much, in what context[730], how reasonably, and how favorably, different target entities[150] are pictured at different points in time by different media outlets[160]. These markers[1100] will be used in conjunction with one another by most embodiments to assess the editorial decision profile[215] of a given media outlet[160] with respect to the use of images[130] in their portrayals of specific target entities[150]. Each marker[1110] assesses different characteristics of images[130] relative to the target entities[150] being monitored. Some of these are very straightforward, such as the attractiveness[1130] of the pictured entities[370], while others are more subtle, such as the degree of centrality[660] and size of each entity[370] in the image[130].

One important vector of assessment is whether or not the image[130] falls within the set[940] of images[130] that should reasonably have been used given the context[730] of the story[100], and how far the media outlet[160] is willing to go to in order to get the image[130] they ideally desire. By this, we mean not only reaching back beyond the system[180]—defined lookback period[960], but other things that include but are not limited to Al enhancements (or degradations) of pictured persons[370].

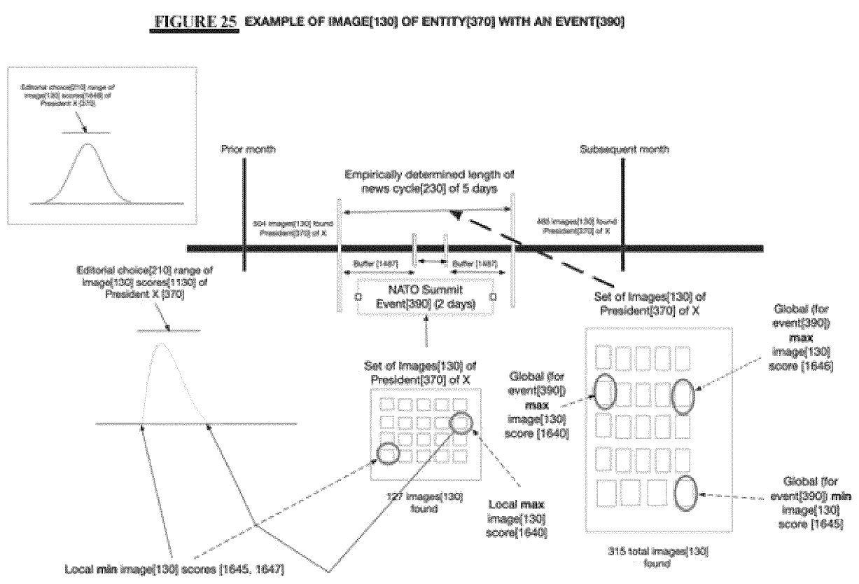

FIG. 25 uses the example of a 2-day NATO summit event[390] which has a peak[1485] appearance in stories[100] of a 5-day period, including the event[390] itself. At such an event[390], many photos[130] are taken of important dignitaries [370], both individually and in groups[1347]. This generates different sets of photos[130]—including from video frames[145]—both from the event[390] itself and a reasonable buffer of time[1487] around the event[390]. While almost all embodiments will provide some buffer[1487], the individual approaches may include but are not limited to: fixed buffers determined heuristically, for example a percentage of the duration of the event[390]; empirically, from prior occurrences of the same event[390] if possible; and empirically retroactively to the particular event[390]. Most embodiments define the universe[940] of images[130] to include the buffer period[1487]. However some embodiments may decide to calculate max and min values[270] for images[130] separately for the event[390] itself and the buffer[1487] (in the event that data is present as to the end of the event[390]). Such embodiments will do so in order to detect the case in which images[130] in the buffer period[1487] were selected for their (positive[635] or negative[637]) polarity[630]—bearing characteristics because no comparably-scored images[130] existed during the event[390] itself.

As shown in FIG. 25, many embodiments will treat aesthetic goodness[1100] as especially important; some may even prefer it to the overall image score[1648] which includes other considerations such as centrality [660].

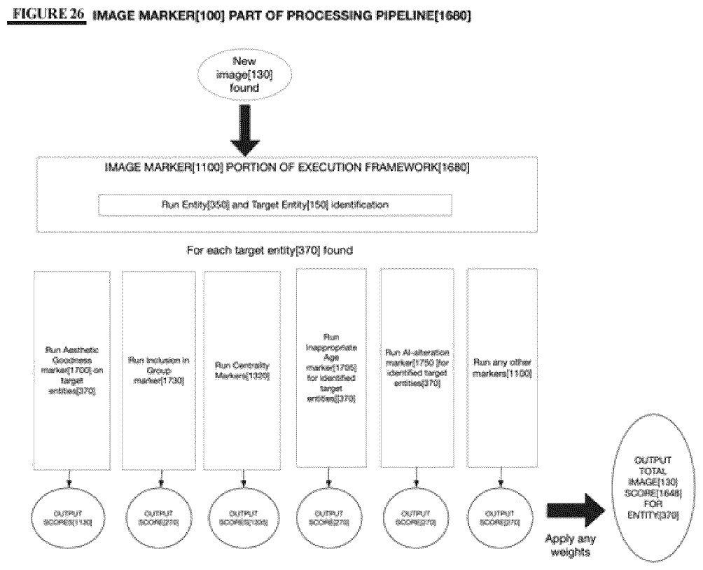

As shown in FIG. 26, different embodiments may generally prefer to apply different weights to the different markers[1100] to derive the overall score[1648]. Each new image[130] will first be processed to determine whether there are entities[350] pictured, and, if so, whether they are target entities[150]. Some embodiments will choose to discard from the pipeline[1680] images[130] that contain neither target entities[150] nor those in the same equivalence class[450] or group[460], depending on the embodiment. In other words, a “known” entity[350] must be present in such cases.

It should be emphasized that in the event that more than one target entity[370] appears in an image[130], each such entity[370] must be independently scored. This is because what is a favorable[635] image[130] for one entity[370] may be horrible[637] for another—even in the same image[130]. Some embodiments will opt to score all pictured entities[350] that it is able to recognize.

Most embodiments will treat video frames[145] as the same as all other images[130] in the sense that if the system[180] is able to detect that a given image[130] was extracted from a video[140] whose metadata indicates that it was shot in the correct context[730], the image[130] will be considered valid.

For this class of marker[1100], most embodiments will obtain values[270] for group entities[380] simply by aggregating the scores[270] for its members[375]. However some embodiments may opt to not generate scores[270] for collective entities[380]; as noted elsewhere, some embodiments may allow specified types of images[130] to represent the entity[380]. These include, but are not limited to: organization logos, organization headquarters, stores, or other clearly branded buildings, company products, and flags. However, many of these embodiments will use such images[130] to establish mentions[310] for these entities[380] rather than for other markers[1100] such as aesthetic goodness[1130]; some of the markers[1100] can clearly only be applied to persons[370].

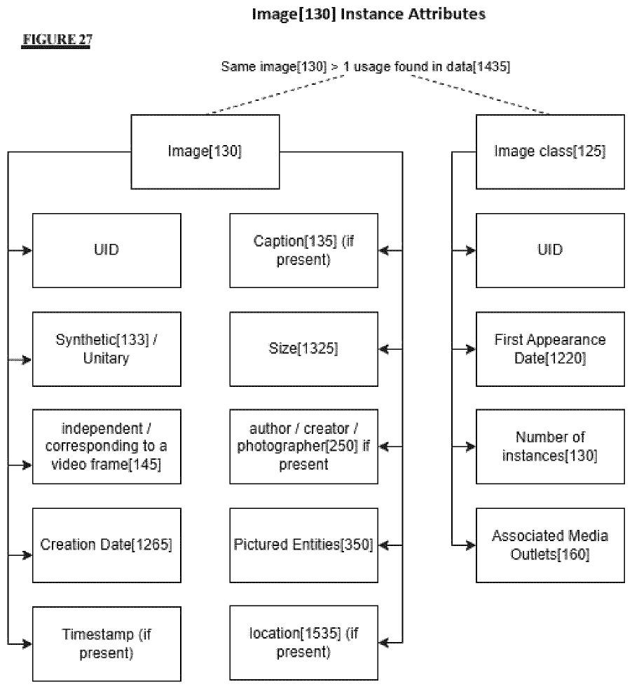

In a default embodiment, as shown in FIG. 27, image[130] instance attributes will include but not be limited to: UID; caption[135] (if present); synthetic[133] or unitary; size[1325]; independent or corresponding to a video frame[145]; creation date[1265]; author/creator/photographer[250] (if present); pictured entities[350]; and, if present, a time stamp; and a location[1535]. In the case where the same image[130] has more than one usage found in the data[1435], an image class[125] object will be created, in most embodiments. The attributes of an image class[125] will include but not be limited to: UID; first appearance date[1220]; number of instances[130]; and associated media outlets[160].

### Contexts[730]

The size of the universe[940] of potentially usable images[130], audio clips[290] and videos[140] for a given story[100] is determined by the context[730] of the story[100], in most embodiments. Some embodiments will permit a story[100] to have multiple contexts[730]. Of these embodiments, some may require the story[100] be at least a minimum number of tokens[900], sentences[910], or sections[410] long, so as to not overuse contexts[730]. In such embodiments, it may be possible for a story[100] to be retroactively assigned additional contexts[730] based on the content[320] in subsequently-released stories[100]. In such cases, the universes[940] of images[130], quotes[560], videos[140], and other objects will be treated as the union of the different contexts[730] assigned to the story[100].

For example, a gathering[390], such as a conference or a summit, is of quite limited duration, and so will have a relatively small universe[940] of images[130] and videos[140] associated with it in most cases. The shorter the duration of the event[390], the more likely that quality issues will arise from temporary conditions including but not limited to illness, post-vacation glow, jetlag, stress, or a poor night's sleep, which will impact the quality of most (or all) photographs[130] or videos[140] taken of a particular target entity[370] in attendance. Other potential factors include, but are not limited to: poor lighting or entity[370] distances from a camera or microphone. Regardless, even from such short spans of time, there are still almost always editorial choices[210] to be made—even if of varying legitimacy. These include not only which of the available images[130] from the event[390] to use (assuming that any exist), to whether to use one of those pictures[130] at all, to using images[130], video[140], and/or audio[290] in the buffer period[1487] around the event[390], to using an image[130] of the target entity[150] that has nothing to do with the particular event[390].

As is further discussed in a subsequent section, most embodiments will consider the set[940] of possible images[130] as those that were taken at the event[390]; most embodiments will consider a time buffer period[1487] proportional to the duration of the event[390], around the event[390], as being during the event[390] (e. g., the night before). A default embodiment assesses all available images[130] and videos[140] from the event[390] that unambiguously contain one or more target entities[370]. Each image[130] is scored for attractiveness[1130] using the embodiment's chosen method for doing so. This establishes the range of attractiveness[1130] of the images[130] and videos[140] for each target entity[370] who was present at the event[390].

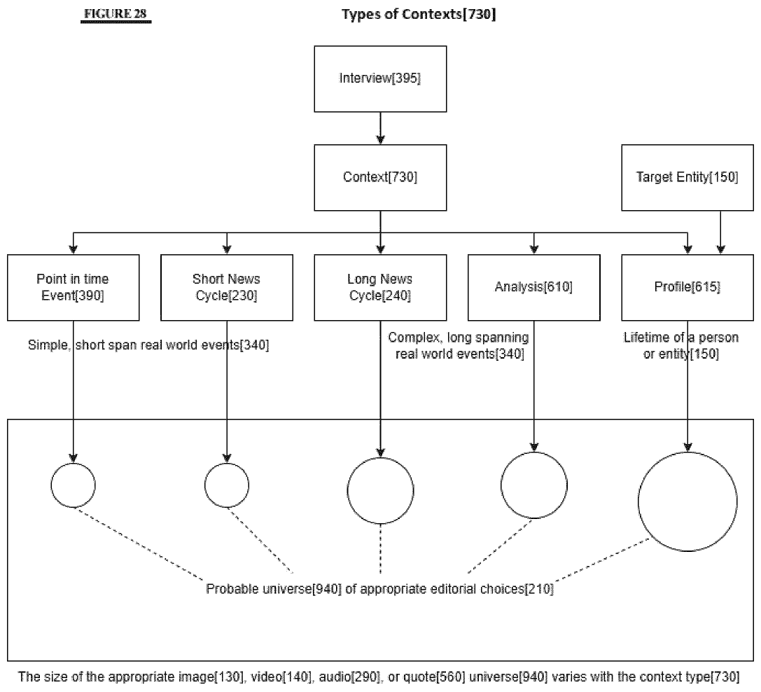

In a default embodiment, the different types of context[730] are depicted in FIG. 28. These include, but are not limited to the following, from the shortest timespan to the longest:
Interviews[395], speeches[395], or any other bounded set of remarks for which a transcript[480] exists.
Point in time events and gatherings [390], a type of real world event[340].
Short/simple news cycles [230] (general class).
Long/complex news cycles[240].
Analyses[610] (no specific news cycle[235]).
Profile[615] of entity[350] (including but not limited to obituaries).

Preferred embodiments will provide subtypes of most of these contexts[730] so as to avoid potential skewing of analytic results caused by things such as edge-case situations as the funeral example noted elsewhere. In a default embodiment, these will include but are not limited to: weddings, graduations, holidays or other celebrations, election result announcements, and announcements of court verdicts.

This is because these different story[100] contexts[730] impact the boundaries of the universe[940] of images[130] that are considered reasonable to have used. Use of inappropriate images[130]—those outside of the system[180]—defined universe[940]—when appropriate images[130] are found to exist in other media outlets[160]—is something that most embodiments will flag as potentially injecting bias[260]. In most embodiments, the value [270] of other image markers[1100] will subsequently be used to assess strong evidence of bias[260]. Thus, the system[180] must endeavor to detect the context[730] of the story[100] that contains the image[130]—or video[140].

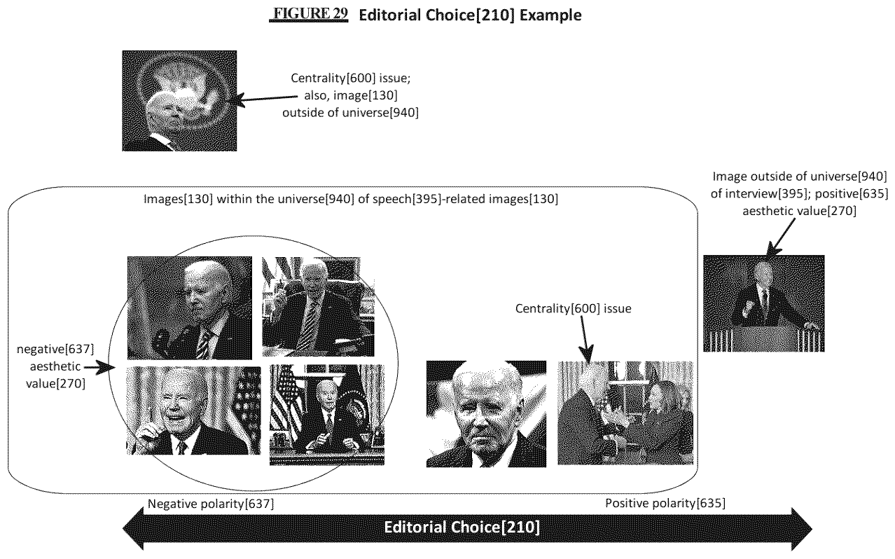

An example of this is shown in FIG. 29, which shows a selection of photos[130] of Biden used in actual stories[100] about the event[390] of his final State of the Union speech[395]. Some of these photos[130] were from within the timeframe of the event[390], and therefore were in the correct universe[940] of images[130]. It can be observed that within the pictured images[130], some have higher aesthetic goodness scores[1130] than do others. One also has a centrality[660] issue. However, some media outlets[160] reached back in time to find photos[120] of Biden more suited to their preferences. For example, the rightmost image[130] has high scores for aesthetic goodness[1130] and centrality [660]. By contrast, the leftmost image in FIG. 29 is also outside of the correct universe[940], but has poor scores for both aesthetic goodness[1130] and centrality[660].

Most embodiments will allow for a story[100] that discusses past eventsl[340] or time periods to use images[130], video[140], and audio[290] objects which date back to the events[390] or time periods described in the story[100] without considering it as inappropriate or demonstrating any evidence of bias[260]. The same logic holds true for certain contexts[730], for example obituaries, in which it is very common to show videos[140] or images[130] of the person[370] in their prime. However, audio[290], image[130], or video[140] objects which fall outside of the universe[940] will be treated as inherently anomalous by most embodiments.

Most embodiments will therefore have markers[110] that detect the regular use by a media outlet[160] of inappropriately old embedded objects[190] relative to specific target entities[150], outside of the specific contexts[730] that justify it. Similarly, most embodiments will analyze the contextually [730]—inappropriate images[130] or videos[140] to determine the favorability or attractiveness[1130] of the images[130] of target entity persons [370]. In this way, obvious attempts to reach back in time to find outlier images[130] of the individual[370] in question—whether to make them look unusually beautiful/handsome or ugly, in order to portray them as being in a specific state[1145], or for any other reason—can be readily detected.

It should be noted that even if the specific reason that such reaching outside of the universe[940] is happening may not be computationally inferable by the system[180], detecting it as an anomaly still has value; the values of other coincident markers[110] will allow the system[180] to infer whether the apparent intent of using a non-recent image[130] is to aid or hinder. An excellent real-world example of this is the use of old images[130] and video[140] of Ukrainian President Zelensky from his days as a comedian/actor playing the president of Ukraine on a popular TV show. The pragmatic intent is mockery, to remind the audience of Zelensky's showbiz background. Stories[100] that include such images[130] or videos[140] are rarely in a positive polarity[630] context for Zelensky.

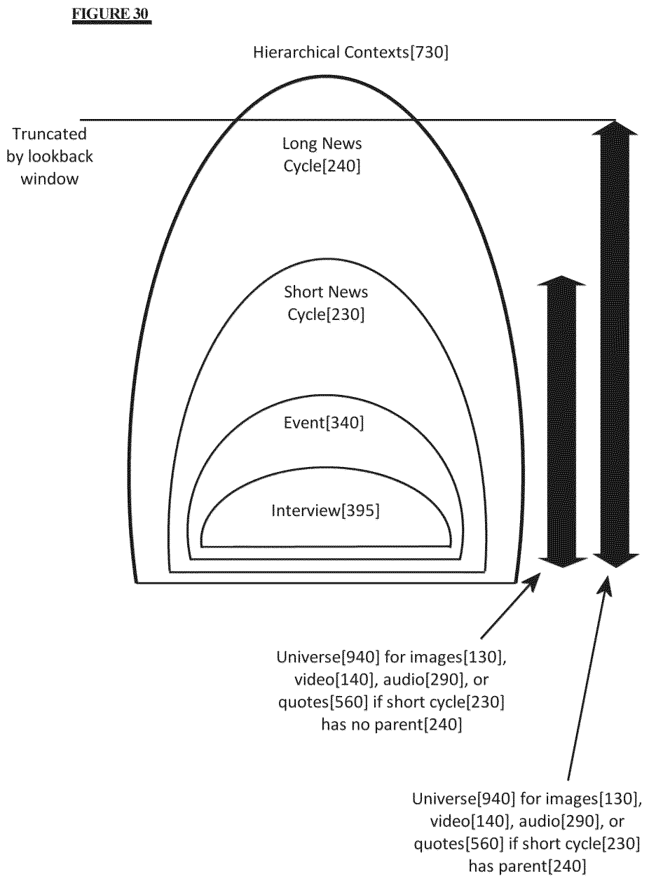

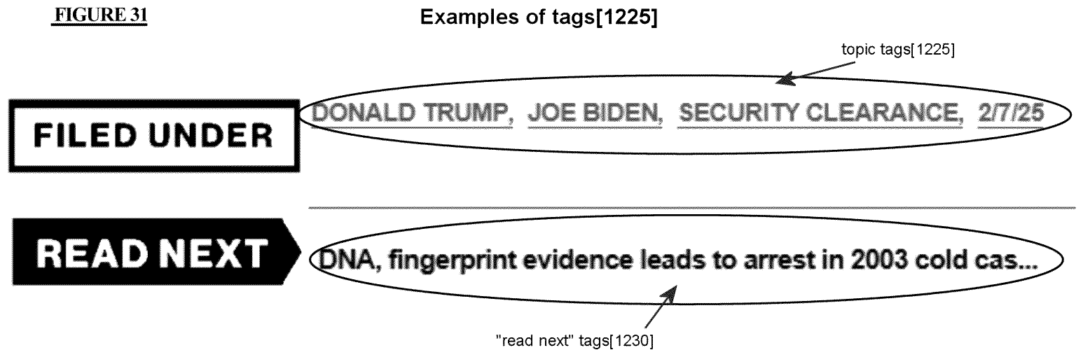

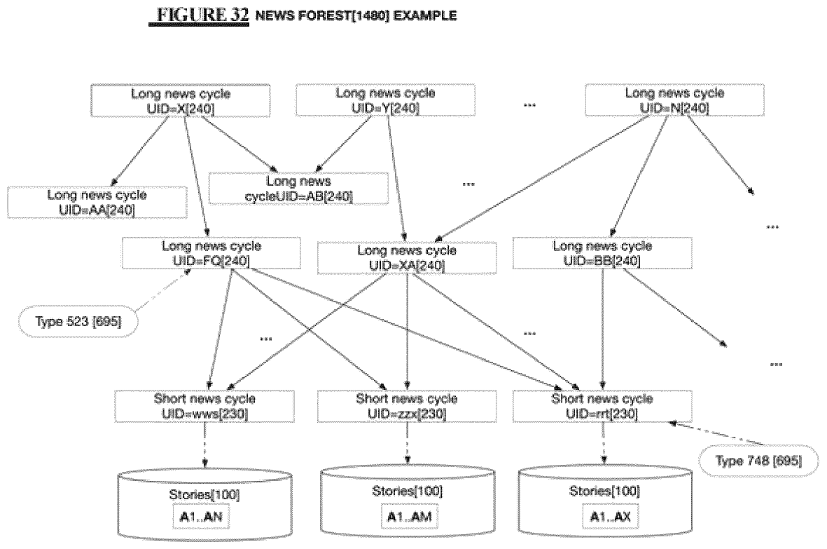

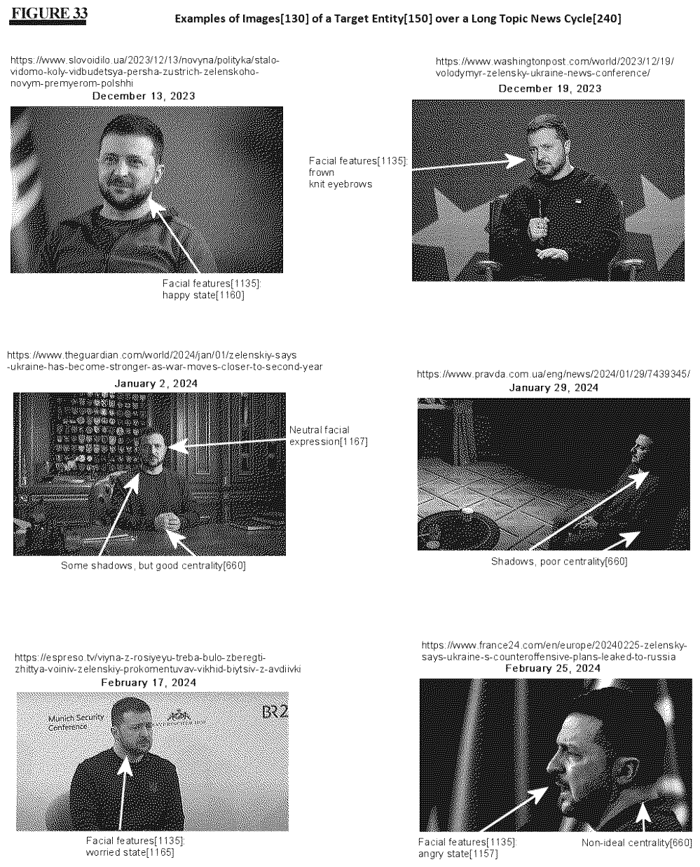

In a default embodiment, the following contexts[730] (also shown in FIG. 28) will be provided by the system[180]. However almost all embodiments will allow the system administrator[810] to modify or add contexts[730]. (Please note that while image markers[1100] may use contexts[730] most heavily as a class, other types of markers[110] will also make use of them in most embodiments. Most embodiments will have all markers[110] share the same context[730] definitions for consistency purposes.)
Interviews/speeches[395] must have transcripts [480], as well at least one target entity[370] mentioned or speaking, a length determined from audio[290] or video[140] clip length[760], (or if purely in text[120] form, number of tokens[900]), as well as a date[1610] which may include a start time, and in many instances a location[1535]. Interviews/speeches[395] are a special case of a point in time event[390].
Point-in-time events[390] have names[1605], date or time ranges[1610], and locations[1535] associated with them; references to them generally appear in bursts, as the event[390] nears, and tail off in its aftermath. Any number of existing ML/LLM methods[1180] can reliably detect such events[390]. Some are annual or otherwise periodic, which makes them still easier to identify based upon content[320] regarding their prior iterations. Note that most embodiments will use NER[155] as at least part of their approach; as noted elsewhere in this document, NER[155] is very mature and quite accurate.
As shown in FIG. 30, in most embodiments, point in time events[390] are treated as a special category of short news cycles[230] that have the defining characteristic that there is high likelihood of quotes[560], images[130], video[140] and/or audio[290] clips to be had from target entities[150] who are present at the event.[390] This will not be the case for many other types of short news cycles[230]. Events[390] may include one or more interviews[395].
Short news cycles[230] are intended to capture news stories or real-world events[340] that are atomic, or in other words, are treated as single news stories rather than as complex, long-lived topics that have numerous subtopics and related topics, and which may span months or longer. However, in most embodiments, short news cycles[230] will often become associated with a parent long topic news cycles[240].
In the short news cycle[230] context[730], most embodiments will assume that contemporaneous, or at least very recent images[130] of any target entities[150] mentioned in the story[100] should be used, assuming that they are available. However, many embodiments will allow the image[130] universe[940] to be expanded to include images[130] from a parent long news cycle[240]—if there is one—so long as the image[130] creation date[1265] is within the system[180]—defined lookback[960] period.
In a default embodiment, short news cycles[230] will have attributes that include but are not limited to the following: UID; creation date; aged-out date (if appropriate); zero or more associations with long news cycles[240]; version number; zero or more real-world events[340] including but not limited to events[390]; number of associated stories[100]; associated entities[350]; associated linguistic entities[1690]; associated assertions[500]; and associated quotes[560].
Long topic news cycles[240] in most embodiments will be composed of short topic news cycles[230]. Most embodiments will create a long-cycle parent[240] for a short-cycle[230] one, or add a short-cycle[230] one to an existing long-cycle parent[240] if the system[180] definition for topically overlapping stories[720] with other stories[100] within the scoped media outlets[220] is exceeded. In most embodiments, such overlap[720] is a common way to identify that a long news cycle[240] or topic[240] has come into existence. This is because an explosion of stories[100] about related real-world events[340] or different angles on the same event[340] suggests a level of complexity and staying power about the news cycle[235].
Most embodiments will consider the emergence of new topic tags[1225] provided by the media outlet[160] as evidence of a new long news cycle[240]. For example, topic and section tags[1225] such as “Election,” “Ukraine, and “EV's” are quite common and fairly consistently applied. Examples of topic tags[1125] and “read next” tags[1230] are found in FIG. 31. Some embodiments will similarly treat “related story,” “read next,” “you might like,” and other such links[1230] in any media outlet[160] where they are known to be dynamically generated per story[100].
Different embodiments may choose to take somewhat different approaches to both how exactly they determine topical overlap[720] among N stories[100] and to the number of stories[100] with which there must be at least a minimum amount of overlap [720] and thus new long news cycles[240]. These may include but are surely not limited to: traditional topic detection algorithms[1650], ML/LLM models[1180], hierarchical clustering[1372] including the use of non-content[320]—bound evidence such as types[695], currently-assigned news cycles[235], inline links[1227] as well as related story[1230] ones, and tags[1225] provided by the media outlet[160]. It should be noted that new news story detection, often referred to as TDT, or Topic Detection and Tracking, is a fairly mature field in IR, dating back at least as far as Wayne 1997 and Yang et al, 2002.
FIG. 9 shows a simple default embodiment. A set of stories[100] in a set of scoped media outlets[220] whose creation dates[1265] fall within the system[180]—specified window[677] are fed into a hierarchical clustering algorithm[1372] using all of the above-mentioned types of evidence, as well as content[320]—related ones (including entities[350], linguistic entities[1690], quotes[560], and assertions[500]) producing a dendogram[1597] of clusters[1375]. When the overlap[720] detected among similar clusters[1375] exceeds the system[180]—specified threshold, a new long cycle object[240] will be created; all stories[100] in the nested or sibling clusters[1375] (which will generally correspond to short cycles[230]) will be assigned the new long cycle[240] as a parent.
Though the results found with different methods will nonetheless vary somewhat, this will not be considered problematic by most embodiments because it is inherent to topic detection[1650], and because almost all embodiments will permit both an arbitrarily deep hierarchy of long news cycles[240] and allow stories[100] to be assigned to multiple contexts[730] (and hence news cycles[235],) which will together counteract most of the issues introduced by differences in topic detection[1650] method. We will refer to the set of news cycles[235] and types[695] (if present) as a news forest[1480]. This is pictured in FIG. 32.
Embodiments may also differ on the time window[670] in which the overlap[720] must occur; in other words the density of the overlap[720]. Some embodiments may have no such time window[670] at all.
Once a cluster[1375] of overlapping stories[720] that meets the system[180]—defined criteria has been detected, a new long cycle or topic [240] will be created. In most embodiments the overlap[720] will be labeled according to the embodiment's preferred summarization technique[1593] applied against the set of member[1380] story[100] headlines[970]. Some embodiments may opt to also consider any topic or section tags[1225] that are provided by the scoped media outlets[220] for naming purposes—especially if these are largely consistent across the outlets[160].
In a default embodiment, long news cycles[240] will have attributes that include but are not limited to the following: UID, creation date, aged out date (if appropriate), zero or more associations with other long news cycles[240] as parents or children in the forest[1480], version number, number of associated short news cycles[230], associated entities[350], and associated assertions[500].
Most embodiments will choose to differentiate between short[230] and long cycles[240] so as to avoid falsely flagging content[320] as being “too old” as well as for aggregating content[320] during the bias marker and detection steps[1415, 1420]. For example, if the long cycle[240] is “elections” that occur only once every four years, it may be entirely appropriate for a roughly 4-year-old image[130], video[140] or other content[320] to be used in a short cycle[230] story[100] about some election-related event[390].
Long topic news cycles[240] are intended to associate individual short cycle[230] stories[100] with clearly related larger and long-running topics such as major elections, wars, migration issues and other such things, with the aim of appropriately broadening the universe[940] of usable content[320] for short cycle[230] stories[100]. Almost all embodiments will support multiple layers of long new cycles[240], since many real-world topics warrant it. For example, individual wars raging as of this writing are surely each long new cycles[240] of their own right, but the collection of them could also be considered a long cycle[240] of global destabilization, march of authoritarianism or similar.
Stories[100] about such long-running topics[240] are quite frequent in many media outlets[160]. Many of these stories[100] may imply positive or negative things about specific target entities[150], and the choices[210] of image[130] or video[140] used to depict them is most cases will be a reliable indicator of this. For example, if the Ukrainian Army has just had a major victory, the images[130] and videos[140] selected of President Zelensky are likely to show a happier, more relaxed facial expression; in the reverse case, bags under the eyes, a frown. An example of this is pictured in FIG. 33.
Many embodiments will opt to age out long news cycles[240] according to the system's[180] archiving policy so as to limit the possibility of having odd or archaic assignments.
Analyses[610] are intended to cover any type of opinion piece or, in many embodiments, any other story[100] that is not clearly in one of the other categories. In some of these embodiments, this acts as a catch-all bucket to provide context[730] for stories lacking discernable references to real world events [340]. Such stories[610] may or may not be clearly linked to any specific real-world events[340] or news cycles[235]. They likewise may or may not be part of an identifiable cluster[1375] of similar stories[610]. Most embodiments will support subclasses including but not limited to predictions. Prediction pieces that contain images[130] of one or more target entities[150] are likely to use the image[130] to signal whether the predictions contained in the story[100] are favorable[635] or unfavorable[637] to the entities[150] in question. Embodiments which implement a separate prediction context[730] will most often train classifiers[1180] to do so. However, other types of CL methods may also be used, because of the distinct proportion of different verb tenses and linguistic markers that can be expected in such content[320].
Profiles[615] can be detected by the unusually high proportion of statements[510] that reference the same target entity[150], and generally require either (or both) a mention[310] of that target entity[150] somewhere in the headline[970] or title[970] of the story[100] or that they appear in an image[130] or video[140] component[190]. ML or LLM models[1180] can easily be trained to recognize this class of context[615] and specific subclasses of it that most embodiments will provide, including but not limited to: obituaries and inaugurations or other highly visible promotions. Most embodiments will consider the entire lifetime of the target entity[150] to be the acceptable window for any images[130], videos[140], audio clips[290] or any other data of theirs. Thus all possible choices[210] for the profiled target entity[150] will be considered equally valid editorial choices[210] in this context[615].

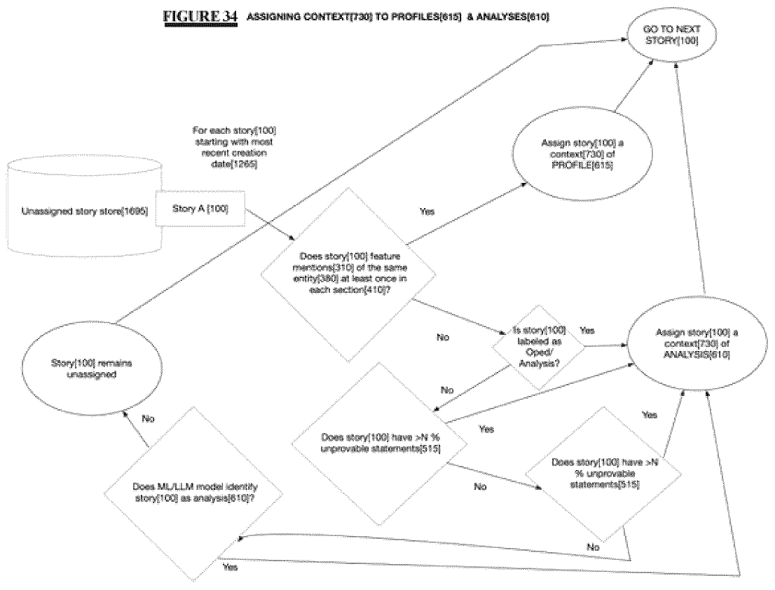

In many embodiments, context[730] is assigned to a stories[100] involving real world events[340] based on the smallest possible context[730] size. For example, an individual interview[395] at a several day conference or other event[390] has a smaller context[730] than does the bounding event[390]. Stories[100] of these last two types[730] may mention many real world events[340]—or none at all. FIG. 34 shows how a simple embodiment determines the appropriate context[730].

First, the embodiment's test for whether the unassigned story[100] meets the defined requirements to be a profile[615]. If yes, a context[730] of profile[615] will be assigned. If no, if the story[100] has been labeled by any of its outlets[160] as being an opinion, analysis or similar story[100], the context[730] of analysis[610] will be assigned. If not, a configuration[815]—specified threshold of percentage of unprovable statements[515] will be applied. If this threshold is exceeded, the context[730] of analysis[610] will be assigned. If not, a final attempt will be made with a properly trained model[1180] to detect stories[100] that are analyses or opinion pieces. If this model[1180] does not identify the story[100] as an analysis[610] the story[100] will be left unassigned in the store[1695].

Most embodiments will make use of existing computer vision techniques to establish the relative aesthetic goodness[1130] of images[130] of a human target entity[370]. Most embodiments will treat the leader[385] of a group entity[380] as representing that entity[380] in this regard. A considerable amount of technology is available to choose from in this regard; common applications such as Zoom™ employ algorithms to optionally improve the appearance of its users during video conferences; cosmetics websites offer on-the spot makeovers. Yet there are natural limits to what can be done in this regard; the average person cannot be made to resemble a supermodel and still remain recognizable. Likewise, an 80-year-old cannot reasonably be made as to appear as a 30-year old.

It should be noted that many characteristics[1135] of facial images are generally agreed to be positive almost universally across cultures—including but not limited to a smile, fully open eyes, facial symmetry, and a lack of wrinkles or skin discoloration—or negative, including but not limited to a frown, open mouth, closed eyes, wrinkles, and bags under the eyes. Such agreement allows the creation of aesthetic scoring algorithms [1255] that are difficult to argue with. Using one or more such algorithms[1255] allows the computation of a local maximum[1640] and a local minimum[1645] “aesthetic goodness” or attractiveness score[1130] for each image[130] of an individual[370], where “local” refers to a bounded window of time[675] that in most embodiments is contextually[750] determined. This is discussed later in this section.

Even objectively very good-looking people have poor photographs[130] taken of them. Common reasons for this include, but are not limited to: closed eyes at a given moment, mouth wide open similarly, shadows, poor lighting, unattractive momentary facial expression, a poor night's sleep, lousy mood, a cold, jetlag, and many more. With numerous reporters and photographers snapping large numbers of digital pictures at news events, there are many photographs[130] of varying objective goodness[1130] of public figures[370] from which media outlets[160] may choose. Thus there is quite a bit of opportunity to display bias[260] in the selection[210].

Note that many embodiments will ignore the issue of copyrights. This is for multiple practical reasons:
1. Social media is likely to ignore copyrights
2. Copyright information may not always be accessible to the system[180]
3. It is generally unknowable to the system[180] what copyright-sharing agreements are in place among media outlets[160]
4. If one media outlet[160] was able to take a picture[130] of a target entity[150] with a given attractiveness score[1130]—whether good or bad—it can reasonably be presumed that others also had the same opportunity. This is especially true when measured over the course of time.

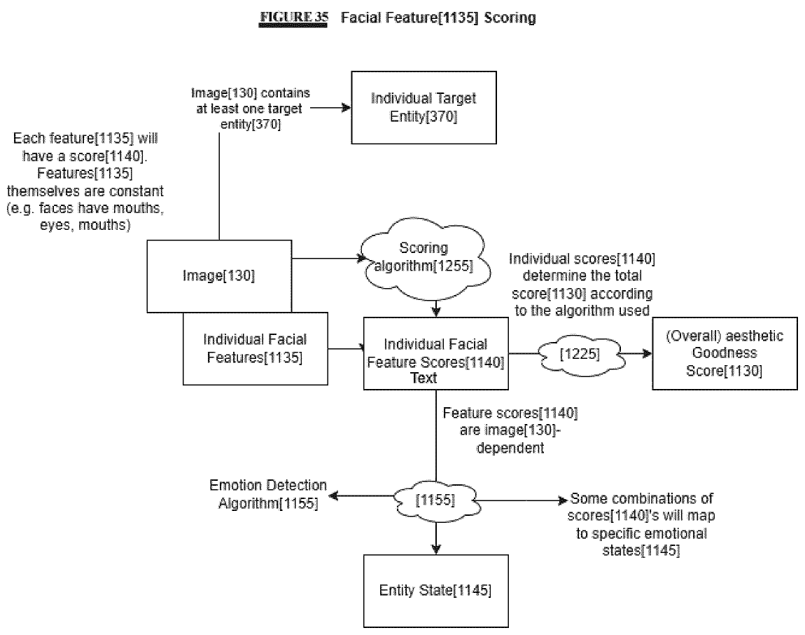

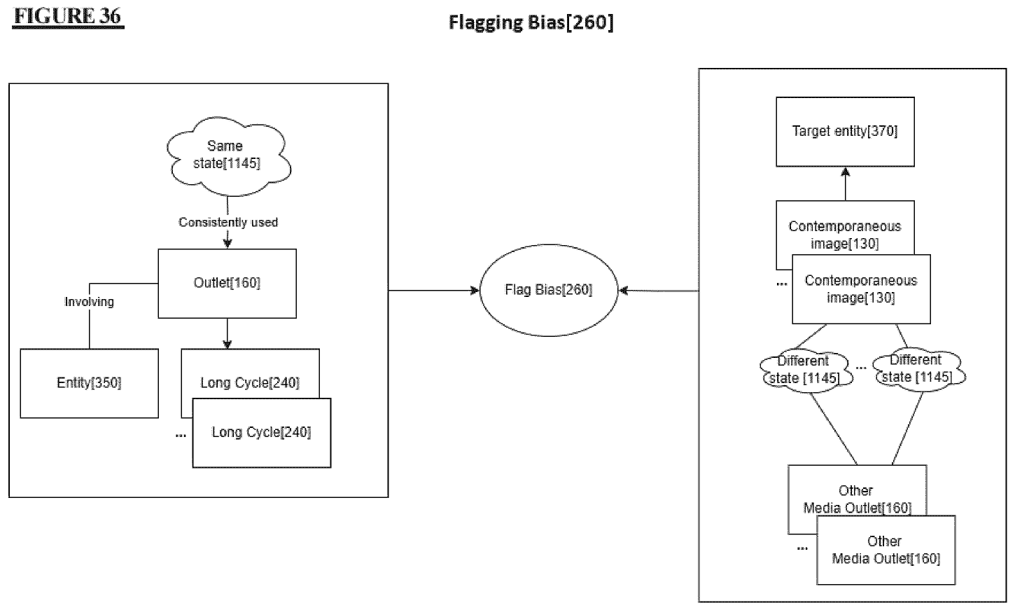

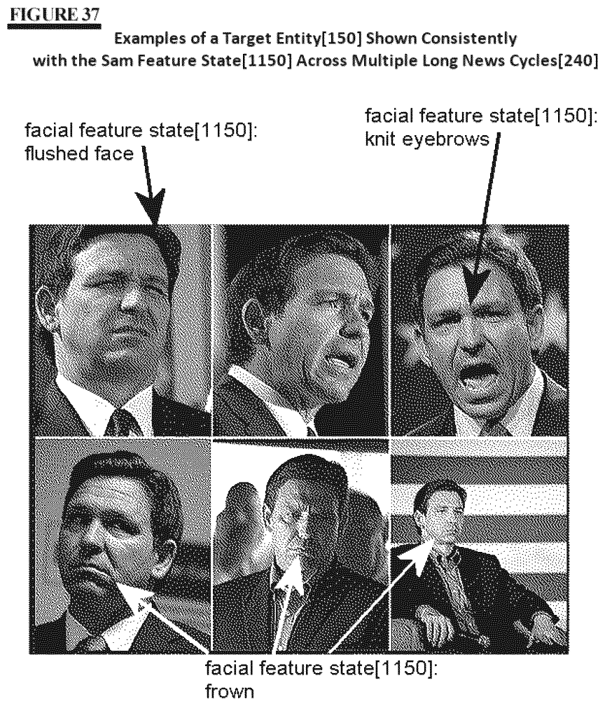

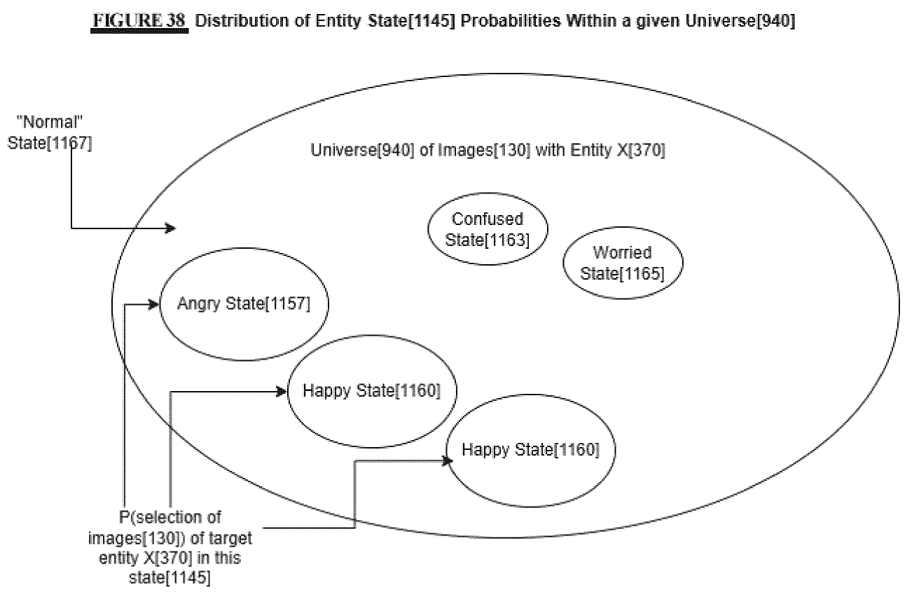

In a default embodiment, image-related markers[1100] include but are not limited to:
1. Aesthetic goodness[1130] of the face (and if relevant, in many embodiments, pictured parts of the body) of the target entity[150] if an individual[370] entity; if a group entity[380], of identifiable members of the group[380] in question. This is a polarity [630]—bearing marker[110]: consistent use of highly-scored images[130] of target entities[150] is considered as an editorial choice[210] to favorably portray the entity[150] in question. Conversely, consistent choices[210] of the worst scoring[1130] possible images[130] of a given entity[370] indicates disfavor.
While comparing different images[130] of the same target individual[370] to ascertain relative levels of aesthetic goodness[1130] is not at all difficult with existing approaches, determining exactly which images[130] to compare is trickier. This is principally because both the set of images[130] available and the set of images[130] actually selected by different media outlets[160] in any instance depend on the real-world context, not only the construct of context[730] documented above.
To see intuitively why this is so, consider that showing an image[130] of a well-loved public figure[370] smiling at a funeral would generally be inappropriate enough that it almost falls outside of the realm of possible editorial choices[210]. (Furthermore, such images[130] are not so likely to exist, which means that the attractiveness scores[1130] on those images[130] are less likely to have high attractiveness scores[1130]; most such algorithms prefer smiling to frowning expressions for example.) However, in certain situations, photographs[130] depicting serious expressions are to be expected.) In most situations though, selecting an image of a target entity[370] smiling is generally a way to indicate either/both that positive things are—or will be—happening for that person and/or tacit support for the individual in question.
In a default embodiment, as shown in FIG. 35 the set of all images[130] of the target entity[370] that appeared in the scoped outlets[220] within the context[730]—determined time window[675] will be aggregated for analysis. Some embodiments may choose to remove the limitation of using images[150] from only scoped media outlets [220] in certain circumstances, specifically when a news cycle[235] is detected in many different scoped sets of outlets[220]. Likewise, many embodiments will opt to expand the window[675] if the number of images[130] of the target entity[370] within the original window[675] is below a specified system[180] threshold going back to the limit of the specified lookback[960] period.
Most embodiments will choose to set minimum requirements to score an image[130]. These include but not limited to: at least one target entity[370] must be in focus in the image[130], require a lower limit for what percentage of the image[130] pixels[1315] at least one target entity [370] must occupy in the image[130] and an upper limit for how many more pixels[1315] any other person[370] consumes in the image[130], for it to be included in the universe[940] of valid images[130]. This is so as to eliminate images[130] in which the appearance of the target entity[370] is largely incidental.
Once the universe[940] of images[130] has been determined by scanning for stories[100] in the scoped media outlets[220] within the particular context[730], in most embodiments, each image[130] will be scored according to the one or more preferred aesthetic assessment algorithms[1255] of the given embodiment. Some embodiments will use a single vector score[270]. Other embodiments may choose to keep some, or all, individual measurements separate, resulting in an N-part score[1140].
These embodiments will often use the various individual feature scores[1140] to look for more specific types of bias[260]—for example, the entity[370] generally frowning. Still other embodiments will use the single vector score[1130] by default but also flag any cases in which there is a consistent pattern of portraying the target entity[150] as appearing in the same specific state[1145] over the course of time as opposed to simply aesthetically well or aesthetically poorly. Different embodiments will choose their own thresholds for what constitutes “consistent.” Different embodiments will likewise choose their own states[1145] to implement; these will most often be emotional or wellness-related states[1145]. Note that almost all embodiments will flag only anomalous, clearly indicated states[1145]. In other words, a “normal”-appearing state[1145] will not be flagged, and indeed is the default expectation.
As shown in FIG. 36, in order to flag bias[260], most embodiments will require either or both a) the same state[1145] to be consistently used by the outlet[160] across multiple long cycles[240] involving the entity[350] in question and/or b) evidence of contemporaneous images[130] of the target entity[370] in a different state[1145] in other media outlets[160] than the one in question. The latter is to eliminate false positives from long-running situations corresponding to news cycles[240] in which the person[370] in question very often is in fact in the portrayed state[1145] and/or a majority of outlets[160] will reasonably portray the particular entity[370] as being in a given state[1145] in the context of the particular news cycle[240]. Different embodiments may specify and define their own collection of states[1145].
For example, it could be the case that one or more media outlets[160] choose to consistently depict a particular target entity[150] as always appearing to be angry[1157]. An example of this using Florida Governor and former presidential candidate Ron DeSantis is illustrated in FIG. 37. This is widely known to coincide with certain facial feature states[1150] including, but not limited to: flushed face, frown, knit eyebrows, and bulging eyes. In addition to “angry,” [1157] a default embodiment will include but not be limited to the following states[1145] as shown in FIG. 38: happiness[1160], confusion[1163], worry[1165], and appearing tired or unwell[1170]. As of this writing, multiple companies exist such as Imentiv.ai and Noldus who sell emotion detection software based on facial images; use cases include retailers (consumer sentiment) interpreting court testimony and focus groups.
In a default embodiment, as shown in FIG. 25 the single vector score[1130] will have a value[270] of “no evidence” if the set of images[130] used in the given media outlet's[160] stories[100] in the context[730]—set time window[675] falls within a standard distribution of the norm. It will be “some evidence” if the score[1130] falls within the next distribution slice, and “strong evidence” if beyond that. Most content-related markers[1107] disclosed in this document will take similar approaches, as will all of the image-related ones[1100] in a default embodiment. Different embodiments can choose their own mechanisms in this regard. However, most of them will use a probabilistic measure of some kind.
In the user interface[820] of almost all embodiments, each specific facial feature[1135] that was identified as contributing to the attractiveness score[1130] will be displayed. This is because this is a score[1130] relative to other comparable images[130] of the same person[370], and even an objectively not so good picture[130] of a very good-looking person may still appear attractive. Likewise, even the best possible picture of an unattractive person may still appear to be an unattractive picture to many. Since it is important for users[800] to understand and believe the system's[180] output, many embodiments will display labeled facial features[1135] along with how they were scored and why.
For example, the facial feature[1135] of “wrinkles” may be much more apparent in one photo[130] than another, based upon lighting, even on the same day. For this reason, one photo[130] may be scored[1130] lower than another otherwise quite similar one. However, other features[1135] may distract from this fact—for example the pictured entity[370] smiling more; providing clear labeling and scoring[1130] of individual features[1135] can be expected to boost user[800] confidence in the system[180] accuracy.

### 2. Inappropriate Age Markers[1705]

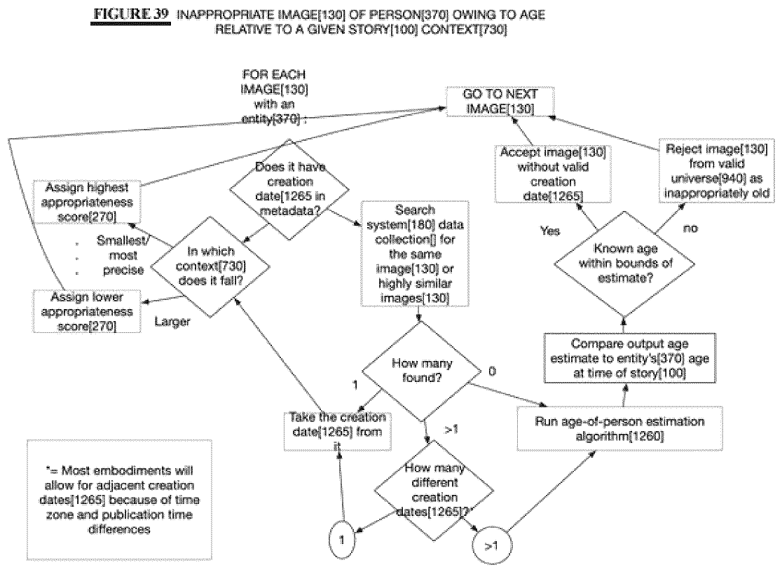

Different embodiments may choose to handle problem of determining when an image[130] of a target entity[150] is too out of date from an age perspective in different ways. Images[130] that are too old cannot reasonably be used in determining what a “good” image[130] of the target entity[150] is today. Furthermore, an editorial choice[210] of out-of-date-range image is unusual—and is suspicious in the event that the image[130] is either highly flattering[635]—or highly unflattering [637], or otherwise unusual in some way. As indicated in FIG. 39, acceptable approaches in this regard used by one embodiment include but are not limited to:
   For images[130] for which the original creation date[1265] can be known by any reliable means, most embodiments will employ a number of years lookback[960] threshold as specified in the system configuration[815]. For example, a lookback period[960] of 4 years would mean that any image[130] older that 4 years from the date[1265] that the story[100] containing the image[130] instance first appeared. Images[130] which exceed the lookback threshold[960] are not eligible for the universe [940] of (reasonably) current images[130] for the target entity[150]. “Reliable means” include, but are not limited to: image[130] metadata trusted third party system data and, first identifiable publication date[1265].
   For images[130] for which original creation date[1265] is unknown, estimation of the age of the image[130] can be performed. The system[180] can use any existing near duplicate image detection algorithm to search the data[1435]—or if desired, a broader data universe—for the initial occurrences of the exact image[130] or any image[130] too similar to it; the particular embodiment will determine its own similarity thresholds.
   Alternatively, existing age estimation technology can be used to estimate the probable age of the individual target entity[370] appearing in a given photograph[130] by analyzing different aspects of their facial features[1135]. Visage Technologies, for example, claims an accuracy of +/−4.5 years as of this writing.
   Any combination of these
Most embodiments will not treat this marker[1705] as being polarity[630]—bearing on its own. This is because the editorial choice[210] to reach back in time by itself is ambiguous with respect to polarity[630].
Many embodiments will have a separate marker[1100] or score[270] component for how young or old a given image[130] makes the target entity[150] appear. This is for two reasons. First, in cases in which an embodiment allows a really long lookback period[960], there can be a noticeable difference in aging in some cases even among the set[940] of valid images[130]. And even with a normal lookback period[960], there can still be meaningful differences. Anyone can be caught on a bad day, or be altered by illness.
Note that some embodiments will choose to use an age appearance appropriateness marker[1705] in addition to the general aesthetic marker[1700] because a photograph[130] can be a good photograph[130] in many respects such as facial expression[1150] despite, for example, wrinkles or bags under the eyes being readily visible. This is a polarity[630]—bearing marker[110]: consistent use of images[130] of a target entity[150] in which they appear noticeably older than they do in other contemporaneous images[130] is considered by most embodiments as an editorial choice[210] to unfavorably portray the entity[150] in question.
In a default embodiment, the score[270] produced by this marker[1705] will simply be one of: age-inappropriate, arguably acceptable, or correct. Some embodiments will use a Boolean score. The judgments will depend at least in part on the specified lookback[960] period in place.

### 3. Centrality[660] & Related (Salience) Markers[1320]

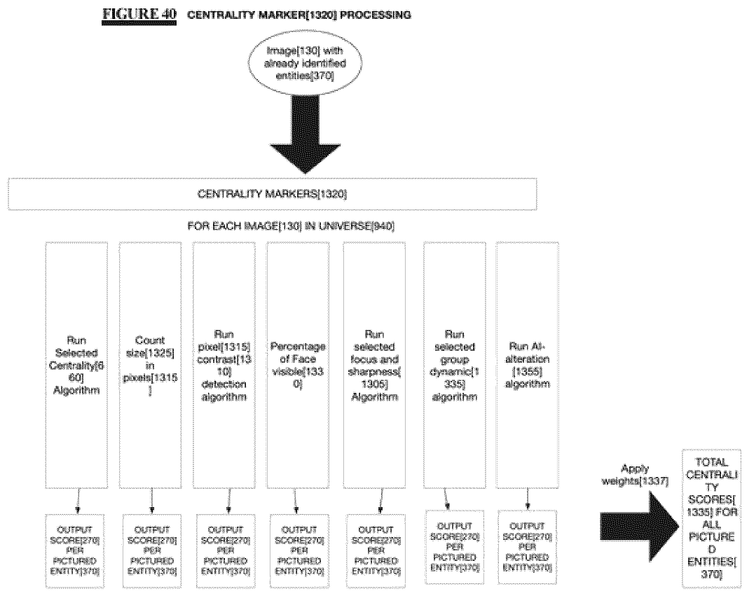

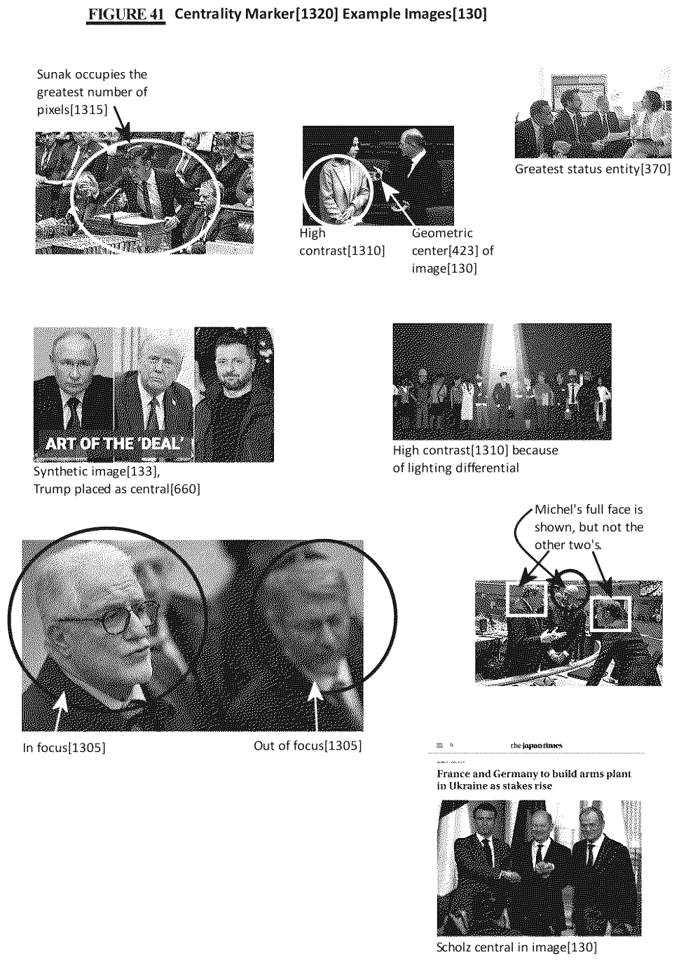

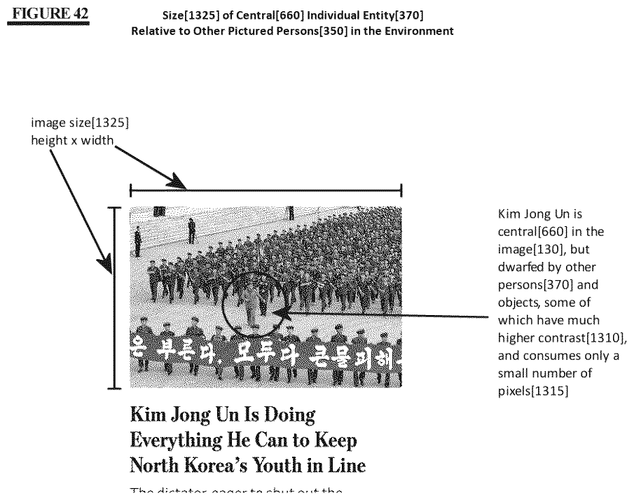

These markers[1320] attempt to asses who and what most of the audience will notice first (and possibly at all) in an image[130] or video frame[145]. This is commonly known as saliency detection. Each of these markers[1320] requires determining what other images[130] were available within the appropriate universe[940] from other outlets[160]. Some embodiments will combine at least some of the markers[1320] below into a single salience marker[1320]. In such embodiments, different weights[1337] will be applied to different markers[1320] under whatever rules specified by the particular embodiment. Many embodiments may opt to train classifiers. Whether or not the scores[270] are combined, these markers[1320] together combine to make some entities[370] seem to “pop” out of an image[130] while other entities[370] fade into the background.
As shown in FIG. 40, images[130] that have already been determined to contain a relevant entity[370] and which have already undergone filtering to ensure that the image[130] meets the system[180] minimum requirements including but not limited to for sharpness[1305] and size[1325] in pixels[1315] are submitted to the centrality marker[1320] processing pipeline[1680]. Each of the centrality markers[1320] implemented by the particular embodiment will be executed, in parallel if possible. In a default embodiment the set of these markers[1320] includes, but is not limited to, the following. Examples are indicated in FIG. 41.
As is indicated in the descriptions below, different embodiments may use somewhat different computations for these markers[1320]. However since most of the measurements are quite simple in nature, this should not result in any introduction of error. Once all values[270] have been computed for a given target entity[150], a total centrality score[1335] will be determined for it. Different embodiments may elect to apply different weights to the output[270] of each of these markers[1320], either empirically via an ML model[1180] or by applying weights via the user interface[820] or programmatically.
   Centrality[660] in the image[130], both absolute and relative to other pictured persons[350] and to large objects[1275] in the environment. The most important individuals[370] are most often placed at or near the exact geometric center of the image[130]. An image[130] in which no entity[370] occupies the pixels[1315] at dead center of the image[130] will be treated by most embodiments as no entity[370] having optimal centrality [660]. Similarly, in the event of an image[130] of person against a backdrop, their centrality[660] in the image[130] connotes either dominance or being, quite literally, in a corner. This is a simple-to-calculate yet highly useful metric.
   Any centrality[660] calculation may be used. In most cases, this will be done simply by calculating the centroid for each pictured entity[370] or other comparably sized object[1275] and determining its distance from the geometric center[423] of the image[130]. This is a polarity [630]—bearing marker[110] in most embodiments; greater centrality[660] is preferable.
   In a default embodiment, entities[350] present in the image[130] or video frame[145] will be scored by rank in the event that multiple entities[350] are pictured; some embodiments may place minimum requirements for what “pictured” means—see below. Ties will be acceptable in most embodiments. If only one entity[350] is so pictured, the score[270] will similarly be relative to pictured objects[1275] meeting the specified size[1325] criteria. If neither of these cases obtains, most embodiments will apply ranks based on the one entity's[350] centrality[660] score[270].
   Size[1325] relative to other persons and to environment. A similar logic applies to size as well. While of course people are the height and width that they are, their dimensions relative to others can be accentuated or diminished in any given image[130] in a number of ways. These include, but are not limited to: camera angle, relative distances of different entities[370] to the camera, some pictured entities[370] being on a podium or staircase, and some people[370] sitting while others are standing.
   Likewise, an image[130] that depicts a person[370] against a large backdrop can make that person[370] seem small and hence insignificant relative to objects[1275] in the background, or do the reverse. FIG. 42 provides an example of an image[130] of North Korean dictator Kim Jung Un in which he is visual central[660] yet hard to notice because of his surroundings in the image[130]. Most embodiments will simply count the number of pixels[1315] occupied by the pictured target entit(ies)[150] relative to each other (if more than one,) other individuals[350], and background objects[1275] of meaningful size[1325] whose bounds lie within the boundary of the image[130]. Most embodiments will simply define this minimum size[1325] as being at least the size of an average person.
   This is a polarity[630]—bearing marker[110] in most embodiments; greater size[1325] is favorable. In most embodiments, pictured entity[350] size[1325] proportional to the total image[130] size[1325] will be the score[270].
   Contrast[1310]: High contrasts[1310] in hue, saturation, or brightness among neighboring pixels will naturally draw the eye. There are numerous contrast detection algorithms to reliably detect such regions of high contrast in an image[130], any of which may be used. These regions of the image[130] must be then be associated with a particular individual[370] or object in the image; any existing technique can be used. Lighting discrepancies: In certain cases, lighting may play a key role in elevating some pictured individuals over others. The simplest example of this is a spotlight on a stage. This is just a special case of detecting contrast[1310] of neighboring pixels[1315]. This will not be treated as a polarity [630]—bearing marker[110] in most embodiments. This is because the choice of contrast[1310] is not always possible or intentional. Any existing pixel contrast detection algorithm[1341] or approach may be used.
   Here too, most embodiments will score[270] based on proportionality; the score[270] will be “NULL” if no meaningful contrast[1310]—related differences are detected, where high contrasts[1310] are detected, any pictured entity[350] whose pixels[1315] are impacted by them will be scored[270] proportionally relative to the max degree of contrast[1310] found in the image[130]/video frame[140].
   Percentage of Face Visible Marker[1330]: Especially in the case of persons[370] who are not well known to an audience, not showing all or most of their face greatly decreases the chances that they will be recognized. Thus, most embodiments will choose to assess this. Existing methods of facial recognition and bounding box estimation can be used for this purpose. This is a polarity[630]—bearing marker[110] in most embodiments; a greater percentage of the face being visible is favorable. The score[270] will be the percentage of the entity's[370] face that is visible.
   Focus Marker[1305]: Is a target entity[150] in sharp focus in the image[130] ? Not at all in focus? A person[370] not being in focus may suggest that they are being assigned a lower importance, especially if it occurs repeatedly. Existing sharpness and focus detection algorithms[1343] may be used. This is a polarity [630]—bearing marker[110] in most embodiments. Being in sharp focus[1305] is preferable. Sharpness value for the entity[350] will be the score[270]; some embodiments will also provide a rank, if multiple entities[370] are pictured.
   Power dynamic[1335]: This refers to the status or dominance hierarchy within a given group[1347] of people[370]. Setti et al 2013 amongst others show effective methods for the detection of groups[1347] in videos[140]. Many embodiments will choose to only use this marker[1335] when the pictured group[1347] corresponds to a group[460] under the system's[180] definition. In the event of multiple images[130] within a particular event[390] or video[140] that offers multiple views onto the same pictured hroup[1347], the stability of the dynamic[1335] will depend on the particular group[460]. In some cases, one individual [370] will always be dominant with respect to the group[460] in any group[1347] interaction—for example, military command or monarchical structures—while in others, dominance may shift back and forth depending on the topic of conversation among near-peer colleagues for example.
   Because in many cases, the dynamic[1335] of a group[460] can easily be changed based upon factors such as one person[370] leaving the group[1347], another arriving, someone being temporarily distracted, or the topic of discussion changing, which dynamic[1335] to select is an editorial choice[210] unless the group dynamic[1335] is fixed. In other words, the editorial choice[210] of images[130] or video clips[140] that contain a group[1347] of people[370] and which feature interaction among them (as opposed to, for example, people standing in a line waiting to be photographed) can be used to convey a particular power dynamic[1335] within the given group[460] that may or may not generally exist.
   Computational approaches such as Personrank (https://arxiv.org/abs/1711.01984) for images [130] already exist to identify probable group[1335] interactions and status hierarchies in pictures of groups of people[370].
   In a default embodiment, the marker[1320] will have a value[270] of NULL if the power dynamic[1335] appears to be stable for the group[1347] of entities[370] pictured. That is because in this event there is no real editorial choice[210].
   Some embodiments will define the group[1347] more loosely than others. This is for the very practical reason that in a video clip[140] of people [370] at a party, for example, the composition of any group[1347] is not likely to remain fixed: participants will come and go. Thus, too rigid a definition would yield little of value in most cases. This is a polarity[630]—bearing marker[110] in most embodiments. Being ranked as having higher status within a group[1347] is unsurprisingly preferable to having average or lower status; the greater the number of distinct groups[1347] a particular entity has high status in, the better. In a default embodiment, the score[270] will simply be the outputted rank in the event that only one ranking of the group[1347] is presented within a given story[100] (including its embedded components[190].) In the event that there are different ranks, for example in the case of a video[140] of the group[1347] that allows for more observation, certainty factors will be applied by many embodiments.

### Inclusion in Group Marker[1730]

Of course, worse than barely being pictured is just not being pictured frequently, or at all, with high status groups[463]. For this marker[1730], almost all embodiments will require that at least two persons[350] are pictured/recorded. Many embodiments will require that an entity[350] be mentioned in the story[100] text[120] to consider that he/she/it could reasonably be present in embedded components[190]. This is also necessary so as to avoid double counting between the analogous text marker[1110] for group inclusion[1770] and this marker[1730]. Of those entities who appear in the story[100] text[120], the following possibilities exist for many embodiments:
a) Someone[370] is clearly pictured and is listed in the caption[135] (if there is a caption[135],) or likewise in a description of the embedded object[190] or elsewhere in the story[100].
b) Same, but entity[370] does not appear in caption[135] or similar description that is present
c) Entity[370] is discernible in the image[130] or video[140] component, but scores below a threshold total centrality score[1335] or size[1325], depending on the embodiment. (Sometimes in a real-world setting, people are inadvertently captured in an image[130] or vide[140] simply because of where they happened to be standing or seated at the time.)

Case a) is unambiguous; different embodiments may make different choices on whether case b) counts as inclusion. Cases a) and b) are the same in the event that there is no accompanying text[120] description of any kind. Most embodiments will not consider case c) inclusion as the “inclusion” may well have been incidental. (Note that some embodiments may decide in case c)—or even b)—by similar reasoning that a mention[310] of the entity[350] in question should not be created.)

Once it has been determined which entities[370] will be considered included in the image[130]/video[140], these entities[370] will be placed into a processing list[1210] to be handled as a potential group[460] in text[120] would be.

Some embodiments will use named entity[370] mentions[310] appearing in captions[135] to help disambiguate entities[370] in the image[130]. However, most of these embodiments will require either that the mention[310] appear inside a list[490] within the caption[135] and/or that the mention[310] is the subject in a phrase[915] or sentence[910] likewise. This is to prevent many types of false positives that would arise from a mention[310] being related to a real-world event[340].

Some embodiments will select purely statistical approaches to identifying groups[460], including the use of non-parametric statistics such as relative ranking ones. Of these, many will calculate separate probabilities given the number of members[455] of the group[460] who are mentioned[310] in any given instance. For example, a 95% chance of having a mention[310] when N>=3 members[455] of a group[460] are mentioned[310], but only a 45% one if N=2 is quite different than having a negligible chance of appearing until N>5.

In some cases, abstract group pictures[133] or montages[133] are created so as to make a desired editorial point. For example, in the aftermath of Hungarian President Viktor Orban's agreeing to unblock ˜$50B in aid to Ukraine, composite pictures[133] of the EU leaders who were presumed to have successfully strong-armed Orban were circulated online. Such images[133] can easily be identified by ML means as at least partially synthetic in nature due to the copy/paste nature of the image[133]. However, in such cases, the choice[210] of which individual[370] is more central[660] takes on that much more significance because obviously the placement of the individuals [370] was entirely chosen, rather than limited by a finite set of real-world pictures[130] of the N individuals in question at some event[390] together. For this reason, most embodiments will give more weight to both the inclusion and centrality[660] markers in synthetic images[133]. Especially if the group[460] in question is a high status group[463], most embodiments will treat this as a polarity[630]—bearing marker[110].

In most embodiments, evidence of a group[460] and membership[465] in it will be merged across formats[200].

The outputted scores[270] in most embodiments will be rank of the entity[350] within the group[460] as determined by the ranking algorithm implemented by the given embodiment, if the entity[350] is in the given group[460], “NULL” if not.

### Application of AI or Other Alteration of Image Marker[1750]

The use of Al to improve, “touch up,” or otherwise alter images of persons [370] is becoming more common. In many cases, such alterations are also detectable with common Al methods. Known methods for doing so include, but are not limited to: automated feature comparison to unaltered images[130] of the same person in the same universe[940] of images[130], by the lack of even small irregularities that would naturally exist in such an image, for example minor variations in skin tone, lack of wrinkles, lack of any eye redness, or fly away hair and discontinuities or inconsistencies in shadows and lighting and/or the environment. As such alterations become ever more commonplace, it will become easier and easier to train classifiers, especially to detect unusually perfect facial and related features[1135]. While the use of Al to improve the appearance of a target entity[150] is more likely than the use of it to make someone look worse than they actually do, both are possible.

Most embodiments choosing to implement this marker[1750] will assume that the use of such AI-altered images[130]—or videos[140] or audio[290] clips—is an editorial choice[210] and so will evaluate the use of such an altered image[130] as an additive marker[1100] to the aesthetic goodness one[1130]. In other words, (for example,) not only was the editorial choice[210] to use the best possible naturally occurring image[130] but also to further polish it (or at least, to select an artificially improved one.)

Some embodiments will treat any kind of image[130] alteration in the same manner, regardless of whether or not it was deemed to be AI-related. Note however that image[130] clipping and filters that have been applied to the whole image[130] will not be considered as alterations by most embodiments. This is because the marker[1100] is targeting attempts specifically to make a particular entity[370] appear credibly subtly differently than they do in real life. For example, the application of a purple filter to a photo[130] may or may not make the pictured person appear more attractive. But it will not lead anyone to think that the person has purple skin. For this reason, most embodiments will not treat this as a polarity[630]—bearing marker[110]. Most embodiments will provide a coarse-grained score[270] of “no evidence” of alteration, “possible” alteration, and “high evidence” based on the outputted probability of alteration determined by the alteration detection algorithm.

### Text-Related Markers[1110]

These are markers[1110] that analyze text[120], including speech-to-text data. In most embodiments, these markers[1110] will be designed to be as simple as possible, with the aims of preserving system[180] objectivity, performance, and overall accuracy. It should be noted that many of these markers[1110] intentionally require only a moderate level of syntactic dependency analysis and shallow semantic parsing.

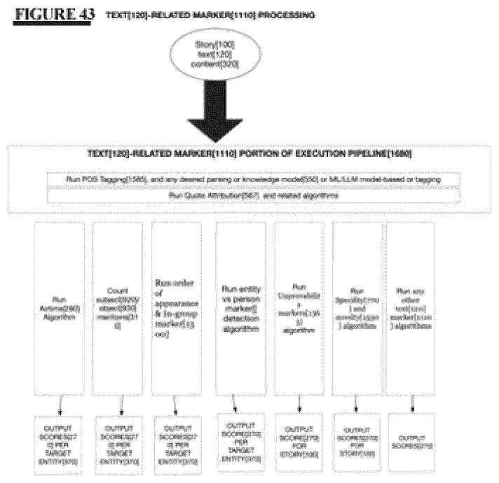

As pictured in FIG. 43, textual[120] content[320] for a story[100] is first processed with POS tagging[1585] and other NLU processing elected by the given embodiment. Next, the quote attribution[567] algorithm selected by the given embodiment must be run. This will reduce some of the actual marker[1110] calculations to be not much more than arithmetic.

### Airtime Markers[1760]

Airtime[280] is the concept of how much a target person[370] or group entity[380] is given the opportunity to directly speak in media outlet[160] coverage. Forms of airtime[280] include but are not limited to: showing video[140] or audio[290] clips of the person[370] speaking, using direct, attributed quotes[565] in any media format[200], and providing live coverage of comments[395]. By quantifying the balance between direct expression[280] and mediated interpretation[285], the airtime markers[1670] contribute to a comprehensive assessment of an individuals'[370] agency and presence in public discourse.

It should be noted that analysis of a person's[370] actions or thoughts often occurs for public figures [370] with little or no direct reference to their actual words—in other words, interpretation[285] untethered from a key aspect of reality. This can easily degenerate into a form of censorship. Most embodiments will treat airtime markers[1670] as being polarity[630]—bearing; more airtime[280] is good, less airtime[280] is bad.

Group entities'[380] airtime[280] in most embodiments is simply the sum of the airtime[280] of its members[465]. Thus, when a group[460] member[465] receives airtime[280] so too does the group entity[380]. However some embodiments may prefer to require a title, role, or at least direct reference[1620] to the group entity[380] for the airtime[280] to be attributed to the group entity[380].

Most embodiments will consider airtime[280] measurement from multiple perspectives. Almost all embodiments will employ both absolute[1205] and relative[1207] measures. Relative measures[1207] will include both other entities[350] in the same equivalence class[450], groups[460], and other people talking about the entity[285]. Almost all embodiments will choose to analyze airtime[280] according to a range of comparison sets[470], starting with the individual story[100] level, and potentially going as high as the set[1020] of all media outlets[160] for which the system[180] has data[1435] available.

Since in most embodiments, absolute airtime[1205] is simply a single value[270], aggregating the scoreI[270] in larger containers (e.g. media outlet[160] to set of scoped media outlets[220] is just a matter of doing the sums of the individual components. Relative airtime[1207] will likewise be a single value[270] per comparator in most embodiments, however different embodiments may take somewhat different approaches. A default embodiment will simply take the aggregate ratio for pairwise comparisons between entities[350], or between a single entity[350] and the average of a group[460] or equivalence class[450].

In a default embodiment, airtime[280] measures will include but are not limited to:
The absolute amount of airtime[1205] a given entity[350] receives from scoped media outlets[220] within a given time window[670]
The relative amount of airtime[1207] any entity[350] in the same group[460] or equivalence class[450] receives from a particular media outlet[160]. (This is important because how much airtime[280] is normal for someone being interviewed can vary tremendously based upon both the media format[200] and the media outlet[160]. For example, some notable podcasts conduct interviews that are two hours in length, while traditional TV interviews are typically only a few minutes long.)
The amount relative to other similarly situated entities[350] (e.g. presidents of countries meeting some criteria)—those in the same equivalence class[450]—from scoped media outlets[220] within a given time window[670]
The amount relative to how different entities[350] are treated within the same story[100] from scoped media outlets[220] within a given time window[670]
The amount relative to all other named entities [350] detected, not only those in the same equivalence class[450] from scoped media outlets[220] within a given time window[670]
The proportion of third party discussion[285] about the target entity[150] to airtime[280] from scoped media outlets[220] within a given time window[670], specifically in quotes about the entity[350] rather than from the entity[350]. Note that many embodiments may, for assessing this particular measurement, decided to count some or even all types of unnamed attribution[1785] as being interpretation[285]. Examples of such unnamed attribution[1785] that may be counted by different embodiments include but are certainly not limited to: “confidential sources,” “someone with knowledge of the matter”, “someone close to”, “government sources”, “experts” and many more.

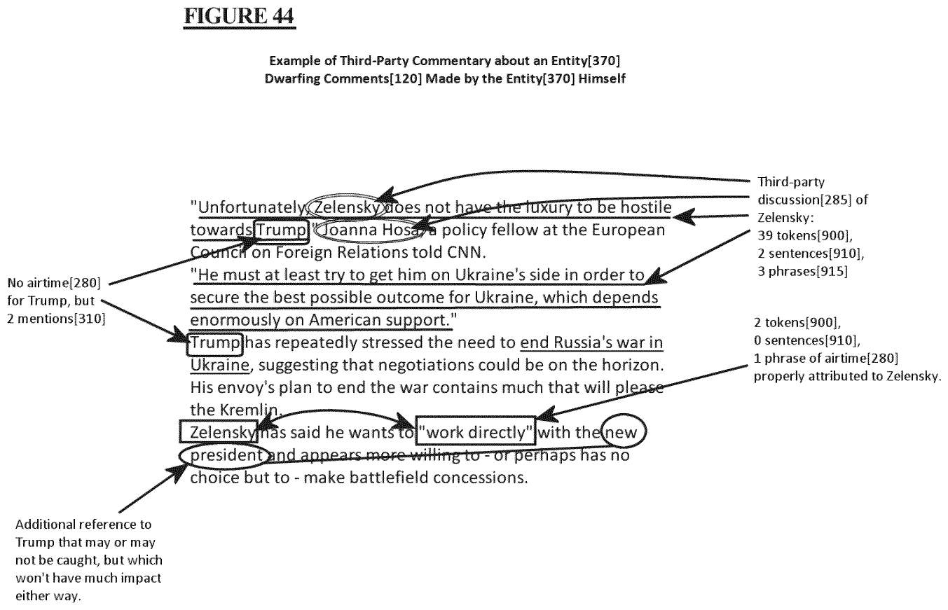

As shown in FIG. 44, third party commentary, often from generally unknown analysts, dwarfs the comments[120] made by the actual “agent.”

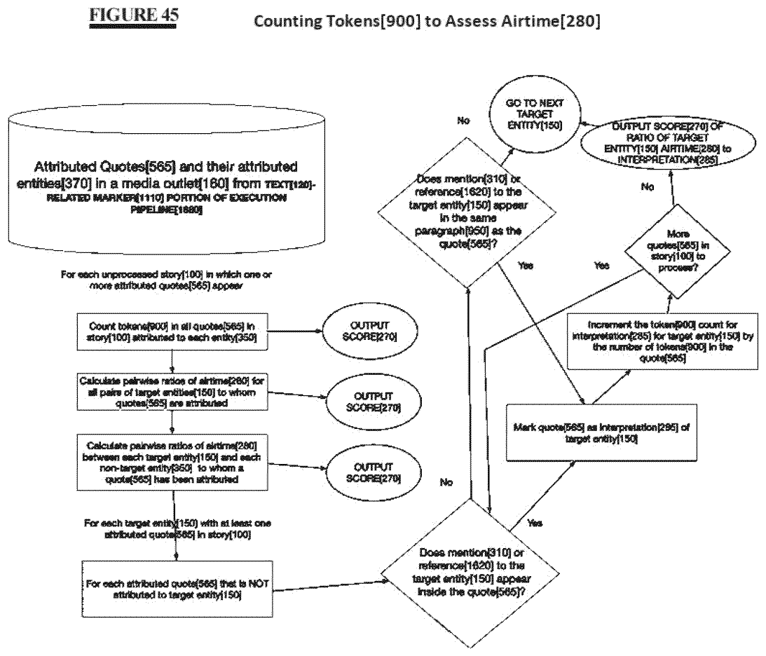

FIG. 45 shows how a simple token[900]—counting embodiment assesses the airtime[280] measure of proportion of third party interpretation[285] of an entity[150] to direct airtime[280] of its own. It uses a brute force method of proximity in determining “about the entity[150]” when there is no mention[310] of or reference[1620] to the entity[150] within the quote[565] itself. Other embodiments can make other choices, at greater computational cost.

Many embodiments will require either or both a minimum threshold in the number of tokens[900] and/or a minimum number of tokens[900] (or other measure they are using) relative to the number of tokens[900] that were reasonably to have been expected in order to consider an attributed quote[565] to be a valid instance of airtime[280]. Different embodiments may interpret “reasonably to have been expected” in different ways.

These include, but are not limited to: providing a fixed minimum number of sequential tokens[900] or n-gram via a system parameter[815], to expanding to count all tokens[900] within the same sentence[910] as the quote[560] fragment (assuming that the full sentence[910] can be found in a different story[100],) and the number of tokens[900] in the most frequently occurring excerpt[570] that includes the quote[560] fragment. The motivation for this is very straightforward: to not count instances of two or three words taken out of context as a valid case of allowing an entity[370] to directly express him or herself. Some embodiments may consider the consistent provision of what they define as inadequate airtime[280] to specific target entities[150] as itself being evidence of bias[260], and will implement a marker[1110] or score[270] component for this purpose.

In most embodiments, the time windows[675] will correspond by default to specific news cycle lifetimes[740] unless specified by the user[800]. In most embodiments, news cycle lifetimes[740] for long cycles[240] are defined as starting when the system[180] first creates the cycle[240] object by aggregating short cycles[230] into it, or when it is explicitly created and defined by a user[800] who wants a very bespoke category tag for stories[100]. In most embodiments, the lifetime[740] of a long cycle[240] ends when no new short cycles[230] have been added to it for a config[815]—defined period of time.

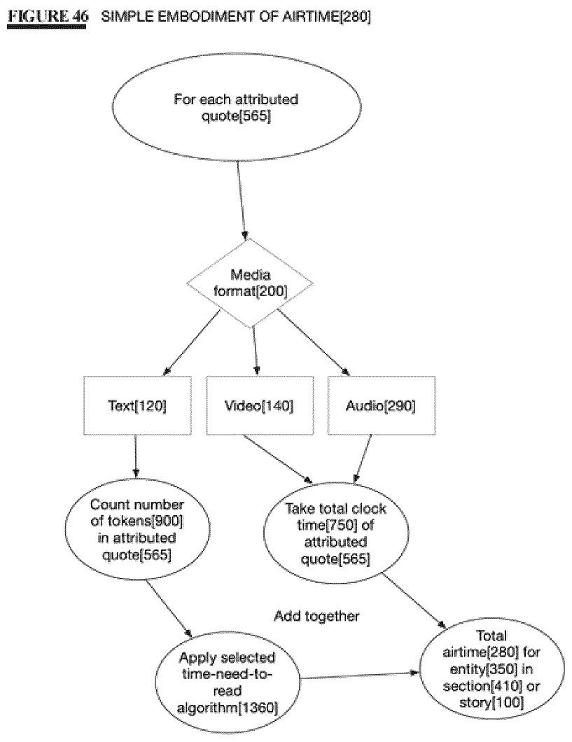

Embodiments will differ in how exactly they choose to measure the amount of airtime[280]. However, as shown in FIG. 46, many embodiments will choose very simple measures, such as counting words[900] in text[120] content[320] and taking the length[750] of an audio[290] or video[140] clip. Then the word[900] count is converted to reading time with a reading time conversion algorithm[1360]. This is both for purposes of clarity, and because the exact airtime[280] is somewhat reader-dependent anyway; consider that an audio[290] or video[140] clip can be replayed if the listener or watcher wants to be sure that they understood something correctly.

Some embodiments may choose to take more complex approaches to the determination of airtime[280] Such embodiments will typically use, or combine, a number of different measures of the amount of airtime[280]. These include, but are not limited to:
Token[900] count: the total number of words [900] that had been directly spoken by the person[370] that appear in the scoped media outlets[220]
The specificity [770] (as defined in U.S. Pat. No. 9,569,729B1) or any other existing method of assessing the degree of specificity [770] of the quote[560]
The informational value (as in U.S. Pat. No. 9,569,729B1) or semantic novelty[780], such as in Ghosal, Saikh 2021 et al inter alia, of the quoted content[560]. Informational value[780] is an important construct because a direct statement[510] which expresses disagreement and/or conveys novel and unexpected semantic content is higher value and more memorable than one that expresses expected agreement with a prevailing view. For example, someone expressing that cold fusion had been successfully achieved would be very newsworthy, just as would be an assertion[500] about a counterintuitive health benefit to eating some “unhealthy” food. (Note that any such novel assertion[500] that receives significant numbers of mentions[310] across different media outlets[160] can reasonably be considered worthy of comment, whether or not it ends up being generally considered as ground truth.)
This impacts airtime[280] insofar as the audience is likelier to wish to read or hear the unexpected statement[510] more than once, hence increasing the airtime[280]. Therefore some embodiments may choose to apply an informational value[780] or other text novelty[1530] coefficient to other measurements so as to increase the assessed value of airtime[280]. However, others will not, because of the need to do more extensive NLU processing including proper handling of negations.
Any preferred measure of semantic complexity[790]
Any preferred measure of syntactic complexity[795]
The literal amount of clock time[750] that the utterances[760] took, (in video[140] and audio formats[290].)
The estimated amount of time that it will take someone to read the text[120] of the quote[560]. Numerous reading time algorithms[1360] exist that may be used for this purpose. (However, there will nonetheless always still be variance by individual reader.)

Combining different measures are useful for embodiments preferring to eschew simple measurements because not all words[900] or sentences[910] are of equal value, equal complexity, or equal novelty[1530]; more complex statements[510] generally require more time for the reader to read. Thus, in a sense, more complex statements[510] yield more airtime[280] than the same number of words in simpler linguistic structures.

Airtime[280] markers[1760] in most embodiments will output an array of absolute[1205] and relative[1207] scores[270]. Most embodiments will output the literal absolute[1205] airtime scores[270]. For relative[1207] scores, most embodiments will use ratios.

### Quote[560] Attribution[567] & the Universe[940] of Attributed Quotes[565]

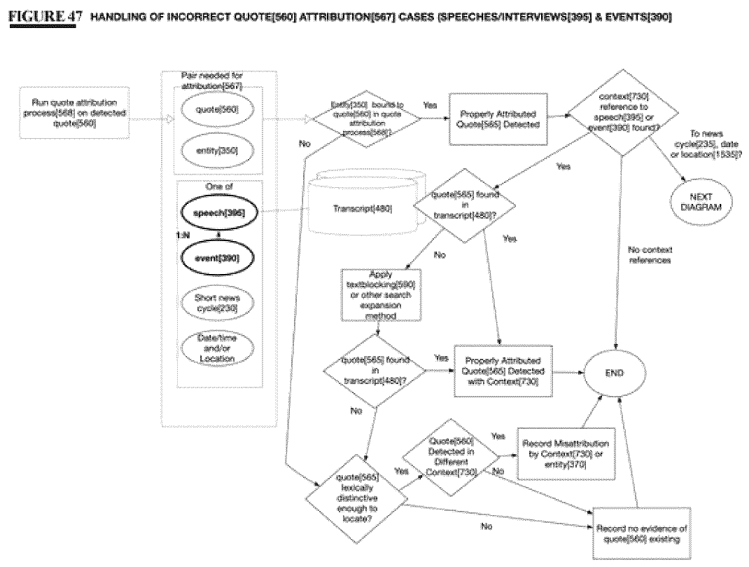

In some instances, the individual[370] in question may have said little or nothing in relation to a given news cycle[235], and hence cannot be directly quoted, at least recently. For this reason, most embodiments will seek direct quotes[560] from the given target entities[150] from scoped media outlets[220] from the same event[390], or failing that, the same short news cycle[230]—and failing that, a long news cycle[240]. In this last event, most embodiments will set an upper lookback period[960] bound, to differentiate between a reasonably contemporaneous quote[580] and an arguably outdated one. While it may often be appropriate to reach back in time for a quote[560], for example from a similar situation in the past—a different short news cycle[230] with the same long cycle[240] parent—such quotes[585] should not be confounded with current ones, nor replace more up to date ones. Some embodiments may choose to exclude quotes[565] that are not considered a contemporaneous quote[580]. This is illustrated in FIG. 47.

Properly attributing quotes[565] that appear in any form of text[120] is a more difficult technical problem than it might at first seem. Real world reasons for this include, but are not limited to: missing start and/or end quotation marks, non-standard punctuation used when a quote[560] is divided into multiple parts, sometimes with quite a few tokens[900] in between the Nth and N+1th quote[560] segment, use of different forms of ellipsis, and the need to resolve pronoun references. The first of these is not uncommon as this example from Al Jazeera demonstrates: Greenlanders do not want to be American or Danish, the Arctic island's prime minister has said, after US President-elect Donald Trump refused to rule out using military force to acquire the territory.

And this related one from CBS News:
Greenland leader says his people don't want to be Americans amid Trump interest: “We want to be Greenlandic”

As is often the case, the somewhat inconsistent use of quote marks appears to be related to a desire to emphasize some quote[560] excerpt[570] over others. This is why many embodiments will choose to look for quote[565] fragments[570] outside of quote marks, at least under certain conditions specified in the system configuration[815], for example that the quote[565] has been attributed to a target entity[150] and not just any entity[350]. Most embodiments will use textblocking[590] or an alternate method of their choosing so as to not miss minor variations including but not limited to the use of contractions, typos, and insertion of tokens[900] in between quote[560] fragments[570].

Most embodiments will leverage the fact that the universe[940] of quotes[560] is bounded by the context[730] of the associated news cycle[235]. It is further bounded by requiring at least one occurrence of the target entity[150] within the story[100], the same section[410] as the quote[560], or the same paragraph[950] (if different from the section[410]) depending on the exact embodiment.

The use of the news cycle context[730] offers an improvement from the general case of quote[565] attribution in text[120] content[320] that was presented in Muzny, Fang et al 2017. Indeed, their method for quote[565] attribution[568] can be readily extended to incorporate the extra structure, as some embodiments will opt to do.

Since properly attributed quotes [560] from the past should be accompanied by at least the year in which they were said, it is a trivial parsing problem to identify the presence of some part of a date[1540]. In such cases, most embodiments will consider quotes[560] to be in the valid universe[940] for the news cycle[235]. However, because not all such old quotes[585] will be properly attributed, some embodiments will choose to also search for the first instance of the quote[560], attributed to the given target entity[150] in an attempt to verify its date of origin. Almost all embodiments will use a more sophisticated method than fixed string search. This is because of things like the use of ellipsis, partial quoting, and various types of transmission errors. A preferred embodiment will use textblocking[590] for this purpose, but a number of other approaches can be used including combining near-duplicate analysis and named entity recognition (NER[155]). For quote[565] attribution[567] from video[140], some embodiments may choose to avail themselves of the additional attribution[567] evidence of facial and voice identification of target entities[150].

Almost all embodiments will require direct quotes[560], rather than references to them, or summarizations of them. For example “Macron has indicated that he will do [X]” is unspecific enough that it could potentially be pure interpretation.

### Subject[920] Vs Object[930] Marker[1765]

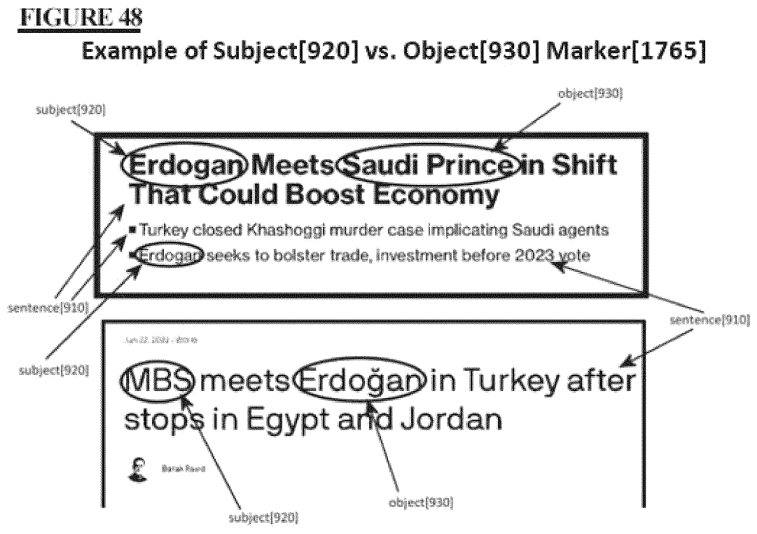

Whether a given target entity[150] is generally the subject[920], or the object[930], in a sentence[910] has significance, especially when it occurs with consistency either altogether, or with respect to particular entities[350] when they co-appear in the same sentence[910]. While contextual factors may dictate a preference for object-oriented structures over subject-oriented ones in certain scenarios, often the choice is very flexible and so just a matter of editorial choice[210]. For instance, consider the following two headlines[970] illustrated in FIG. 48 “Erdogan Meets Saudi Prince in Shift That Could Boost Economy,” and “MBS meets Erdogan in Turkey after stops in Egypt and Jordan.”

In the former example, Erdogan is the subject[920], or the doer, and in the latter, it is Saudi Crown Prince MBS. In the former instance, Erdogan assumes the role of the subject, or the initiator, whereas in the latter, it is MBS. While the same real-world meeting is being referenced in both headlines[970], the emphasis is quite different.

In some news cycles[235], a target entity[150] will rarely be seen as the subject[920]. This indicates that the person[370] is either seen as having little agency or power—or being portrayed as such. That said, in the vast majority of cases, the same target entity[150] will at times naturally be the subject[920], and at times the object[930] simply depending on the immediate context. Thus this is a marker[110] that exists mostly to capture some interesting edge case situations. These edge cases are likeliest to arise from bias[260] in the case of individual media outlets[160], or in the context of particular news cycles[235]. An excellent example of the latter case occurred when Yevgeny Prigozhin launched a surprise and initially successful mutiny against Vladimir Putin. Until the revolt was quelled, in sentences[910] containing mentions[310] of both men, Prigozhin was the subject[920] and Putin the object[930] a very high percentage of the time.

Thus most embodiments will calculate this marker[1765] in ways that include but are not limited to the following:
Determining the probability that Entity[350] A will appear as a subject[920] (vs object) in a given media outlet[160]
Determining the probability that Entity[350] A will appear as a subject[920] (vs object) in a set of scoped media outlets[220]
Determining the probability that Entity[350] A will appear as a subject[920] (vs object) in a given news cycle[235]
Determining the probability that Entity[350] A will appear as a subject[920] (vs object) when appearing in the same sentence[910] with Entity[350] B, where A and B have been determined to be in the same equivalence class[450] and/or frequently co-occur in the same group[460] or lists[490].
Determining the probability that Entity[350] A will appear as a subject[920] (vs object[930]) when appearing in the same sentence[910] with any other member[455] of the same equivalence class[450] or member[465] of the same group[460].

It should be noted that a particular news cycle[235] can potentially influence the value[270] of this marker[1765] for given entity[350]. This is owing to the fact that the real world context of the real world event[340] may naturally cause an entity[350] to more often appear as the subject[920] than as an object[930.] Thus most embodiments will remove the values[270] of this marker[1765] from any statistical outlier news cycles[235] in this regard for assessing the overall marker value[270] for a given target entity[150] and a given media outlet[160].

A key exception to this is the case in which multiple unrelated news cycles[235] are anomalous with respect to the score[270] with this marker[1765] in one or more media outlets [160], as this would suggest a spike in bias[260]. A good real-world example of this occurred in response to political statements by Elon Musk. A slew of headlines predicted a variety of unpleasant things that would happen to Musk, thus making him the (indirect) object[930] rather than the subject[920] with unusual frequency for him. Examples included headlines such as “Markets will punish Musk's stock” and “Federal government likely to investigate Musk for . . . ” A sustained tendency to favor one entity[350] as the subject[920] relative to certain others[350], if present, will span different news cycles[235] and so will be treated differently than the individual news cycle[235] by most embodiments.

Most embodiments will use existing natural language processing frameworks to parse textual content including but not limited to the use of dependency parsing, POS taggers[1585], shallow semantic parsing, tokenizers, and named entity extraction (NER)[155]. But any reliable method for performing the tagging can be selected by a given embodiment. Most embodiments will treat this as a polarity[630]—bearing marker[110]. This is consistent with Chandar, Chong, Yap et al who show that adding subject[920]/object[930] increased the accuracy of sentiment analysis by 7% when used.

The outputted scores[270] in most embodiments will simply be the calculatable probabilities mentioned above, or “NULL” if insufficient data[1435] to calculate.

### Order of Appearance & In-Group Marker[1770]

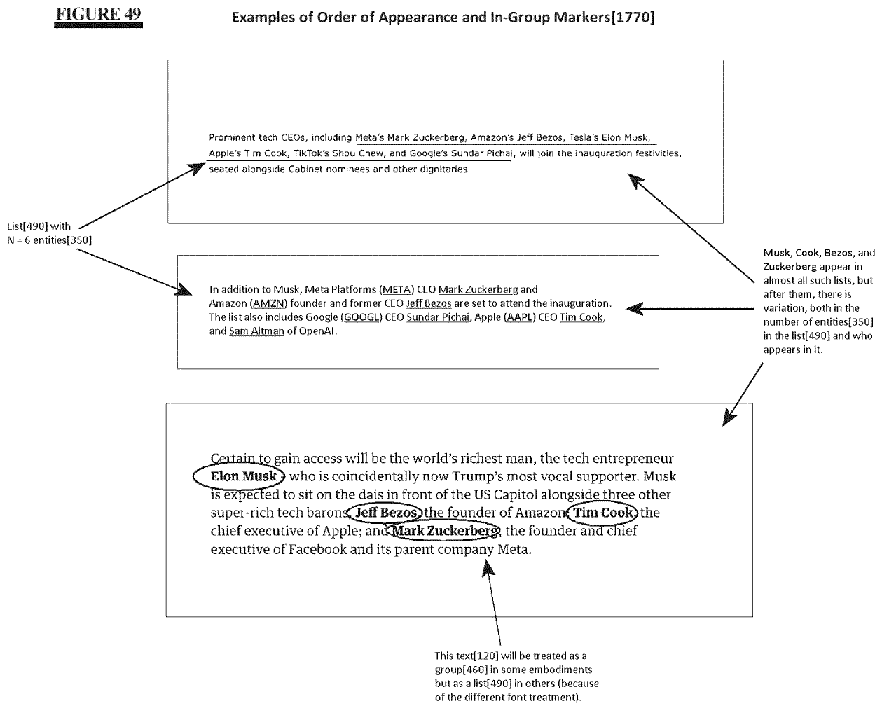

In a similar vein, there are many contexts in which lists[490] of target entities[150] and other entities[350] naturally appear in a story[100]. Being first in a list[490] is always best; in longer lists1[490], being dead last may be preferable to appearing in the middle owing to the serial position effect and some embodiments may decide to score accordingly. Some common examples of such lists[490] include but are not limited to: senators casting yes or no votes, attendees at high profile events (some examples of which are pictured in FIG. 49), sponsors of laws, and lists of the most important or greatest individuals in a given category.

Most embodiments will define a list[490] as requiring only two or more named entities[350]. Different embodiments may choose their own logic for separators. For example, some embodiments will choose any combination of commas, “and” and “or”—or their equivalent in different languages. Some embodiments will treat a series of bulletized text[120] where each entry begins with an entity[350] as logically being a list[490]. Likewise, some embodiments may treat cases in which entity[350] mentions[310] are bolded or otherwise have different font treatment from surrounding text[120] as indicating a list[490]. Other embodiments may elect somewhat different choices.

The choice of N=2 is because if, for example, whenever “Batman” and “Robin” appear in the same list, “Batman” always comes first, it usually indicates that “Batman” is more important or powerful than “Robin.” Similarly, if in lists of popular comic book heroes “Aquaman” always occurs after “Batman” and “Superman” do it suggests that, it suggests that “Aquaman” is less significant than the other two.

Most embodiments will treat this as a polarity[630]—bearing marker according to the configured[815] rules. For example, some embodiments may require that N exceeds a number larger than 2.

It should be noted that this marker[1770] is distinct from the placement markers[300] that involve the placement[300] of mentions[310] of different entities[350]. This is because its scope is more narrow: simply the entities [350] and their order in the list[490], or the relative order of mentions[310] within each section[410] of a story[100]. In this sense, a list[490] is almost an embedded component[190].

Likewise, most embodiments will treat lists[490] that are captions[135] for entities[350] which appear in an image[130] as being handled by the analogous image marker[1730] which is documented in another section of this document. However, if there are mentions[310] of entitiesl[350] in an image[130] caption[135] that do not appear in a list[490], some embodiments will treat the caption[135] as any other text[120], using the placement[300] of the image[130]. Other embodiments may choose to do otherwise, and include any text marker[1110] analysis of the caption[135] in the analysis of the image[130].

The in-group marker[1770] for text[120] is analogous to the image inclusion marker[1730]; not being included in the list[490] consistently, often—or at all—is even worse than having a low position in it. A mention[310] of an entity[350] not appearing in a mention[310] of a group[460] is treated as a “NULL” position in most embodiments. Most embodiments will assess group[460] inclusion relative to other scoped media outlets[220]. Each time that an entity[350] appears in a list[490] with other entities[350] it will be logged as a possible member[465] of that group[460]; some embodiments will age out from the list[490] entities[350] who have ceased to occur in the list[490] after a system[180]—specified interval of time. Some embodiments will try to identify the names of any formal real world groups, such as “G7 Leaders.” Especially if the group in question is a high status group[463], most embodiments will treat this as a polarity[630]—bearing marker[110].

Some of these embodiments will in turn choose to use publicly (or otherwise) available lists of members of the real-world group in question, for example, a list of currently serving congressmen. It is in this way that the system[180] can detect that someone[350] isn't mentioned[310] at all in the context of the group [460] by any media outlet[160] despite being a member of the group in question. This is necessary since the vast majority of people[350] will not—and should not—be listed in a group of congressmen for example. Otherwise put, there must some logical reason to believe that a given entity[350] could occur in such a list.

The number of entities[350] in the list[490] will be considered by most embodiments. It is one thing to not be included in a list[490] of 3 entities[350] and another thing to not be included in a list[490] of 10 entities[350] for example. However, as practical matter, for reasons of space most lists[490] contain at most a handful of entities[350]. But in the event of longer lists[490] most embodiments will specify a weight for incremental evidence for a target entity[350] not appearing. For example, an entity[350] not being included in a relevant list when N=2 may have a “no evidence” value[270] attached to it, but if N=5, “some evidence” of negative[637] polarity[630]. Conversely, consistent inclusion in even short lists[490]—for example “Top 3 most powerful leaders in Europe” will be assigned positive[635] polarity[630] in most embodiments.

Most embodiments will not handle lists [490] extracted from tabular data in this way. Tabular data can be identified using any reliable table detection algorithms[1250]. Many embodiments will not try to analyze them for bias[260]. A key motivation is that such tabular data may be ordered in a number of ways that do not connote importance, for example alphabetically or according to some variable to which the system[180] often will not have access. This of course also may impact which entities[350] will be shown at all, or without needing to traverse a link or take some other user action.

As already noted in the Overview section on groups[460], most embodiments will consider entity[350] mentions[310] or references[1620] that appear in the same paragraphs[950] with sufficient frequency according to the statistical, matching rules[1215] or other test provided by the particular embodiment to be considered a group[460]. Some embodiments will prefer to use sections[410] in preference to paragraphs[950]. Other embodiments could even choose to consider co-occurrence of the entities[350] anywhere in the same story[100] as being sufficient. Alternatively, some embodiments may provide a set of matching rules[1215] that handle different buckets of content[320] differently, for example requiring a greater threshold to define a new group[460] if the entities[350] only co-occur at the entire story[100] level vs being in the same section[410] or the same paragraph[950] if different.

It should be noted that while quite generally accurate named entity extraction techniques[155] exist to identify target entities[150], certain specific kinds of constructions may be difficult to always identify correctly, especially collective ones. For example: “the leaders of countries such as Morocco, Algeria, and other princes in the region” may not only cause parsing difficulties in some embodiments, but “other princes in the region” is also arguably ambiguous. For this reason, some embodiments will either choose to weigh this marker[1770] less heavily, or do so in any instances in which there is a low certainty factor to resolving the references[1620] accurately.

The outputted scores[270] in most embodiments will be rank of the entity[350] within the group[460] as determined by the ranking algorithm implemented by the given embodiment, if the entity[350] is in the given group[460], “NULL” if not.

### Entity Vs Person Marker[1775]

Strong leaders of group entities[380] such as countries may become not only synonymous with the entity[380] that they lead, but become the preferred reference[1620] for the entity[380] when the entity[380] is acting as an agent. To take a simple example: “Macron promises more aid” as opposed to “France promises more aid.” As elsewhere noted, in most embodiments, this measure is also made relative to that of other persons[385] in the same equivalence class[450] in the same media outlet[160] as well as, separately, others[160] that share a scope[170].

In the case in which the entity[380] is a country, state, city, or region, almost all embodiments will treat references[1620] to the nationality or other adjective associated with the given country as the same as the country name—for example “Danes” as opposed to “Denmark”, “Michiganders” for “Michigan” or “New Yorkers” for “New York City.” Likewise, if there is an adjective commonly associated with members[375] of an entity[380] that is not a country, most embodiments will do the same, for example accepting “IBM'ers” as a reference for “IBM.”

In instances in which an entity[380] is consistently referenced predominantly by its name or a reference[1620] to it rather than that of the leader[385] relative to others in the same equivalence class[450] or group[460], it may suggest the existence of bias[260] towards the leader[385] of the entity[380] which can be validated or disproved by the values of other markers[110] for the same media outlet[160]. An illustrative example of this phenomenon can often be observed in Western media discourse, where countries from the Middle East are frequently mentioned as agents without direct association to their leader[385]. For example, headlines such as “Saudi Arabia tries to broker a peace deal.” are surprisingly common as of this writing. Note that any noun clause that includes the entity[380] name or an adjective indicating it will be treated in the same way in most embodiments as just the entity[380] name, so long as it does not include the name of the leader[385]—for example “the German government” will be treated as “Germany.”

Some embodiments will choose to define classes of exceptions to this which include but are not limited to: names of leaders[385] that contain an above average number of characters (e.g. for space reasons,) leaders[385] who are new and hence not yet well known, and leaders[385] whose name occurs rarely in the given scope[170]. Note that in the latter two cases, the person's[385] full title would likely have to be included for clarity, so once again a space issue. In most embodiments, the references[1620] will be extracted using existing natural language processing techniques to parse textual content and extract named entities (NER)[155].

Most embodiments will also seek to exclude statements in which convention, grammatical or other linguistic rules would preclude (or at least greatly limit) the possibility of the leader's[370] name being used to represent the entity[380] or vice-versa. For example, France can't reasonably have the flu, and it would likewise be odd to say that Macron's weather will stay cool in January. Most embodiments will opt to train classifiers on the appropriateness of which name to use in which semantic contexts. Such embodiments will do this on a language-by-language basis because genuine differences are possible by language.

Most embodiments will consider cases in which the entity[380] affiliation and the name of its leader[385] are both present simultaneously as neutral polarity[630], especially if the co-occurrence is common in the particular set of scoped media outlets[220] for the given target entity[150]. This is because of the often low likelihood that the names of leaders[385] of entities[380] that exist outside of the scope[170] of interest of the given media outlets[220] will be recognized by the audience. However other embodiments may make different choices.

Many embodiments will treat a higher than average percentage of references [310] to the person[385] leading the entity[380] as indicating positive polarity[635] but will not apply negative polarity[637] in instances in which this is not the case because the appearance of the leader's[385] name in preference to that of the entity[380] is an asymmetric variable. Often the score[270] of this marker[1775] will be “no evidence.” For those entities[350] enjoying an unusually high percentage of such direct references to themselves, most embodiments will simply output a coarse-grained score[270] of “some evidence” or “strong evidence” based on the number of deviations from normal.

### Unprovability Marker[1780]

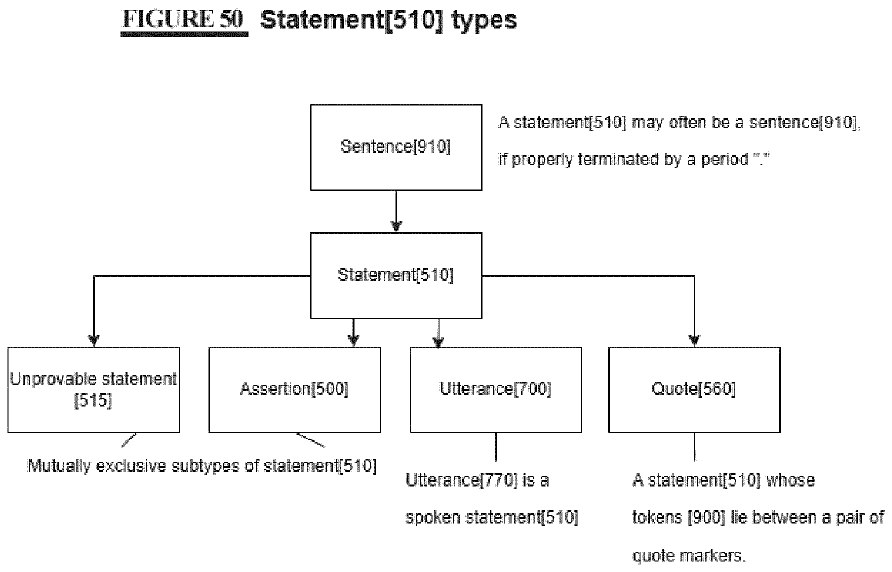

This marker[1780] involves determining the percentage of linguistically subjective and other forms of logically unprovable statements[515] in the story[100] (e.g., this may be a big problem later, many people think, I believe that, Why X won't, etc.) vs other types of statements[510]. (The statement[510] types supported in a default embodiment are shown in FIG. 50. This marker[1780] measures the amount of text[120] content[320] that is asserted as a specific, verifiable—or disprovable—fact (whether or not it is.)

Subjective statements[515] typically involve expressions of personal opinion, belief, or interpretation, rather than objective facts. These include, but are not limited to: predictions about the future, imperatives, normative or prescriptive statements, and statements of explicit opinion or belief. In news stories that are ostensibly factual, and not merely opinion pieces, subjectivity can be introduced subtly, often through the non-obvious use of quotations. For example, consider the headline “Ukraine war ‘cannot be won on battlefield’ as soldiers fear defenses ‘impassable barrier.’”¹ In this example, the quotation is not directly attributed to any specific individual within the article, and thus not qualifying as a fact insofar as Person X did say [X]. ¹ https://www.express.co.uk/news/world/1788500/Ukraine-war-battlefield-offensive

Most embodiments will implement this marker[1780] because an elevated percentage of subjective or unprovable statements[515] from a given media outlet[160] with respect to an entity[350] or news cycle[235], either an individual[370] or group[380] one, may suggest a particular need to “spin” facts in one direction or the other.

A default embodiment will include but not be limited to the following forms of such unprovable statements[515]:
Imperatives: Statements that express commands, instructions, or requests, such as “Shut the door,” “Be kind,” or “Do your homework.”
Normative Statements: Normative statements express value judgments about what should or ought to be, rather than describing what is empirically true. For example, “We should protect the environment,” or “Stealing is wrong.”
Prescriptive Statements: Prescriptive statements prescribe a course of action or suggest what someone should do. For instance, “You should exercise regularly,” or “You ought to eat more vegetables.”
Ethical Statements: Ethical statements express moral beliefs or principles, such as “It is morally wrong to harm others for personal gain.”
Aesthetic Statements: Aesthetic statements express judgments about beauty, taste, or artistic merit, such as “This painting is beautiful,” or “That song is moving.”
Deontic Statements: Deontic statements express obligations, permissions, or prohibitions, such as “You must pay your taxes,” or “You may not enter without permission.”
Questions. Questions in news stories, while not inherently expressing subjective opinions, often suggest a level of uncertainty and contribute to opinion formation. The framing of a question may reflect the bias or perspective of the author, for example, asking, “Is the US doing enough to help Ukraine win the war?” implies a judgment about the government's actions and suggests that more could be done. Questions that have an obvious punctuation mark “?” are the easiest to detect with a simple search for the correct punctuation mark in the given language. Some embodiments will also consider linguistic questions that do not have a question mark or other expected punctuation at the end. This process will typically use a combination of analyzing linguistic features and syntactic structures, including but not limited to detecting interrogative pronouns (who/what/where/when/why/how) that signal the beginning of a question, inversion of subject and object, or auxiliary verbs.

Many embodiments may choose to ignore this marker[1780] for any story[100], outlet[160] or sub-outlet[165] that is clearly labeled with labels that include but are not limited to: “opinion”, “OpEd”, and “analysis.” In addition, some embodiments will do similarly with stories[100] assigned a context[730] of analysis[610] by the system[180]

Most embodiments will use existing hedge detection algorithms [985], lexical approaches, morphological analysis, POS tagging[1585], train classifiers, or any combination of these in order to detect subjective statements [515]. Such classification can be performed with adequate or better accuracy for the task at hand, which is detecting outlier percentages of subjective statements[515].

This marker[1780] by itself does not indicate polarity[630] in most embodiments. In most embodiments, the outputted score[270] will simply be the percentage of unprovable statements[515] of all statements[510] within the story[100].

### Unnamed Attribution Marker[1785]

In many embodiments, this is a sub-marker[1785] of unprovability[1780]. A common means of indirectly communicating an opinion is to assert that it is the prevailing view, especially among people who are reputed to be experts. Such statements are by definition not provable. For example:
“Many fear Donald Trump, will cut American funding to Ukraine.”

It is impossible for the reader to know what “many” actually means—for one thing, it is many of whom, exactly? And what percentage is implied by “many” ? Such statements[515 lack the specificity[770] or any other existing method of assessing the degree of specificity[770] that makes them not only unverifiable, but also not particularly credible. There are numerous fairly common constructions that most embodiments will look for. These include but are not limited to:
“Most/many/a majority/all/almost, nearly all”<coupled with verb clause, including but not limited to “say, advise, counsel, caution, recommend, suggest, believe, consider, agree, and emphasize.”
“Experts <coupled with verb clause, including but not limited to “say, advise, counsel, caution, recommend, suggest, believe, consider, agree, and emphasize.”
“The [X] community” same verbs
“[X's] we have spoken with/interviewed

Some embodiments will consider whether any entities[350] are actually referenced in the statement[510] in support of the assertion being made, and if so, how many. For instance, if a group is indicated, followed by the 3 actual appropriate entity[370] names, any editorial sleight of hand is far less than if there are none. The following is a good example:
“Sens. Mitch McConnell of Kentucky, Lisa Murkowski of Alaska and Susan Collins of Maine are among the Republicans concerned about her nomination”

In addition, almost all embodiments will look for universal quantifiers and treat them similarly. This is because it is almost always unprovable that “everyone”, “nobody”, “all experts” have done, thought, or said any particular thing.

Most embodiments will score the presence of both multiple instances of the same subjective expression strategy and instances of multiple kinds of subjective expression strategies within the same sentence[910] as reflecting greater subjectivity and hence bias[260] of some kind. For example, a statement[515] might include multiple hedges[980] of different kinds, one or more universal quantifiers, and a prediction. Some embodiments will do likewise at the paragraph[950] level.

Most embodiments will either opt to use ML/LLM models[1180] or existing natural language processing algorithms to detect known linguistic markers of subjectivity within text. This may include but is not limited to analyzing sentence structures, syntactic cues, and semantic context to identify statements[510] that should be flagged.

This marker[1780] by itself does not indicate polarity[630] in most embodiments. In most embodiments in which it is a separate marker[1110], the score[270] will be the percentage of unattributed statements[515] to attributed ones. Whether or not it is part of the unprovability marker[1780], any statements[510] flagged by this marker[1785] will be considered unprovable statements[515],

### Wrong Attribution Marker[1790]

Unfortunately, in some instances quotes[560] may be a) altered beyond recognition, b) wrongly attributed by entity[350] and/or by real-world context, or c) just simply made up or wrong altogether. There are multiple forms of this supported in most embodiments.

The first form is the simplest case. This is when the quote[560] is asserted to have been made by a specific entity[350] in a particular identifiable context[730], such as an interview[395] or a press conference, from which a transcript[480] exists. In this case the quote[560] can easily be found—or not—within the transcript[480]. A preferred embodiment will use textblocking[590] (as defined in, rather than strict substring search so as to provide some flexibility in what strings will match. Otherwise put, most embodiments will not demand that the quote[560] is verbatim correct so long as it remains computationally recognizable. Some embodiments may choose to also seek the quote[560] in other transcripts[480] within a bounded lookback period[960] to try to correct for simple sloppiness on the part of the media outlet[160].

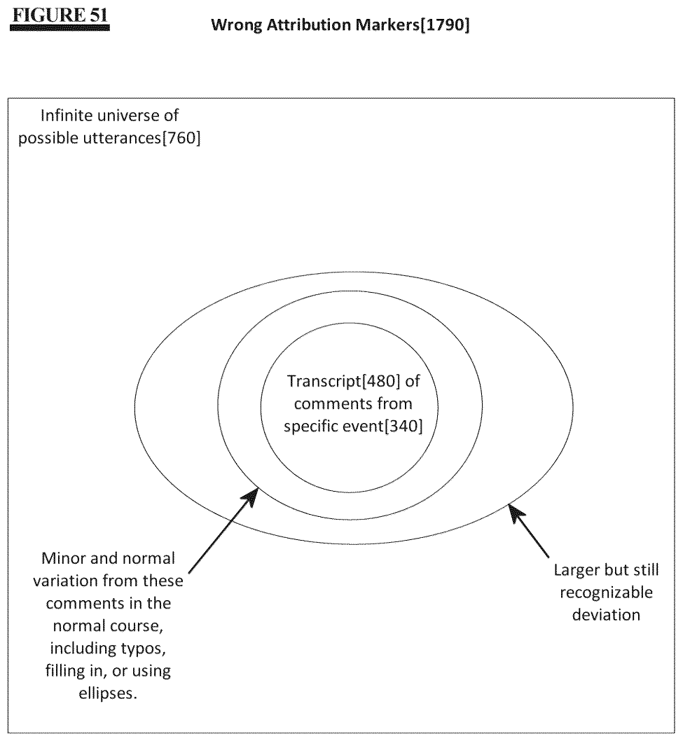

For example, for this marker[1790] and elsewhere, most embodiments will typically ignore the presence or absence of filler, filled pause, hesitation markers, crutches or planners. These are sounds or words that participants in a conversation use to signal that they are pausing to think but are not finished speaking. This includes but is not limited to words such as “and,” “well,” “so” and “you know,” and also simple sounds like “ah,” “um” and “er.” This is because the goal is to measure intent to present information objectively, rather than not always helpful exactitude with respect to fillers and the like. Most embodiments will similarly choose to overlook differences in the usage of contractions and detectable instances of the use of ellipsis. Many embodiments may choose to further expand the definition of acceptable likeness in ways which may include but are not limited to: multiple excerpts[570] separated by multiple tokens[900], shorter or other references[1620] to entities[350] and use of synonyms.) This is conceptually pictured in FIG. 51.

The next form handles the case in which a quote[560] is properly attributed[567] to a given entity[350] but either lacks an exact date[1540] and place[1535], or perhaps any real-world context (and/or context[730]) at all. Without at least some form of context, it may well be impossible to prove (or disprove) the veracity of the quote[560].

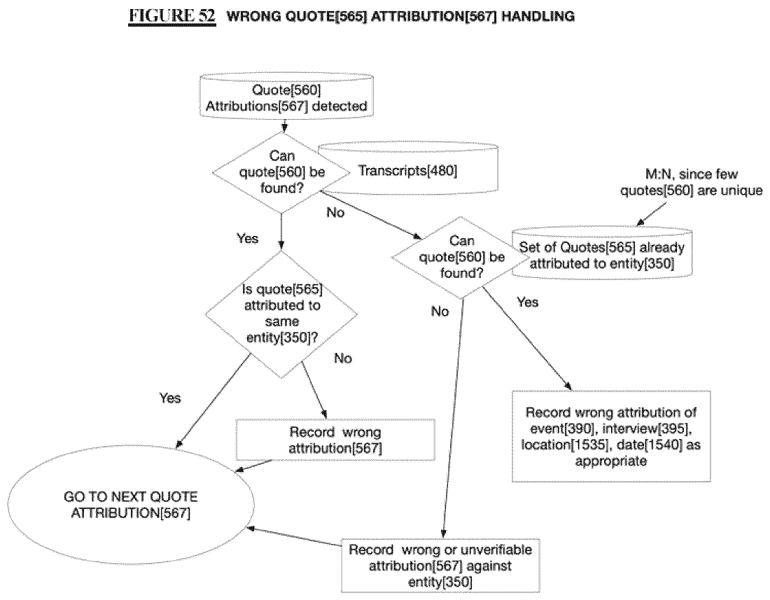

As shown in FIG. 52, if the quote[560] cannot be found even with expansion methods including but not limited to textblocking[590] in the referenced transcript[480], the system[180] will look for any transcripts [480] containing the entity[350] within the context[730] of the story's[100] news cycle[235]. If the quote[565] is found in a different transcript[480], an attribution[567] error will be logged with respect to the pair of the originally specified event[390], interview[395], or failing that, location[1535] and date[1540] and the actual one. If that also fails, most embodiments will search the set of quotes[565] attributed to the given entity[350] through the time window[675] determined by the system configuration[815]. In this case, the same error is logged as in the previous case.

The next case is one in which the quote[560] was mistakenly attributed to the wrong person[370] —or at least there is disagreement as to the person[370] to whom it is attributed, and that disagreement is omission[690] cluster-dependent[1385]. In the case in which a particular context[730] was provided, most embodiments will simply search the transcript[480] to verify the attribution[567]. In the case of the incorrect attributions[567], most embodiments will simply look for a repeated pattern of this occurring with the pair of given media outlet[160] and target entity[150]. This is because any isolated instance of such misattribution can easily be just plain error. Some embodiments may choose to carve out certain classes of exception to this in cases in which human error is more likely, for example when the pair of names of the entity[350] who should have originally had the quote[560] attributed to them and the entity[350] to whom it was initially misattributed are very similar to one another, or in which a prior occupant of a particular role was incorrectly referenced.

However, if there is no context[730] or real-world context such as location[1535] or date[1540] is provided at all, it is trickier. This is because quotes[560] are often not unique, and it is possible that many people have said the exact same thing at one time or another. Because it is impossible to prove conclusively that a person did not ever say a particular sequence of words, most embodiments will simply treat this case the same as the prior case; the quote[560] cannot be attributed out of thin air.

Most embodiments will also consider as a specific editorial choice[210] sequences of words[900] that were not actually stated in the interview[395], but which are falsely reported as having been in the transcript[480], so long as the excerpt[570] in question is clearly being attributed to the particular event[340] via entity[1690] NER[155]. This is because altering, not verifying, or simply inventing quotes[565] is unfortunately a possible editorial choice[210]. Here as elsewhere though, before assigning such a choice[210], most embodiments will use their preferred methods to expand and search for the permissible variations according to the embodiment so as to avoid falsely flagging inconsequential differences, as opposed to absences or fabrications.

If however, the media outlet[160] or specific author[250] (if different) has a demonstrated pattern of inventing quotes[565] for given entities[350], almost all embodiments will consider it “strong evidence” of bias[260] though without polarity[630]. If it is a general pattern, some embodiments may choose to eliminate the media outlet[160] or specific author[250] from the set of valid media outlets[160].

This marker[1790] by itself does not indicate polarity[630] in most embodiments. Some embodiments will consider it as just part of the quote[560] attribution[567] process. In most embodiments the only cases in which it will generate a non-NULL score[270] are a) there is a statistically anomalous percentage of quotes[565] that should have been attributed to Entity X[350] by a given media outlet[160] or author[250] but were instead attributed to other entities[350] and b) likewise, there is a statistically anomalous percentage of quotes[565] attributed to Entity X[350] that cannot be otherwise verified and were likely fabricated. In these two cases, the scores[270] will be based on the assessed probability of randomness of the scenario used by the given embodiments.

### Hedging[980] Marker[1795]

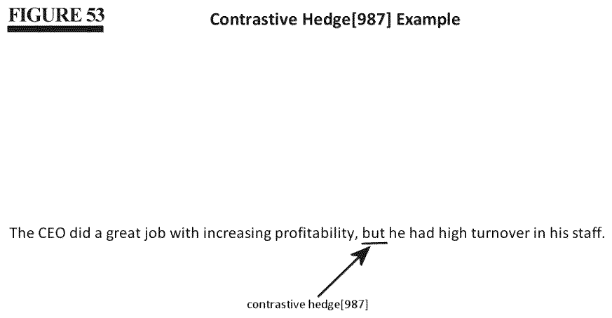

This marker[1795] involves the use of unusual amounts of linguistic hedging[980] relative to the target entity[150]. It is different in most embodiments from the unprovability marker[1780] which also in most embodiments will avail itself of hedging detection algorithms[985] insofar as its focus is on identifying what are commonly referred to as “weasel words” and instances of hedging[980] whose pragmatic intent contrasts between the first part of the statement[510] and the second—in other words, what is known as contrastive hedging[987], as shown in FIG. 53.

The pragmatic intent of such hedging[987] is often to create a sense of murkiness or negativity with respect to its target. For example, “Yes he won the primary, but by much less than he should have.” is an example of such linguistic hedging[987] because of the “but.” Less frequently however, this style of hedging[987] may be used to try to mitigate issues relating to a target entity[150]. For example, “yes, he lost the primary, but he was outspent 3:1.” Or any statement[510] of the form “s he isn't good looking but has [other good qualities.]”

While such hedging[987] strategies are not in themselves at all uncommon or suspicious, an unusually high concentration of them with respect to a particular target entity[150] over time by a given media outlet[160] suggests the presence of a probable bias[260] of some kind. Most embodiments will use lightweight approaches such as shallow parsing coupled with NER[155] to identify the target of the hedge[980]. Most embodiments will measure this both with respect to how much other scoped media outlets[220] hedged with respect to the target entity[150], and how much hedging[987] that particular media outlet[160] does with respect to other named entities[350] in the same equivalence class[450] or group[460]. Some embodiments will also consider this at the level of the individual author[250] in the case of media outlets[160] that have multiple authors[250] associated with them.

Any good quality hedging detection algorithm[985] may be selected by the individual embodiment for the contrastive hedging[987]. Most embodiments will take a lexicon-bound approach to detecting the “distancing” or “weasel” words and phrases. These include, but surely are not limited to: likely, plausible, possible, probable, appears to be, apparently, might, and many more.

This marker[1795] by itself does not indicate polarity[630] in most embodiments. Many embodiments will treat it as part of the unprovability marker[1780]. In most embodiments, this will be analogous to the prior marker: the scores[270] will be based on the assessed probability of randomness of the amount of hedging[980] with respect to a given entity[350] or news cycle[235] used by the given embodiment.

### Specificity[770] & Informational Value[780] & Similar Markers[1110]

Some embodiments will choose to assess measures that include but are not limited to indicating the level of detailed information [770] being provided in a statement[510], and its novelty[1530]. Such markers[1110], while not typically polarity [630]—bearing may have genuine value in certain specific cases, especially when there is substantial divergence among similarly scoped[170] media outlets[160]. For example, an especially high- or especially low—degree of specificity[770] on stories[100] relating to a given news cycle[235] on the part of a given media outlet[160] can be strategies to either hide one or more specific unwanted details, or alternatively, to drown the reader/viewer/listener in unimportant details so as to distract notice from one or more unwanted details. Likewise a lack of informational value[780] or otherwise assessed novelty[1530] can indicate a fear (or the actuality of) censorship.

Different embodiments may select their own preferred mechanisms for measuring specificity[770], informational value[780] and/or novelty[1530] more generally. However, most embodiments will score[270] according to the whether or not the detected levels are significantly in the tail of the expected distribution. This is because substantial variation in the values[270] of this kind of marker[1320] are to be expected in the normal course. Otherwise put, some news cycles[235] naturally call for more detailed information that others; in others[235] there may be little unexpected or contrarian to say.

Scores[270] of this group of markers[1110] in many embodiments will be straight randomness scores.

### Video-specific Markers[1115]

Most embodiments will choose to analyze the static image[130] to represent the video[140] component[190] as a sort of visual title. In other words, it will treat the static image[130] as it would if it were only an image[130] not a video[140] so as to assess bias[260]. This static image[130] will be assigned a higher weight than other video frames[145] by most embodiments in scoring the video[140] clip in its entirety, which many embodiments will do by running the image markers[1100] on each video frame1[145].

As with text[120] content[320], both video[140] and audio[290] content[320] may also have omitted or edited out excerpts[575] some of which may be outlet[160]—cluster-dependent[1385]. However, especially with video[140] content[320] but also with audio[290], excerpts[575] containing certain specific classes of entity[350] actions may be unusually likely end up as omissions[690]. With video[140], entity[370] this means actions including but not limited to: stumbling, tripping, falling, or exhibiting tremors may fall into such a category. With audio[290] data, similarly at least coughing and verbal tics likely fall in this category. Many embodiments may therefore choose to test any cluster-dependent[1385] omissions[575] to see if they match any behavior defined as “interesting.” Different embodiments of this kind will choose their own sets of such behaviors, most often training classifiers to detect them. Some embodiments who have done so may choose to always look for the relevant content[320].

### Audio-Specific Markers[1120]

Audio[290] content[320] is treated very similarly to video[140] content[320] other than for visual measures, with the exception of any static image[130] associated with the audio[290] clip if such exists. The AI-enhanced marker[1750] if implemented will look for unnatural improvements in voice that include but are not limited to voice smoothing.

### Placement-Related Markers[1105]

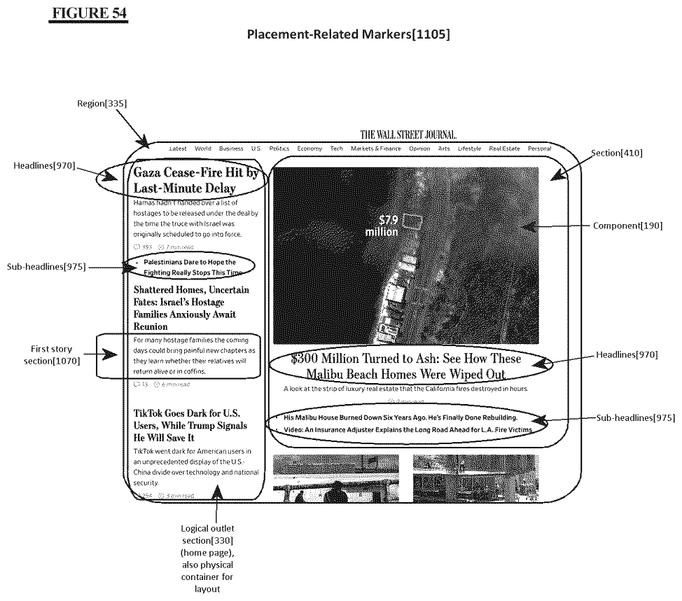

Placement markers[1105] refer to the “where” rather than the “what.” Placement[300] relates to the value[305] of the particular “real estate” [330] within the structure of a given media outlet[160] in which a mention[310] of a target entity[150] is made. For example, on a news website[1630], the home page container[420] is the most desirable real estate[330]. Specifically, as shown in FIG. 54, placement[300] defines the different sections[330] and container objects[420] of a media outlet[160] in which mentions[310] of relevant entities[350] can be made. In a default embodiment, these include but are not limited to: headlines[910], sub-headlines[975], regions[335], stories[100], sections[410] of a story[100], the section[330] within the container[420] in the outlet[160] and embedded components[190]. In many embodiments, placement scores[305] are then obtained by tallying the number of those mentions[310] in each story[100] in each section[330], assigning values[305] for the individual mention[310], totaling them, then multiplying them by the value of the container[420] (if relevant for the specific outlet[160].)

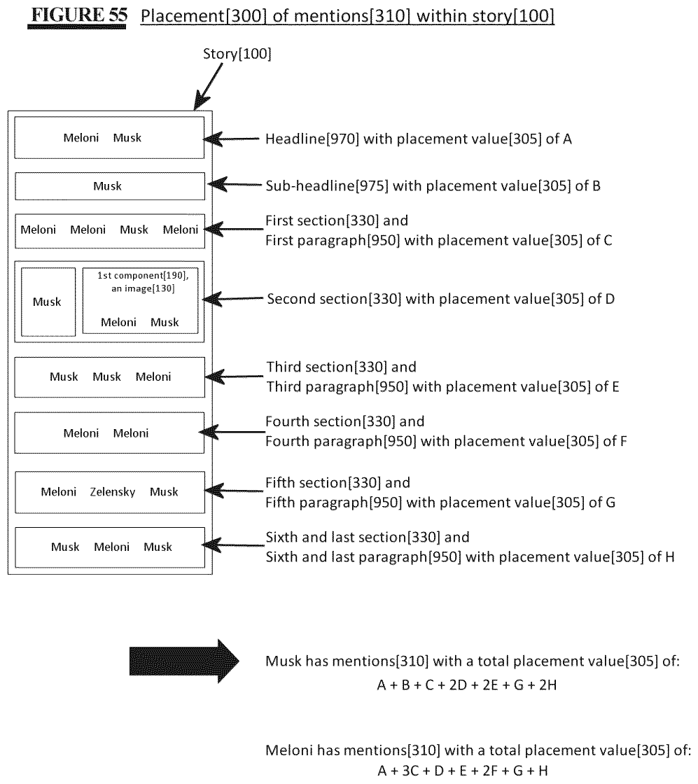

A simple example of this is shown in FIG. 55. Mentions[310] of both Musk and Meloni appear in the text[120]; the figure shows the number and relative order of each such mention[310]. The two also appear in an image[130] together. The overall absolute placement scores[305] for each entity[370] in many embodiments are simply determined by multiplying each mention[310] of the entity[370] by the placement value[305] of the section[410] it occurred in. However, some embodiments may choose to assign different weights to mentions[310] in different formats [200]. For example, some embodiments might decide to value appearances[310] in images[130] more highly than those in text[120]; some of these embodiments might make more granular choices, such as a mention[310] in a headline[970] (only) trumping one in an image[130], or the entity[370] in question having an overall image[130] score[1648] within the image[130] that is greater than some specified value.

This is a continuous measurement in almost all embodiments. New content[320] with fresh mentions[310] of the target entity[150] will always be appearing. And even if not all content[320] will at some point be put beyond a paywall or otherwise disappear, its placement[300] will in most instances change as it ages out. Different embodiments may choose different approaches to this issue of changing placement[300]. These include, but are not limited to: updating the placement values[305] as they change (in either direction), applying a retroactive lifetime placement value[308] for a story[100] according to a scheme of its choosing, and simply ignoring the fact.

In most media outlets[160]—and generally any long format one—the “where” matters considerably. Airtime[280] for example only has practical meaning if the relevant content[320] is actually viewed or listened to in the first place. Furthermore, an overall increase or decrease in the placement[300] of a target entity's[150] mentions[310] over time is highly unlikely to be random; many embodiments will handle the case in which a particular real-world event[340] deprives all else of placement[300] and airtime[280] during some particular time period by removing the impacted media[160] editions[990] from placement marker[1105] analysis by doing frequent—at least daily in most embodiments—analyses of placement values[305] by news cycle[235] on the given day. However, well-placed airtime[280] is essentially always a zero-sum game. For example, there is only so much that can be fit into the initially visible portion of a computer screen, or in the first segment of a news show.

The importance of the placement[300] of mentions[310] is very straightforward: if one subscribes to the common view that all publicity is good publicity, it is always best to appear on the front or home page, in the headline[970], or in the first few minutes of a news broadcast. Even more importantly, especially in text[120]—heavy media formats[200], stories[100] that have poor placement[300] are likely to be seen by very few people, since few people have the time to do more than glance at the big stories[100]—or perhaps even just flit through the headlines[970]. Thus, significant differences in the placement[300] of specific entities[150] among scoped media outlets[220] can signal significant and meaningful bias[260].

Tallying mentions[310] in specific placements [300] in different media outlets[160] within the same scope[170] can often provide a good sense of how a given target entity[150] is being portrayed in any given media outlet[160]. In other words, it is an implicit measure of importance. It is also one that, with the exception of coreference[1620] detection, avoids the need for deep NLU.

Most embodiments will consider a mention[310] occurring in the very last section[410] of a story[100] as preferrable to one in the middle sections[410] of a story[100] with more than three sections[410]. This is because of the serial position effect, which dictates that in many circumstances, information in the middle of a list is the likeliest to be quickly forgotten. A similar rule of thumb exists for textual[120] content[320] more generally. Most embodiments will allow users[810] to implement their own rules of thumb both in general for a given media format[200], and for specific media outlets[160].

### Valuing Sections[330]

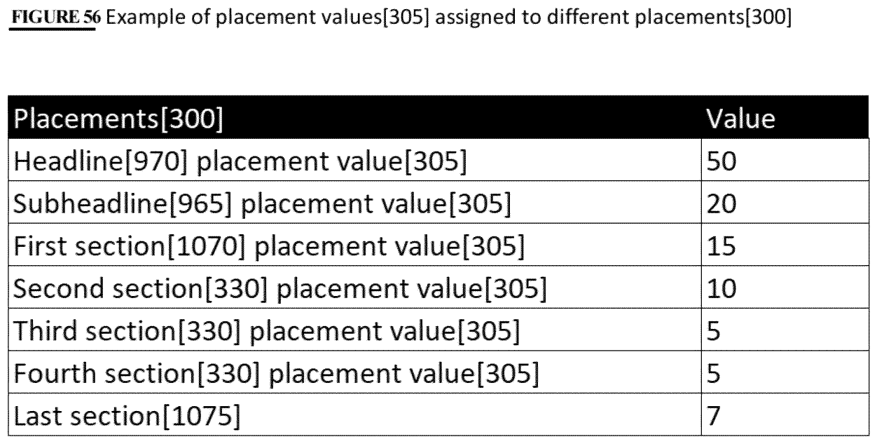

Most embodiments will have a default set of user[800]—modifiable placement values[305] for the sections[330] typically found in each media format[200] and for different regions[335] of these sections[330], with the exception of audio[290] content. For example, on a news website, the home page is a section[330]. For example, as shown in FIG. 56, content[320] that begins on the part of the home page that is visible on a standard laptop without the user having to scroll to see it is considered a region[335] of the home page.

This “above the fold[422]” region[335] is then divided into as many vertical slices as needed to capture stories[100] starting at the top of the region[335]. In practice, between one and three slices will be needed in most instances for a laptop screen. (Most embodiments will choose the exact approach for this; of course the notion of “above the fold” or “initially visible” is device, and hence also somewhat audience-dependent. Thus, different rules of thumb may be elected by different embodiments for this estimation. In almost all embodiments, regions[335] will be device-dependent, and normalized in the normalization step[1405] as the notion of the “fold” is quite different among cell phones, tablets, and computer screens.) Most embodiments will allow hierarchical definitions of regions[335].

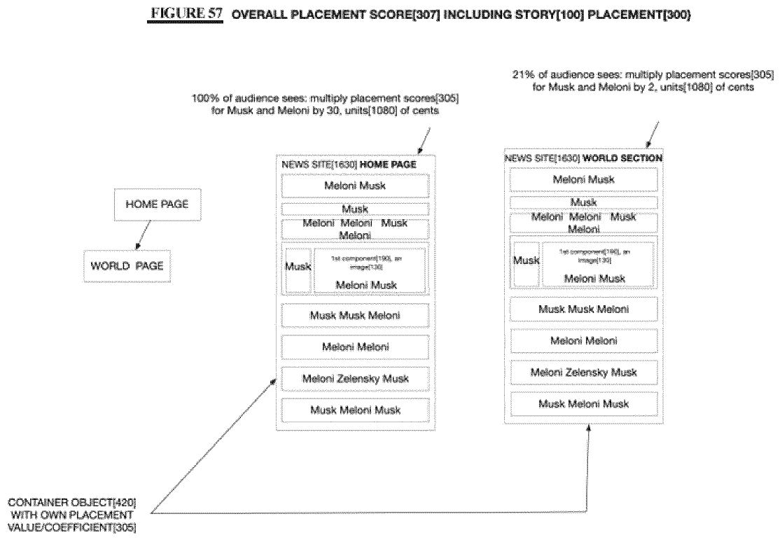

A default set of placement values[305] within a story[100] used in one simple embodiment is illustrated in FIG. 57. The values[305] descend as one might expect. For outlets[160] that are considered especially important by the end-user[800], most embodiments will support the definition of custom formats[360] with their own customized placement values[305]. However, most embodiments will require all placement values[305] to be greater than zero essentially under the logic that “all publicity is good publicity.”

In some embodiments, regions[335] will be defined distinctly from sections[330] in any situation in which the logical section[330] differs from the visual region[335]. For example, a paragraph[950] will in most embodiments be treated as a section[410] of a story[100]. However, it is possible that a paragraph[950] may be continued on another page in digitized print format[440], or that it is interrupted by a “read more” link or a large ad. Furthermore, ad placement for example may be done in an automated and even user-specific way.

In valuing mentions[310] in different places[330], most embodiments will by default implement current, empirically observed broad rules of thumb for different media formats[200] in scoring placement[300] in different sections[330], such as 50% of users disappearing with each additional click, or 5% of the audience disappearing at a commercial break during a TV show[1545].

However, some embodiments will take this a step further. Each media outlet[160] has its own specific characteristics, economics, audience, and audience behaviors. For example, placement[300] on the home page may simply be worth proportionally more than a placement[300] a link down on some news websites than others. To extend the example, if it were known that Wall Street Journal readers would drop off at a rate of 70% rather than 50% for each additional mouse click, the WSJ home page placement[300] would be more valuable than it would be for a different outlet[160] that was at the standard 50% rate—and so its placement value[305] will be altered accordingly. A similar logic holds true if the system[180] has access to the amounts that advertisers paid for ads placed in the home page vs pages one level further down in the site hierarchy. An example of this is illustrated in FIG. 57.

Many embodiments will allow units[1080] to be attached to the placement values[305] by the end-user[800]. For example, placement values[305] could include but are not limited to: dollars, other currencies, “eyeballs”/audience counts, or some kind of other credit scheme. Providing such units[1080] helps make the real world value of consistently good placement[300] more real. Any units[1080] specified in this way will be displayed in the user interface[820] in almost all embodiments. Many embodiments will generate reports[1090] that show the total placement value[307] scores and units[1080] (if any were defined by the user[800]) over a requested time period[670] for one or more entities[350] by media outlet[160].

For these reasons, many embodiments will allow placement values[305] to be defined programmatically, so that they can be driven by actual data from the specific media outlet[160].

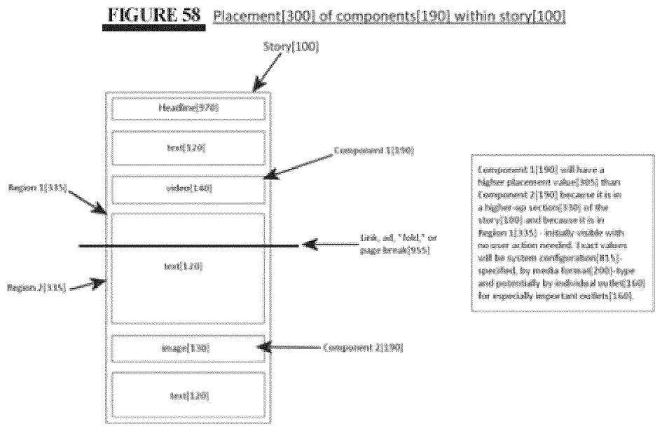

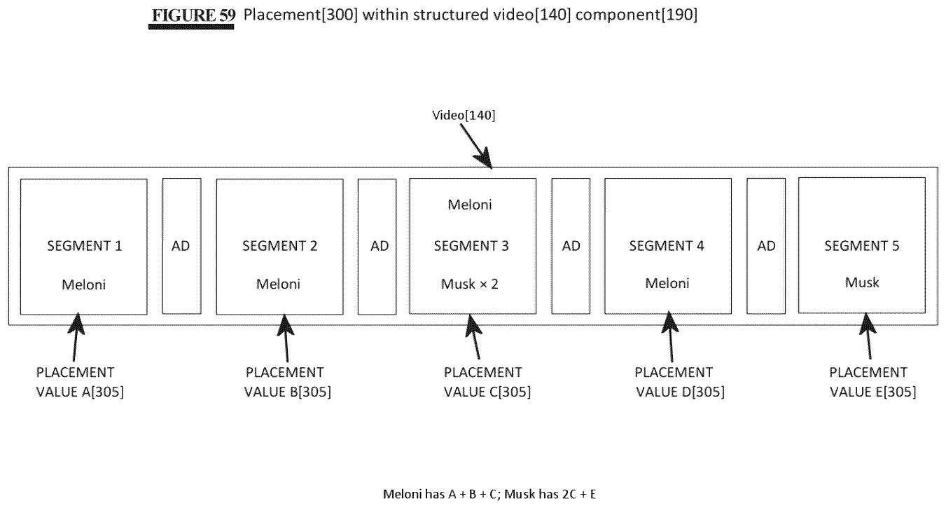

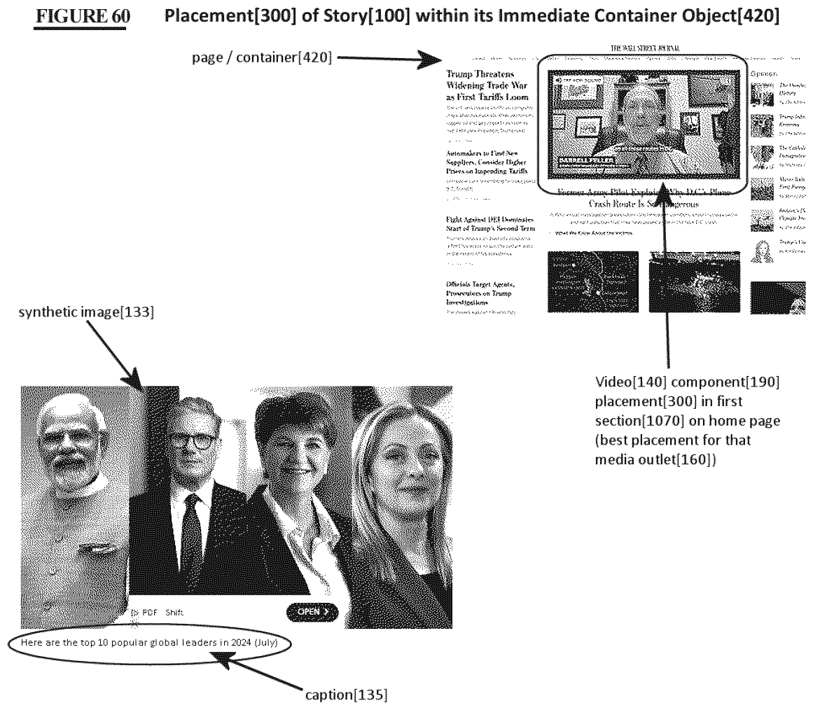

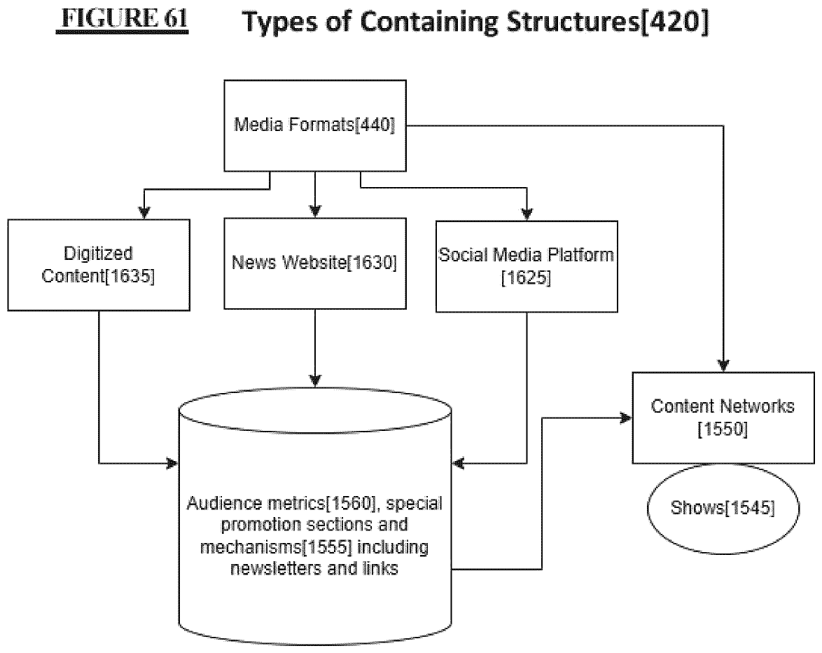

In almost all embodiments, there are at least four types of placement[300]:
1. Mentions within a story[100]: The placement[300] of mentions[310] of target entities[150] within a specific bounding piece of content[320] such as a post or a news article in other words, a story[100.]. Almost all embodiments will measure both absolute placement[1030] of each target entity[150] and relative placement[1040], in the event that more than one target entity[150] is mentioned in the same story[100]. Many embodiments will also choose to assess relative placement[1040] for members[350] of the same equivalence classes[450] and groups[460] related to a specific target entity[150]. Many embodiments will likewise do so with the mentions[310] of not previously seen entities[350] relative to the target entities[150] and other entities[350] that belong to any comparison set[470] for other target entities[150].
   Relative placement[1040] within a story[100] should not be confused with the ordering markers[110]. The latter asses the relative order of the mentions[310], which will often be in the same sentence[910] or paragraph[950] but can occur anywhere within the same story[100]. However, from a placement[300] perspective, if both mentions[310] are in the same section[410] of the story[100], their placement[300] is equivalent. One mention[310] has better placement[300] than another only if the placement value[305] of its section[410] is higher than that of the other mention[310].
   Some embodiments may choose to elevate the placement values[305] of images[130] or videos[140] over text[120] content[320] in the same section[410]. Of these embodiments, many will choose to specify a minimum size[1325] of the component[190] with the reasoning that it must be large enough to immediately draw the eye in order to merit a boost in placement value[305].
2. Placements[300] of components[190] within a story[100]: In most embodiments the placement[300] of components[190] such as images[130] and video[140] both relative to which section[410] of the story[100] it appeared in and also relative to the placement[300] of any other components[190] in the story[100]. FIG. 58 shows an example of a story[100] with two embedded components[190], and with a text[120] section[410] divided into two different regions[335]. Some embodiments will also consider the placement[300] of the component[190] relative to its physical container[420]. For example, an image[130] that appears at the top of a digitized page[420], even if the result of spill over from another page[420], as having better placement[300] than that of a section[410] which preceded it on the prior page[420] at the bottom of that page[420].
   Most embodiments will also consider the size[1325] of the image[130] in the case of image[130] or video[140] components[190]. Those that do will typically compare the sizes[1325] of images[130] within the same story[100] (if more than one) and the range of sizes[1325] of images[130] typically used in the given media outlet[160]; most embodiments will assess this at the sub-outlet[165] level (if it exists in a given case.)
3. Mentions[310] within a structured multimedia component[190] embedded in a story[100]: As shown in FIG. 59 in the case in which an embedded video[140] or audio[290] clip itself is structured into different segments[410], mentions[310] can have their own placement[300] within the embedded component[190]. Target entities[150] may appear or have mentions[310] in these components[190] and thus have an independent placement[300] within it. In most embodiments, the length[750] of the appearance[310] is treated as airtime[280] rather than N mentions[310]. The most common examples of the use of this type of placement[300] would be an embedded component[190] that contained breaks for advertisement, or is otherwise clearly broken into distinct, easily detectable segments[410].
4. Placement[300] of the story[100] within its immediate container object[420]: The placement[300] of the particular story[100] within a media outlet[160] or sub-outlet[165], for example a story[100] within a news website[1630]. In most embodiments, different media outlet formats[440] will have their own default definitions of how to evaluate the value[305] of the container object[420] placements [300]; most embodiments will also support user[800] customization for specific media outlets[160] and media outlet formats[440] if desired. In most embodiments, the value[305] of the container[420]—when one is present—will be used as a multiplier for all mentions[310] in stories[100] which begin (or are wholly contained in) the container[420] such as a home page.
   A very simple example of this is depicted in FIG. 57 which shows that mentions[310] in the exact same story[100] will have their placement values[305] altered according to the placement value[305] of the container object[420] in which it is placed. In the pictured example, the same story[100] involving Elon Musk and Georgia Meloni appears alternatively on the home page of a website[1630] and on a “World” page. As shown in the figure, the same mentions[310] have far greater value in the former case than the latter.
   For example, by default, on a news website[1630], it is best to be as close to the top of the page[420], visually centered, be as large as possible given the bounds of the display, and be on the home page—as in FIG. 60 or failing that, a sub-home page. However best vertical starting position[425] and being at visual center[427] will not always occur for the same story[100]. Further, an image[130] or video[140] component[190] may draw the eye to one story[100] vs another adjacent one[100], hence pragmatically impacting which of the stories[100] has the best placement[300] within the page[420]. Different embodiments can choose their own rules here; the order in which different languages are read for example will obviously impact this; cultural issues may also be possible in some cases.
   However, in addition to determining the best placement[300] in the physical or logical container[420] there are exceptions to this that some embodiments may choose to entertain. For example, in the case of large media outlets[160] that often have newsletters, the inclusion of a direct link[1227] to a given story[100] can drive considerable traffic to that story[100], regardless of its standard placement[300]. The newsletter is thus considered a promotion mechanism[1555] that can cause a spike[1485] in viewership and so in most embodiments that can impact the placement lifetime value[308] of a story[100]. If the number of users who viewed a particular story[100] suggests this or a similar anomaly, most embodiments will boost the placement score[305] of the story[100] in question.
   Types of containing structures[420] in a default embodiment are shown in FIG. 61 These include, but are not limited to:
      Digitized[1635] newspapers, magazines and other print content[320]. Placement values[305] determined by region[335] and specific container or page[420] number; first page[420] best.
      Websites[1630]
         The placement[300] will be assessed by the starting location of the content[320] in most embodiments
         Some embodiments may in addition or instead choose to use any available type of site[1630]—or platform[1625] specific elevation or promotion sections or mechanisms[1555] (including but not limited to: “Popular,” “Most commented on,” “most liked”, “most read/watched/listen to”, “most shared” and sending out text messages, emails or other forms of communication that promote specific stories[100]) Almost all embodiments will also support the direct use of audience metrics[1560] to help determine placement values[305], some of which are what cause the story[100] to be featured in such mechanisms[1555]. In most cases this will be provided through API support. Such audience metrics[1560] may include but are certainly not limited to all of the just above and “trending now.”) Most embodiments will make use of third party media and/or advertising enterprise systems to determine placement values[305].
      Social Media/User Forums[1625]
         Any type of platform[1625]—specific elevation or promotion of content[1555] (e.g. “trending now” and similar displays)
         Derivable social networks including but not limited to: from citations, retweets, likes, and other such platform-specific mechanisms
      V shows[1545], radio shows[1545], or other regular video[140] or audio[270] editions[990] [1545]: Some shows[1545] on a literal or logical content[320] providing network[1550] have far better and more valuable audience than others. In most embodiments, audience share or value data (if available to the system[180] will be used to determine the placement value[305] of the containing show[1545] relative to its containing outlet[1550].
      Specific custom formats[440] in any of these that impose their own rules, for example a Q&A section will feature 1 through N distinct questions.

In most embodiments, placement[300] involves the literal starting position of the content[320] in time or space, and in media formats[200] other than audio[290], its visual centrality[660]. Some embodiments will treat separated content[320] in the same story[100] as having its own placement[300]—for example, a story[100] that starts on the top of page 1 of a digitized news source[1635] and then continues at the bottom of page 17, or an article that requires the reader to click on a link to see the rest of it. However, many of these embodiments will assign a positive weight based on the placement[300] of the initial section[410]. Most embodiments which perform continuous monitoring will also consider the length of time that a particular placement[300] exists—for example, how long that top story[100] remains on the home page before being demoted.

In the case of specific social media platforms[1625], the system[180] must be able to access platform information that indicates the popularity or visibility of the piece of content[320] to users on that platform[1625] at a given point in time[670] in order to fully assess placement[300]. This is essentially the equivalent of placement[300] in traditional media, as it has a large impact on how many people will actually see the particular content[320].

Almost all embodiments will attempt to normalize placements[300] across different media formats[200] to the extent logically possible. Straightforward examples of this that will be implemented by most embodiments include, but are not limited to:
TV chyrons[620] equated to headlines[970] in any print media format[200]
Temporal placement[300] in video[140] or audio clips[290], with the position of text mentions[310] of target entities[150] in a text story[120]
Placement[300] of named entities[350] in different sections[330] of online format and different segments[330] in video[140] or audio[290]
Placement[300] of named entities[350] in different suboutlets[165] in a news site[1630] that has a certain amount of readers and in TV or radio shows[1545] with their relative audience levels
Number of mentions[310] of target entities[150] in a text story[100] to number of their physical appearances in videos[140], to mentions[310] of them in audio clips[290], to them speaking in an audio clip[290]

In a default embodiment, the different levels of objects and containment are:

Mention[310]: In most embodiments, either a reference to, or an appearance by, a target entity[150]. By “appearance” we mean images[130], videos[140] and audio[290] clips of the target entity[150]. For text[120], including speech-to-text, nearly all embodiments will use existing NER[155] techniques to detect references[1620] to the desired target entity[150]. Note that since in text[120], an “appearance by” translates into a quote[560], most embodiments will simply assume proper attribution of the quote[560], which will by definition include a reference[1620].

Most embodiments will not count multiple mentions[310] of an entity[350] in text[120] that co-occurs in the same sentence[910] with other mentions[310] of the same entity[350]. Under the same reasoning, only one mention[310] will be counted for quote[560] attribution[567] for quotes[560] in contiguous sentences. Other embodiments may select different rules to avoid counting redundant mentions[310] that are most often the result of poor writing style.

For videos[140], different embodiments can select their preferred facial (or whole body) recognition algorithms and/or trained models to detect the appearance[310] of the target entity[150]. Detecting verbal references[1620] will rely on the use of speech-to-text data, and use NER[155], as it does with audio[290]—only content. For audio[290], each embodiment can likewise choose its own existing voice biometric fingerprinting approach in order to identify the appearance of a target entity[150] (if it chooses to implement this feature.) Some embodiments may choose to combine these approaches for multimedia content[320]; some of these will always try to very accurately identify target entities[370] regardless of media format[200], others only in the event of any ambiguity in the primary method for the format[200]. For example, a video[140] may have an audio[290] track, and may also have some form of speech-to-text transcription of it.

(Story) Component[190]: An embedded audio[290], video[140], or image[130] object within a story[100]. These objects[190] have their own placement[300] characteristics which may include but are not limited to: size[1325]/length[750], centrality[660], and region[335].

(Story) Section[410]: A section[410] is a contiguous piece of content[320] within a story[100] (unless, in some embodiments, interrupted by the insertion of an ad or other exogeneous content[320] or by a break such as a link); stories[100] are often divided into multiple distinct pieces in order to save real estate, insert a component[190] or to make room for advertisements. Note that where there are not clearly delineated sections[410], almost all embodiments will opt to use what natural partitioning there is—for example, in a text[120] story[100], paragraphs[950] —so as to be able to differentiate between a mention[310] appearing in the first paragraph[950] or the tenth. Some embodiments will define visual regions[335] to deal with the situation in which logical sections[410] are interrupted in such a way as to require the user to either have to take a specific action such as clicking or scrolling, or to have to wait for more than a config[815]—specified number of seconds to continue on with the story[100]. In these embodiments, different regions[335] of a section[410] are likely to be assigned different placement values[305].

Headline[970], title[970] or in the case of some video[140] formats associated with TV chyron[660]: This is a unique section[410] with which all stories[100] generally begin. It is considered in almost all placement value[305] schemes to be the best possible placement[300].

However, many embodiments may decide to further adjust the headline's[970] placement value[305] based on its font size[1235] and other font characteristics. This is because larger font size[1235] indicates a more significant real-world event[340] whereas small font size[1235] signals a more routine story[100]. Placement[300] is fundamentally about valuable real estate” and a headline[970] consuming an unusual amount of the most valuable space owing to font size[1235] is unusual. Many embodiments will also factor in the font size[1235] of the sub-headline[165] if present.

Story[100]: A content[320] container that has a headline/title[970], additional bounded content[320], and may have multiple sections[410], embedded multimedia objects[190] and a byline or other attribution.

Components[190], sections[330], stories[100] and their sections[410] on news or other complex websites can be detected by methods such as that of Welsh, Kaz, Vu, Zhou, and Spangher, November 2024. Welsh et al use a class of method that combines both computer vision on rendered content[320] and some HTML parsing in order to parse the complex layouts that are often associated with news sites[1630].

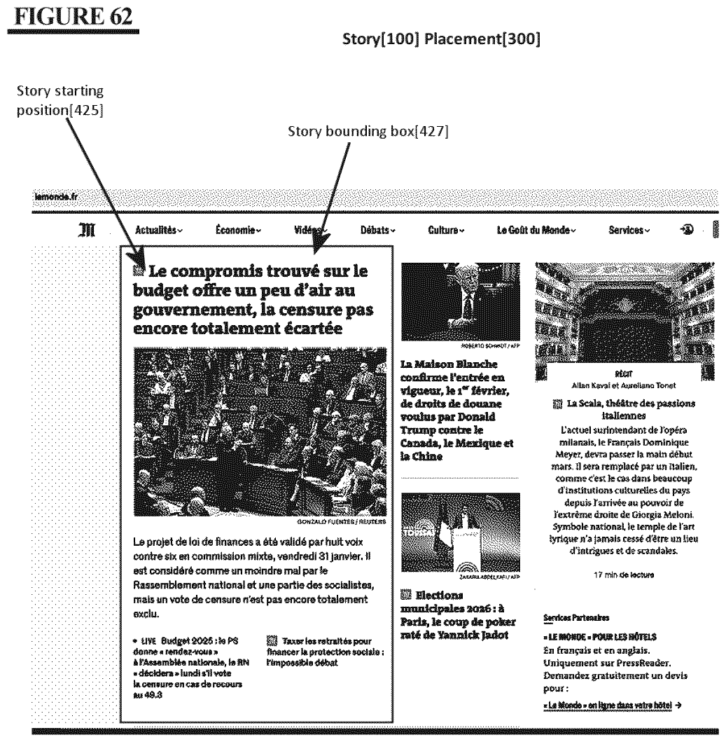

Such methods produce output that includes the position[425] and bounding box[427] coordinates of each story[100], as shown in FIG. 62 as well as the different story[100] sections[410] and outlet[160] sections[330], and all sequenced tokens[900] associated with each. (Welsh et al focus on the “newsworthiness” of a given news cycle[235] as seen by different media outlets[160], and editorial decisions[210] in this sense. The system[180] described herein with respect to placement[300] is focused instead on the entities[350] who make the news, and who will persist in most cases of interest over a large number of news cycles[235], and in so doing generate a large sample set of data to analyze.)

Once each token[900] has been assigned a specific placement[300]—keep in mind that stories[100] can sometimes be broken up other than at sentence boundaries—for text[120] content[320] all the system[180] need do is to implement its preferred NER[155] (named entity resolution) approach to identify target entities[150], tally the mentions[310] of each target entity[150] in each section[330], applying the correct placement value[305].

In the case of video[140] content[320], most embodiments will understand sections[330] as being sequential segments, as are found on TV news shows. Most embodiments will only support a single notion of “sections” for video[140]. Many existing methods can be used to detect breaks in the sequence since a substantial number—if not 100%—of the pixels[1315] will change at once. Fewer embodiments will implement regions[335] for video[140]; those that do will treat it to mean regions[335] of the video frame[145].

It is much the same for audio[290] content[320], though without the notion of regions[335] as here too there is substantial discontinuity between segments[337]. If the same person is speaking without interruption, most embodiments will consider it as a single segment[337]. Some embodiments may prefer to specify a number of seconds of pause that would end the segment[337] if detected. This is because doing otherwise would result in somewhat arbitrary ways to define segment[337] boundaries. However, a change in speaker, including for ads, or the addition of new speakers present clear cut boundaries. Numerous mature algorithms that use acoustic features including but not limited to: pitch, intensity, and spectral characteristics. Many existing methods can be used to detect changes from one segment[337] to another. Almost all embodiments will discard ad, public service or other exogeneous content[320] between segments[337] in video[140] or audio[290] content[320.] Existing methods to do this may include, but are not limited to: speaker change recognition, and substantial concurrent change in most or all pixel[1315] values.

Media outlet format[440]: A format[200] used by a media outlet[160], for example website vs digitized print version. Some media outlets[160] use more than one format[200]—for example, have both an online news site and a once or more daily TV news show[1545]. When a media outlet[160] has more than one format[200], each version will result in a media sub-outlet[165] being created, in most embodiments. A default embodiment will support at least the following types of formats[200] as shown in FIG. 61: digitized print[1635], news or similar website[1630], social media platforms[1625] and shows[1545] (video[140] or audio[270]). In most embodiments, bias[260] and collusion[650] scores[270] will be performed at both the level of the individual format[440] and for the outlet[160] as a whole.

Media outlet[160]: Any regular producer of content[710] for a public audience—a media brand whether an individual content producer[710] operating on a social media platform[1625] or a large corporate entity—including paid subscriptions or platforms[1625] that can adjudicate such content[320].

Media sub-outlet[165] A clearly distinct, often branded, portion of the media outlet[160], for example, a particular TV or radio show, or a particular column in a news website]1630]. In some instances, this is functionally equivalent to author[250]. In other cases, it corresponds to the same media outlet[160] delivering different versions having different formats[200]. Some embodiments will choose to perform analysis at the sub-outlet[165] level in situations in which the different sub-outlets[165] differ substantially in content[320] or format[200] from one another. Identification of distinct sub-outlets[165] will vary by embodiment. They may include, but are not limited to: the presence of different scopes[170] of language[1520], sector[1515] or geography[1510], different media outlet formats[440], significant observed differences in editorial choice profile[215], distinct audiences (if information is available to the system[180],) according to specific brands (as in the case of TV shows for example,) provided programmatically or by a third party system, or specified by the user[800]

Conglomerate[430]: An owner of multiple media outlets[160] operating within the same scopes[170] (and therefore presumably having at least some overlapping news cycle[235] coverage. Most embodiments will choose include this notion, as it can be presumed that media outlets[160] with the same owners may behave similarly from an editorial perspective.

Note that almost all embodiments will consider any government that controls more than one media outlet[160] in the same way as a conglomerate[430]; some embodiments however may choose to use different labels for the government vs private sector cases. In most embodiments, data about conglomerates [430] is entered into the system[180] either programmatically using data that is believed to be high quality and up to date, or by the end-user[800]. This is because outlet[160] ownership can change, and is not always straightforward to determine accurately.

Placement-related markers[1105] will be considered polarity-bearing[630] by almost all embodiments. For purposes of bias[260] and collusion[650] analysis, in most embodiments the total placement score[307] per story[100] will be used. However some embodiments will carve out specific high value[305] cases of value to score[270] separately. These include, but are not limited to headline[970] appearances [310] and appearing in photos[130] or videos[140] as determined by the definition present in the configuration[815]. These include, but are not limited to: the placement[300] of the image[130], the size[1325] of the image[130], the centrality[600] of the entity[370] in question, and the aesthetic goodness[1130] of the entity[370].

To summarize the scoring of placement-related markers[1105], absolute[1030] values[270] in most embodiments will be the scores[270] outputted by each marker[1105] that is run. However some embodiments may prefer to output probability (of achieving the placement value[305] scores[270] instead or in addition. For relative[1040] scores, most embodiments will report pairwise ratios, and/or probability of randomness scores[270].

### Model-Related Markers[1125]

Model-related markers[1125] require the construction of models[680] that go beyond fairly straightforward comparisons and tallying. This is in contrast to the other classes of markers[110] present in most embodiments.

One common use of this class of marker[1125] is to detect omissions[690] of various kinds; the absence of content[320] cannot be detected without some kind of model[680] that says that the “missing” content[320] not only exists, but is likelier to be omitted by outlets[160] who have a particular bias[260].

A central underlying assumption is that content[320] which is dull, unimportant, repetitive, generally irrelevant or otherwise uninteresting will be ignored or removed by the vast majority of outlets[160], simply out of competence and basic commercial motivations. These are therefore not considered omissions[690] by almost all embodiments. However, when certain outlets[160] consistently provide specific content[320] that other outlets[160] in the same scope(s)[170] conspicuously do not, it can reasonably be said that these outlets[160] are deliberately omitting that content[320]. Otherwise put, these outlets[160] are making the editorial choice[210] to not present certain content[320] that is nonetheless clearly valued enough by other outlets[160] to use.

The models [680] used may be of different broad implementation types, sometimes even for the same marker[1125] in the same embodiment. This is because for specific cases of interest, users[800] may prefer to include a symbolic systems[550] approach, whether on its own, or in a context like supervised learning. (Note that such usage does not violate the system[180] design policy of avoiding bias[260] injection because the approaches in question are not being used to detect bias[260], or sentiment but rather to build broad CL models[1180,550] for general use, for example to identify statements[515] as unprovable.)

Most embodiments will use the most specific approach available for the given content[320]. For example, one marker[1855] in this class looks for cases in which quantities[1270] are interpreted or somehow referenced but not actually stated. This can be done purely on the basis of certain linguistic constructions, but can be done more accurately if the system[180] knows what numeric quantities[1270] to expect with respect to a given knowledge object.

One group of markers[1125] in this group deals with missing slots[520] in the frame-slot knowledge model[550] sense conceptually. In the case of complex stories[100] that are likely to have a fairly sizable number of frames [540] and slots[520], it would not be expected that every slot[520] is always mentioned or filled in every story[100]. For this reason, almost all embodiments will choose to evaluate whether or not a reference to a slot[520] is missing based on the set of stories[100] within the same media outlet[160] that share the same long news cycle[240] parent and occur within in a system[180]—specified sliding window of time[677]. We will refer to this as the set of overlapping stories[720], specifically stories[100] which overlap both topically and at least approximately in time according to the system[180]—specified definitions.

As already noted for the case of long new cycle[240] object creation, topical overlap can be determined by any topical categorization methods[1650] preferred by the individual embodiment, or any combination of them. Some embodiments may even choose to use something as simple as using the topic tags[1225] provided by the media outlet[160], inline[1227] and “related story”-style links[1230], if present. The overlapping in time part is trickier to define precisely, for a number of reasons. One issue is the potential online per-user customization of content[320] delivery; another is the presence of promotion mechanisms[1555] which may include but are not limited to: a link[1230] in one freshly posted story[100] to another slightly older story[100], whether embedded in the content[320] or an explicit “read next” link[1230] and a newsletter or other communication sent to the user which has the effect of making that older story[100] more accessible—and in placement value[305] schemes that rely on audience measurements, thus boosting the story's[100] placement score[305].

However for the purposes of the system[180] in this regard, for most embodiments it will suffice that two or more topically overlapping stories[720] were posted within a short time period, typically 2-3 days; most embodiments will have a system configuration[815] parameter for this purpose. This is because readers interested in a particular topic[240] can, on average, reasonably be presumed to view, read or listen to multiple stories[100] about that topic[240], and to remember key points, at least for a small number of days.

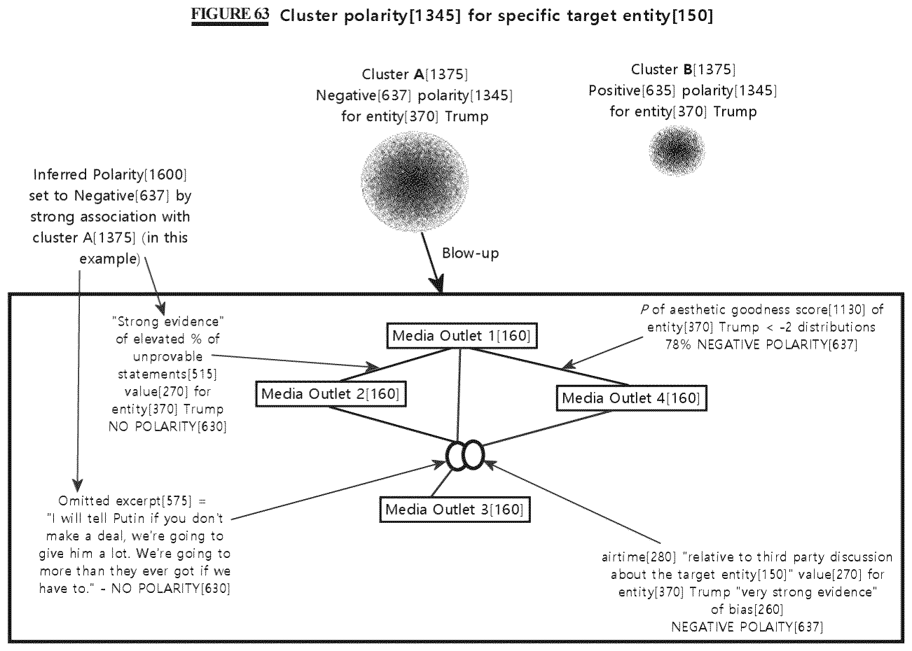

Model-related markers[1125] are not by themselves considered polarity[630]—bearing in most embodiments. This is because their purpose is to identify more complex patterns of manipulation, the pragmatic intent of which can only be known by placing the output[270] of these markers[1125] in the context of other editorial decisions[210] made by the given outlet[160]. Specifically, as shown in FIG. 63, the portions of the editorial choice profiles[215] related to user[800]—specified target entities[150] are fed into a clustering process[1340] (discussed in more detail in the relevant section) in which the different media outlets[160] are connected to one another for each shared (or, in many embodiments, highly similar) editorial decisions[210], and/or to shared decision[210] nodes that many of them[160] implemented, such as selecting certain excerpts[570] while consistently omitting others[575].

In FIG. 63, Cluster A [1375] contains media outlets[160] whose editorial decision profile[215] vis-à-vis Trump[370] were quite similar to one another—by definition of “cluster”, meaningfully more self-similar than to other outlets[160]. Some of these similarities unambiguously involve clear negative[637] polarity[630] marker[110] scores[270], for example a very low airtime[280] score[270], and constant selection of low aesthetic goodness scoring[1130] images[130] of Trump[370]. However, in the pictured simple example, one of two shared similarities is the constant omission[690] of a specific excerpt[575], the omission[690] of which made it appear that Trump would threaten Ukrainian President Zelensky, and not Russian President Putin.

Without assessing the semantics, or real-world calculus behind this particular choice[210], in most embodiments, this particular excerpt[575] choice[210] will be assigned an inferred polarity[1600] of negative[637] based on the overall polarity of the cluster[1375].

A default embodiment will use at least the following markers[1125] of this kind:

### 1. Pattern of Suppression of Specific Slots[530] [1865]

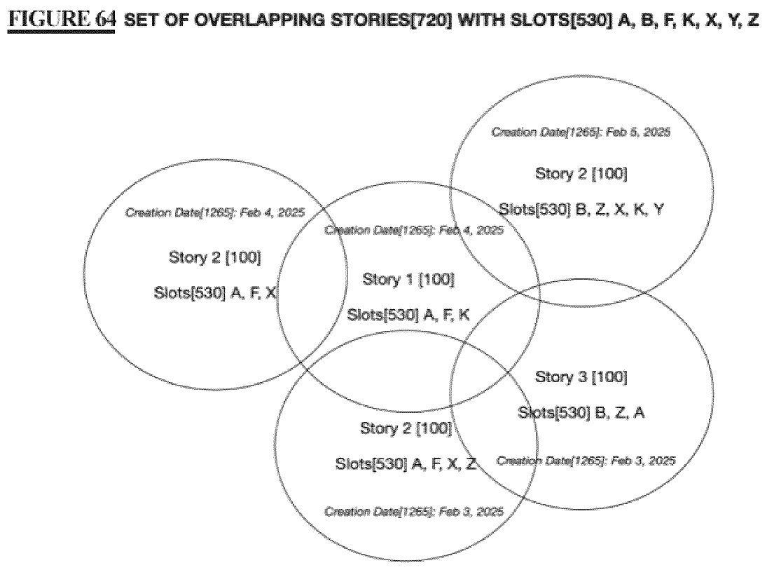

A good real world example of this is the following. Virtually all stories[100] about drone and missile attacks on Ukraine consistently note the number of drones and missiles that were fired—and perhaps even their types. Most stories[100] also mention and fill other slots[530] including but not limited to the number of buildings destroyed, and the number of wounded and dead (if any.) But only a few of them mention the next key logical point or slot[530]—all or almost all of the missiles and drones were shot down by Ukrainian air defense. This is a good real-world example, because a steady flow of stories[100] about aerial attacks on Kyiv without this mitigating fact would lead the audience the false conclusion that Kyiv has been reduced to rubble. (In fact, as of this writing, it is difficult to find damage from aerial attacks in many parts of Kyiv.)
   There are two logical cases of this. The first case assumes that the particular slots[530] are usually being ignored, at least in the case of a given news cycle[235]—and in many cases, more generally. The second case occurs when a given slot[530] is very often omitted for some specific entities[350] but not others. This second case is described under the next section.
   Different embodiments may use symbolic system[550], machine learning or LLM-style[1180] systems, any combination of these, or anything else of their preference in order to establish the expected distinct pieces of information[530] in a story[100] of type[695] aerial attack. These could correspond representations including but not limited to the following: slots[520] or the equivalent in a standard knowledge model[550], salient features[1175] as detected in an ML or similar model[1180], assertions[500] detected by the system[180] as described elsewhere in this document, or any combination of these. By “expected” in this case, we mean types of information that have at least a reasonably high probability of occurrence given the nature of the particular news cycle[235]. We will use the term “slot” [530] for simplicity, regardless of the means of its provenance.
   When knowledge models[550] are used, they effectively provide a template for particular types of stories[100] that differs from a long news cycle[240] in that it is used for stories[100] about specific types[695] of events[340], regardless of who or what is involved. For example, a knowledge model[550] would provide the system[180] with the slots[520] to be expected in any story[100] about an aerial attack anywhere. Feature[1175]—detection models[1180] can be trained to perform the same type of labeling. Regardless of the derivation strategy in the particular embodiment, we will refer to this as the type[695] of story[100]. However, despite stories[100] about aerial attack events[340] in Ukraine and in Saudi Arabia sharing the same type[695] of “aerial attack”, they are usually unrelated news cycles[235]. The differences in the named entities[350] appearing and their respective number of mentions[310] between Ukrainian and Saudi-related stories[100] will be large. Thus, type[695] may, or may not, correspond to one or more long news cycle[240].
   A certain amount of variation will naturally exist among individually stories[100] with the same short news cycle[230] and/or type[695], even if simply due to lack of space or time to state every pertinent fact. In other words, not all pieces of information[530] that logically could or should appear in a particular type of story[100] will. For example in this case, perhaps the exact number of drones or missiles used is not considered critical information by a particular reporter; perhaps it was also not fully known at the time of publication of a given story[100]. Perhaps victims were not mentioned because there were none from a particular attack. There are a large number of possibilities in this regard, and these should not be conflated with bias[260].
   For this reason, this marker[1865] measures the markedly consistent or total absence of a particular slot[530] by a media outlet[160] even as it appears in the same timeframe[670] the same type of stories[100] in other outlets[160] of the same scope[170]. Note that most embodiments will consider assertions[500] to effect that something is currently “unknown” or “unavailable” as a valid filling of the slot[530] in question. This will be simply implemented by many embodiments by requiring the relevant references or keywords from the model[550, 1180] (e.g. victim, missile, etc.) plus language that expresses unavailability of information. This is because the primary point of the marker[1865] is whether the slot[530] in question is mentioned at all, not how well it is specified.
   This marker[1865] is calculated in a default embodiment as follows. First, compare the set of stories[100] for which one of the types[695] is aerial attacks (in this example) and where the entity[350] is in this example Ukraine, across media outlets[160] of the same scope[170]. Each story[100] is scored with the number of occurrences of the each slot[530]. In a default embodiment, this will be −1 if the slot[530] is entirely absent, “0.5” each time that the slot[530] is referenced but without a value[535] and “+1” for each occurrence of that slot[530] filled with a value[535] in the story[100]. However different embodiments may make different choices, depending on how much value they assign to a slot[530] value[535] being present.
   As already noted, most embodiments will consider the unit of measurement to be the set of overlapping stories[720] in the same media outlet[160] as the bounding story[100]. This is to avoid misleading marker[1865] measurements owing to multiple stories[100] on the same news cycle[235] being present in the same outlet[160] which collectively but not individually include and fill most or all of the expected slots[530] for the combination of news cycle[235] and type[695]. A simple example of this is shown in FIG. 64. All pictured stories have creation dates[1265] within an example 3-day window. While no single stories[100] contain all of the expected slots[530] on their own, collectively they do. Some slots[530] appear in most stories[100], one slot[530] Y appears only in one story[100]. No slots[530] appear in all stories[100].
   Note that while this is a distinct usage of overlapping stories[720] from the long new cycle[240] creation one, in many embodiments the method of determining overlapping stories[720] will be the same—with the exception that all stories[100] in the overlapping set[720] must be in the same media outlet[160]. In addition, some embodiments may use a different sliding window[677] for overlapping stories[720].
   Next the scores[270] for each slot[530] for each story[100] with the news cycle[235] in question in each media outlet[160] are added up for each media outlet[160] being analyzed during a particular time window[670]. Most embodiments will discard media outlets[160] with a number of stories[100] on the particular news cycle[235] that are too low according to a system configuration[815]—provided threshold; some of these will also use simple metrics such as total word[900] count in each story[100] as a means of estimating the amount of content[320] provided by the outlet[160] in this regard.
   Most embodiments will use statistical tests for randomness of distribution and score accordingly.
   In almost all embodiments, the more slots[530] relative to the combination of type[695] and news cycle[235] (assuming that a type[695] has been defined) are being suppressed by a given media outlet[160] within a given window of time[670], the greater the evidence of bias[260] in the given instance. So long as this guiding principle is observed, different valid embodiments will make different choices in how to score[270] this marker[1865]. For example, some embodiments will choose to consider one or more types of placement[300], not only whether or not a slot[530] appeared.
   Unless modified by the user[800], by default the time window[670] will be the creation date[1265] of the first story[100] associated with the long news cycle[240] in question to the present moment if the system[180] is operating in continuous mode. If in retroactive mode, by default in most embodiments, the window[670] will end with the life span[750] of the relevant long news cycle[240].
   In the case in which there is no long news cycle[240] present, some embodiments will use a system[180]—defined parameter to use for the time window[670] when the particular type[695] is being applied. For example, an initial story[100] about an earthquake that just occurred may not yet be assigned to a news cycle[235]. But the story[100] would nonetheless immediately be identified as having a type[695] of “earthquake” by whatever topical detection mechanism is being employed by the particular embodiment. Since the expected slots[530] and slot values[535] for earthquakes likely change only very slowly if at all, the default window[670] defined in such cases will be quite long; some embodiments may simply allow the window[670] to include all data[1435] available to the system[180].
   Most embodiments will be continuously be evaluating incoming content[320] so that empirically-driven models[1180] can be updated appropriately. For example, perhaps a new aerial weapon begins to be used, or chemical attacks become common. Or perhaps certain weapons become obsolete and their use ceases. Likewise users[800] may update knowledge models[550] used by the system[180] with new frames[540] and slots[520] to reflect new incoming content[320].
   Most embodiments will have some discontinuity test that results in the time window[670] being restarted if significant changes have occurred in either/both the knowledge models[550] (if present) and/or the content[320]—and hence any empirical models[1180]. These tests can include but are not limited to: number or percentage of new slots[530] added or discovered and number or percentage of slots[530] that have fallen into disuse across the vast majority of relevant media outlets[160].

### 2. Comparable Treatment of Referencing and Filling Slots[530] in Stories[100] Sharing the Same News Cycle[235] and Type[695] [1850] in Scoped Media Outlets[220].

To extend the previous example, Ukraine also conducts aerial attacks against Russian facilities with drones and sometimes missiles. However, on certain media outlets[160], it was reported with great consistency that the Russian military managed to shoot down most or all of the Ukrainian drones, while they did not report the fact that the Ukrainians likewise were shooting down most of the Russian drones attacking Ukraine.
   Specifically, stories[100] of the same type[695]—in this case, aerial attacks—that are also part of the same news cycle[235]—the war in Ukraine—by definition involve the same entities[350] in a bounded time frame, and therefore have the same slots[530] and possible values[535] at any one time. Such stories are therefore directly comparable with regard to which slots[530] they mention, and whether or not values[535] for the slots[530] are provided in a story[100].
   The value of this marker[1860] is determined in a default embodiment in the same way as the slot suppression one[1865], with two added steps. First, subject[920]/object[930] analysis will be applied so as to ascertain whether Ukraine or Russia (in this example) is the subject[920]—in other words, which of the two named entities[350] is doing the attacking, and which is being attacked. Some embodiments may decide to add further CL methods beyond POS tagging[1585] to be even more accurate in this regard. Next, each media outlet's[160] treatment of the two entities[350] (in this example, Ukraine and Russia,) in stories[100] of type[695] aerial attack in news cycles[235] about the long news cycle[240] of the war in Ukraine will be compared to see whether any statistically significant differences in consistently unreferenced or unfilled slots[530] exist between them. Most embodiments will otherwise use a simple scoring as indicated in the prior section. This analysis is statistical, and so obviously can only be performed with sufficient data. If the data is lacking, the value[270] of the marker[1860] will be “NULL” in most embodiments.
   If such a significant difference is found within the same media outlet[160], it would generally be “strong evidence” of bias[260] in most embodiments, since the same journalistic standards should be applied regardless of the identity of the entity[350]. This is perhaps most clearly seen in the case of favorability ratings being consistently provided for one politician but his opponent in a story[100] about an election. However, it is equally relevant for a single outlet[160] in the context of a scoped media set[220]. For example, it can logically be expected that Russian media will stress their victories rather than their defeats.
      3. Lack of Quantification where Quantification is to be Expected[1855].
Certain types[695] of stories[100] simply demand some key numbers[1270] so that sense can be made out of them. Some simple examples of such stories[100] include but are not limited to:
   Earthquake magnitudes
   Amount of snow or rain, if causing shutdowns, federal emergencies, etc
   Sports team game results
   Election outcomes
   Health outcomes
   It would indeed be strange for example to see a major news bulletin about an earthquake without its magnitude at least being estimated somewhere within the story[100]. Or a story[100] about a final election outcome that did not provide any concrete numbers on votes cast. (However, in the run up to elections, just the reverse may occur, in an attempt to spin reality.)
   For example, a statement such as “DeSantis has now lost considerable support,” but not providing any numbers, polls, etc., so the reader is left to interpret a vague term such as “considerable” and to wonder about the timeframe, the size, timing, and number of the polls—and whether the assertion[500] is even being made on the basis of specific polls.
   More importantly, sometimes numbers[1270] left to the imagination can cause people to make very bad decisions. For example, a very slight increased risk of cancer or death is a very different thing than a substantially increased risk.
   The bias[260] determination comes in when numbers[1270] with respect to a given target entity[150] are deliberately and consistently withheld by a given media outlet[160] for some reason. For example, a media outlet[160]—especially a state-owned one—may regularly report details on unemployment or inflation numbers in some other country but avoid doing anything beyond vaguely characterizing for their own because it would paint a politician they support in a poor light. Usage of interpretative terms for this sort of obfuscation when the quantity[1270] in question remains unstated include but are not limited to: slight, substantial, considerable, (in)significant, excessive, limited, negligible, reduced and many others.
   In a default embodiment, any knowledge[550] or empirically-driven models[1180] used by the system[180] in a given embodiment will be utilized to identify expected but missing numeric values[1270]—in other words logical slots[530] with numeric values[535]. This allows logically “missing” numbers[1270] like Richter scale value for earthquakes to be identified even in the absence of any linguistic hints that a quantity[1270] was to be expected.
   Almost all embodiments will flag missing quantifications[1270] even without any kind of knowledge model[550] or machine learning one[1180] for the type[695] of story[100], or indeed any conception of the topic at hand or its semantics. For example, linguistic constructions that suggest a reference to quantities[1270] because of the presence of specific quantity[1270]—related words[900] can be used as hints that an expected quantity[1270] is missing. Such constructions include but are certainly not limited to the following:
      The X is growing
      The level/amount/index of Z has changed
      Q is now more/higher/lower/greater/lesser than B
      The rate of D is currently
      The P went up/down

Some embodiments may opt to use very simple empirically-derived knowledge models[1180] that indicate for example that a stock has a (price) value associated with it and that unemployment has a level—even without any semantic understanding of what the values signify. Such very simple models can be easily trained because all they require is detecting the frequent co-occurrence of a specific keyword or reference[1620] and a numeric value[1270] within N tokens[900].

In a default embodiment, the value[270] of the marker[1855] is determined by scanning the text or speech-to-text content[120] of each story[100] featuring each target entity[150] in any scoped media outlet[220] within the desired time window[670] looking for missing quantifications[1270] with the most precise models [550, 1180] available to the system[180] for this purpose for each type[695] and news cycle[235]. By “featuring” we mean that the particular entity[350] can be considered the dominant entity[355] featured in the particular story[100].

In a default embodiment, this is the entity[350] with the highest overall placement score[307] in the story[100] (that is, as described in the section on Placement[300], overall placement score[307] is the set of mentions[310] of the entity[350] in the story[100] each multiplied by its placement value[305] within the story[100].) Most embodiments will allow there to be more than one dominant entity[355] in the event that their overall placement[307] or other measure used for this purpose are the same. Some embodiments may also decide to evaluate this marker[1855] purely on the basis of news cycles[235], without any relation to any target entity[150].

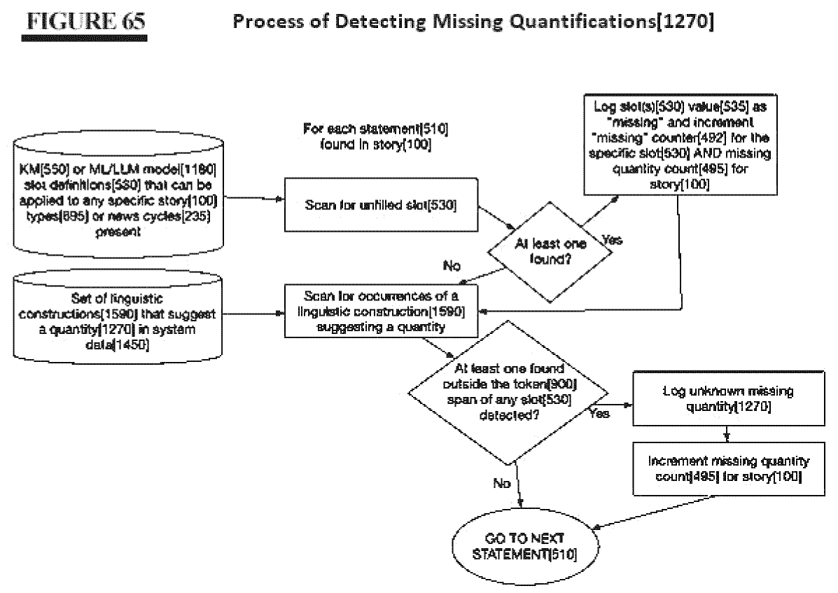

One such embodiment is shown in FIG. 65. Each missing quantification[1270] is tallied by slot[530] by story[100], scanning statement[510] by statement[510]. Most embodiments will seek a missing quantity[1270] in at least the N+1th statement[510]. Next, any instances of non-overlapping-in-tokens[900] linguistic constructs[1590] with any detected slot[530] references are sought. Any that are found are totaled with the count[492] for missing slots[530] to produce the overall count of missing quantities[1270] for the story[100].

For most embodiments that try to associate this marker[1855] with entities[150], the same process is performed on other target entities[150] in the same equivalence class[450], for comparison purposes. Finally, a statistical test of the embodiment's choice will be performed to determine whether or not the differences among media outlets[160] with respect to their absolute treatment of the particular target entity[150], and with respect to that target entity[150] relative to other entities[350] in the same equivalence class[450] or group[460]. The result of the one or more statistical tests used will determine the scores[270] of the marker[1855]. Some embodiments may treat the results of these absolute and relative outputs as separate markers[1125].

Since the above is only an estimation performed with a fairly simple method, some or even many embodiments may prefer to perform more NLU processing in order to more correctly assess the specific entity[350] in relation to the missing quantity[1270]. However, as a practical matter, patterns of missing quantifications[1270] are less likely to be observable within a single story[100] as opposed to among different stories[100] in the same outlet[160] or stories[100] appearing in different outlets[160]. This is because providing quantities[1270] for some target entities[150] and others in the same equivalence class[450] but not others within the same story[100] is somewhat obvious bias; consider the inappropriateness of a story[100] that noted how many electoral votes one presidential candidate had already locked up but not the other.

Other types of markers[1125] appearing in a default embodiment include, but are not limited to the following:

### 4. Pattern of Suppressions[690] of Entire News Cycles[235] [1870]

A form of censorship, whether or not self-imposed, occurs when stories[100] on specific news cycles[235], or assertions[500] related to one or more news cycles[235] involving a particular target entity[150] simply do not appear in a given media outlet[160] or barely appear—not even so as to be refuted. As elsewhere, the system[180] is able to detect the absence by dint of the fact that the content[320] appears in other media outlets[160] of the same scope[170]. It is worth noting that even in the case of a news cycle[235] that is considered highly suspect by a given editor, and therefore arguably not “news”, just the fact that it has established a noticeable footprint in other outlets[160] with the same scope[170] means that it would be reasonable—and even expected—for the editor to try to debunk it. In embodiments that support the notion of “comparable” outlets[1525] as defined by a user[800], suppressions [690] can be assessed against the comparable outlets[1525].
Attempts to debunk particular assertions[500] considered dubious would of course lead to some version of the assertion[500] appearing in his or her outlet[160]. (Note that an outlet[160] trying to debunk an assertion[500] that is in fact true would be a form of bias, but not the type of bias[260] identified by the system[180] which is unable philosophically to determine ground truth. However, such attempts in many cases could end up being themselves identified as a class of assertion[500].)
This marker[1870] is distinct from the marker[1865] involving missing slots[530] because slots[530] however calculated are effectively attribute-value pairs associated with an object. For example, attacks have victims which have a quantity associated with them.
Assertions[500] by contrast can be literally any statement[510] of fact. The universe is infinite. Although a set of core assertions[500] constitutes the basis for a story[100] in much the same way as a basis for a matrix in mathematics, the universe of just the assertions[500] that appear in stories[100] relating to a long news cycle[240] is extremely large. In other words, it is a long tail distribution. By contrast, in formal knowledge models[550], slots[520] are generally only defined for attributes of value; frames[540] are likewise only defined for objects of value. Most systems that are isomorphic to statistical approaches will concern themselves with detecting salient features[1175].
However, since the purpose of this marker[1870] is to detect when one or more individual assertions[500] are largely or totally absent from one or more media outlets[160] that also is likely to be fairly low frequency even in other outlets[160] the approach must be a bit different. This is because the system[180] must differentiate between low frequency and total absence. For this reason, many embodiments will score only whether the assertion[500] occurred in a given media outlet[160] at all for a short news cycle[230], and among overlapping stories[720] in long news cycles[240] in an analogous way to how missing slots[530] are handled. In other words, assertion[500] presence will be treated as an asymmetric variable.
It should be noted that many mundane factors govern whether or not a given assertion[500] is included in a particular story[100] or even a media outlet[160]. These include, but are not limited to: different media outlet formats[440] which allow for varying numbers of assertions[500] to be presented owing to space or time limitations, media outlets[160] that are not so easily scoped[170], and how much competition there was for placement[300] on a given day because of the volume of new short news cycles[230].
Note that there may not always be a clear logical connection among the different news cycles[235] or assertions[500] that are being suppressed. Apart from being about the same target entity[150], the stories[100] or assertions[500] may not be similar under most metrics such as near-duplicate, topic detection, various edit distance metrics or other lexical similarity measures. The key computationally observable commonality is their absence from one or more media outlets[160] for a sustained period of time while at the same time being meaningfully present in others[160]. Some embodiments may choose to consider consistently poor placement[300] of the assertions[500] or stories[100] as being effective absence. In other words, the assertions[500] are buried where relatively few even astute readers will ever find them. These embodiments will set maximum placement values[305] for different formats[200] below which the placement[300] will be considered poor via a system configuration parameter[815].
A compelling real-world example of this phenomenon of suppression occurred in the attempts by many American media outlets[160] to hide Biden's decline in various respects during his presidency. “Decline” is an abstraction that expresses itself in various practical ways—for example, physically stumbling, becoming visibly disoriented, making inappropriate comments, becoming easily angered, and mumbling to name just a few—any of which can reasonably be associated with a variety of different root causes. And some specific events[340] such as Biden refusing to take a cognitive test could be considered evidence of decline by some editors, while others might not consider it so.
Otherwise put, even if their editorial aims were the same, absent collusion[650], the exact interpretations and treatments of such ambiguous events[340] will vary somewhat by outlet[160]. Thus, the key commonality (other than “Biden” as the central entity[355]) is that despite the fact that numerous short news cycles[230] as well as analysis pieces[610] in some media outlets[160] contained relevant assertions[500] these assertions[500] were almost wholly absent from many media outlets[160] during an extended period of time.
Note that most embodiments will provide a system config[815] parameter for “acceptable delay” in reporting an assertion[500] or initial story[100] on a news cycle[235] appearing in a given outlet[160]. (As noted in the section on omission[690] detection, computationally this will result in a co-omission[685].) This refers to the case in which a small number of outlets[160] initially break a story[100], and/or provide one or more new assertionsl[500], and it takes some period of time for other outlets[160] of the same scope[170] to pick it up. Of course, not all stories[100] or assertions[500] will ever appear in all media outlets[160] even with the same scope[170]. Many short cycles[230] will simply vanish, with only having appeared in a small number of outlets[160]. Therefore many embodiments will only consider that suppression[690] can occur in the case of short news cycles[230] that are associated with long news cycles[240]. This is because long cycles[240], by definition are composed of different but related short cycles[230] that occur over some period of time, and therefore should reasonably be considered as newsworthy.
The more shared omissions[690] different media outlets[160] have in common, the system[180] will consider that the amount of evidence is greater that they are each suppressing content[320] that they find to be undesirable in some way. In the implied collusion detection step[1425], in most embodiments, synchronicity[1430] in the timing of changes of omissions[690] is considered likely evidence of collusion[650]. (Note that since, by definition, in this scenario, the thing in question was being omitted, it was known and covered by other outlets[160] of the same scope[170]. Therefore, it cannot be a case of “new” facts being genuinely discovered, hence the concept of “co-omission[685].)
It is important to note the critical importance of the marker[1870] being relative to particular target entities[150] for it to be of value. Surely, for example, outlets[160] that suppressed the various news cycles[235] relating to Biden's decline did regularly during this time carry stories[100] with detailed assertions[500] about the age-related impairments of other public figures[370]. In the event that for a given audience, whole topics are taboo regardless of what named entity[350] it concerns, almost all embodiments will not consider it bias[260], because it is equally applied regardless of the identity of the entity[350].

### Assertions[500]

A short news cycle[230] that is associated with a story[100], is a container of assertions[500] (as well as other types of statements[510] as well as possibly embedded components[190].). As described in US Patent US-2024-0070458-A1, assertions[500] are linguistically statements of fact. By this we mean that they are (at least in theory) refutable statements, as opposed to predictions, subjective, normative, prescriptive, questions, and a wide variety of other statements. (See the section on the Unprovability Marker[1780] for a longer list of such statement[515] types.)
In most embodiments, the placement[300] of assertions[500] is determined in the same way as for just simple references to entities[350]. The added difficulty with assertions[500] is detecting when, for example, an abbreviated version of an assertion[500] is squeezed into a headline[970], chyron[620], sub-headline[975], image[130] caption[135] or other very space-limited place. However, identifying statements[510] as being instances of particular assertions[500] is an imperfect process to begin with, since it can be somewhat arbitrary whether there are two logically adjacent assertions[500] or two slightly different instances of the same assertion[500]. Because in most embodiments, assertions[500] are treated much as slots[530] are, in the sense of the main point being that a given thing was at least mentioned rather than whether the slot[530] is filled, this bounded level of arbitrariness will be considered acceptable. In most embodiments, the placement[300] of an assertion[500] will be based on its starting position, in the event that it spans more than one section[330] or region[335]

### Identifying Assertions[500]

In most embodiments, the set of unprovable statements[515] is removed from the set of statements[510] to process as potential assertions[500]. In most embodiments, the remaining sentences[910] and sentence[910] fragments will be considered assertions[500] if they minimally:
Contain a reference[1620] to more than one entity[350], as well as at least one named entity linguistically[1690] that is not an entity[350]. This includes but is not limited to locations[1535], dates[1540] and leaderless or non-organizational collections of persons[370] (e.g. “cancer patients.”)
Contain at least one verb phrase[1490] that is identifiable with a POS tagging[1585]

The next question is whether two provable statements[510] are instances of the same logical assertion[500] or are two different, if related, assertions[500]. In order to avoid both full NLU processing and the injection of subjectivity, some embodiments will cluster[1340] with their preferred clustering method[1240] only on the basis of the shared entities[350] and other named entities in the statements[510], and a date/time stamp of the bounding story[100]. The exception to this in many of these embodiments is the case of an assertion[500] which asserts a quote[560] attribution [567]. In this event, most embodiments will use the same quote attribution process[568] as it uses elsewhere. However, some embodiments may prefer to use inverted word order tables or similar approaches in order to cluster[1340] on the basis of uncommon words that are not proper nouns. Other embodiments may choose N-gram-based approaches.

The date/timestamp is important because two statements[510] that appear in close temporal proximity to one another and which by definition share multiple entities[350] and other entities are much more likely to be referring to the same real world thing than if the statements[510] appeared at considerably different times from one another.

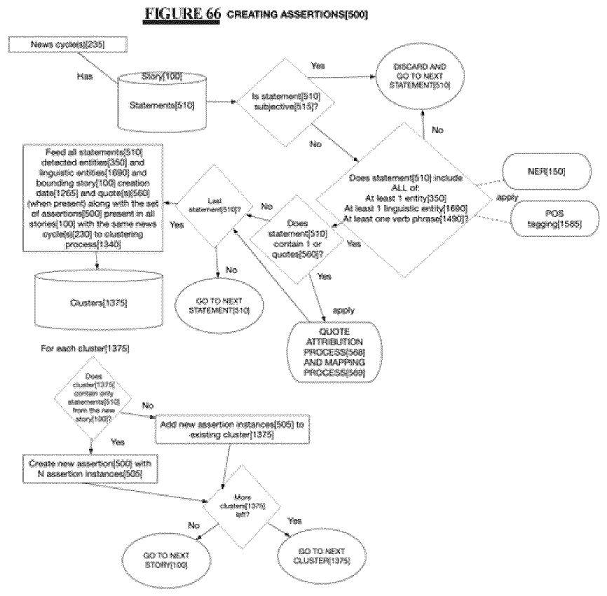

Statements[510] that end up in the same cluster[1375] will be bound to the same assertion[500]. If it is a cluster[1375] which contains only one or more instances[505] of assertions[500] from the newly processed story[100], a new assertion[500] object will be created. If a cluster[1375] also includes previously identified assertions [500], the new assertion instances[505] will be assigned to that assertion[500]. In a default embodiment, it will have attributes that include but are not limited to the following: UID, human readable name derived from summarization[1593], initial appearance date/time, and referenced entities[350]. A simple embodiment of this is shown in FIG. 66.

It should be noted that full NLU of the assertions[500] is not considered necessary or even desirable by most embodiments. Coarse-grain bucketization of assertions[500] may be preferred by many embodiments because they may be less prone to both outright error and arbitrary boundary-setting between similar assertions [500]. This is similar reasoning to the idea that even the reference to a slot[530] without a value[535] being meaningful—that it is explicitly noted that there were victims is more important in most cases than quantifying the number of victims. Furthermore, trying to accurately extract subtleties of expression in these assertions[500] is beyond current NLU capabilities as of this writing—and is very computationally expensive. Rather, the need is only to establish that Assertion A[500] is similar enough to Assertion B[500] so as to be considered within the same bucket of assertions[500] for the given purpose.

It is also important to note that many embodiments will not try to assess negation within assertions[500] for this purpose. There are two reasons for this. The first reason is that assessing negation is a very tough problem if the goal is high accuracy. For example, a pragmatic intent of negation can be achieved with a given target audience purely by making a historical or cultural analogy that they will understand. For example: “Person X is as honorable as Putin.” It cannot be assumed that all such historical and cultural knowledge will find its way into an LLM for example, especially globally. Further, outright negation is not the only relevant thing; rather in most cases there are a large number of shades of gray. Reality is often uncooperatively murky. Secondly, the intended purpose in most embodiments is simply to establish whether or not a particular assertion[500] has been referenced at all in a given story[100] or media outlet[160].

An excellent real-world example of the somewhat limited value of detecting negations again comes frOm Biden's cognitive decline. Initially, there were assertions[500] in (only) some media outlets[160] as to his failing capabilities—and otherwise for the most part, silence. Eventually, members of Biden's administration began to refute these assertionsl[500], with the refutations receiving broad coverage even in those outlets[160] which had previously suppressed the topic[240]. However, the attempts to refute it put and kept the topic in the news, and so in the public view.

Why it is useful to decompose stories[100] into assertions[500] and other types of statements[510] is best illustrated with a real-world example. As of this writing, President Trump has expressed the desire to buy Greenland from Denmark. A large number of stories[100] have been written about this in many different outlets[160]. The vast majority of the stories[100] that appeared in the recent aftermath of his comments contain some basic assertions[500] which generally initially include the following:
Greenland is a long-time territory of Denmark
Greenland's population is largely Intuit
Greenland may want to be independent from Denmark.
Greenland has military importance. (There is a strategic US military base (Pituffik Space Base, formerly Thule Air Base) situated on Greenland
   as well as quotes[560] from various Danish government people objecting to such an idea, quotes[560] from the leader of Greenland and of course quotes[560] from Donald Trump and other world leaders. Many of these quotes[560] were of a highly emotional and/or subject nature, and most had a very clear (negative) sentiment polarity[630]. Most of these statements[515] expressed contempt for the notion of such a purchase. A much smaller percentage expressed support for it for military reasons in an “increasingly dangerous” world.

(On the point about independence, a spectrum of statements[510] can be found. As is often the case in such independence issues, without an actual election, it can be very difficult to discern what is actually true. This is a good example of why most embodiments will content themselves with establishing that a statement[510] that contains references to “Greenland”, “Denmark”, and “independence” within this time period is sufficient to mark the assertion[500] about the above point as being present in the story[100].)

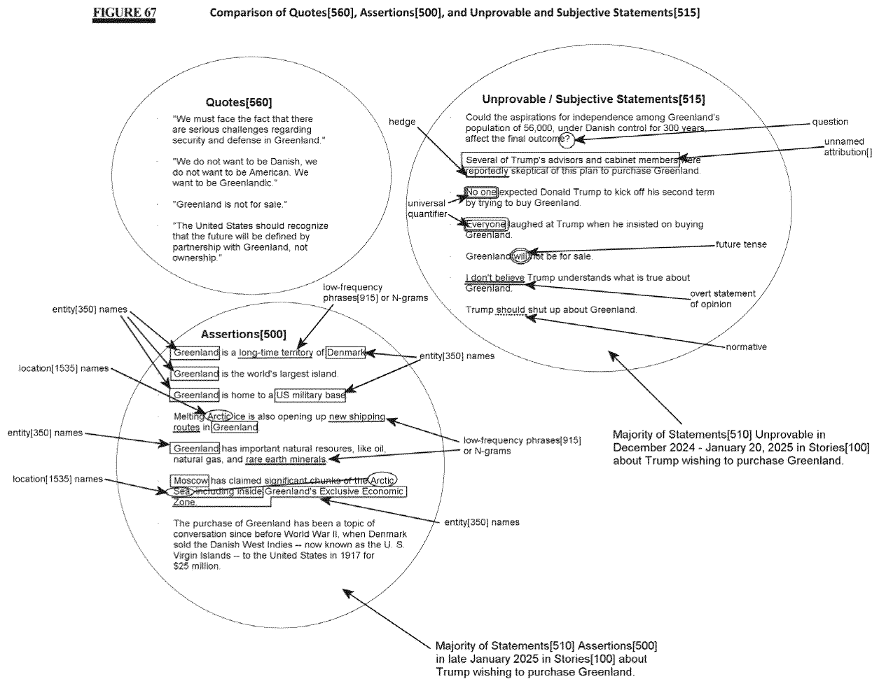

As shown in FIG. 67 the largest percentage of sentences[910] at the start of the news cycle[240] involving the possible purchase of Greenland were initially subjective statements[515] of many different forms. This is illustrated in FIG. 67 which shows three classes of statement[510]: quotes[560], unprovable statements[515] and assertions[500]. The relative sizes of the circles indicates the rough original proportion of statements[510] of the different types. In each circle are some representative examples of statements[510]. In the case of the unprovable statement[515] examples, labels of the different types of subjective expression strategies are indicated.

Some stories[100] included further assertions[500] about the strategic value of Greenland, for example its geographic location, mineral and sea rights. Others spoke of the small size of its population, and provided various demographics. Still others spoke of its natural beauty, climate change-related issues, and provided some human-interest details about its history. Once the more key assertions[500] have been made, such variance is entirely normal.

But only a sliver of these stories[100] contained assertions[500] involving the fact that Trump is not the first US president who publicly expressed the desire to purchase Greenland.

Two prior presidents did the same, Andrew Johnson and Harry Truman. As the WSJ reported:
“In 1946, under President Harry Truman's administration, the U.S. made a formal offer to purchase Greenland from Denmark for $100 million in gold. Denmark declined.”

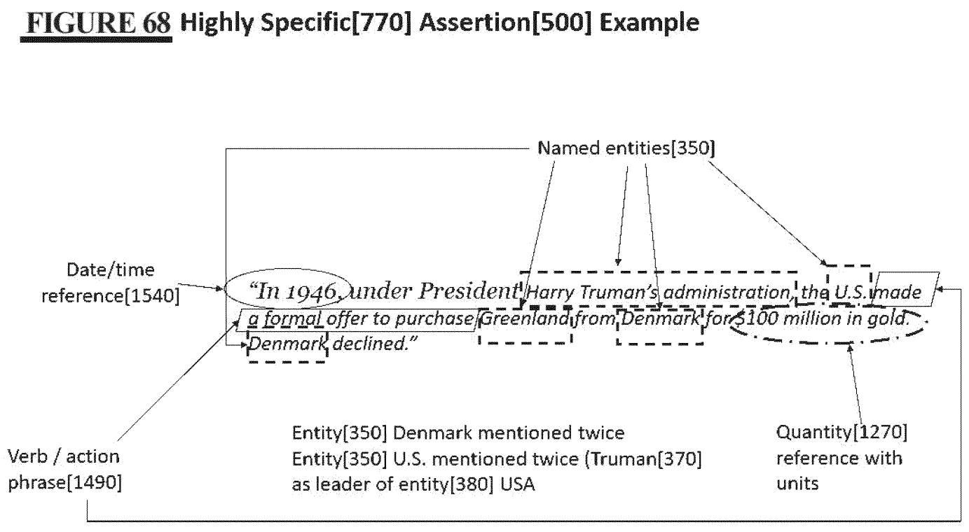

As shown in FIG. 68, this is a good example of both what will be referred to as a co-omission[685] and an assertion[500] with high specificity[770]. It contains multiple named entity references[350], a reference to a date, and describes an action. It is distinctive. But even less detailed assertions[500] would, in most embodiments, be placed in the same group of assertions[500]—for example “Truman also wanted to buy Greenland.” This is because by 2025, references to Harry Truman, who was US president from 1945-1953, are uncommon—and even more so when coupled with Greenland. And more so still in the context of the set of statements[510] occurring in a short news cycle[230] related to Trump's comments on Greenland many years later.

A further such historical assertion[500] emerged as the ratio of assertions[500] relative to unprovable statements[515] increased:
The purchase of Greenland has been a topic of conversation since before World War II, when Denmark sold the Danish West Indies—now known as the U.S. Virgin Islands—to the United States in 1917 for $25 million

In other words, a third prior US president had actually purchased territory from Denmark—for national security reasons, during the time period of World War I.

These two are also good examples because they are relatively low frequency assertions[500]. This is in part because it is historical fact being provided for context, obscure but highly relevant. Their inclusion is a classic example of editorial decision[210]. However, frequency of occurrence does not always correlate to importance. Regardless of what one thinks of the merits of Trump's proposition, failure to report that the idea has not one but in fact three historical precedents with other US presidents despite doing many stories[100] on the topic is manipulation.

While the exact real-world reasons for it are unknowable, over the first few weeks of the Greenland purchase news cycle[240], the ratio of assertions[500] to subjective statements[515] notably grew, as it seemed to become generally acknowledged that at least the reasons for theoretically wanting to buy Greenland were rational. This is illustrated in FIG. 67. Thus in this example, using the score[270] of ratio of subjective statements[515] to assertions[500], an implicit change in sentiment towards the idea of buying Greenland can be detected by the system[180] (at least as far as whether the motivations are sensible, rather than whether the goal of purchasing Greenland is or should be achieved.)

The output of this marker[1870] in most embodiments is an array of assertion[500], assertion instances[505] (in the event that more than one instance[505] of the same assertion[500] appears in the same story[100],) and stories[100].

The key point is that without performing any kind of sentiment analysis or deep parsing, the editorial choices[210] of which assertions[500] to include and which accomplishes the task of detecting not only de facto sentiment towards both entities[350] and policies, but more importantly, bias[260].

### 5. Biased Editing Marker[1875]

### Introduction

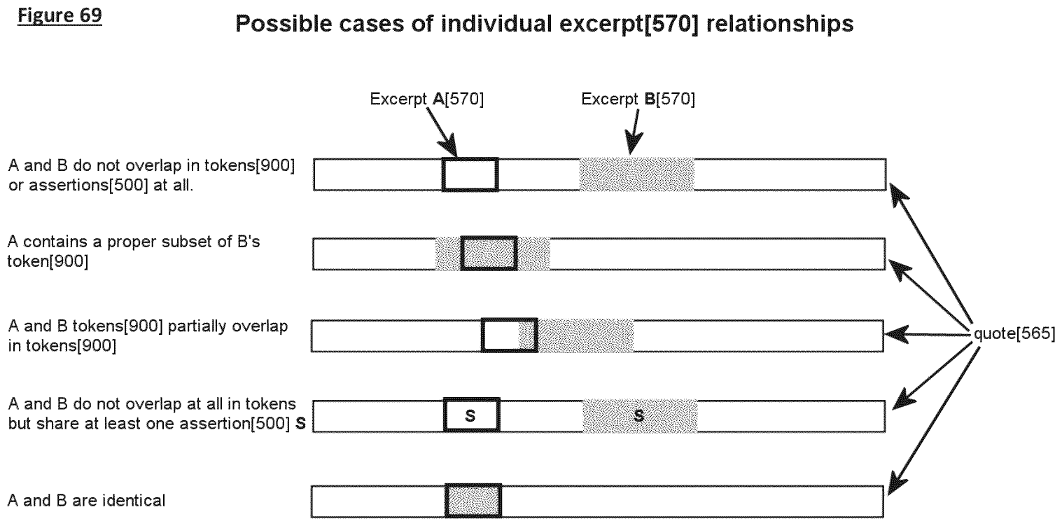

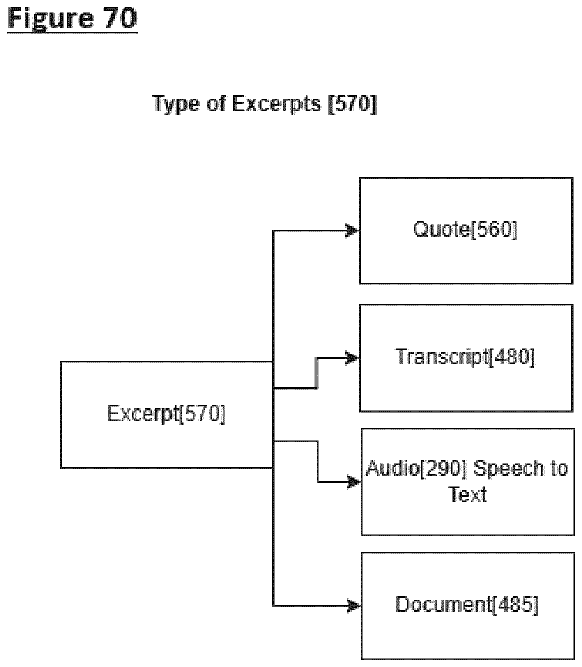

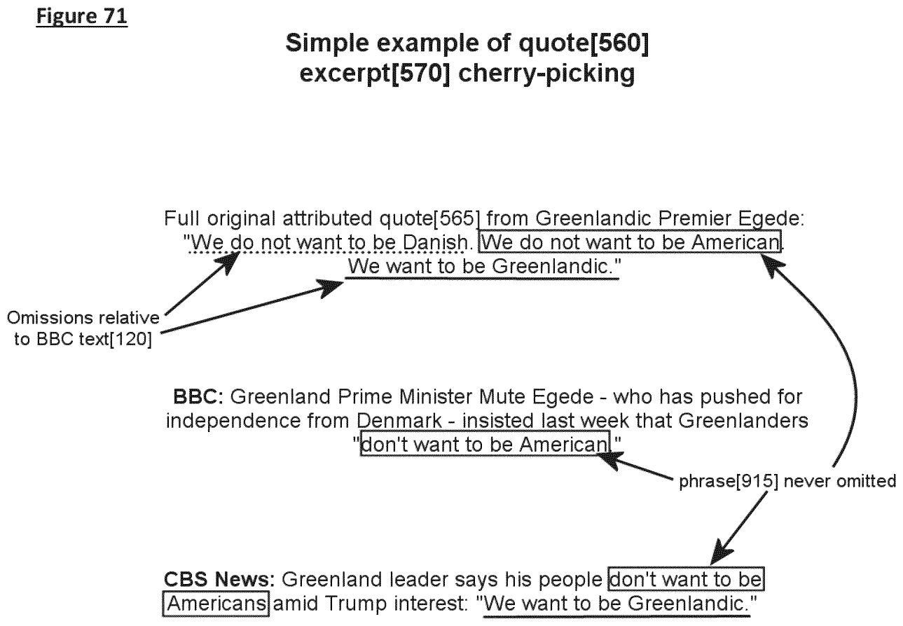

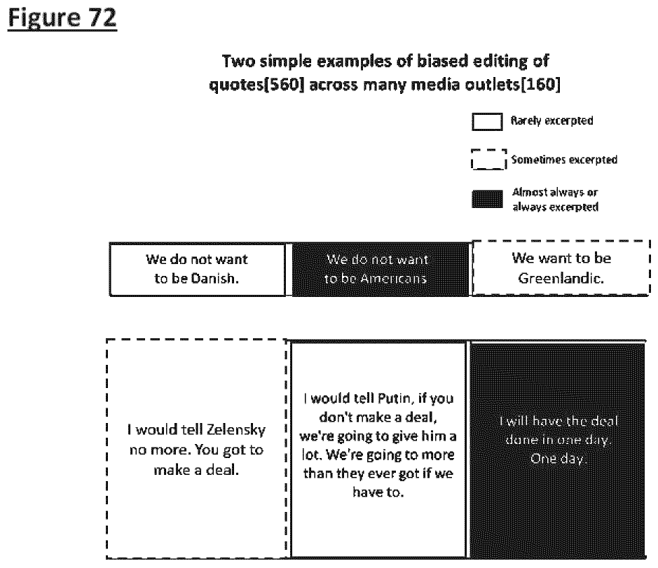

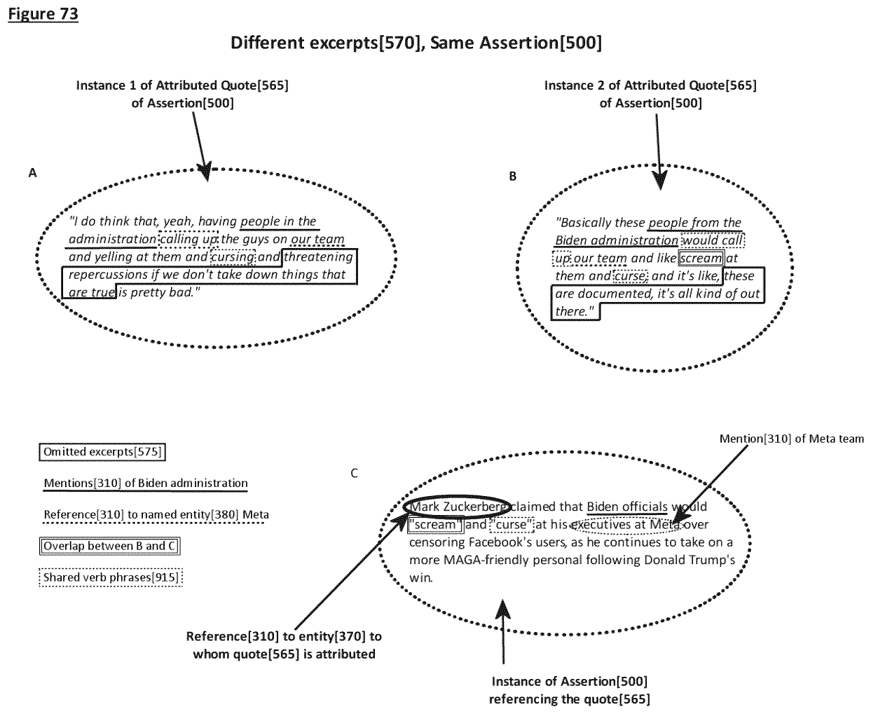

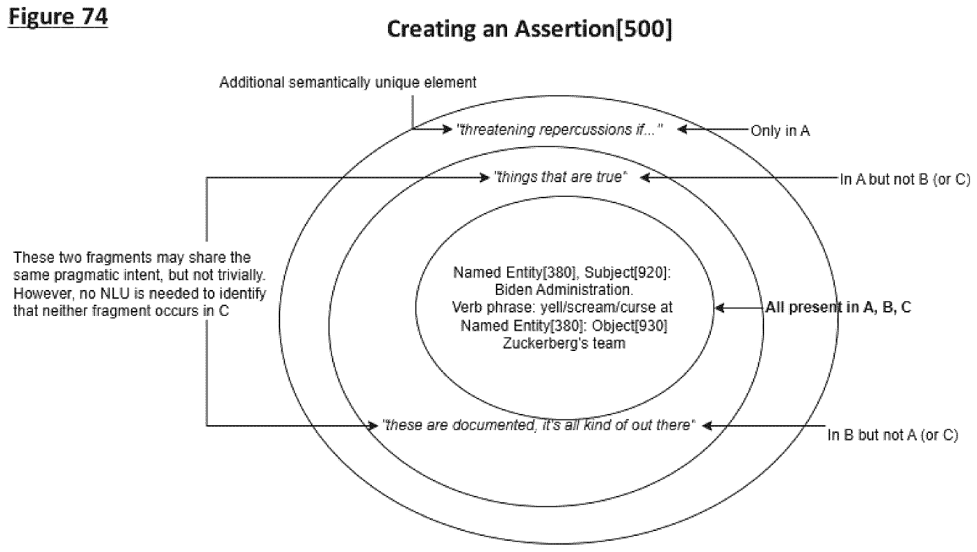

This marker[1875] measures the case in which specific excerpts[570] of a quote[560], speech[395], or audio[290] and/or video[140] clip of, or a document[120] by, an entity[370] are selected by different media outlets[160] in ways that are cluster-dependent[1385] in ways that do not (only) correspond to scope[170]—related issues such as differences in sector scope[1515]. FIG. 69 the different logical possibilities that can exist in this regard in a simplified pairwise comparison of how different media outlets[160] excerpted[570] a quote[560] that both referenced. Note that some embodiments may require a quote[560] to be attributed[567] before applying this marker[1875]. In a default embodiment, these possibilities are:
   Excerpt[570] A is a proper subset of Excerpt[570] B
   Excerpts[570] A and B are the same—most embodiments will choose to ignore specific minor differences, including but not limited to: punctuation, “fillers” and contractions.
   Excerpts[570] A and B do not overlap in any way
   Excerpts[570] A and B partially overlap in N=2 or more contiguous tokens[900]; some embodiments may choose a greater value of N
   Excerpts[570] A and B do not overlap with respect to tokens[900] but do contain one or more instances of the same assertion[500]
It can be expected that different media outlets[160] will make at least somewhat differing choices[210] in which snippets they choose to excerpt for other reasons as well as scope[170] including but not limited to: their media format[200], the demographics and other characteristics of their target audience. However, in most—but not all—real-world instances, most stories[100] will include content[320] that at least overlaps in part, either/both in actual token[900] sequences and/or referenced assertions [500].
Otherwise put, as shown in FIG. 70, this marker[1875] seeks to identify the editing or presentation of quotes[560], documents[120], audio[290] or video[140] clips or any other bounded piece of text content[120] such that the most-cited-by-others, important, newsworthy, or otherwise in some measurable sense “best” portion of the original content[320] is excluded. For example, consider a detailed and distinctive answer on a question of policy gets edited down to merely a very non-distinctive “Well, it's a hard problem.” This marker is not polarity [630]—bearing in most embodiments, (with one class of exception relating to multimedia, which is covered in the relevant section.)
While “most-cited” is a relatively straightforward proposition; a preferred embodiment will use textblocking[590] (as defined in U.S. Pat. No. 7,143,091B2) so as to catch the greatest number of attempted citations within the set of scoped media outlets[160] from the point in time that the text[120] content[320] was released forward, “important” is less so. “Importance” cannot be subjectively determined without compromising system[180] accuracy. Therefore, an approach of training ML, LLM or similar models[1180] is undesirable, as these systems almost always incorporate the political and other biases of their trainers as documented in studies¹. Thus a preferred embodiment will determine the importance of text[120] within a given set of text[120] such as a document or interview[395] transcript[480] empirically by contrast; by establishing whether the specific excerpts[575] are cluster-dependent[1385] in clusters[1375] unrelated to scope[170]. ¹https://www.realclearpolitics.com/articles/2025/02/04/whos_afraid_ofJonathan_turley_chatgpt_for_one_1523 00.html
A simple but compelling real-world example of selective quote[560] excerpting[570] is present in FIG. 71 which shows how two different media outlets[160] exercepted the quote[565] in different ways. The leader of Greenland had stated:
   “We do not want to be Danish, we do not want to be American. We want to be Greenlandic.”
As shown in FIG. 71, of these three phrases, in a sample data set, the first “We do not want to be Danish “was often omitted in the attributed quote[565]. The second, “We do not want to be American” was never omitted, and the third “We want to be Greenlandic.” was inconsistently present. The full quote[565] is fairly short, and provides valuable context that is lost when only the second phrase[915] is quoted. The system[180] however only can be aware that, for example, in this data set[1440] a) there is a large difference in the frequency with which the three phrases[915] are excerpted[570] or not, b) that these frequency differences are significantly scope[1510]—dependent internationally, and c) likewise cluster-dependent[1385] within media outlets[160] scoped[1510] to the US. However this is more than enough evidence to score bias [260] for this marker[1875] relative to the Greenland purchase news cycle[240] in almost all embodiments.
As can also be seen in FIG. 72 famous Trump quote[565] about “ending the war in Ukraine in one day” similarly the original quote[565] had four statements[510] that were broken into three excerpts[570] in the media[160] treatment. The first excerpt[570] asserted that Trump would pressure Zelensky. The second excerpt[570] made a parallel statement about applying pressure to Putin; the third excerpt[570] contained the claim about ending the war in “a day.” The third excerpt[570] was always present in any references to the quote[565], the first[570] was sometimes present, and the second[570] only rarely.
Another more complicated but excellent real-world example comes from Facebook CEO Mark Zuckerberg's comments during an interview[395] about censorship requests by the Biden administration with respect to the Covid vaccines and side-effects. The lengthy interview contained this quote[560]:
   “I do think that, yeah, having people in the administration calling up the guys on our team and yelling at them and cursing and threatening repercussions if we don't take down things that are true is pretty bad.”
While the interview on a very popular podcast were covered by many media outlets[160], the above quote[560] was commonly cited only by right-leaning media outlets[160]. Some outlets[160] preferred to use milder, similar excerpts [570] from the same interview[395] clearly referencing the same assertion[500], such as:
   “Basically these people from the Biden administration would call up our team and like scream at them and curse, and it's like, these are documented, it's all kind of out there”
Many interpretations or summaries of these and other similar excerpts[570] from the interview[395] were included in stories[100] in different outlets[160] at the time. Below is a typical example:
   Mark Zuckerberg claimed that Biden officials would “scream” and “curse” at his executives at Meta over censoring Facebook's users, as he continues to take on a more MAGA-friendly persona following Donald Trump's win.
As shown in FIG. 73 these three pieces of text[120] all clearly relate to an assertion[500] of Biden officials yelling at Facebook managers in relationship to censorship requests. As can be seen in FIG. 74, all three contain 3 common elements which combine to create an assertion[500]:
   Clear named entity references[310] to some subset of Biden administration employees
   Highly similar verb phrases, especially between the two quote[560] examples.
   Clear named entity references[310] to some subset of Meta/Facebook employees
After this though, there is divergence. Quote A[565] and Quote B[565] each contain some additional non-overlapping tokens[900]. While there is some semantic overlap among the two sets of additional tokens[900], without deep parsing (and very possibly even then) this similarity of pragmatic intent might not be detected because of the poor phrasing of that part of the utterance[760]: “and it's like, these are documented, it's all kind of out there”
The analogous content in the first excerpt[570] is far clearer “things that are true” which may be why some outlets]160] preferred it over the second excerpt[570] above. Likewise, the inclusion in Quote A[565] of the token[900] sequence “threatening repercussions” might not be understood as a semantic element unique to Quote A[565]. Further, even were it understood via deep parsing or other techniques, its real-world importance (e.g. that in addition to emotional behavior like yelling, screaming, and cursing, specific threats were made,) as “coded language” likely would not have been.
However inclusion—or omission[690]—of these extra tokens[900] in quotes[565] in various stories[100] can still be used to distinguish the two excerpts[570] from one another despite both their lexical similarity and the fact that they both include a reference to the same assertion[500]. Assuming that the choice of Quote A[565] vs Quote B[565] is cluster-dependent[1385], these semantics need not be understood by the system[180] for the biased-editing marker[1975] to be assessed.
Although references to the censorship quotes[565] were the most frequently cited, it should be noted that some outlets[160] largely ignored the comments on censorship in their coverage of the interview[395], instead preferring to focus on completely different excerpts[570] from the interview[395]. For example, from Axios:
   “A new class of creators should become the new kind of cultural elites.”
This is a good example of an instance in which the editorial choice[210] to use a less objectively newsworthy excerpt[570] over a highly newsworthy one was made. It is one of the motivations for most embodiments to implement this marker[1875].

### Computation

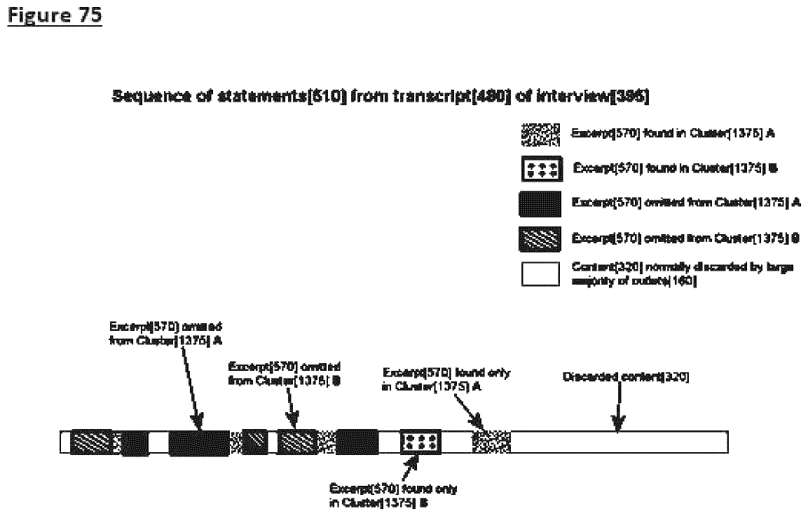

As more stories[100] belonging to the same long news cycle[240] appear in a given media outlet[160], excerpting[570] choices[210] will stack up. In some cases, more content[320] means that further excerpts [570] will be added and/or already published ones will be extended in length. In other cases, essentially the same excerpts[570] will simply be doubled down on again, being reported over and over.
In some embodiments, once the clustering process[1340] has been performed, and scope[170]—dependent clusters[1375] removed, each quote[565] (or other bounded content[320], that appeared with any meaningful frequency) will be decomposed as shown in FIG. 75, some excerpts[570] will appear in a non-cluster-dependent[1387] way—that is, appear in almost citation of the quote[565], while others will be highly cluster-dependent[1385]. Some excerpts[570] will fall somewhere in the middle of the spectrum, being more (or less) common in some clusters[1375] than others. Still other content[320] portions will rarely or never appear in any outlet[160] due to its objective dullness or irrelevance. (Note that a particular embodiment of this process is provided in a following section.)
Many embodiments will provide a heat map-style visualization[830] of oft-cited and oft-partially excerpted[570] quotes[560] (or documents[120]) so as to visualize which sequences of tokens[900] within the quote[560] are very frequently cited, very frequently omitted, and where there are major cluster-related[1385] discrepancies in excerpting within a set of scoped media outlets[220]. Most of these embodiments will allow the user[800] to view and receive reports[1090] on the content[320] instances which have the greatest amount of cluster-dependent[1385] differences in excerpts[570]. (The cluster-dependency[1385] requirement is to filter out cases in which the differences in choices[210] do not appear to be related to any kind of consistent bias[260].)

### Handling of Video[140] and Audio[290] Excerpts[570]

Most embodiments will use speech-to-text data[120] for analyzing the editing out of excerpts[575] in video[140] and audio[290] content[320]. In many embodiments, separate, logically parallel markers[110] performs the same function on video[140] and audio[290] content[320] whether or not any utterances[760] are involved. Many embodiments will simply perform frame[145] to frame[145] comparisons of video[140] clips from the same speech[395] for example, looking for content[320] omitted by some outlets[160]. Almost all embodiments will allow a small number of “buffer” frames[145] without flagging any difference as this can very easily occur owing to differences in video[140] editing skills.
However, when this buffer is exceeded, the “missing” frames[145] become considered as an omitted excerpt[575]. Some embodiments may simply leave it there, using the evidence of shared omitted excerpts[575] in the omission graph building process[1350]. Other embodiments however may choose to take the analysis another step forward. Assuming that the analysis of text[120] excerpts[575] is being handled separately as discussed above, the video[140]—only omitted excerpts[575] are likely to often fall into one of a number of classes. As noted elsewhere, these include, but are not limited to: editing of video content[140] to remove falls, momentary freezing, tremors, or any other sign of an entity's[370] poor health condition. (Note that mundane and uninteresting things such as someone[370] coughing or sneezing are likely to be edited out by most outlets[160] in the normal course.) Some embodiments may use existing computer vision methods of their preference to detect the presence of specific cases of interest in omitted video[140] excerpts[575]. In the event that a poor health-related sequence of video frames[145] has been found to have been omitted by a given outlet[160], the polarity[630] will be positive towards the particular entity[370] in question since the editorial intent would be unambiguous.
Much the same applies for audio[290] excerpts[570] in most embodiments. Examples of audio [290] content[320] events that may be defined in the system data[1450] include but are not limited to: wheezing, coughing fits, and stuttering.

### Contextualization[1410] & Bias[260] Detection Step[1415]

As noted elsewhere, most markers[110] require computation across different levels of containers[470], as shown in FIG. 23. As pictured, these container objects [470] include—if present: media outlet[160] and sub-outlet[165], all content[320] produced by author[250], conglomerate [430], set of scoped media outlets[220]—and even the set[1020] of all media outlets[160] for which the system[180] has data[1435]. While not all embodiments need use all of these containers [470] in each situation—for example, for each marker[110], group of markers[110], or entities[350]—or at all, most will minimally use the set of scoped media outlets[220] as well as media outlet[160].

This is because both there must be a sufficient content[320] from a statistical point of view to analyze, and because in order to properly ascertain the actual source of bias[260] it must be contextualized. The specific source of bias[260] can in practice range from an individual author[250] who creates content[320] for a small number of media outlets[160] to a vast conglomerate[430] controlling many outlets[160] such as those existing with respect to the governments of China and Russia. It would for example make little sense to conclude that a given Russian government[430]—controlled media outlet[160] independently exhibits bias[260] against Ukraine—just as it would not be sensible to consider entire media outlets[160] biased with respect to particular entities[150] solely on the basis of a single author[250] demonstrating bias [260].

In addition to the calculation for the various containers[470] most embodiments will further contextualize by extending the marker[110] calculations to non-target entities[350] that co-occur in groups[460] and/or equivalence classes[450] with one or more target entities[150]. This is because, for example, certain outlets[160] may consistently express contempt for all politicians, or all Western leaders[385]. Such broad class-based biases[260] should be correctly identified as such, assuming that the system[180] has sufficient evidence to do so. For this reason, many embodiments may choose to use both groups[460] and equivalence classes[450]. However, other embodiments may prefer alternate approaches. These may include but are not limited to: calculating markers[110] for the N most frequently co-occurring non-target entities[350] with each target entity[150] (if not already calculated,) and requiring the user[800] to specify comparator entities[350].

Almost all embodiments will require a specified time window[670] for the contextualization step[1410] for the simple reason that information spaces are highly dynamic, and sometimes extremely volatile. An outlet[160] that had been clearly biased against a given entity[150] five years ago may no longer be, for example.

It should be noted that different embodiments may implement the contextualizations it deems necessary in an earlier, or later, stage in the processing than is shown in FIG. 4, or include it in a different step. Whether or not a given embodiment performs a separate contextualization step[1410], in most embodiments the inputs from the various marker[110] scores[270] after the contextualization step[1410] can be summarized as follows. Each marker[110] provides per-container[470] per entity[350]—and as appropriate, also scores[270] for groups[460] and equivalence classes[450].
Content-related markers[1107] each provide one or more numeric scores [270] per entity[350] per container[470]. Some scores[270] may be attribute-value pairs in some embodiments rather than implemented as separate markers[110]. These scores are sometimes aggregated into overall scores[270] for the type of marker[110]. These scores[270] are more often than not polarity[630]—bearing in many embodiments.
Placement[300]—related markers[1105] return placement values[305] for total mentions[310] for entities[150] similarly. Higher placement values[305] are desirable, and so the total placement values[307] for a given entity[350] are at least implicitly polarity[630]—bearing relative to other entities[350].
Model-related markers[1125] do not provide single vector scores[270], and they are not polarity[630]—bearing. They provide results as to different types of omitted information including but not limited to slots[530], assertions[500], slot values[535], news cycles[235].

### Bias[260] Determination Step[1420]

The overall score representing a level of belief that some comparison set[470] has bias[260] in a preferred embodiment will be calculated via a dynamic Bayesian inference network[2070]; other embodiments may opt to select alternate, but largely isomorphic methods. There is a large body of literature about—and many widely used libraries—for implementing such networks[2070], so we only provide a very brief introduction here. A Bayesian inference network[2070] is a set of variables and their conditional dependencies represented via a directed acyclic graph (DAG). Observed values are called input variables[1995] here. Additional inferred variables, called latent variables[2080], represent possible causes for (subsets of) the observed values[1980]. Each variable[1995] is described via a probability distribution function (PDF) in most embodiments.

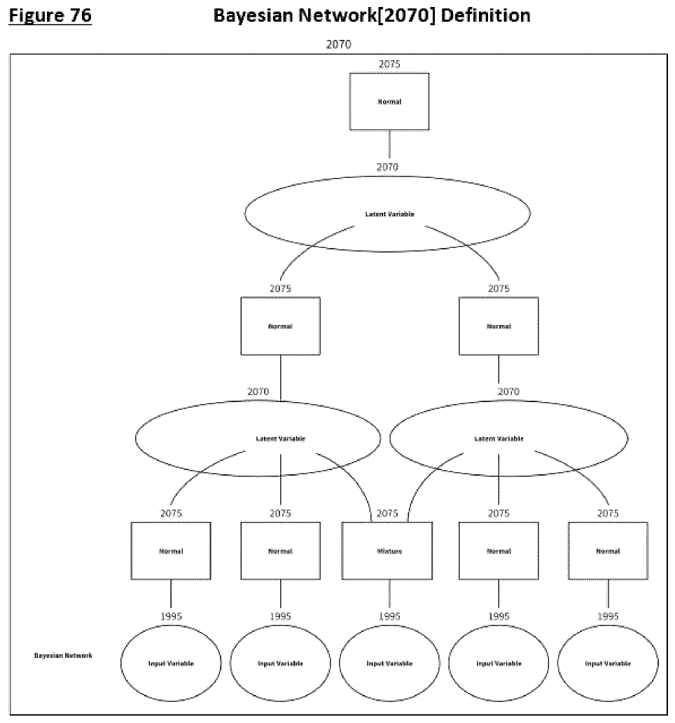

To illustrate, FIG. 76 contains a Bayesian network[2070] translated into a factor[2075] graph (most implementations use this representation). As pictured, the round nodes are variables and the square nodes are factors[2075] (i.e. pdfs). The bottom row are input variables[1995], and the higher rows contain latent variables [2080]. Factors[2075] describe relationships between variables[1995]. In cases where an input variable[1995] contributes to multiple latent variables[2080], its associated factor[2075] is a function that combines the distributions associated with the parent nodes. The type of mixture depends on the relationship between the latent variables [2080]. In this case, there is a topmost variable[2080] that is dependent on all the input variables[1995], as will be the case for scoring overall bias[260]. However embodiments may add additional variables[1995] representing other aspects of a comparison set[470].

When scoring a comparison set[470], input variables[1995] are lists containing one value per story[100] in the comparison set[470]. Because these lists are generated from different parts of the system[180] they may not always completely agree on the stories[100] represented in them. For instance, variables[2080] produced by the omissions[690] subsystem[1920] are the result of several rounds of clustering, and therefore may not always include stories[100] that other subsystems believe to be in the comparison set[470] in some cases. For this reason, the variables[2080] should handle missing values[1980] in some way. There are several commonly used strategies:
Use a ‘missing’ value if the network[2070] implementation used by the particular embodiment allows for it
Throw out any stories[100] for which any of the variables[2080] are missing a value[1980]
Impute values for any missing stories[100] in a variable[2080], there are many strategies for doing this for different embodiments to choose from.

A preferred embodiment documented here requires a network[2070] implementation that handles ‘missing’ values.

The goal is to compute a belief that the comparison set[470] is biased one way or the other.

The calculation is done in a preferred embodiment by running inference over the network[2070]. Inference can be thought of as working upwards from the observed values to update prior beliefs in parent variables. First each of the network's latent variables are initialized to some neutral default distribution. A default embodiment uses two bias variables[1995], one for positive[635] bias[260] and one for negative[637] bias[260]. The means of their distributions are set to some low, but non-zero value, any other parameters specifying the distribution are set to a system[180]—specified default value. After running inference the change in the distributions of the two bias variables[1995] determines the bias assigned. A default embodiment assigns bias[260] scores[270] based on the ratio of the resulting beliefs (i.e. the means of the bias variables distributions).

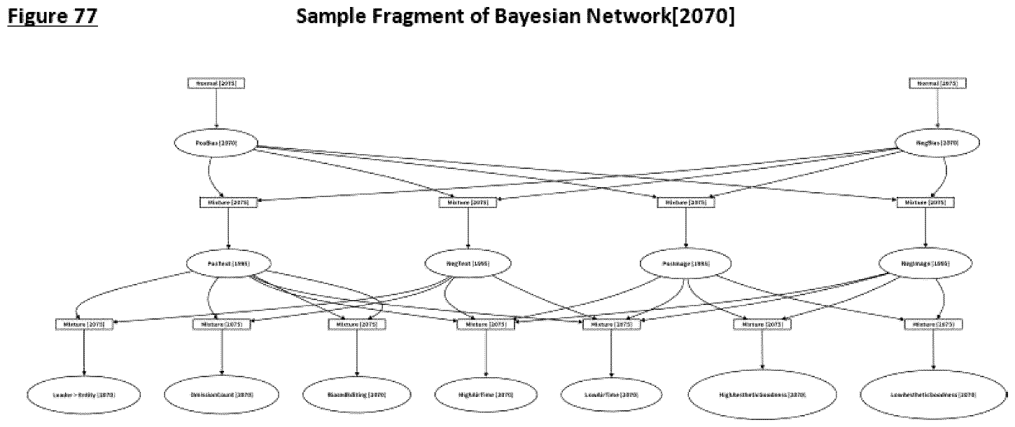

FIG. 77 shows what a tiny part of the network[2070] might look like, for illustrative purposes, as it does not represent any part of an actual network[2070]. Input variables[1995] generated from marker[110] values contribute to a layer of latent variables [2080] which then contribute to the bias[260] score[270] (i.e. the top two nodes). Note that once inference has been run over the current comparison set[470], the updated beliefs can be used as starting distributions for running inference for individual stories[100]. Inference can be used to “solve” for any variable[1995] in the network[2070].

In effect, once the bias[260] has been determined for the comparison set[470] as a whole, it provides default distributions to use as priors when running inference for a smaller set[470] including the individual story[100] (though as noted elsewhere, bias[260] is typically considered to be above the level of the individual story[100], then the posteriors on variables[1995] of interest can be checked for direction of change. The results are only meaningful relative to a “solved” comparison set[470], but it could be used to determine which stories[100]—and hence their containers, such as media outlets[160]—are more or less biased.
While bias[260] associated with the members of specific comparison set[470] is principally evaluated relative to specific entities[350], many embodiments will also calculate an overall bias1[260] tendency. For example, one media outlet[160] may be willing to go much farther than another in the degree to which they are willing to blatantly manifest bias[260] towards those entities[350] it really favors or disfavors. It should be noted that such tendencies may not be symmetric. For example, a given outlet[160] may be willing demonstrate more positive[635] bias[260] towards favored entities[350] than negative[637] bias[260] towards an unfavored one. In the sample diagram, these might be the PosText/NegText variables, for example. Any embodiment may choose to add latent variables[2080] representing other aspects of the story[100], not just the directions of bias[260].

### Implicit Collusion[650] Detection

It is important to note that a set of media outlets[160] may all be demonstrated to be exhibiting similar and unambiguous biases[260] towards specific entities[350] without actual collusion[650] being involved. Bias[260] is defined by consistent editorial choices[210] made by a given outlet[160] with respect to particular entities[350] that collectively demonstrate an editorial intent to help or harm the entity[350] in a particular period of time[670]. Simply put, for example, it may often be the case that many outlets[160] of the same scope[170] all wish to promote or deprecate the same entity[350]. In such cases, they share a common intention—and a common bias[260].

But what they will not naturally share is the same detailed editorial profile[215], especially as iterated over the course of time. If 20 different media outlets[160] all have the shared intention of helping a particular presidential candidate to win an election, in the normal course, they will each go about it with at least some variation in editorial profile[215] from one another. This scenario will result in 20 different surely at least somewhat similar editorial profiles[215] but not nearly identical ones.

A probabilistic model[680] can assess the probability that editorial profiles[215] with respect to one or more specific entities[350] are too similar to one another to have been likely to have occurred by chance, even with shared editorial intention. Otherwise put, if an outlet[160] wishes to make a particular candidate look good (or bad) there are almost always a great many possible ways to do so. This becomes even more true the higher the public profile of the entity[350], since it means that much more content[320] about them should be readily available from which to choose.

Note that even though it can be presumed that these media outlets[160] will borrow ideas from one another, it is to their own clear commercial benefit to not have content[320] that is too consistently similar to that of their competitors. This fact makes sustained unusual levels of agreement in choices[210] related to a particular entity[350] that much less likely. For example, when there is shared intent among outlets[160], significant overlap in assertions[500] involving the entity[350] is to be expected. However “significant overlap” differs from near total agreement as to which assertions[500] are presented, or for example which exact quote excerpts[570] are—and how often. Or what their placement values[305] are.

Note that almost all embodiments will exclude from any collusion[650] analysis stories[100] that either/both is clearly labeled as being associated with content[320] syndicator such as AP, and/or appears with virtually identical content[320] in multiple outlets[160]. In most embodiments, the system[180] will have lists of such syndicators so as to recognize them and remove their content[320]. Different embodiments may choose their preferred method of identifying “virtually identical.” A preferred embodiment will use textblocking[590].

Almost all embodiments will also consider a pattern of synchronicity[1430] (as defined in U. S. patent 2022/0164643 A1) among outlets[160] as a factor in assessing the presence of collusion[650]. It is entirely natural for editorial choices[210] to change over time at an outlet[160]. There are many reasons for this, including but not limited to change in management or ownership, change in editorial policy in response to market forces, and new information or events[340] that provoke genuinely changes in perspectives. What is not natural however, except in the last of these cases, is for changes in editorial profile[215] to occur in synchrony with other media outlets[160] who, unless owned by the same conglomerate [430], should have no reason to substantially change their profile[215] at more or less the same time.

Many embodiments will handle the case in which a real world event[340] caused significant and sudden changes in the coverage of a particular entity[350] across multiple outlets[160] in one or more sets of scoped media outlets[220]—not only those who otherwise had displayed at least similar biases[260]—as not contributing to a conclusion of collusion[650]. Consider a case in which a very popular public figure[370] was conclusively and very unexpectedly discovered to have committed a repugnant crime. In such an event, editorial choices[210] made with respect to that person[370] could be expected to change overnight, and with very high consistency across outlets[160]—no collusion[650] needed.

### Identifying Omissions[690]

The subsystem responsible for finding omissions[690] fills two roles in most embodiments. First, it continuously monitors incoming stories[100] to build an overall model[680] which will be used in the overall bias[260] scoring. Secondly, it provides internal system[180] querying functionality which can be used for arbitrary sets of stories[100] (from the perspective of the subsystem[1920], these sets will be meaningful within the requesting subsystem). This section documents the omission subsystem[1920] in a default embodiment.

Omissions[690] are defined as features[1900] missing in some stories[100] but not others. Omissions[690] only exist relative to a context[1910], which contains a set of stories[100], and a set of omission features[1925] found in these stories[100]. For the purposes of this subsystem[1920], context[1910] refers to a data structure including the sets above. This definition does not cover other senses of omissions such as the absence of features that “should” be part of a story[100] known by outside knowledge.

Ideally the context[1910] is very specific, consisting of stories[100] associated with a short news cycle[230]. However even the most focused news cycle[230] may cover different aspects of an issue, and be part of one or more long news cycles[240]. As already noted for example, stories[100] about Biden's disastrous 2024 presidential debate have many different aspects, such as analysis of the verbal performance versus comparison's to Trump versus supporter reactions versus campaign impact and others. The presence or absence of different features[1900] across all the different stories[100] related to the debate's long news cycle[240] is essentially random, because the stories[100] are talking about many different subjects. In order to find omissions[690] that represent intent, we need to define smaller subsets with highly correlated features[1900], i. e., stories about a very narrow range of subjects, where a difference in the extracted feature values[1980] actually represent one author leaving out information that other authors choose to reveal.

Nevertheless, omissions[690] that occur across a broader context and longer time spans are often very interesting. However, multi-faceted some issue such as Biden's cognitive decline may be, its omission[690] or lack thereof is still the main point of interest and relevance to most of the public. It is to this end that the system[180] builds a continuous model[680], as some of these wider questions may be answered, at least in part, looking at changes in omissions[690] in different media outlets[160] over time. If features[1900] have some additional structure, like a larger hierarchy that classifies them as related to a topic[240] such as Biden's cognitive decline, this can be used to further refine the comparison.

Co-omissions[685] are the opposite of omissions[690], they are the omission features[1925] that are only present in some of the stories[100] out of a context[1910]. Co-omissions[685] are just as much of an attempt to shape perception as omissions[690]. To carry over a prior example, when Donald Trump started talking about acquiring Greenland prior to his 2025 return to the presidency, it was not initially noted that earlier presidents had also expressed interest, and had even made formal offers to do exactly the same thing. These assertions[500] are not something that would have shown up as an omission[690] earlier on, but would have shown up as a co-omission[685] at a later point when a few stories[100] started emerging that other presidents had indeed explored the same idea.

One could say that the distinction is arbitrary, a small number of instances of a feature[1900] within a context[1910] is a co-omission[685], and a large number of instances of a feature[1900] within a context[1910] results in omissions[690]. However, there is utility to the distinction. When looking at an omission[690]/co-omission[685] pair, the set of stories[100] that each occurs with are significant. The characteristics of the two sets of stories[100] can further determine the quality of an omission[690] or co-omission[685] for scoring or other purposes. In some embodiments, these characteristics may be used to filter out potential omissions[690] and co-omissions[685]. For instance suppose an omission[690] is associated with stories[100] whose media outlets[160] frequently share omissions[690]. If the associated co-omission[685] is associated with media outlets[160] from a broader spectrum then this makes the paired omission[690] higher weighted or more valid. (See the section on scoring for a more detailed explanation.)

Context features[1930] and omission features[1925] are used for defining contexts[1910] and calculating omission[690] co-omission[685] pairs respectively. Each feature[1900] has an identifier and a textual, categorical, or numerical value. The identifier can be thought of as a type, and all features[1900] with the same identifier have the same type of value. Features[1900] are created via an extractor[1940] which scans each story's[100] content[320] and stores the resulting features[1900] in a matter[1950] in metadata associated with the story[100].

A preferred embodiment will define multiple sets of feature extractors[1940], organized into proposals[1945]. These different proposals[1945] represent different short news cycles[230] of interest, and will generally also include some broad general purpose feature[1900] sets. An extractor[1940] may appear in several proposals[1945] and may produce any number of different features[1900]. Thus a story's[100] content[320] may also be associated with the same feature[1900] instance appearing in several different matters[1950]. The result of this is that the same story[100] may appear in multiple contexts[1910] during processing by the subsystem[1920]. Typically the context feature[1930] and omission feature[1925] sets do not overlap, though quotes[560] if used as context features[1910] may be handled in a special way (see below) so as to produce their own omissions[690] and co-omissions[685] (specifically when excerpts[570] of quotes[560] are omitted or retained in a given story[100]).

Temporality is a key part of defining contexts given our focus on short news cycles[230], at least for the ongoing detection of omissions[690]/co-omissions[685] that will serve as the “basis” for later analysis. Stories[100] are assigned a relevancy window[1955], defined as a time interval value, during which the story[100] is considered active (i. e., active for the purposes of omission[690] processing). A standard embodiment implements this as a fixed value which determines the width of the window[1955] before and after the creation date[1265] or later spike dates[1485] (e. g., points in time at which the accessibility or visibility of a story[100] is boosted, usually as a result of specific promotion[1555] of it.) The width of the window[1955] is calculated differently for each media outlet format[440] and reflects the length of a short news cycle[230] for that format[440]. Other embodiments for example may directly calculate a length for each news cycle[230].

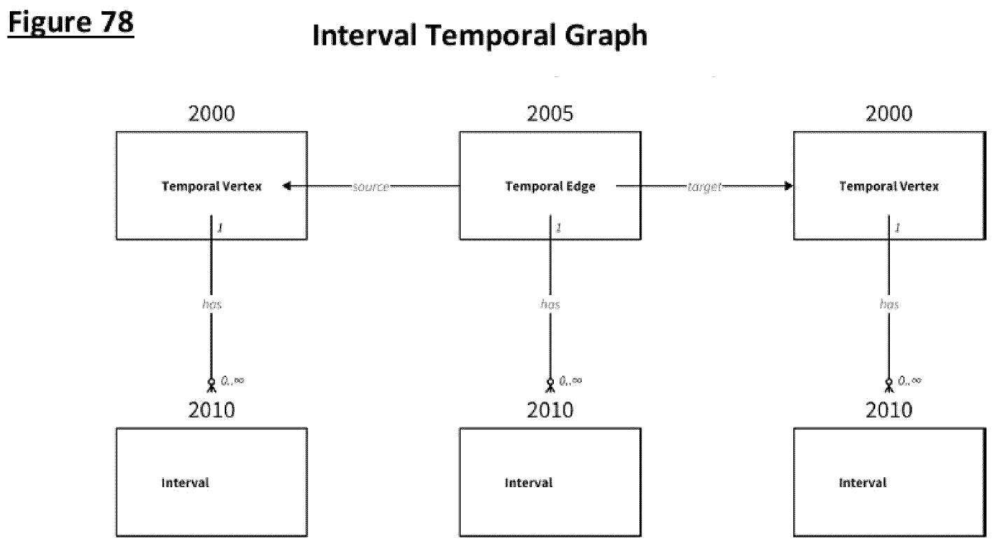

In the default embodiment, the process which determines contexts[1910] uses an interval temporal graph (ITG), which is the main mechanism by which temporality is introduced into calculations. While the ITG is a standard data structure, we introduce some (minorly) non-standard variations and will thus briefly describe it as pictured in FIG. 78. An interval temporal graph adds time intervals[2010] and transition times to the graph edges[2005]. Additionally, we add time intervals to the vertices and drop or ignore the transition times. We are interested in using such a graph in order to constrain clusters[1375] of stories[100] (which are the basis for contexts [1910] formed) so that they are consistent with the relevancy windows[1955] on the constituent stories[100]. Usage of the graph is simple, stories[100] are represented by vertices, context features[1930] are represented by edges, and we are interested in traversals where vertices and edges overlap in time.

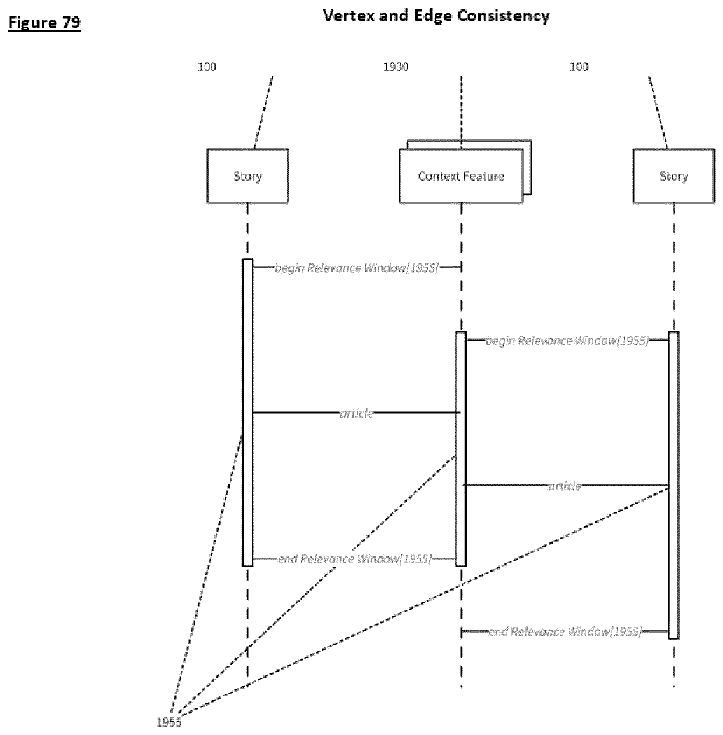

To that end the graph structure is constrained, as indicated in FIG. 79, where an edge between two vertices is only permitted if they share one or more context features[1930] associated to the story[100] they represent and there is a non-empty intersection between the relevance windows[1955]. The edge is labelled with the set of shared features and a time interval (relevance window[1955]) equal to the intersection. In the default embodiment all that is strictly necessary is to retrieve edges and vertices as one would with a basic graph to get time constrained traversals of the graph. Additionally, we add the idea of a focused time interval, which can either be set as a global default time span for the graph, or optionally used with retrieval operations on the graph. Only edges/vertices with time spans with a non-empty intersection to the focus will be retrieved.

### Omission Detection Subsystem[1920]

The subsystem is described here as a mostly independent black box with respect to the rest of the system described in this patent. It continuously processes incoming stories[100], after collection, processing and augmentation (such as metadata, inclusion in the various elements of a news forest[1480]) of those stories[100]. It then issues to other system components notifications of individual omissions[690] as they are found. Other system components can interact with this subsystem[1920] by submitting proposals[1945] and retrieving omissions[690] for set(s) of stories[100] specified in a news forest[1480].

### Important System Objects

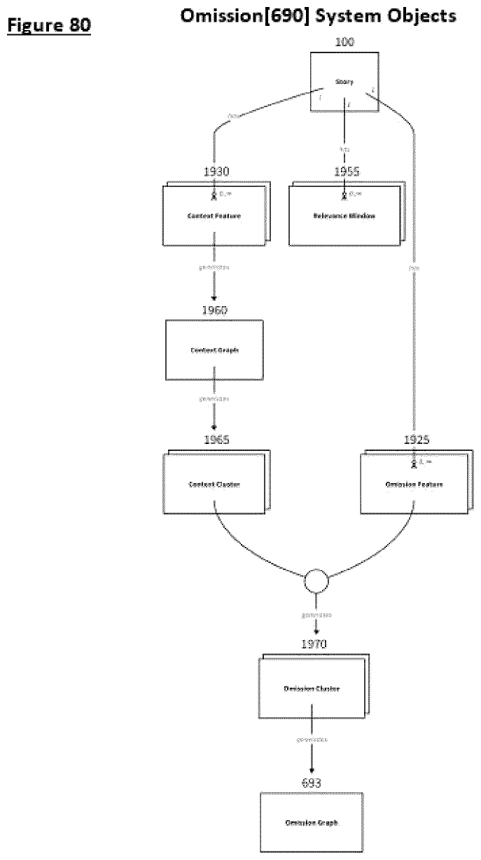

From FIG. 80, stories[100], Context Features[1930], Omission Features[1925], Relevance Window[1955] have already been discussed above.

The context graph[1960] is an interval temporal graph as defined above. It is generated by adding a vertex for each story[100] processed, then adding all possible edges between the new vertex and any existing active vertices. Note that given the restrictions on valid edges as described above, edges may only be added for recent vertices. Various embodiments may define secondary structures to make this process faster, such as maintaining an inverted index from feature[1930] values to current active vertices. Given that the relevance windows[1955] will be fairly small (usually no more than a few days), only a small fraction of vertices will be active at any given time, making it feasible to maintain the graph[1960] and supporting structures dynamically. Occasionally older stories[100] may become active again, for example because a story[100] from years prior is reposted by a high profile influencer, in which case the story[100] is reposted to the subsystem[1920] with a new spike date[1485]. In the default embodiment, the relevance window[1955] assigned to such a story[100] is updated while its containing structure (typically a short news cycle[230]) is active. However there are several ways this could be handled in alternate embodiments, such as defining a static period for such stories[100].

A context cluster[1965] is a set of stories[100] used as the basis for creating a context[1910. In the default embodiment, these clusters[1375] are formed directly from the graph[1960]. The clusters[1375] formed should be very “tight”, e. g., narrowly defined as discussed in the introduction above. For this reason, partition-based clustering methods are not good choices. A method like bottom-up agglomerative clustering will work better, but the cut-off point at which the algorithm should stop merging is very arbitrary. The quality of clusters[1375] will be very sensitive to the context features[1930] chosen and the method of distance/dissimilarity computation between clusters[1375]. A well-performing and fast approach is described below for the default embodiment. This clustering method does not take into account any grouping information used elsewhere in the overall system[180], outside definitions of groups will be used in a later stage of analysis.

Other embodiments may use such information to define or constrain clusters (for example by intersecting found clusters[1375] with externally provided groups), but since we are aiming at clusters[1375] of greater granularity than the small news cycles[230] it is doubtful that the groupings calculated by other parts of the overall system will be very helpful in most cases.

Omission clusters[1970] in this embodiment are formed via analysis of context clusters[1965]. They consist of (sub)sets of omission features[1925] chosen to be highly correlated. While the proposal[1945] mechanism can be a method for selecting feature[1900] sets, there is expected to be a large number of feature types[1975] in most proposals, generated features[1900] when used as omission features[1925] will also have large numbers of values[1980] and so will generally be too broad for effectively measuring omissions[690]. It should be noted that omission clusters[1970] are meant to be distinct from dimensionality reduction, where a smaller set of features[1900] are selected or created via transformation and used to represent the original set without losing essential structure of that set.

The system[180] will select sets of features[1900] with values[1980] that vary across news cycles[235] and hence stories[100], but are nonetheless somewhat related. In general, this often means measuring some kind of correlation between features[1900]. In some embodiments omission clusters[1970] may be associated with further subsetting of the context cluster[1965], effectively re-clustering the stories[100] within a context[1910]. There are several approaches that embodiments can use, varying from inferring probability distributions to matrix decomposition of a feature value[1980] X story[100] matrix, or pairwise measurement of correlation of feature values[1980] over a set of stories[100] in order to implement linkage based (agglomerative) clustering of the features[1900].

The system[180] is described as separating context clustering[1965] and omission clustering[1970] for the sake of generality, but some embodiments may do both as part of one algorithm (for example the COSA algorithm). Another decision is what steps are taken to control overfitting, depending on the algorithms/features used this can range from selecting one clustering of features[1900] to be used across the data set to a per context cluster[1965] clustering of omission features[1925] that are constrained to take into account their correlations in the larger stories[100] dataset[1440]. The implementation of a default embodiment described below will assume a separate linkage-based clustering of omission features[1970] using correlation coefficients with L1/L2 regularization. Another appealing approach is to run COSA or a similar algorithm for each context cluster[1965] (augmented with additional sampled stories[100] for the sake of protection against overfitting).

The omission graph[693] records the overall pattern of shared omissions[690]/co-omissions[690] between stories[100]. It can be either a temporal graph or a regular graph, depending upon the particular embodiment. A default embodiment uses a regular graph, as it simplifies some later operations. The graph consists of edges labelled with the set of omissions[690]/co-omissions[685] that are associated with the stories[100] represented by the source and target vertices. Embodiments using an interval temporal graph representation will typically construct the graph[693] using the same kind of structure as that of the context graph[1985]. The width of the assigned relevance windows[1955] would typically be much larger. By setting the graph[693] focus, the system[180] can control how much history is included when retrieving patterns from the graph[693].

The system[180] however requires results at a less granular level, specified in retrieval requests by specifications of a desired entity container[383] type and comparison set[470] type. In order to return results at the correct level of granularity, the subsystem[1920] will perform graph contractions on the omission graph[693]. That is, the set of vertices sharing some attribute[2050] (as specified in a comparison set[470], e. g., media outlet[160]) are replaced with a new vertex associated with that attribute, and edges incident to the original vertices are consolidated. Essentially this means that the edges are grouped by the neighboring vertex (e.g., selected from the set of neighbors to the original vertices), and each of those edge groups are replaced with a new edge that merges the labels from the original edges.

After all vertices have been so collapsed, the resulting graph[693] represents shared omissions[690]/co-omissions[685] among the set of media outlets[160] as specified in the requested comparison set[470]. If an embodiment uses an interval temporal graph to implement the omission graph[693], the edges are grouped by a combination of an attribute and relevance window[1955]. Relevance windows[1955] between edges put in the same group must be consistent. The easiest consistency requirement is simply that the edges in the group have the same window[1955], e. g., the same start and end times (within some tolerance). Similarly, contractions over just the edges are used to narrow the graph to the requested entity container[383] type.

The comparison set[470] specification in a retrieval request[2040] also specifies a graph query[1988], matched against feature[2010] values[1980] in stories. A default embodiment implements a simple Boolean query format (AND, OR, NOT, . . . ) over feature[1900] values. In general, the query[1988] will likely depend on the mechanisms used to extract features, and may be generated at least partially automatically.

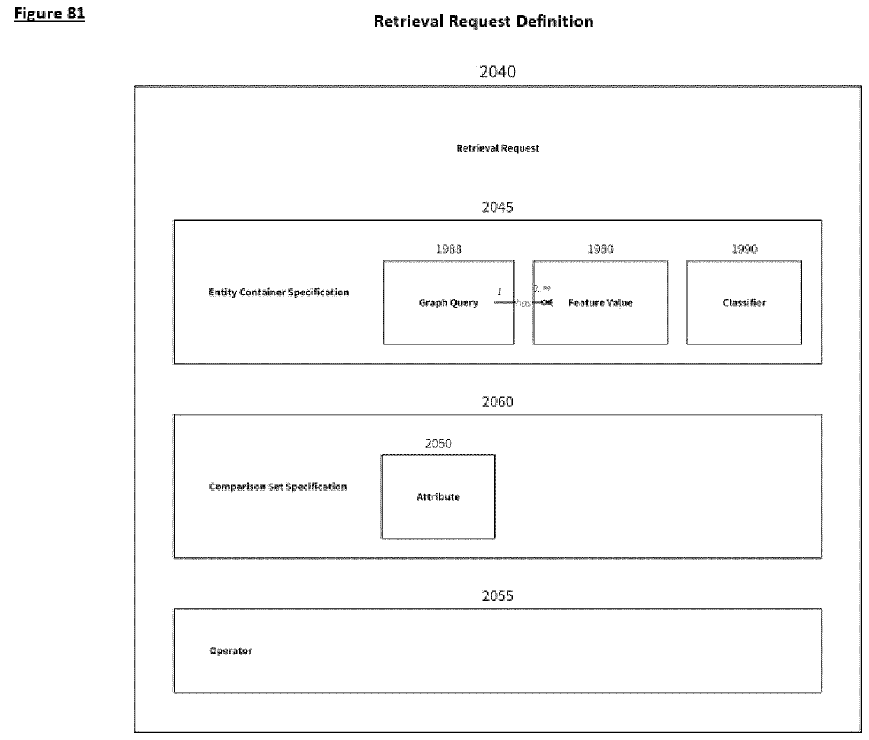

From FIG. 81, a retrieval request[2040] also specifies an operation[2055] which includes at least:
Return omission[690]/co-omission[690] feature values for some entity[350] grouped into a list of comparison sets[470], weighted if the embodiment specifies weights.
Return similar comparison sets[470] to those matched by the query[1988]. The comparison sets[470] may be simplified to the values of the attribute used to group the constituent stories[100]. The group may be defined by additional clustering on the omissions graph[693], or by simply returning neighbors linked via edges passing a system[180]—specified threshold test.
Return time series for each of the random variables used in scoring/training the overall bias[260] score[270] relative to each comparison set[470] for each entity[350] being measured.

In addition, requests[2040] may contain additional options such as referring to comparison sets[470] and their members[160] with their UID's returned from previous queries[1988], returning a sub-graph of the contracted omissions graph[693] rather than lists/groups for example.

### Subsystem Processing Pipeline

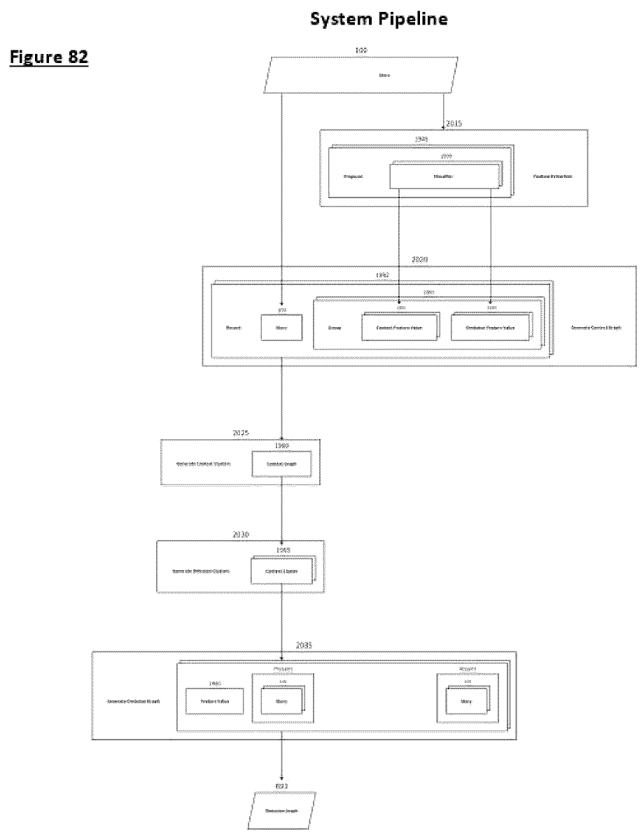

(As shown in FIG. 82.)

By the time this subsystem is invoked, at the least, stories[100] have already been collected, subjected to some level of preprocessing, and been updated with additional metadata attributes such as marker[110] scores[270].

### Extraction[2015]

This step runs the classifiers[1990] contained in a list of proposals[1945]. For each story[100] a classifier[1990] creates feature values[1980] for some number of context features[1930] and omission features[1925]. These values[1980] are stored in a record[1992] along with the originating story[100], and are placed in groups[2065] corresponding to the proposal containing the originating classifier[1990].

Text[120] values[1980] require some special handling, both for normalization of values[1980] and calculation of excerpts [570]. Some cleanups of the text[120] are relatively inexpensive, and can be done on an item by item basis. For example, normalization or removal of punctuation, removal of some tokens[900], stemming or replacing tokens[900]. Essentially transforming the text [120] so that matching of text feature values[1980] is more accurate. This is especially important when feature values[1980] are quotes[560]. As noted elsewhere, there are a number of changes that can be made to quotes[560] and still be considered objective:
Removal of filler words and dysfluencies.
Correcting minor grammatical and orthographical errors.
Eliding portions of the quote and replacing with ellipses ( . . . ).
Adding brackets for inserting clarifying text[120], or changing a specific word[900], for example inserting “[sic]” to show that a spelling or other error is part of the original quote[560].
Tidying up the quote[560], making other small changes to clarify the quote[560] without changing its meaning.

Several bias [260]—suggesting techniques will be checked for in most embodiments as well:
Quote[560] patching, linking separate sentences[910] to create a more “coherent” or concise quote[560].
Changing the meaning, or otherwise making larger alterations to the quote[560].
Selective and misleading quoting, such misattributed context[730] or omitting key excerpts[575].
Altering or even fabricating quotes[560] purely as desired.

Additionally, there may be differences in the original recording/transcription [480] of the quote[560] done by different outlets[100] and authors[250]. Obviously if those differences are too large then there is little to be done. As elsewhere noted, in most cases these differences come down to punctuation, inclusion or removal of filler words, and mishearing occasional words.

The smaller issues can be handled by the inexpensive cleanups mentioned above. There are some extra cleanups specifically for quotations[560] in most embodiments. For example, there are conventional grammatical markers used when quote[560] patching, if done somewhat objectively, that can be used to split the sentences[910]. Removal of bracketed text[120] should also be done. However, dealing with alterations and editing requires the same sort of algorithms as do calculation of excerpts [570].

For this reason these calculations may be delayed until context clusters[1965] have been derived. This is done under the assumption that the quotes[560] and other texts[120] that the system[180] must compare to one another to find differences are time and possibly context[1910]—limited, meaning that the system[180] can only use text values[1980] found on stories[100] in similar contexts[1910], or in all active contexts[1910] (i. e., contexts[1910] based on active context clusters[1965]).

A default embodiment uses a suffix tree data structure for finding common substrings across values[1980] taken from the contexts[1910] to be used. When the substrings are long enough to be considered uniquely identifying (a default embodiment requires a minimum number of tokens[900] in the substring, though certainly other embodiments could use a more sophisticated test), then the text[120] values[1980] containing that string are considered to be from the same origin. This can be used for finding omissions[690]/co-omissions[685] between the different versions of text[120] values[1980].

Excerpts[570] can be directly identified from the suffix tree by the substring test mentioned above. Ideally a classifier[1990] would only extract text[120] from which excerpts[570] are likely to come (such as clear quotes[560]), but in worst case the system[180] may have to place the full text[120] content[320] in a suffix tree to find all excerpts[570], which would benefit greatly from the limited pool of stories[100]. In cases where an original transcript[480] has been identified as a source for text[120] content[320], it will be passed in as a metadata attribute of the story[100] and excerpts[570] can be calculated directly.

### Context Graph[1985] Generation

Construction of the context graph[1985] is straightforward, from each record[1992] produced at the prior step a vertex representing that story[100] is added to the graph[1985]. The new vertex is labelled with the grouped context feature values[1980]. In a default embodiment this simply means that a reference to the record[1992] is added as a label for the vertex. If the story[100] is an older story[100] that has become part of a news cycle[235] again, indicated by a spike date[1485] in its metadata, then the prior vertex representing the story[100] is re-activated, that is a new relevance window[1955] will be established. The vertex label is then updated with the new record[1992]. In a default embodiment this means that an additional reference is added to the existing vertex label. Other embodiments will define merging as is appropriate to how they construct their labels.

Edges are added for feature values[1980] shared between the newly active vertex and other currently active existing vertices, as described above for interval temporal graphs. The default embodiment uses a simplified clustering scheme which requires the context graph[1985] to be directed. Edges are directed to the vertex with the larger number of context feature values[1980], where ties are broken by directing the edge to the existing (older) vertex. This is a simple heuristic that works well enough and is inexpensive to implement. There are methods that other embodiments may use to make this ordering more precise (for purposes of the clustering scheme introduced here), but the choice to use them must be balanced against the computational cost (usually requiring an extra pass or multiple passes through current active vertices, which can be quite expensive).

The step described here is applied incrementally, though in practical terms, new records[1992] will likely be processed in batches. It should be noted that only the active nodes and edges need be accessible in faster storage (e. g., ram or on-disk caches), meaning that the amount of work scales to the rate at which new stories[100] are collected rather than the total number. Older stories[100] will be saved in slower long term storage by most embodiments as they are relatively infrequent. Different embodiments may use secondary data structures to speed up the search for existing vertices sharing feature values[1980], such as inverted indices from features[1910] to stories[100].

### Context Cluster[1965] Generation

The goal of this step is to create clusters that are “tight” with regard to the amount of variation between context features[1930] and values[1980] appearing in the stories[100] being analyzed. If there is too much variation, then detected omissions[690]/co-omissions[685] are more likely to be spurious. If there is not enough variation allowed, then many omissions[690]/co-omissions[685] are likely to be missed. Therefore it is not as useful to use an approach that partitions the set of active vertices. In these cases some kind of additional check would need to be made to filter out inappropriate vertices from a partition. Agglomerative clustering tends to be subject to the chaining effect, where pairwise differences may be within tolerance, but the variation across all pairs may be too high.

Thus a default embodiment uses a specialized clustering scheme to avoid these problems, which is also fast and easy to implement incrementally. The approach is heavily dependent on the characteristics of the features[1910] used for clustering. The default embodiment primarily uses quotations[560], which can in some form be derived for all media formats[200] and types[440] relevant to the system[180]. Quotations[560] tend to be highly specific to news cycles[235].

There are a much smaller set of quotes[560] that tend to be used more widely, though these appear distributed over time and tend to be used in isolation (e. g., one broadly used quote shared between stories[100] associated with different news cycles[235] should not be enough to put them in the same cluster[1965]).

Thus quotations[560] have the inherent characteristic that they are much less likely to “chain” through unrelated stories. This drastically simplifies clustering. The scheme does rely on a couple of arbitrary thresholds, which can be determined by analysis of sample datasets. First it needs an allowable maximum and minimum variance between feature values[1980] in members of a cluster[1965]. Again we rely on the characteristics of quotations[560] to curtail chaining, so it can be implemented as a pairwise constraint rather than checking across the entire cluster[1965]. Additionally we need some minimum requirement on the amount of shared feature values[1980] among members of the cluster.

First we will describe scheme from a static perspective (i. e., we start with the entire graph and then cluster), and refer to it as the implementation used in a default embodiment. However, the default embodiment uses an incremental variant addressed later in the description). The goal is to process the heaviest weighted vertices (as described in context graph generation), in descending order. For each such vertex, a cluster center, check each incoming neighbor to see if the variance and minimum tests are met. In the default embodiment we simply check the ratio of the number of shared quotes[560] versus the total number of quotes[560] in each of the pair of stories[100] (e. g., the current vertex and one of its neighbors) and require a minimum number of quotes[560] under the assumption that any shared quote[560] is significant.

A default embodiment uses a union find algorithm to merge clusters[1965] as in standard linkage-base clustering. This means that stories[100] can only be a member of at least one cluster[1965]. An alternative embodiment allows stories[100] to end up in multiple clusters[1965], as a story might touch on multiple news cycles[235] (however a later step in the pipeline can also deal with this problem in a different way, which is why the default embodiment does not do this). The above procedure is modified so that for each cluster center, the system[180] skips over it if its already part of a cluster[1965], otherwise start a new cluster[1965] as the current cluster[1965]. Check the incoming neighbors as before and if they pass the tests, add them to the current cluster[1965] and recursively apply the incoming neighbor checks with the current cluster[1965]. In either of these pathways, a node is reached that cannot meet the minimum criteria (e. g., it has too few feature values) the process can stop—that is, terminate the top level iteration, or stop recursing on the current branch.

Now we describe the modifications for running this incrementally. In a default embodiment when a story[100] is new to the graph[1960], the system[180] checks all neighbors (instead of just the neighbors on incoming edges) and for those that pass the tests it either adds the vertex to the existing cluster[1965] or starts a new one. If more than one cluster is found then they must be merged. The most straightforward method is to keep children and parent pointers in each cluster[1965] and link them together. This means that the pointers have to be followed when retrieving members of the cluster[1965] and checking to see which cluster[1965] a vertex is in (similar bookkeeping to union find), but we no longer require a separate data structure for a union find algorithm. Note that if the vertex has been reactivated we can usually follow the same procedure as vertices that were already checked will usually have become inactive. If necessary, for instance if the spike date[1485] is close enough to the last activation, then creation dates need to be compared in order to filter out those neighbors that are still active.

For the alternate embodiment that allows membership in multiple clusters[1965], the process becomes much simpler. Check outgoing neighbors, for each passing neighbor either add the new vertex to any clusters[1965] the neighbor already belongs to, or start a new one if there aren't any.

Additional embodiments may use any number of incremental clustering methods.

### Omission Feature Cluster[1970] Generation

Omission features[1925] are clustered as described in the initial description of omission clusters[1970] above. This step is pretty straightforward. For each context cluster[1965], for omission cluster[1970] (whether defined globally or locally to for a context cluster[1965]), find the matching set of stories[100] in the context cluster[1965]. In order to match, a story[100] must contain at least one feature value[1980] for a feature[1930] in the cluster[1970]. More realistically there might be some minimum threshold required by most embodiments. Omissions[690]/co-omissions[685] are calculated relative to the set of matching stories[100] and the set of features[1900] in the current cluster[1970].

First a matrix of stories[100] x feature values[1980] is created, where a special missing value is filled in for stories[100] that are missing the feature altogether. For each column, make a set of the unique values that appear (e. g., for a Boolean feature, the set might be {True,False,Missing}). Any column where more than one value appears represents some number of omission[690]/co-omission[685] pairs, depending on the number of missing values. For this reason, omission features[1925] with a small number of values tend to work best. The simplest features[1925] have one valid value, and so a story may simply have that feature[1900], or not. Basically each non-missing value is an omission[690]/co-omission[685] pair. For numeric feature values[1980], different embodiments might use different strategies:
Ignore them.
Reduce to present/missing values.
Bin the values and treat as a categorical Feature.

Text[120] feature values[1980] are generally not used unless its known that there will be a specific limited set of distinct text[120] strings that might appear, and thus can be treated categorically. Quotation[560] features are a fine example of this. Since different versions of a text[120] value might be treated the same for purposes of matching, the system[180] should check for differences between matching text[120] values[1980] (see discussion under extraction[2015] step). The longest common substrings found in the suffix tree built during extraction[2015] are used for this. As above, each such substring generates an omission[690]/co-omission[685] pair using the difference between the substring and the other values[1980] containing it.

For each omission[690]/co-omission[685] pair the system[180] records the feature value[1980], a current list of stories[100] that contain that value[1980] and a missing list of those that don't, to be passed on to the next step.

### Omission Graph[693] Generation

This step records omissions[690] and co-omissions[685] for later retrieval requests[2040] made from other subsystems. The default embodiment uses an undirected omission graph[693] with weighted edges. For each pair[1993] passed from above:
Edges are created (or weight updated on existing edges) between all members of the present list and labelled as co-omissions[685] with the feature value[1980].
Edges are created (or weight updated on existing edges) between all members of the missing list and labelled as omissions[690] with the feature value[1980].

### Omissions[690] Contribution to Scoring

As discussed under scoring, the scoring component can solve for any of its input variables[1995]. Thus in addition to contributing to the bias[260] score[270], note that scoring could in principle be used to help determine the likelihood that a particular omit[690] is valid or how likely an apparent excerpt[570] from a quote[560] is valid and so on. While scoring would not answer these questions directly as it would answer for the story[100] as a whole, but even so the scoring system might add some weight one way or another to individual instances.

Variables[1995] are reported across comparison sets[470] as specified via a retrieval request[2040]. A variable[1995] is represented as a list of values, one per story in the comparison set[470]. If necessary a variable[1995] can contain a distinguished “missing” value for any story[100] for which it is unknown. If it does not apply to the story[100], then a defined value should be returned, for example ‘omits[x]=0’. Variable[1995] values can be categorical or numeric.

As discussed in more detail in other sections, variables[1995] for different media outlets[160] should minimally include but are not limited to:
Omits[690] count.
Quote Excerpt[575] count.
Entity container[383] has a history of Omits[690].
Entity container[383] has a history of Quote Excerpts[575].
Average Omission[690]/co-omission[685] pair width.
   Omission[690]>co-omission[685].
   Omission[690]<co-omission[685].
   Omission[690]˜co-omission[685]
One variable for Outlet[160], one for Author[250], depending on Entity Container[383] stories might all only have one outlet[160] and/or author[250], in that case the value reported is ‘˜’ in a default embodiment.

Different embodiments may define additional variables[1995] beyond those specified in this document to best serve its specific needs, so long as they can be determined at the story[100] level.

Some embodiments may define a local inference network[1997], as for the scoring system, dedicated to finer grained distinctions, such as variables for things such as how many different text values a common substring is contained in, and so on. For use in deciding validity of questionable or borderline cases (i. e., does this substring represent an excerpt[575] or not).

### Visualizations[830]

While almost all embodiments will provide the usual array of bar, line, pie and similar charts to visualize the findings of the system[180] both in the user interface[830] as well as in reports[1090], such basic charts cannot adequately capture the complexity and dynamism of bias[260] and coordination [650] assessments. For one thing, omissions[690], or the absence of an expected thing, is a challenge to visualize well. Coordination or collusion[650] is also a difficult thing to visualize well. Furthermore, much of the underpinning of the bias[260] calculation involves assessing the editorial choices[210] made from a large number of different data universes by a large number of media outlets[160].

Furthermore, any system whose goal is to faithfully measure bias[260] and accuracy in reporting must itself go to great lengths not only to be accurate and objective but also to ensure that the system's[180] users[800] understand and trust the basis for the system's[180] conclusions.

For these reasons, most embodiments will offer complex visualizations [830] that are designed for the specific problems associated with silent bias[260].

### Data Crystal Visualization[837]

The visualization of omissions[690] is not a well-studied problem. It is a difficult one because most users are primed to associate a dot, bar, or other shape rendering with the presence of data rather than its absence. In order to overcome this widespread expectation, a preferred embodiment will visualize the commission/omission behavior of different media outlets[160] in a way that makes systemic omissions[690] both readily visible and intuitive.

One example of “nothing” being visually highlighted comes from the field of crystallography in which bright light sources are shone on a crystal so as to illuminate its structure and abnormalities. This causes the holes or empty spaces in the crystal to be brightly colored, since there is no mass blocking the light rays. Irregularities in the crystal are thus made much easier to see. It is conceptually similar to shining a very bright light at a wall that sits behind a fence.

Almost all embodiments of the system[180] have a need to visualize omissions[690] in an intuitive and scalable way. A preferred embodiment will leverage the metaphor of crystallography for this purpose in the following way.

A lattice[885] structure will be created for a user[800]—selected group of scoped media outlets[220] crossed with a specific news cycle[235], during a time window[670] that is either user[800]—specified or a user interface[820] default range. Many embodiments will support the end-user[800]—specified topic[1370] for this and similar purposes, which will generally be associated with one or more long news cycles[240]—for example “US presidential election” or “War in Ukraine.” In such embodiments, the user[800] may provide their own name for the topic[1370] as well as specify news cycles[235] or other criteria for inclusion. We will refer to the data structure as the lattice[885] and its visual representation as a crystal[880].

Depending on the individual embodiment and user[800] preference, either rows[1065] or columns[1067] will be chosen to represent individual assertions[500] that occurred in the set of all stories[100] related to a user[800]—selected news cycle[235]. The remaining dimension will represent the units of content[320] to be visualized, depending on the setting in the user interface[820]. In the default embodiment, this will include but not be limited to: individual story[100], media sub-outlet[165],media outlet format[440] of media outlet[160], media outlet[160], conglomerate [430], and scoped media outlets[220].

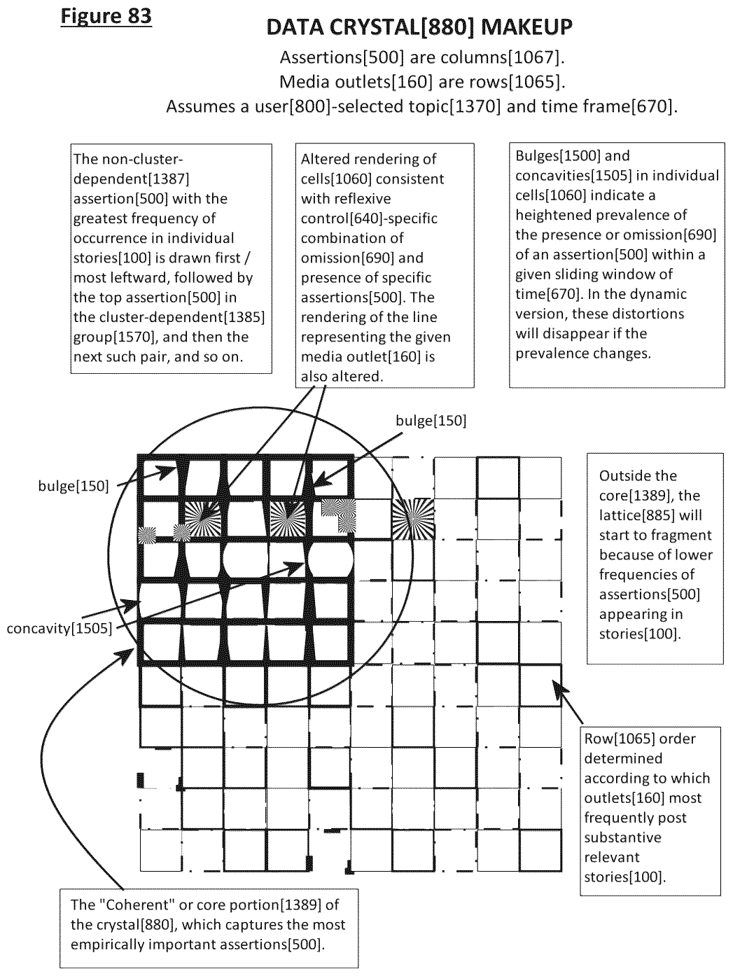

As pictured in the example in FIG. 83, the assertions[500] are columns[1067] in the lattice[885] and individual media outlets[160] are the rows[1065]. This creates a matrix[885] in which each cell[1060] indicates how many times an assertion[500] appeared in a given media outlet[160] within the time window[670] being displayed, if at all. In most embodiments, a given assertion[500] being frequently present in a given media outlet[160] (or other content container[1377] selected) is indicated by the line element[1660] representing the assertion[500] being rendered more thickly than were the assertion[500] only present once or twice; if the assertion's[500] frequency is low relative to other container units[1377] being displayed in the same crystal[880], the line element[1660] will reflect a concavity[1505] in many embodiments is shown in FIG. 83.

If the assertion[500] is largely or totally absent from all rows[1065] (if content[320] is displayed horizontally) then the line element[1660] in most embodiments will be rendered with the minimum possible width, for example 1 pixel[1315]. If by contrast the given assertion[500] appears frequently, the associated line element[1660] will be rendered more thickly; if the frequency is nonetheless relatively still less than in other outlets[160] (in this example) the thicker line will be curved in a concavity[1505]; if relatively more frequent, then the line element[1660] will bulge into the relevant cell[1060]. In other words, most embodiments will both measure and display both relative and absolute assertion[500] mentions[310]. A preferred embodiment will use line width to indicate the absolute data and curvature to indicate relative measures, as seen in FIG. 83.

Curvature will be used in a preferred embodiment for three reasons. First, it metaphorically suggests that force is being applied to the crystal[880]—in other words, bias[260]. Second, the bulges[1500] and concavities[1505] have the desired effect of robbing or adding space to the relevant cells[1060]. Third, curves stand out visually against what is otherwise largely straight lines and angles in the crystal[880].

The core or coherent portion[1389] of the crystal[880] is defined by portion of cells[1060] that are bounded by both line elements[1660] that have a minimum logical width in one dimension and in the other dimension by content[320] being present that contains the assertion[500] at least once in the given cell[1060].

In most embodiments, if the coherent portion[1389] of the crystal[880] will include fewer than N cells[1060] it will not be rendered in the first place, with N being a configuration[815] parameter. This is because such a situation would indicate that there is an insufficient amount of agreement among the relevant stories[100] being pictured in the key facts. (Note that this situation is unlikely to occur in most embodiments because of how stories[100] and news cycles[235] are defined. However since users[800] can request crystals[880] to their own specifications, this situation could potentially occur.)

This visualization[837] in most cases therefore is best suited to displaying whole media outlets[160] or larger groupings rather than individual stories[100] as the coherent portion[1389] of the crystal[880] will be noticeably larger.

### Building the Lattice[885]

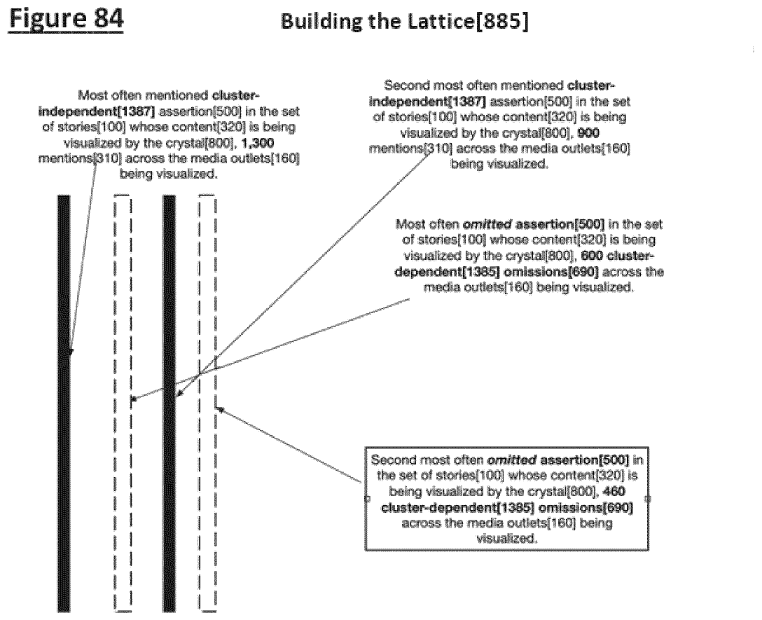

As shown in FIG. 84, once a new crystal[880] has been requested, an omissions graph[693] based on the relevant outlets[160] will be constructed which will then be fed into the clustering process[1340] selected by the given embodiment. This will be done by almost all embodiments so as to determine whether the discrepancies in assertion[500] presence are strongly correlated to specific clusters[1375]—in which case the system[180] will consider them to be omissions[690] or whether, as in the case of some of the human-interest assertions[500] in the Greenland example, their appearance is largely (or totally) independent of a cluster[1375]. In other words, while variability in assertion[500] presence is normal and desirable, the coherent portion[1389] of the lattice[885] must be adequately sized for purposes of analysis. If the number of cells[1060] in the coherent portion[1389] of the lattice[885] falls below the configuration [815]—defined threshold, the crystal[880] will not be rendered. In this event, a user interface[820] error will be generated; some embodiments may offer iterative search capabilities, in other words suggesting to the user[800] ways to expand the scope of the content[320] so that a crystal[880] could be generated.

Almost all embodiments will exclude the case in which outlet[160] membership in a qualifying cluster[1375] highly correlates to a specific scope[170]. For example, if a given assertion[500] is very highly probable to occur in media outlets[160] scoped[170] to the finance sector[1515], but in few other places, the most probable real world explanation for any absent assertions[500] more broadly is simply is that they contain very sector[1515]—specific content[320]. Some embodiments may nonetheless opt to analyze the tokens[900] in such assertions[500] to determine if they are in fact far likelier to occur in highly sector[1515]—specific jargon of the given type than general content[320]. Such embodiments may choose to not exclude these cases. Certain embodiments will find it useful to compare this small omissions graph[693] to the graphs used in the full processing of the bias detection[1420] and omission steps[1425]. This is with the aim of assessing whether the media outlet[160] behavior with respect to the given topic[1370] currently being visualized is generally consistent with the already established clusters[1375] of biases[260]. Likewise, some of these embodiments will prefer to order the presentation of outlets[160] in the cluster-dependent[1385] group[1570] in the crystal[880] not purely by frequency of occurrence of assertions[500] but also factor in the degree of similarity between the graph structures of the relevant media outlets[160] in the omissions graph[693] associated with the particular crystal[880] and within the broader omissions graph[693]. Any subgraph matching algorithms of the appropriate scale for the graph sizes in question can be selected for this purpose.

In most embodiments, the assertions[500] will be ranked in order of their frequency of occurrence in the set of all stories[100] on the given news cycle[235] in the set of media outlets[160] during the specified time window[670]. In just about any real-world situation, at least several assertions[500] will appear in the vast majority of individual stories[100] associated with the news cycle[235] being viewed. This is somewhat definitional: for new news cycle[235] objects to be formed, there must be enough commonality among them that clustering[1340] or other isomorphic process can recognize substantially (more) self-similar groups. Most often this will be at least in large part on the basis of such core assertions[500] (However, as noted above, users[800] could conceivably request crystals[880] that would generate edge cases)

In most embodiments, the assertions[500] will now be divided into two groups. The first group[1570] is the highly cluster-dependent[1385] ones, the second group[1580] the largely cluster-independent[1387] ones. Different embodiments may set their own thresholds for what the bar will be for an assertion[500] to be considered cluster-dependent[1385]. Most embodiments will choose to truncate a distribution curve past N distributions so as to to eliminate assertions[1575] that are both low frequency and cluster-independent[1387]; very low frequency assertions[500] even that are cluster-dependent[1385] will also be truncated below configuration[815]—specified threshold values. Most embodiments will provide two parameters[815] for this purpose, one for each of the two groups of assertions[500]. Likewise, most embodiments will set thresholds for the high frequency case in which only a very small number of clusters[1375] representing a small number of outlets[160] omitted the assertion[500]. This is because there will always be a small number of outlier media outlets[160] which do not behave in normal ways, and most embodiments will choose to discard such outliers.

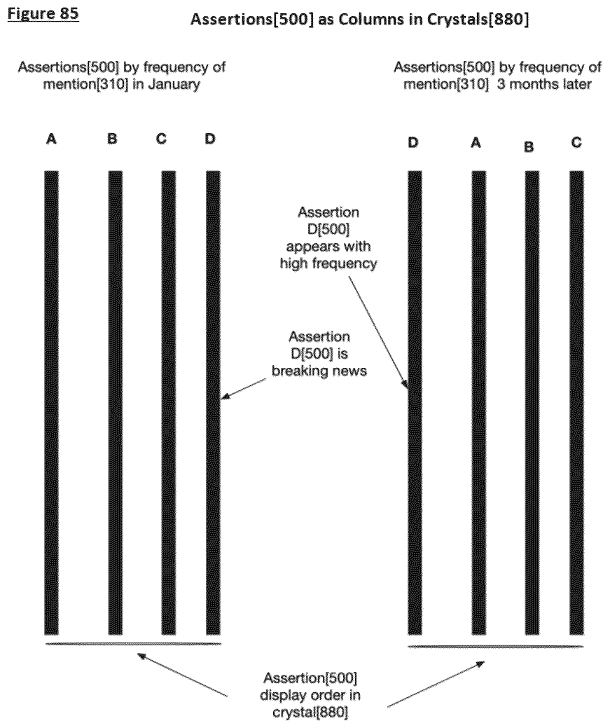

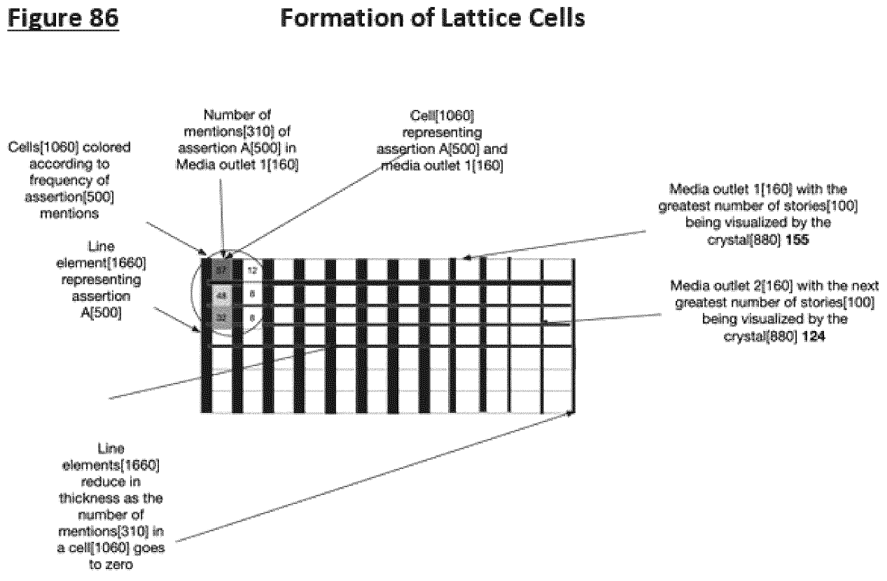

In most embodiments, if columns are being used to depict assertions[500], instances[500] from the two groups of assertions[500] will be displayed in alternating order, with the highest frequency assertion[500] from the cluster-independent[1387] set[1580]. This is shown in FIG. 85. In most embodiments and configurations, this means ordered from left to right, if the assertion[500] are represented by columns[1067]. This will continue until the last remaining assertion[500] that has not been truncated from the list has been rendered. In most embodiments if the cardinality of the two sets is different, a visual boundary will be rendered to separate contiguous instances of assertions[500] from the same group as per FIG. 86. Some embodiments may prefer to visualize and order the cluster-dependent[1385] assertions[1570] by number of omissions[690] in preference to frequency of appearance. This ordering approach to the assertions[500] will be taken by many embodiments because it creates a desirable crystal-like regularity especially in the coherent part[1389] of the crystal[880].

In most embodiments, columns[1067] or rows[1065] will have their widths increased, decreased, or curved in different parts of the matrix[885] so as to draw the user's[800] eye to an anomaly. Note that actual, well-formed crystals usually have a distinct regularity to them which makes deformations in given cells much more noticeable as per FIG. 83. Most embodiments will color the “empty” cells[1060] of the crystal[880] to be based on the frequency of occurrence of Assertion A[500] associated with the cell[1060] to the right (in most embodiments) of the line element[1660] representing Assertion A[500]. Since by definition, the cluster-dependent[1385] group[1570] of assertions[500] will often be omitted especially in the coherent portion[1389] of the matrix[885], the column of cells[1060] for these assertions[500] will “empty” and hence in most embodiments will assume the bright color of the background.

In some embodiments, the content container units[1377]—in the pictured example, media outlets[160] are rendered in descending order based on the number of stories[100] they posted on the selected topic[1370] within the selected time frame[670]. Many embodiments will also choose to factor in the size or length of the stories[100] in this calculation. Any reasonable length calculation can be used, even counting tokens[900] or sentences[910]. (Note that almost all embodiments will anyway have a system[180]—defined minimum story[100] length.) In other embodiments, included the pictured one in FIG. 85, the display order of the content container units[1377] is determined by the count of non-discarded assertions[500] present.

In this way, as shown in FIG. 84, a lattice[885] for what we will refer to as a “data crystal” [880] is built up. In most embodiments, the line elements[1660] representing assertions[500] in the cluster-independent[1387] group[1580] will be depicted in a dark color, often black. By contrast of cluster-dependent[1385] group[1570] may be rendered with a lighter fill or no fill at all in some embodiments. Thus they will take on the bright background color of the display instance. While most embodiments will allow end-user[800] configuration of the color scheme to be used, by default this background color will be consistent with the type of high contrast coloring common in crystallography images.

The quasi-regularity of lattice[885] will break down as the two lists of assertions[500] are rendered; the lower frequency assertions [500] will, by definition, appear in fewer container units[1377]. Thus more and more empty cells[1060] bounded by minimal thickness will be rendered; some embodiments may choose not to render any visible line. Likewise, the container units[1377] that had only few stories[100] on the given topic[1370] are not likely to contain a large range of assertions[500]. For this reason, most embodiments will truncate the list of container units[1377] based on insufficient content on the topic[1370] within the specified time window[670]. This is actually a desirable feature of the lattice[885] visualization[837]. This is because it is an effective means of visualizing both the core set of assertions[500] about a given topic[1370] within a given time period[670], and also what can be called the most polarized or cluster-dependent[1385] assertions[1570]. At the same time, the size of the coherent portion[1389] of the lattice[995] relative to the rest of the lattice[885] indicates how much agreement there is among the pictured outlets[160]; if it[1389] is small for example, collusion[650] is clearly not occurring.

### Reflexive Control[640]

Those embodiments intended for use by intelligence organization will often include a visualization of reflexive control[640] in the lattice[885].

Reflexive control (RC) is a Russian disinformation doctrine which Wikipedia describes as “a process in which one adversary hands over to the other the basis for decision-making. In other words, there is a substitution of motivation factors of the enemy in order to encourage him to take disadvantageous decisions.” In practice, this involves altering the national information space so that topics which are disadvantageous to achieving one's objectives are marginalized in, or even removed from the space. Those topics which are helpful by contrast will be introduced or boosted.

The assertions[500] in question may be true, untrue, debatable, or simply unknowable. Reflexive control is disinformation doctrine because its aim is to exert malign influence over an enemy—even in the event that all assertions[500] are clearly true. A simple real-world example of RC[640] is that Russia benefits from the US government believing that China is a very serious national security threat—so serious that nothing else can be allowed to waste focus on anything else.

It is important to note that a media outlet[160] happening to post content[320] with similar assertions[500] to known RC campaigns[645] does not by itself suggest that that media outlet[160] is in fact being influenced by that campaign[640]. However it may nonetheless be interesting to understand and visualize instances in which, over the course of time, any particular media outlets[160] even fairly consistently align with known RC campaigns[645] attributed (by the user[800]) to a particular government or entity—and only rarely, if ever, substantially diverge from them by whatever preferred measurement. To this end, most embodiments will offer a system configuration[815] parameter for how much overlap is too much in such cases; most embodiments will also allow the use of any custom calculations preferred by the user[800].

Most embodiments will accept either end user[800] input through the user interface[820] or programmatically-entered input that allows the system[180] to know of what specific assertions[500] and topics[1370] a particular RC[640] campaign of interest consists. The exact input required will depend on the particular embodiment. For example, some embodiments will accept a collection of stories[100] that are considered to be part of the RC[640] campaign in question. Others may offer the user[800] a selection of topics[1370] and assertions[500] to associate with a particular RC[640] campaign via the user interface[820].

Others may prefer to create a set of scoped outlets[220] that corresponds to outlets[160] that while targeted at the audience of one country or region are part of a conglomerate[430] believed to be controlled or owned by a particular adversary. Many embodiments will offer multiple input methods since RC[640] is designed to blend into the information space. Half of the mission of RC[640] is to amplify assertions[500] that were already organically present anyway. And because, as elsewhere noted, establishing accurately who actually owns a given media outlet[160] is not always straightforward, even outside the context of those running intelligence operations on behalf of a government.

Most embodiments will visualize possible instances of RC campaign[645] influence by altering the rendering the cells[1060] in the matrix[885] which reflect potential evidence of such influence. A default embodiment will use a rendering technique that evokes the growth of some kind of organism, or an apparent chemical reaction that is degrading the structure of the matrix[885]. Whatever exact technique is selected, it should result in rendering sets of pixels[1315] in the specified areas that immediately suggest that something is amiss—like mold growing on food or rust on the bottom of a car. An example of this is pictured in as per FIG. 83.

Almost all embodiments will change the rendering of more than just the impacted cells[1060] however; they will also use the same rendering technique in other places across the entire line in the matrix[885] that represents the particular media outlet[160]. This is because the real issue—if there is one—lies with the management of the media outlet[160], not any given story[100] here or missing assertion[500] there.

Continuing the example above, for US audiences, Russia wishes to de-emphasize the topic of increasing Russian-Chinese military cooperation as this would make Russia appear to be a greater strategic threat. Thus, not only would an ongoing emphasis on the Chinese threat be required, but omissions[690] involving the Russia-China military cooperation; most embodiments would require at least several pieces of such evidence to establish a possible pattern of influence. Different embodiments are likely to set their own thresholds in this regard.

While RC[640] is generally associated with governments or para-statal organizations, analogous commercial use cases exist. These include, but are not limited to, RC[640]—like attempts to dominate and manipulate the information space provided by specific channels[1627] or forums on social media platforms[1625], especially with respect to either specific entities[350] or linguistic entities[1690.] Such cases include but are not limited to so-called “pump and dump” efforts to temporarily elevate the price of a particular traded commodity[1690] or impact the outcome of a large lawsuit by flooding the channel[1627] with many instances [505] of specific assertions[500] about the particular linguistic entity[1690] or entity[350] while notably omitting others [500].

Most embodiments will require specific elements to be present in order to establish “domination and manipulation” of the given channel[1627] with respect to the given commodity[1690]. These elements may include, but are not limited to: determining the percentage of all content[320] on the channel[1627] involving the entit(ies)[350, 1690] in question, applying statistical models of choice based on data[1435] available to the system[180] to determine the level of audience for the transcript[480]—equivalent (either relative to the channel[1627] altogether or relative to the particular linguistic entities[1690],) and data[1435] exogenous to the channel[1627] including but not limited to: changes or fluctuations in the actual trading price of the commodity[1690].

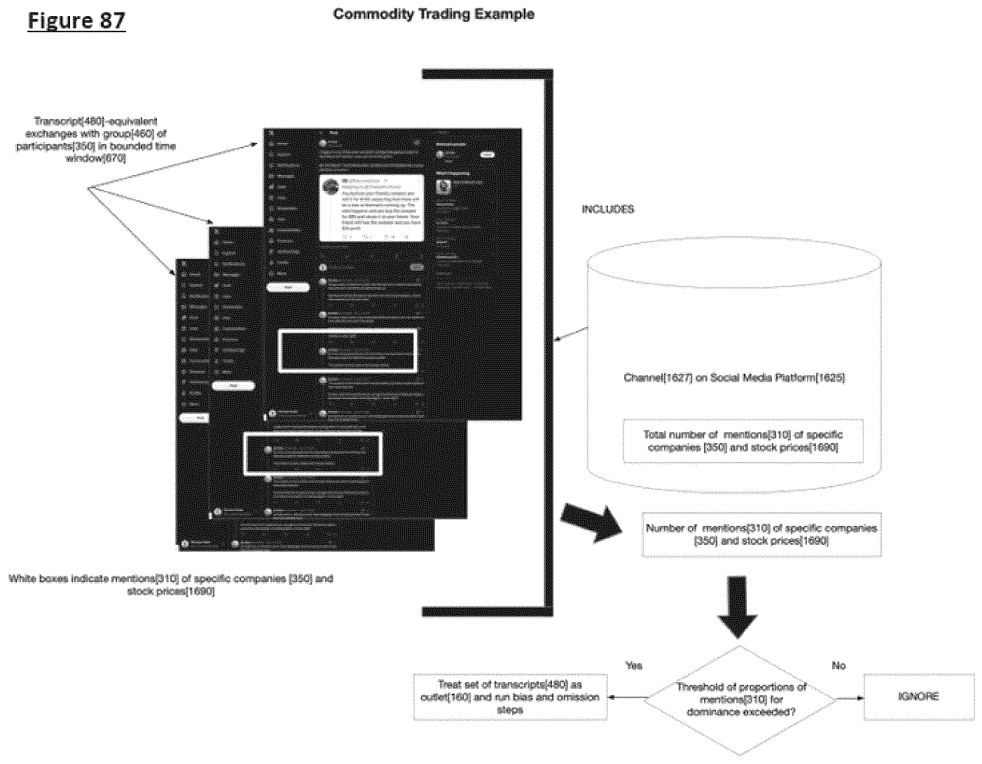

In other words, as shown in FIG. 87, the system[180] will aim detecting actors[350] whose interactions on a particular channel[1627] or other container[420] in a social media platform[1625] dominate that channel[1627] or other container[420] to such an extent with respect to specific entities[350] or linguistic entities[1690] (such as a stock) that it can reasonably be said that they are shaping opinion within that context. Most embodiments will place minimum size constraints of their choosing on the channel[1627] or other container[420]. These can include but are not limited to: content[320]—related, placement[300]—related (in the sense of appearing in special containers[420] or sections[330], or audience size-related, if such information is available to the system[180].

### Dynamic Visualization

Most embodiments will support a dynamic version of the matrices[885] and hence crystals[880]. When the matrix[885] uses individual stories[100] for rows[1065], the rows[1065] are constantly being added as new relevant stories[100] appear. Older stories[100] will age out, with their row[1065] being removed. If the rows[1065] represent media outlets[160], a sliding window[677] will be used to select the stories[100] whose content[320] is currently reflected in the display instance[840]. This is sensible since, for example, “popular” stories[100] may be quite visible online for even several days after they appear—or longer in some cases, such as promotions[1555]. Similarly, new assertions[500] may appear over the course of a news cycle[235], while older ones will be aged out if they no longer occur, resulting in the removal of a column[1067] from the matrix [885].

Because the number of assertions[500] related to a given topic[1370] may be quite large in any given period of time, and because the cases in which an assertion[500] is inconsistently present are the interesting ones, the columns[1067] representing such assertions[500] should be moved leftwards (in most embodiments) based on the extent of such disagreement. This is because in most parts of the world people read left to right, and because not all columns[1067] will always be visible without scrolling.

However, because it is quite visually distracting, no assertion[500] display order swaps as shown conceptually in FIG. 84 and later will be performed in most embodiments unless the difference in frequency of occurrence as defined above or cluster-dependency has become large enough to merit the visual distraction to the user[800]. In many cases there are unlikely to be major shifts after the initial rendering of the matrix[885]. Different embodiments may set different threshold levels and mechanisms in this regard.

Bulges[1500] and concavities[1505] will be rendered as growing (up to the system[180]—specified max) or likewise receding according to the incoming data in most embodiments.

### Crystal[880] Shattering

The class of edge case in which massive, abrupt change in numerous omissions[690] across a significant number of media outlets[160] occurs may be rare, but when it does appear, the visualization[837] must adequately reflect its importance.

A preferred embodiment will handle a case such as the avalanche of reporting on Biden's decline after a disastrous debate with Trump in the following way. The crystal[880] will start to break apart at the line elements[1660] representing the specific assertions[500] whose treatment with respect to being stated or omitted has suddenly and dramatically altered across at least a preset fraction of media outlets[160] that appear in the core or coherent portion[1389] of the lattice[885]

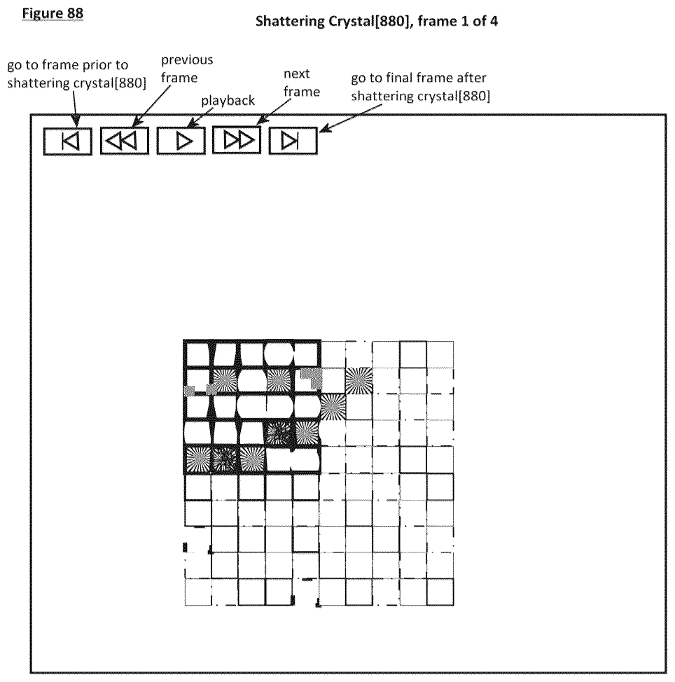

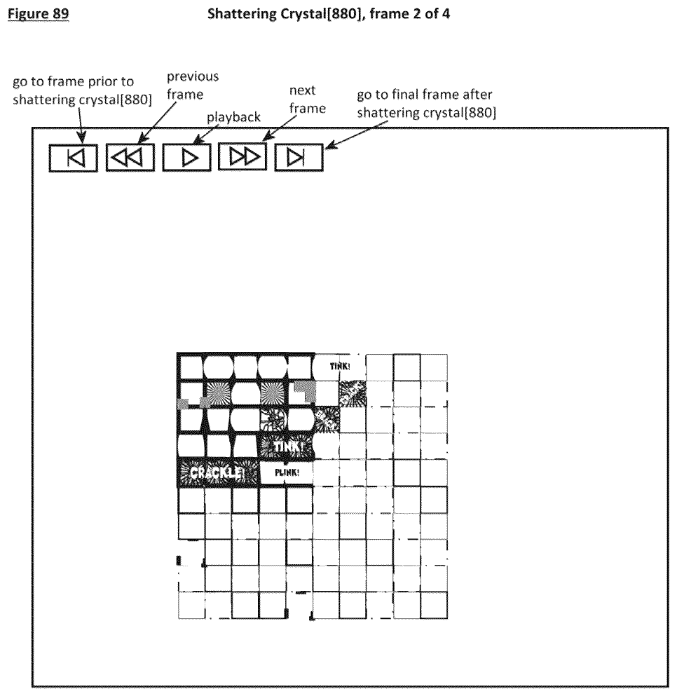

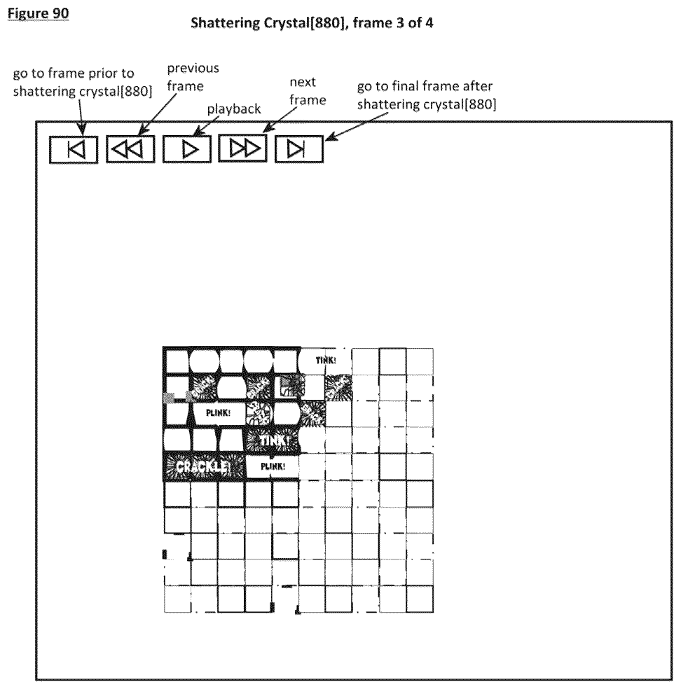

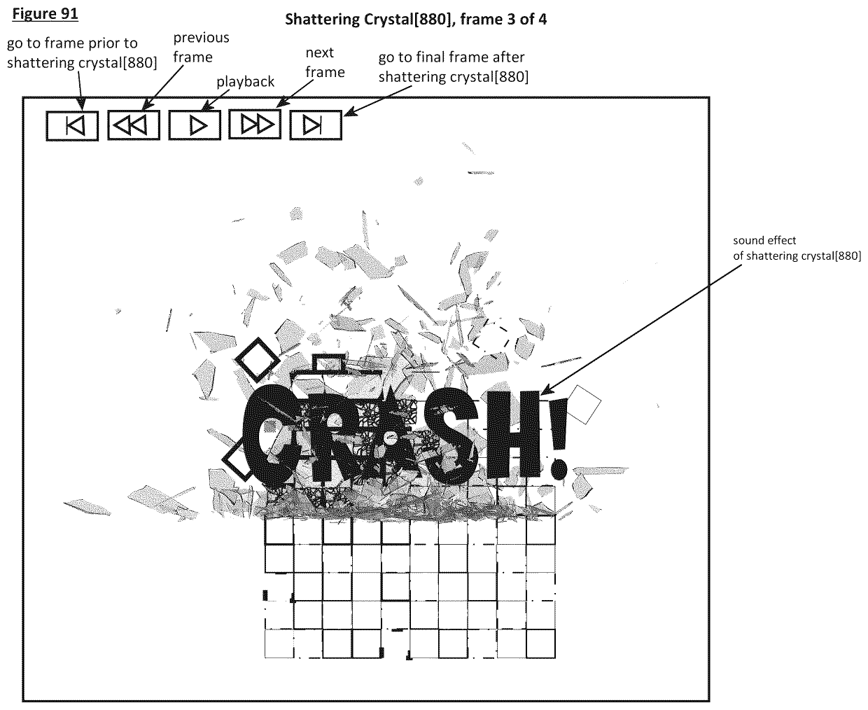

In this event, in most embodiments, the user interface[820] will display an animation in which the crystal[880] shatters. The degree (of score[270] change) and scope (number of impacted assertions[500]) of the discontinuity will cause the crystal[880] to shatter with more force depicted in the animation and with a correspondingly louder and/or longer sound effect of shattering in many embodiments, as more line elements[1660] in the lattice[885] break with greater force. This is depicted in frames in FIG. 88, FIG. 89, FIG. 90, and FIG. 91. Many embodiments will also use optional sound effects of shattering glass or similar.

In deciding when to shatter the crystal[880], many embodiments will consider not only changes in assertion[500] appearances[310] but also prior non-textual omissions[690] being abruptly reversed. For example, media outlets[160] who only started showing video footage of Biden stumbling or appearing disoriented after the debate—and so concurrently to the change in omission[690] patterns.

In the event that a crystal[880] is shattered, most embodiments will recalculate the matrix[885] based on only data from the point in time that the large discontinuity that caused the crystal[880] shattering was observed. Otherwise put, any data collected prior to the point at which the system[180] determined that the crystal[880] should be shattered will no longer be considered for the purposes of current analysis and visualization. However, most embodiments will provide both user interface[820] and computational methods for comparing “before” and “after” shattering crystals[880]. Many of these embodiments will require a suitable amount of “after” content[320] so as to have sufficient data[1435] to perform an apples-to-apples comparison. In most embodiments, there will be one or more configuration parameters[815] to address the minimum data amounts required for comparison purposes.

### Comparing & Contrasting Different Data Crystals[880]

One of the key advantages of this visualization[837] is the ability to visually compare data crystals[880] to one another. Conceptually, this can be likened to viewing the patterns of light escaping through the holes in one piece of Swiss cheese and then comparing it to when another piece of Swiss cheese of the same size and with the same orientation is added. With nearly identical slices of cheese, the projected light patterns will also be nearly identical to either slice viewed independently.

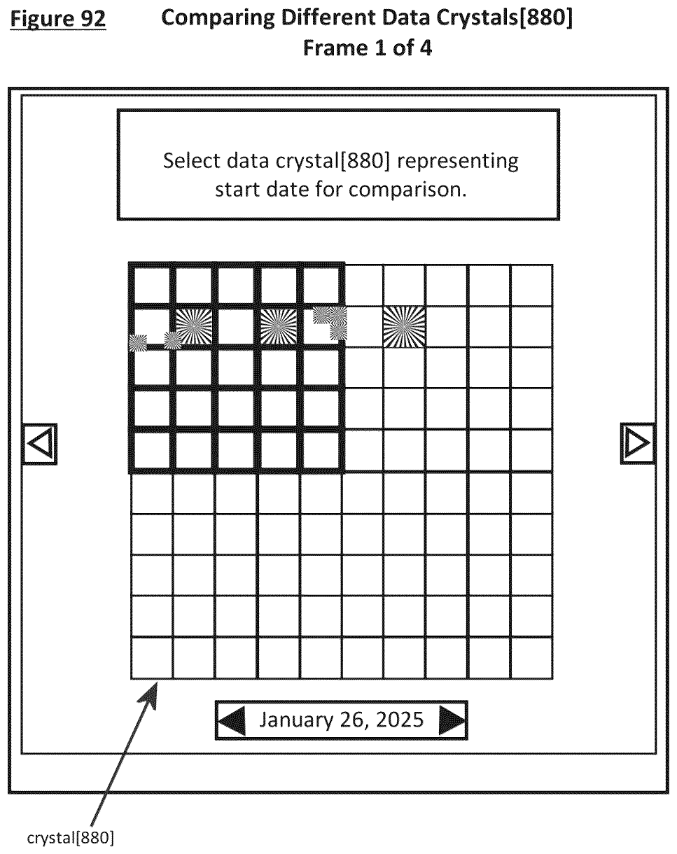

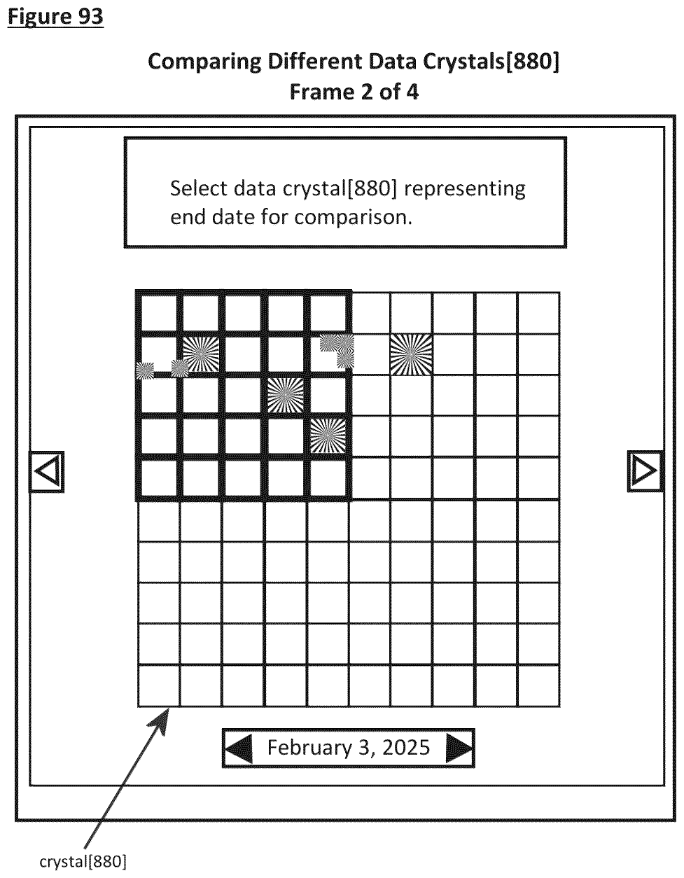

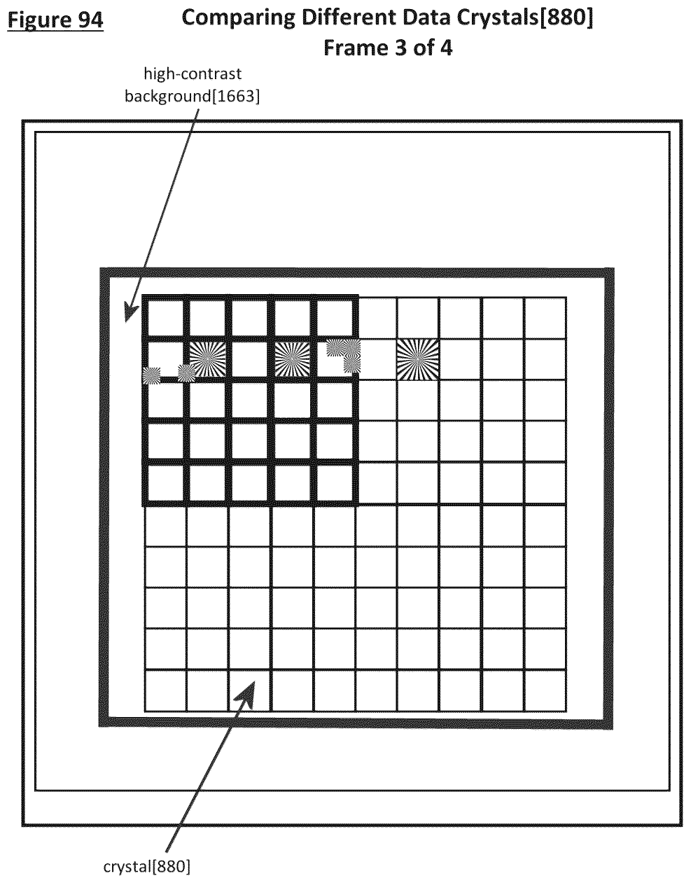

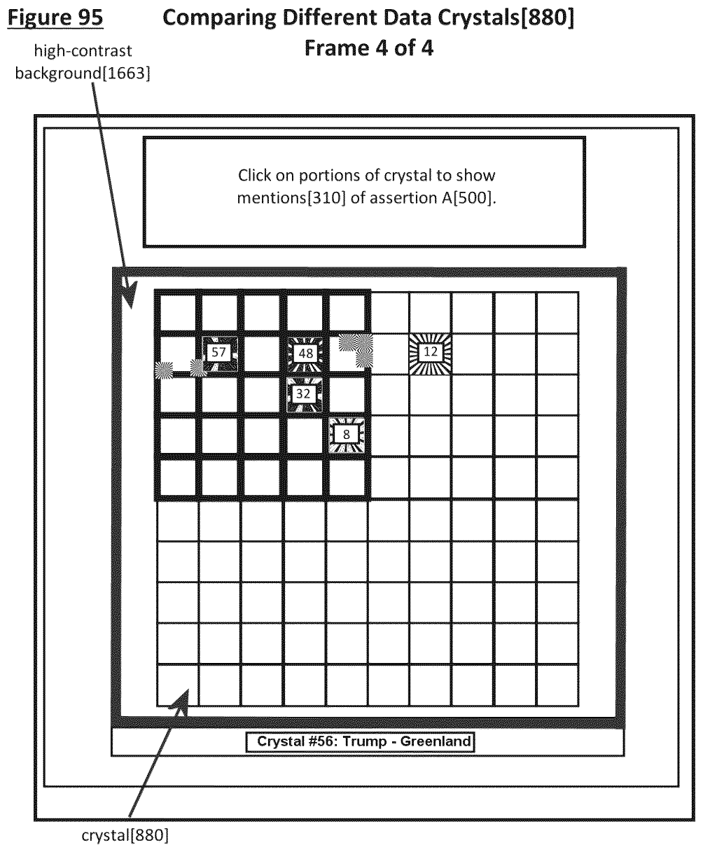

Many embodiments will display two crystals[880] representing different media outlets[160] coverage of the same topics[240] and same time periods[670] on top of one another with each crystal[880] being semi-transparent. This is illustrated in frames in FIG. 92, FIG. 93, FIG. 94, and FIG. 95. This is a visually compact method of showing the differences. Many embodiments will offer views with matrices of small images of comparable data crystals[880] so that more crystals[880] can be on screen at once. Many embodiments will provide this capability in animated or video[140] form by concatenating images of the states of the crystals[880] in sequence over the user[800]—requested time period.

Almost all embodiments will allow the user[800] to mouse over or click on the different portions of the crystal[880] to bring up panels containing detailed information including but limited to the relevant assertion[500] mentions[310], related statistics, RC campaign[645] correlation.

### Radio Tower Visualization[835]

Because news is happening 24×7, and the number of media outlets[160] will be large in most scopes[170], most embodiments will choose to provide a highly dynamic visualization[835] that provides a gestalt view of one or more scoped media outlet[160] ecosystems[1020], and that is much richer than a standard chart. To this end, a preferred embodiment will offer a visualization[835] that combines the streams of mentions[310] of target entities[150] with other visual indicators of success or failure.

The goal of the visualization[835] is that it is immediately apparent to users[800] which of the target entities[150] that they are following are currently faring well in the overall media environments[1020] of interest and which are not. Almost all embodiments will support the notion of user[800]—defined groups of target entities[150] for purposes of generating more readable reports[1090], and for having different display instances [840] for different logical groups rather than trying to cram too much information into a single display instance[840].

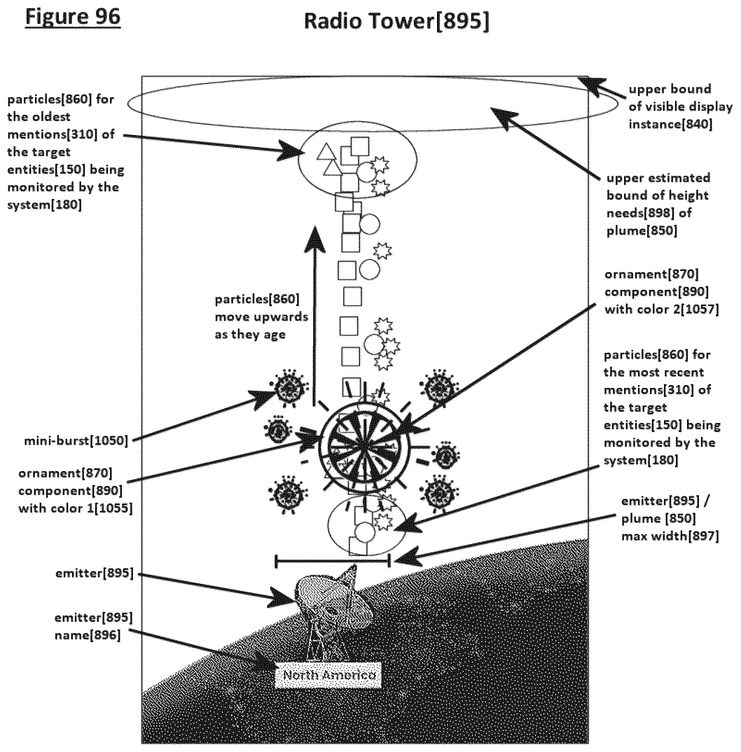

As shown in FIG. 96, in a default embodiment, each set of scoped media outlets[220] will be rendered as an object[895] that emits a stream of fireworks-like bright particles[860]. In some embodiments, the particles[860] may jitter in a Brownian-motion-like way. Most embodiments will allow users[800] to specify which scoped media outlets[220] to render and allow minimum thresholds for mention[310] activity with respect to the set of target entities[150] so as to ensure that there will be sufficient activity for the visualization[835] to be effective. Likewise, the user interface[820] in most embodiments will allow users[800] to specify which target entities[150] should be included in the display[840]; most embodiments will allow multiple display instances[840], as well as the choice as to whether or not to combine or compare target entities[150] within the same display instance[840] and within the same stream of rendered mentions[860] and other notifications[1000].

Each mention[310] of a relevant target entity[150] is visualized as a small particle[860]. In some embodiments, particles[860] representing mentions[310] from the same story[100] will be rendered much closer together than the particles[860] for mentions[310] from different stories[100] appearing at a similar time. The particles[860] are assigned different colors[1055]—and/or sizes[867], depending on the particular embodiment—to reflect the qualitative value[305] of the mention[310] it represents. In most embodiments this will be placement value[305]—focused, because mentions[310] with their placement values[305] are by far the most frequently instantiated system[180] object in most embodiments. In a default embodiment, the different particle[860] colors (and/or sizes[867], if appropriate) will be as follows:
Placement[300] in headline[970], video[140] or audio[290] content title[970], inferred title[970] or chyron[620].
Likewise, for sub-headlines[975] or chyron[620] content separated by a period, colon, or semi-colon from the initial text[120].
Placement[300] in first section[1070]
Placement[300] in the middle sections[330]
Placement[300] in closing section[1075]

Some embodiments may choose to simultaneously depict relative placement[1040] and absolute placement[1030], using the two dimensions of size[867] and color[1055]. For relative placement[1040], most embodiments will offer choices that include, but are not limited, to the following options:
Placement[300] relative to specific other target entities[150], as supplied either through the user interface[820] or programmatically by the user[800].
Placement[300] relative to other entities[350] in the same equivalence class[450], for example other world leaders, or group[460]
Placement[300] relative to any named entity[350], whether one recognized specifically by the system[180] or not.
Any custom scheme of the user's[800] choosing

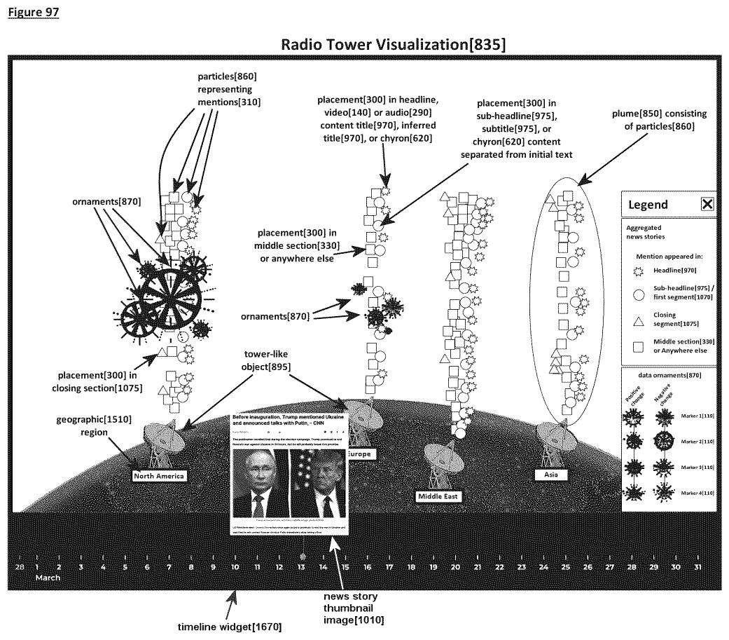

Each new set of mentions[310] detected by the system[180] of a relevant target entity[150] of a media outlet[160] that is rendered in the particular display instance[840] will result in one or more new mention[310] particles[860] being rendered at the base of the stream or plume[850] of the relevant emitter[895]. In a default embodiment as pictured in FIG. 97 this is a tower-like object[895]. In most embodiments, the size of emitter[895] object will be correlated to the average logical height[898] and width[897] of the associated plume[850] during hours of peak activity for the associated geographic area for the scoped media outlets[220] being represented. This includes 3D perspective rendering such that some emitters[895] are pictured as being farther away than others[895] and hence smaller.

Most embodiments will set a maximum width[897] for a single emitter[895] in a display[840] that contains multiple emitters[895]. This is to help ensure that the user[800] will not need to scroll horizontally, nor use any other kind of navigation control in order to view all of the emitters[895] simultaneously. Most embodiments will likewise set a minimum width that allows more complex objects in the plume[850] like ornaments[870] to be rendered visibly. What determines the width[897] of each emitter object[895] within these bounds in most embodiments is the probability, (based on prior observed levels of activity if near-real time mode, or the actual level of activity if in playback mode) that particles[860] in the emitter's[895] plume[850] will have to be overwritten by other particles[860] or ornaments[870]. This is because, ideally, all particles[860] and ornaments[870] should be fully visible to the user[800] without having to resort to zooming in.

Similarly, the expected height[898] need for the plume[850] will be considered by most embodiments in placing the emitter object[895] in the display[840] even if it means changing the globe orientation (in the embodiments that use this.) Each plume[850] has a defacto maximum height that comes from the upper visible bound of the display instance[840] in many embodiments. This is in part because almost all embodiments will provide users[800] with a single click control to capture the current display[840] image. Potentially significant information could thus be either lost or not seen by the user[800] prior to screen capture if plumes[850] were allowed to become arbitrarily high and draw outside the boundary of the visible part of the display instance[840]. Most embodiments will also set minimum plume[850] heights[898] to allow particles[860] to float up before disappearing from the display[840].

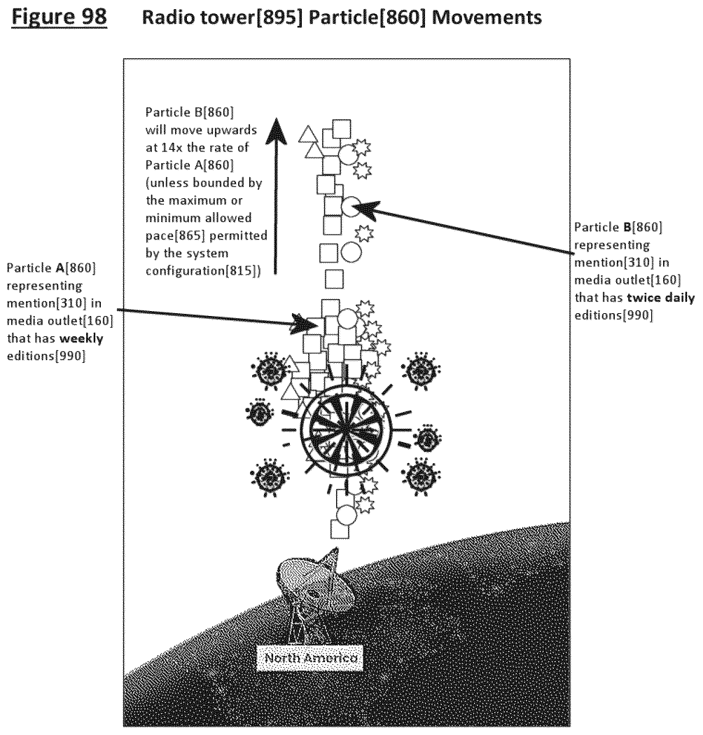

As shown in FIG. 98, what determines the positioning of the emitter[895] and hence the available plume[850] height[898] in most embodiments is the average rate of incoming particles[860] during peak operating hours for the relevant scoped media outlets[220]. This is because a higher rate suggests a shorter edition[990] periodicity of at least some of the media outlets[160] and/or a greater number of stories[100] per day for at least some of the media outlets[160]. Both of these things mean that particles[860] will have a faster upward pace[865] and so will age out[995] of the plume[850] faster. (For clarity, this is because not only do mentions[310] from new stories[100] that involve target entities[150] replace the slightly older ones as the “most current” but also the next edition[990] of an outlet[160] replaces the prior one[990] causing the mention[310] particles[860] to age out[995].)

This in turn means that the plumes[850] that have greatest peak activity (e.g. the highest number of particles[860] within a given day) should be given more vertical space to render in the display[840] than plumes[850] with lower levels of activity. The exact display[840] layout used by the particular embodiment for this visualization[835] will vary. However, most embodiments will determine emitter[895] position—and hence available plume[850] height[898] by prioritizing the most active plumes[850] to have the greatest vertical space.

Since scopes[170] will often be geographic[1510] in nature, a default embodiment renders the emitters[895] so as to indicate the geographic region[1510] to which they are bound. However, other embodiments may choose to use no metaphorical emitter object[895] and to forego a geographic[1510] display of data. These embodiments may choose from any number of different display strategies for the plumes [850]. These include, but are not limited to: labeled horizontal or vertical swim lanes, partitioning the available viewing space into a matrix of smaller, labeled individual display instances[840], and rotating 3D views.

Because media outlets[160] may have more than one scope[170], most embodiments will provide users[800] a choice as to whether to collapse the sets of scoped outlets[220] by the scope[170] with the largest number of outlets[160]. This will most often be geographic scope[1510]. Similarly, users[800] may choose to have separate emitters[895] rendered in the display[840] according to secondary scopes[170]. In this event, the plume[850] data[855] from the smaller emitters[895] can be kept separate from the emitter[895] for the primary scope[170], or displayed twice in essence. For example, an emitter[895] for North America could have three different language scopes[170]: English, French, and Spanish. Depending on the system configuration[815], this could result in 4 emitters[895] being rendered: an overall one for the region of North America, plus the three smaller, language-related ones[895]. All data[855] from North America would be included in the overall emitter[895] for North America as per FIG. 97.

As new mention particles[860] are emitted at the base of the plume[850], older, unrefreshed ones[860] will scroll off the top (or end) of the display view[840]. In a default embodiment, these particles[860] dissolve in the same way that fireworks do in the sky, allowing more screen space to be consumed by incoming particles[860].

However, the motion of the plume[850] is not only driven by the arrival of new mentions[310]. Earlier mentions[310] will age out in most embodiments whether or not there are new mentions[310] arriving to replace them. Thus, in almost all embodiments, once initially rendered, particles[860] will move upwards at a certain minimum pace[865] until they fade from the top of the display[840]. If no new mentions[310] are appearing, there will simply be no new particles [860] being rendered until more do.

The pace[865] at which a given particle[860] (or groups of mentions[310] that appeared in the same story[100] will be determined in most embodiments according to the system's[180] estimate of the aging out period[995] of the media outlet[160]—and if appropriate, any sub-outlet[165] with its own particular characteristics—in which the bounding story[100] appeared. However, most embodiments will establish default, but user[800]—modifiable, minimum and maximum rate of movement[865] for the particles[860]. This is because particles[860] that move too quickly may in effect not be visible to the user[800]. Particles[860] that move so slowly so as to appear fixed in time would falsely convey the impression of content that does not age.

Because different formats[440] of media outlets[160] have content[320] that ages out at very different rates, and in quite different ways, most embodiments will try to estimate appropriate rates of aging out[995] for different media outlets[160]—or at least different classes of media outlet[160] in this regard. “Aging out” [995] does not generally mean that the story[100] disappears altogether. Rather it refers to the fact that stories[100] lose placement[300], and in most cases relevance, over time. In other words, their accessibility and accordingly viewership greatly diminish, at least absent some anomalous event. What today is the top story on the home page of a website may within just two days require a correctly targeted search to find in many cases. At some point, stories[300] may effectively disappear behind a paywall, into an archive, or into the bottom of long search results.

In those embodiments in which lifetime placement value[308] of the story[100] is calculated, the same calculation will be used here in most, scaled to the range established by the maximum and minimum rates of particle[860] movement[865]. In other embodiments, a range of options may be used. These include, but are not limited to:
The edition[990] periodicity of the lowest level media outlet[160] that contains the story[100] that contains the relevant mentions[310]. For example, once a new edition[990] of a podcast or a news show has appeared, content[320] from the prior edition[990] is considered aged. Some embodiments may simply use an average value for a class of media outlet[160].
Analysis of the viewership curve fall off—in other words, when for example 80% of the people who will read the story[100] have done so—for the lowest-level media outlet[165] that contains the story[100] that contains the relevant mentions[310]—if it is available to the system[180]
Analysis of the curve for user comments for the lowest-level media outlet[165] that contains the story[100] that contains the relevant mentions[310]—if it is available to the system[180]
The average or specific length of time that a link to the story[100] remains available in any type of “featured content” display. Such displays include but are not limited to special sections[330] like “trending now,” “most popular”, “most read,” “most shared,” “most commented on,” and “best of” or otherwise curated lists.

In most embodiments, more mentions[310] associated with an emitter[895] means that first the plume[850] of particles[860] will increase in width[897] to the extent possible in the location in which a greater number of mentions[310] has appeared. However, in almost all embodiments, the possible width[897] of the plume[850] is bounded by the size of the emitter[895]—whose width[897] is initially determined according to the expected display needs of its plume[850]. Were this not the case, the plumes[850] from different emitters[895] would overwrite each other in the display[840], which is not desirable. Most embodiments will not change the size or position of the emitter[895] dynamically in an active display[840.] However, some embodiments may choose to provide other visual clues to the user[800], for example showing tower[895] changing color so as to suggest metaphorically that it is straining with activity; some embodiments may offer users[800] the choice of automatically modifying the emitter[895] size and position periodically.

Thus the density of the particles[860] will become greater once the permissible width[897] has been consumed. In almost all embodiments, in this event the higher quality, and hence rarer mention particles[860] will be rendered above the lower quality ones. For example, particles[860] representing headline[970] appearances, will be rendered at the highest level (that is, will be rendered above all other particles[860]) so that they remain easily visible to the user[800]. This will have the effect of distinguishing the more important target entities[150] from the less important, and barely mentioned ones[150].

In almost all embodiments, the user[800] can click anywhere inside the plume[850] to bring up a panel containing information about the relevant mentions[310] or other notifications[1000] such as a change in marker[110] value[270]. In most embodiments, the information will minimally include but not be limited to the plume data[855] and the values of any markers[110] that were calculated for the given story[100].

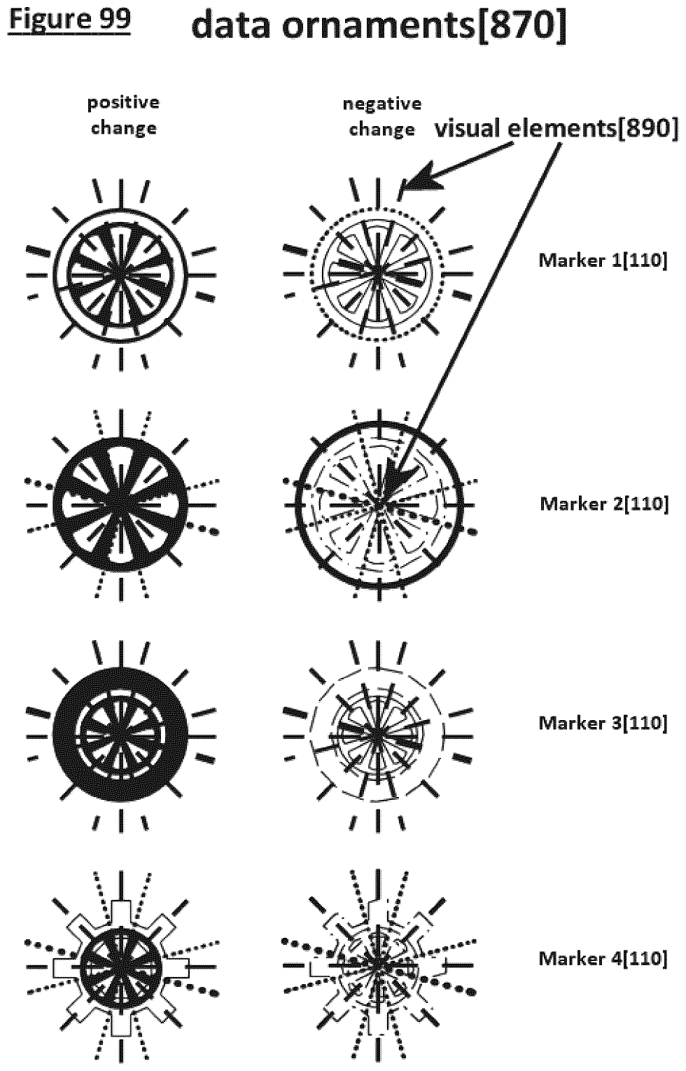

For the entities[150] or sets of entities[150] that are currently doing well—receiving many highly placed mentions[310] and marker values[270] changing for the good—the plumes[850] should resemble fireworks in many embodiments. However other valid embodiments may make different choices so long as the selected metaphor is something that most users[800] will associate with a sense of joy or celebration. Conversely, for those entities[150] who are falling out of view for whatever reason and receiving fewer, more lowly placed mentions[310], the plumes[850] will appear to be sputtering or not working well in most embodiments—like an engine that sparks a little intermittently but can't actually be started. As with the positive[635] case, different embodiments may choose alternate representations with the same connotations. This is pictured in FIG. 99.

### Fireworks Bursts/Ornaments[870]

While the volume and quality of mentions[310] form the backbone of the plume[850] in most embodiments, more complex data ornaments[870] or “fireworks bursts” will be used to provide other important types of notifications[1000]. These notifications[1000] will include significant changes in the values[270] of any of the markers[110] for the target entities[150] for whom data is being analyzed in the display instance[840]. The ornaments[870] are composed of visual components[890] of different sizes, shapes, colors, and trajectories, much as are real world fireworks.

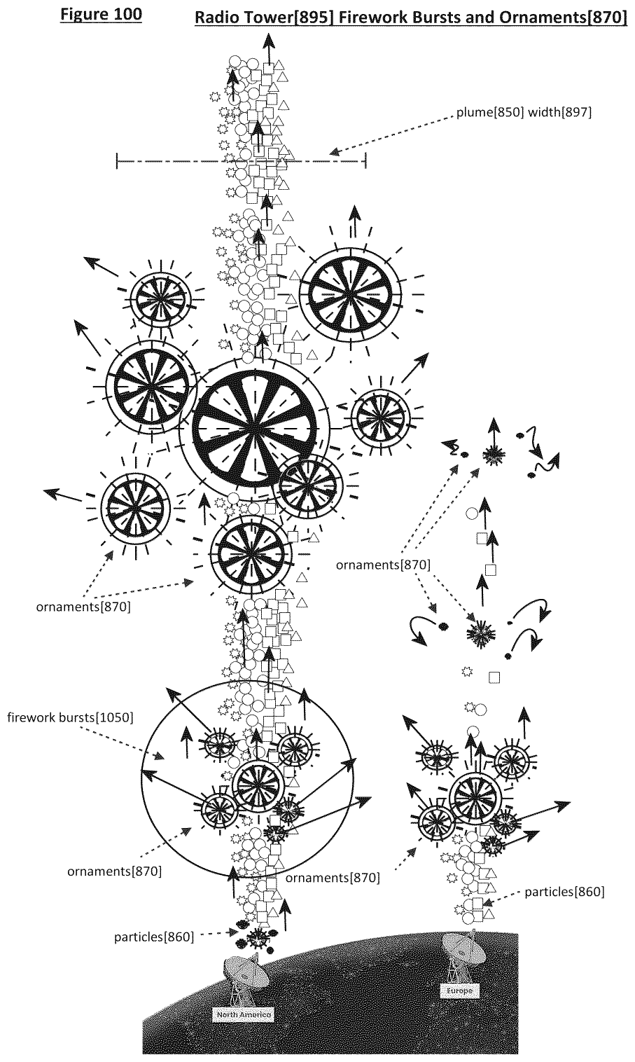

As depicted in FIG. 100, in most embodiments, these ornaments[870] will be substantially composed of angular and straight line visual elements[890] so as to clearly distinguish them visually from groups of particles[860] which are composed of curves rather than edges in most embodiments. For the same reason, the ornaments[870] when they “burst” will have at least some of their visual components[890] travel in a horizontal or clearly diagonal trajectory (assuming that the particles[860] are moving mostly vertically.) Thus the trajectory of the visual components[890] of the ornaments[870] will differ from that of the particles[860]. Most of the visual components[890] of the ornaments[870] will also be noticeably larger than particles[860]

Because even a large change in value[270] of a single marker[110] can occur temporarily for somewhat random reasons (including but not limited to someone being physically absent at a specific event, or under the weather), some embodiments will require statistically significant changes in two or more unrelated markers[110] over a specific window of time[670] in order to render a data ornament[870] in the stream[850]. The more significant changes in different marker values[270] that are detected within the same or adjacent windows of time[677], the greater the number of bursts or mini-fireworks[1050] rendered in the plume[850].

Most embodiments will set a system configuration[815] threshold for what constitutes a “significant” change in marker values[270]. In a default embodiment, each independent marker[110] that manifests a significant score[270] change will be partially rendered in the color[1055] associated with the given marker[110] by default in the system configuration[815], or as modified by the user[800]. The more such markers[110] there are in the same time slice[677], the greater the number of mini-bursts[1050]—and so the larger the size of the ornament[870]. However, owing to width[897] limitations, the system[180] will size-to-fit the mini-bursts[1050] in the ornament[870].

As pictured in FIG. 96, most embodiments will provide graphics and animation templates for ornaments[870] to help ensure that they are very distinct from groups of particles[860]. In most of these embodiments, templates for more complex ornaments[870]—which is to say, ornaments[870] with a greater number of visual components[890]—will be available for related groups of markers[110]. Otherwise put, each mini-burst[1050] in an ornament[870] should be associated with mutually orthogonal markers[110].

Most embodiments will allow users[800] to determine the colors[1057] of some of the visual components[890] of these ornaments[870] which indicate positive[635] vs negative[637] polarity[630] changes. This is to deal with the fact that the meaning of different colors differs by culture. Some embodiments will divide up color usage of ornaments[870] by visual component[890] while others will mix the two colors[1055] [1057] when both are defined in some or all of the larger visual components[890] of the ornament[870.] Some embodiments may choose to go further than this in terms of allowing user[800] customization.

Most embodiments will support the idea of positive[635] vs negative[637] polarity[630] changes both in terms of specific individual markers[110] for the given target entit(ies)[150] that have a clear associated polarity[630]—for example, the aesthetic goodness marker[1700] which measures how flattering or not a given photo[130] is of a particular person[370]—and of overall changes in marker values[270]. Although many markers[110] do not have a context-free polarity[630], many embodiments will allow marker[110] polarity[630] in the given instance to be set according to the cluster polarity[1345].

Many embodiments will also support “unknown” change. This occurs when the polarity[630]—bearing markers[110] change in inconsistent directions, or when the values[270] of multiple independent markers[110] are vacillating. This situation could occur for example in a big breaking news story in which the initial facts are murky and may subsequently be contradicted. As such situations can be quite important, most embodiments will choose to specially visualize “unknown” changes.

It should be emphasized that different embodiments may make different determinations on which markers[110] or polarity[630]—bearing and even what the polarities[630] are. For example, while in some cultures making someone[370] look older than they actually are may be considered a disservice, in other cultures, conceivably the reverse could be true. Likewise, it is conceivable for example that in some cultures being last in a list[490] is preferable to appearing first.

In some embodiments, the data ornaments[870] will move at the average pace[865] of particles[860] in the plume[850]; other embodiments may choose to take different approaches. At the time that the ornament[870] is first detected by the system[180] and is rendered in a display instance[840], it is unknowable whether the detected change(s) in marker values[270] will last, revert to their prior state, or change further. Thus it is a bit arbitrary as to what exact point the ornament[870] should appear or fade from the display[840].

Almost all embodiments will allow prior periods of time to be replayed with standard video clip navigation tools. For both playback and real time viewing, almost all embodiments have a date and timeline widget[1670]. In most embodiments, this will appear at the bottom of the display. In many embodiments, a system[180]—generated thumbnail image[1010] of any news story that was responsible for anomalies on a given day or hour will be rendered in or near the timeline widget[1670] as data[1435] for that day or hour is displayed, and for a frame or two before and after. In most embodiments this thumbnail will be generated based on an image[130] selected from the cluster[1375] of images[130] containing the most commonly occurring entities[350] in relation to the specific news cycle[235]—or alternately just selecting a canonical image[130] related to the new cycle[235] at random from the set of scoped media outlets[220] associated with the particular emitter[895] object. This can be seen in FIG. 97. This serves as a visual cue as to why, for example, the number of mention particles[860] soared at a particular day or time. It is especially useful in playback mode, since over time it is easy for users[800] to forget which news events[340] occurred on which dates.

Almost all embodiments will include a single click control to capture the current state of the display instance[840]. Most embodiments will also include controls to easily create video snippets that capture user[800]—specified periods of time, both by starting and ending time or date stamp and by selecting one or more notifications[1000]. In the latter case, the user[800] can provide a desired window of time[670] around the notification(s)[1000] in most embodiments; there will also generally be a system[180] default.

### CONCLUSION

The invention disclosed in this document presents a cross-media format[200] and outlet type[440] system[180] for comprehensively assessing different kinds of bias[260] in an objective manner, based on empirical models[680] of how different media outlets[160] with different scopes[170] demonstrably behave over time. The system[180] in most embodiments places a strong emphasis on omissions[690], with respect to individual assertions[500], entities[350] and news cycles[235] as well as with excerpts[575] from specific bounded content[320] such as transcripts [480], documents[485], or videos[140]. This is because strategic omission[690] can often generate far more real-world influence—and therefore cause potentially significant real-world good or harm—than statements[510] that actually did appear.

In an era in which information operations are becoming simultaneously more sophisticated, subtle, and generative AI-driven, the need for comprehensive, large scale, cross-media[200, 440] analysis of bias[260] has never been greater. The disclosed invention is responsive to this important emerging need.

Some portions of the detailed description are presented in terms of algorithms and symbolic representations of operations within a computer or other computing environment (e.g., a server, cloud architecture with storage, etc.) involving physical hardware processors and physical storage or memory. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for detecting silent bias across media platforms, comprising executing several empirical models on media across different media outlets to detect strategic omission.
